(19) United States
(12) Patent Application Publication
(10) Pub. No.: US 2024/0112143 A1
(43) Pub. Date: Apr. 4, 2024

(54) ADMINISTRATION SERVICES FOR MANAGING GROUP FEEDBACK

(71) Applicant: Degree, Inc., San Francisco, CA (US)

(72) Inventors: Eric Koslow, San Francisco, CA (US); Amy Ming Luo, Millbrae, CA (US); Byron Sha Yang, San Jose, CA (US); Joan Roig, San Francisco, CA (US); Victor Kmita, San Francisco, CA (US); Johannes Ma, San Francisco, CA (US); Elliot Dahl, San Francisco, CA (US); Adnan Chowdhury, San Francisco, CA (US); Ricky Rizal Zein, Brooklyn, NY (US); William Michael Dybas, San Francisco, CA (US); Jack Hanford, San Francisco, CA (US); Ryan Hinshaw, San Francisco, CA (US); Jared Erondu, New York, NY (US); Aleksandr Mistratov, San Francisco, CA (US); Rahul Rangnekar, San Francisco, CA (US); Carrie Jo Noonan, Wheat Ridge, CO (US); Jerry Xie, San Francisco, CA (US); Nathalie Corinne Bize, Noisy-le-Grand (FR); Hari Vignesh Ganesan, Jersey City, NJ (US); Audrey Chou, Brooklyn, NY (US); Elise Fung, San Francisco, CA (US); Jay Ashish Mahabal, New York, NY (US)

(21) Appl. No.: 18/479,777

(22) Filed: Oct. 2, 2023

Related U.S. Application Data
(60) Provisional application No. 63/377,973, filed on Sep. 30, 2022.

(51) Int. Cl. G06Q 10/105; G06F 9/451; H04L 67/306

(52) U.S. Cl. CPC G06Q 10/105; G06F 9/451; H04L 67/306

(57) ABSTRACT

A method of implementing administrative services for managing group feedback is disclosed. A selection of a feedback visibility setting for a feedback message from a plurality of predefined feedback visibility settings is received via a give feedback tab of a user interface. The feedback message and a selection of one or more recipients are received via the give feedback tab. The feedback message is sent to the selected one or more recipients based on the selected feedback visibility setting. A request for feedback and a selection of one or more feedback providers are received via a request feedback tab of the user interface. The request for feedback is sent to the selected one or more feedback providers. Received feedback responses linked to a user profile of the feedback requestor are stored.

### CROSS REFERENCE TO RELATED APPLICATIONS

This application claims the benefit of U.S. Provisional Application No. 63/377,973, filed Sep. 30, 2022, which is hereby incorporated by reference herein in its entirety.

### TECHNICAL FIELD

The present application relates generally to the technical field of computer system administration and, in one specific example, to implementing and/or configuring computer services, applications, user interfaces, and/or tools to facilitate administration of a performance platform deployed within one or more computer networks.

### BACKGROUND

Organizations may deploy one or more software applications within one or more computer networks to facilitate management of employees of the organization. Such software systems may include human resource (HR) systems, which may be configured to, for example, store and manage confidential employee data, handle employee-centric HR processes, such as recruitment and/or performance, and or handle offboarding. Additionally, some HR platforms may be configured to keep track of employee goals, performance, compensation, or engagement.

### BRIEF DESCRIPTION OF THE DRAWINGS

FIG. 1 is a network diagram depicting a system 100 within which various example embodiments may be deployed.

FIG. 2 is a block diagram illustrating example modules of the service(s) 120.

FIG. 3 is a schematic of a user interface displaying a create custom role page containing various permissions which can be granted.

FIG. 4 is a schematic of a user interface displaying a 1:1s reporting page.

FIG. 5 is a schematic of a log in page for a mobile app.

FIG. 6 is a schematic of a user interface displaying a preview of a company 1:1 template.

FIG. 7 is a schematic demonstrating how to navigate a user interface to deactivate company 1:1 templates from within the 1:1s settings page.

FIG. 8 is a schematic demonstrating how to navigate a user interface to be taken to the 1:1s settings page.

FIG. 9 is a schematic demonstrating how to navigate a user interface to add recurring talking points from within the 1:1s settings page.

FIG. 10 is a schematic of a user interface displaying a user's 1:1s page containing recurring agenda items.

FIG. 11 is a schematic of a user interfacing displaying the 1:1s tab from within the 1:1s log.

FIG. 12 is a schematic of a user interface displaying the individuals tab from within the 1:1s log.

FIG. 13 is a schematic of a user interface displaying an adoption page with a graph of the participated metric.

FIG. 14 is a schematic of a user interface displaying an adoption page in table view.

FIG. 15 is a schematic demonstrating how to navigate a user interface to adjust groups within the participated graph on the adoption page.

FIG. 16 is a schematic demonstrating how to navigate a user interface to make groups visible or invisible within the participated graph on the adoption page.

FIG. 17 is a schematic of a user interface displaying a portion of the adoption page where information may be grouped by a filter and the time frame may be adjusted.

FIG. 18 is a schematic demonstrating how to navigate a user interface to enter a 1:1 agenda for a direct report.

FIG. 19 is a schematic demonstrating how to navigate a user interface to add talking points to an agenda.

FIG. 20 is a schematic demonstrating how to navigate a user interface to shuffle through recommended talking points for a 1:1.

FIG. 21 is a schematic of a user interface displaying a direct report's profile page containing a 1:1 context panel.

FIG. 22 is a schematic of a user interface displaying a direct report's profile page with a 1:1 context panel containing past activity.

FIG. 23 is a schematic demonstrating how to navigate a user interface to hide the 1:1 context panel.

FIG. 24 is a schematic of a user interface displaying a direct report's profile page containing shared notes.

FIG. 25 is a schematic of a portion of a user interface displaying the addition of an action item.

FIG. 26 is a schematic demonstrating how to navigate a user interface to view past 1:1 agendas.

FIG. 27 is a schematic demonstrating how to navigate a user interface to turn on a 1:1 relationship for a direct report.

FIG. 28 is a schematic demonstrating how to navigate a user interface to complete the set up of a 1:1 relationship.

FIG. 29 is a schematic demonstrating how to navigate a user interface to view different 1:1 relationships.

FIG. 30 is a schematic of a user interface displaying the inactive section of a 1:1s page.

FIG. 31 is a schematic demonstrating how to navigate a user interface to create an agenda for a team.

FIG. 32 is a schematic demonstrating how to navigate a user interface to edit or delete an agenda template for a team.

FIG. 33 is a schematic demonstrating how to navigate a user interface to add a talking point to a 1:1.

FIG. 34 is a schematic of a user interface displaying a popup modal for planning a 1:1.

FIG. 35 is a schematic demonstration how to navigate a user interface to apply a template to a 1:1: agenda.

FIG. 36 is a schematic of a user interface displaying a review packet for a direct report.

FIG. 37 is a schematic of a user interface displaying a direct report's 1:1s page.

FIG. 38 is a schematic of a user interface displaying a direct report's review packet containing the option to plan a 1:1.

FIG. 39 is a schematic of a user interface displaying a direct report's 1:1s page containing the option to browse 1:1 templates.

FIG. 40 is a schematic demonstrating how to navigate a user interface to be taken to the settings page for a 1:1 with a direct report.

FIG. 41 is a schematic demonstrating how to navigate a user interface to toggle recommended talking points on/off from within a settings page for a 1:1 with a direct report.

FIG. 42 is a schematic of a user interface displaying a 1:1 page for a direct report containing the option to shuffle recommended talking points.

FIG. 43 is a schematic of a user interface displaying a home page with the option to plan 1:1s.

FIG. 44 is a schematic of a user interface displaying a list of upcoming and inactive 1:1s on a 1:1s page.

FIG. 45 is a schematic of a user interface displaying a settings modal for a 1:1 with the option to toggle off 1:1s.

FIG. 46 is a schematic of a user interface displaying the inactive 1:1s section of a 1:1s page.

FIG. 47 is a schematic of a user interface displaying a 1:1s page containing a list of upcoming 1:1s and inactive 1:1s.

FIG. 48 is a schematic of a portion of a user interface displaying a 1:1s setting page with an option to connect to an existing calendar event.

FIG. 49 is a schematic of a user interface displaying a popup for connecting a calendar provider.

FIG. 50 is a schematic of a user interface displaying a popup modal requesting permission for Outlook to sync with the system.

FIG. 51 is a schematic of a user interface displaying a popup modal for selecting a calendar to integrate.

FIG. 52 is a schematic of a user interface displaying a popup modal for selecting an event to integrate.

FIG. 53 is a schematic of a portion of a user interface displaying an Outlook calendar with a link to join Zoom.

FIG. 54 is a schematic of a user interface displaying a 1:1s page containing a link to settings.

FIG. 55 is a schematic demonstrating how to navigate a user interface to view the 1:1s page.

FIG. 56 is a schematic demonstrating how to navigate a user interface to view settings for a 1:1 relationship.

FIG. 57 is a schematic of a user interface displaying a home page with a link to the plan 1:1s page.

FIG. 58 is a schematic of a user interface displaying a set up page for a first 1:1 meeting.

FIG. 59 is a schematic of a user interface displaying a completed set up page for a first 1:1 meeting.

FIG. 60 is a schematic demonstrating how to navigate a user interface to set up a 1:1 with a teammate.

FIG. 61 is a schematic of a user interface displaying a page for setting up a 1:1.

FIG. 62 is a schematic of a user interface displaying a completed set up page for a 1:1.

FIG. 63 is a schematic demonstrating how to navigate a user interface to access the profile of a 1:1 participant from the 1:1s page.

FIG. 64 is a schematic of a portion of a user interface displaying a 1:1 agenda with a date and time.

FIG. 65 is a schematic of a user interface displaying an email notification that a 1:1 relationship was created.

FIG. 66 is a schematic demonstrating how to navigate a user interface to enter a 1:1 agenda with a manager from the 1:1s page.

FIG. 67 is a schematic of a user interface displaying a 1:1 agenda with the option to add a talking point.

FIG. 68 is a schematic of a user interface displaying a 1:1 agenda with the option to add a system recommended talking point.

FIG. 69 is a schematic of a user interface displaying a 1:1 agenda page containing a 1:1 context panel.

FIG. 70 is a schematic of a user interface displaying a 1:1 agenda page containing a 1:1 context panel.

FIG. 71 is a schematic of a portion of a user interface displaying a 1:1 context panel with the option to hide the panel.

FIG. 72 is a schematic of a user interface displaying a 1:1 agenda page containing shared notes.

FIG. 73 is a schematic of a portion of a user interface displaying an action item.

FIG. 74 is a schematic of a user interface displaying a 1:1 agenda page containing a drop-down with upcoming and past 1:1 agendas.

FIG. 75 is a schematic demonstrating how to navigate a user interface to be taken to a desired 1:1 agenda.

FIG. 76 is a schematic demonstrating how to navigate a user interface to be taken to settings from a 1:1 agenda page.

FIG. 77 is a schematic of a user interface displaying a 1:1 settings page with the option to select an agenda template.

FIG. 78 is a schematic of a user interface displaying a create agenda template page.

FIG. 79 is a schematic of a mobile user interface displaying the you page containing all 1:1 relationships.

FIG. 80 is a schematic of a mobile user interface displaying the employee profile of a 1:1 relationship.

FIG. 81 is a schematic of a mobile user interface displaying a past 1:1 page.

FIG. 82 is a schematic of a mobile user interface displaying the detailed view of a goal for a 1:1 participant.

FIG. 83 is a schematic of a mobile user interface displaying completed talking points for a 1:1 meeting.

FIG. 84 is a schematic demonstrating how to start a direct message with the system in Slack.

FIG. 85 is a schematic demonstrating how to select the system in Slack.

FIG. 86 is a schematic of a portion of a user interface displaying a 1:1 agenda with a Slack conversation added as a talking point.

FIG. 87 is a schematic of the Slack Bot displaying a list of system actions including adding a new 1:1 talking point.

FIG. 88 is a schematic of the Slack Bot displaying the option to be taken to the 1:1 agenda to create a new 1:1 talking point.

FIG. 89 is a schematic of a modal for adding a new 1:1 talking point.

FIG. 90 is a schematic demonstrating how to navigate a user interface to add a 1:1 talking point via message action.

FIG. 91 is a schematic of a user interface displaying a 1:1 agenda containing action items.

FIG. 92 is a schematic of a user interface displaying a 1:1s page containing action items.

FIG. 93 is a schematic of a user interface displaying a 1:1 agenda containing the options to add an action item and schedule a due date.

FIG. 94 is a schematic of a user interface displaying a list of action items.

FIG. 95 is a schematic of a portion of a user interface displaying a 1:1 agenda containing list of complete and incomplete action items.

FIG. 96 is a schematic of a user interface displaying a 1:1s page with the option to mark action items as complete.

FIG. 97 is a schematic of a portion of a user interface displaying a 1:1 agenda containing the option to turn off action items.

FIG. 98 is a schematic demonstrating how to navigate a user interface to be taken to the settings page for a 1:1 agenda.

FIG. 99 is a schematic of a user interface displaying the settings page for a 1:1 agenda with the option to toggle on/off recommended talking points.

FIG. 100 is a schematic of a user interface displaying a 1:1 agenda page containing recommended talking points.

FIG. 101 is a schematic of a user interface displaying the updates tool containing the option to add a question to an update.

FIG. 102 is a schematic of a user interface displaying the updates tool containing the option to add a question from a direct report to an upcoming 1:1 agenda.

FIG. 103 is a schematic of a user interface displaying a 1:1 tool containing a context panel with the option to view update.

FIG. 104 is a schematic of a user interface displaying a 1:1 containing an update comment.

FIG. 105 is a schematic demonstrating how to navigate a user interface to view a 1:1 agenda from the 1:1 tool.

FIG. 106 is a schematic of a user interface displaying a 1:1 agenda containing a context panel with active growth areas.

FIG. 107 is a schematic of a user interface displaying a 1:1 agenda containing a text box to add a progress description to a growth area.

FIG. 108 is a schematic of a user interface displaying a grow tool containing a growth area update beneath a progress heading.

FIG. 109 is a schematic of a user interface displaying a 1:1 settings page containing the option to toggle on/off rolling over unchecked talking points.

FIG. 110 is a schematic of a user interface displaying a 1:1 agenda containing talking points from a previous meeting.

FIG. 111 is a schematic demonstrating how to navigate a user interface to select a 1:1 meeting from the 1:1 tool.

FIG. 112 is a schematic of a portion of a user interface displaying a 1:1 agenda containing the date of the 1:1.

FIG. 113 is a schematic of a portion of a user interface displaying a 1:1 agenda containing fields for adjusting the date and time of a 1:1.

FIG. 114 is a schematic demonstrating how to navigate a user interface to select a 1:1 agenda.

FIG. 115 is a schematic demonstrating how to navigate a user interface to view settings for a 1:1 meeting from a 1:1 agenda.

FIG. 116 is a schematic of a user interface displaying a 1:1 settings page with the option to adjust the time and date of a following 1:1.

FIG. 117 is a schematic of a portion of a user interface displaying the option to join Zoom from within the 1:1 agenda.

FIG. 118 is a schematic of a user interface displaying a notification center with the option to select a delivery method for 1:1 notifications.

FIG. 119 is a schematic of a notification indicating that a 1:1 relationship has been set up.

FIG. 120 is a schematic of a notification containing the agenda for an upcoming 1:1.

FIG. 121 is a schematic of a notification containing the agenda for a past 1:1.

FIG. 122 is a schematic of a user interface displaying a notifications settings page with the option to enable or disable pre- and post-meeting notifications.

FIG. 123 is a schematic of a user interface displaying a home page with a set up 1:1s with your new direct report task.

FIG. 124 is a schematic of a user interface displaying a 1:1 setup modal.

FIG. 125 is a schematic demonstrating how to navigate a user interface to send 1:1s notifications from the notification center.

FIG. 126 is a schematic of a slack notification regarding a 1:1 meeting.

FIG. 127 is a schematic demonstrating how to navigate a user interface to be taken to the updates settings page.

FIG. 128 is a schematic of a user interface displaying an employee sentiment score rating with the option to add context through the share more button.

FIG. 129 is a schematic of a user interface displaying an updates settings page containing default updates settings.

FIG. 130 is a schematic of a user interface displaying an updates adoption page containing a graph of sentiment metrics.

FIG. 131 is a schematic of a user interface displaying a table view of the data shown in the graph of sentiment metrics.

FIG. 132 is a schematic demonstrating how to navigate a user interface to make groups visible or invisible on the graph within the updates adoption page.

FIG. 133 is a schematic of a user interface displaying the updates tab of the updates log.

FIG. 134 is a schematic of a user interface displaying the individuals tab of the update log.

FIG. 135 is a schematic of a user interface displaying a team settings page containing default questions and the option to input custom questions.

FIG. 136 is a schematic demonstrating how to navigate a user interface to be taken to an update settings page.

FIG. 137 is a schematic of a user interface displaying an update settings page for a specific employee.

FIG. 138 is a schematic demonstrating how to navigate a user interface to be taken to the people page from a home page.

FIG. 139 is a schematic demonstrating how to navigate a user interface to review an update from the updates page.

FIG. 140 is a schematic of a user interface displaying an updates page for reviewing an update.

FIG. 141 is a schematic of a user interface displaying a rating system for an update with the option to mark the update as reviewed.

FIG. 142 is a schematic of the format for attaching a link within the comment section of an update.

FIG. 143 is a schematic of an email reminder that an update is due.

FIG. 144 is a schematic demonstrating how to navigate a user interface to access an updates page from the people page.

FIG. 145 is a schematic of a user interface displaying an updates page indicating the last time the draft update was auto saved.

FIG. 146 is a schematic of a user interface displaying an updates page containing a list of updates which may be edited.

FIG. 147 is a schematic of a user interface displaying an updates page with the option to edit the update.

FIG. 148 is a schematic of a user interface displaying a page for editing an update.

FIG. 149 is a schematic of a portion of a user interface displaying the option to save edits to an update.

FIG. 150 is a schematic demonstrating how to navigate a user interface to select an update from the updates page.

FIG. 151 is a schematic of a user interface displaying an update page containing the option to clear the update.

FIG. 152 is a schematic of a confirmation message for clearing an update.

FIG. 153 is a schematic of a mobile user interface displaying a home page containing the option to access the updates toolkit.

FIG. 154 is a schematic of a mobile user interface displaying the updates toolkit with privacy turned on for the update.

FIG. 155 is a schematic of a mobile user interface displaying the updates toolkit with privacy turned off for the update.

FIG. 156 is a schematic of a portion of a mobile user interface displaying the option to save an update as a draft.

FIG. 157 is a schematic of a portion of a mobile user interface displaying the option to select . . . to view previously published updates.

FIG. 158 is a schematic of a portion of a mobile user interface displaying a list of previous updates.

FIG. 159 is a schematic of a mobile user interface displaying a page for editing an update.

FIG. 160 is a schematic of a user interface displaying a notifications center containing the option to select Slack, Microsoft Teams, or email for updates notifications.

FIG. 161 is a schematic of an email notification indicating that updates have been turned on for an employee.

FIG. 162 is a schematic of an email notification indicating that updates have been turned on for an employee who has not had updates turned on before.

FIG. 163 is a schematic of a Slack notification indicating that updates have been turned on for an employee.

FIG. 164 is a schematic of a Microsoft Teams notification indicating that updates have been turned on for an employee.

FIG. 165 is a schematic of an email notification containing a link to view an update submitted by an employee.

FIG. 166 is a schematic of a Slack notification containing a link to view an update submitted by an employee.

FIG. 167 is a schematic of an email notification indicating that a manager has reviewed an update made by an employee.

FIG. 168 is a schematic of a user interface displaying an updates settings page containing the option to set a cadence for updates reminders.

FIG. 169 is a schematic demonstrating how to navigate a user interface to update updates settings when manager override is on.

FIG. 170 is a schematic of a user interface displaying an updates page for an employee containing a link to view updates settings.

FIG. 171 is a schematic of a user interface displaying an updates settings page for an employee.

FIG. 172 is a schematic of a portion of a user interface displaying a notifications settings page with the option to toggle on/off the update reminder.

FIG. 173 is a schematic of an email notification containing a reminder to submit an update.

FIG. 174 is a schematic of a Slack notification containing a reminder to submit an update.

FIG. 175 is a schematic of an email notification indicating that a manager left a comment on an update made by an employee.

FIG. 176 is a schematic of a Slack notification indicating that a manager left a comment on an update made by an employee.

FIG. 177 is a schematic of a user interface displaying a task list for a manager including a task prompting the manager to set up updates with a new report.

FIG. 178 is a schematic of a user interface displaying a modal containing the option to set up questions and settings for a new report.

FIG. 179 is a schematic of a user interface displaying a task list for a manager including a task prompting the manager to review an update.

FIG. 180 is a schematic of a user interface displaying a modal for reviewing an update submitted by an employee.

FIG. 181 is a schematic demonstrating how to navigate a user interface to view feedback settings.

FIG. 182 is a schematic demonstrating how to navigate a user interface to customize feedback types.

FIG. 183 is a schematic of a user interface displaying a feedback tool containing the option to select the visibility of feedback.

FIG. 184 is a schematic of a user interface displaying a feedback tool with the private+manager feedback type disabled.

FIG. 185 is a schematic demonstrating how to navigate a user interface to toggle on/off external feedback.

FIG. 186 is a schematic demonstrating how to navigate a user interface to toggle on/off feedback nudges for managers.

FIG. 187 is a schematic of an email notification containing a nudge given three weeks after an employee's start date.

FIG. 188 is a schematic of a Slack notification containing a nudge given three weeks after an employee's start date.

FIG. 189 is a schematic of an email notification containing a nudge given if a direct report has not received praise in 60 days.

FIG. 190 is a schematic of a Slack notification containing a nudge given if a direct report has not received praise in 60 days.

FIG. 191 is a schematic demonstrating how to navigate a user interface to access the praise wall as an admin.

FIG. 192 is a schematic of an example slide from the praise wall slideshow presentation.

FIG. 193 is a schematic of a user interface displaying a feedback reporting page containing a graph of given feedback adoption.

FIG. 194 is a schematic of a user interface displaying a feedback reporting page containing a table view of given feedback adoption.

FIG. 195 is a schematic of a user interface displaying a feedback reporting page containing a drop-down menu for making groups visible or invisible.

FIG. 196 is a schematic of a user interface displaying the feedback tab of the feedback log.

FIG. 197 is a schematic of a user interface displaying the pending requests tab of the feedback log.

FIG. 198 is a schematic of a user interface displaying the individuals tab of the feedback log.

FIG. 199 is a schematic of a user interface displaying a page for customizing a CSV before exporting.

FIG. 200 is a schematic demonstrating how to navigate a user interface to request feedback.

FIG. 201 is a schematic of a user interface displaying the request feedback tab of the feedback modal.

FIG. 202 is a schematic of a portion of a user interface displaying a notification indicating feedback was requested.

FIG. 203 is a schematic of a user interface displaying a page for providing feedback.

FIG. 204 is a schematic demonstrating how to navigate a user interface to enable company values.

FIG. 205 is a schematic of a user interface displaying a feedback page with the option to select one or more values.

FIG. 206 is a schematic demonstrating how to navigate a user interface to monitor which company values have been attached to specific individuals when giving feedback.

FIG. 207 is a schematic demonstrating how to navigate a user interface to request feedback for a team.

FIG. 208 is a schematic of a user interface displaying the request feedback tab of the feedback modal.

FIG. 209 is a schematic of a portion of a user interface displaying a notification requesting feedback.

FIG. 210 is a schematic of a user interface displaying the give feedback tab of the feedback modal.

FIG. 211 is a schematic demonstrating how to navigate a user interface to view feedback for a team.

FIG. 212 is a schematic of a user interface displaying the feedback tab of a my team page.

FIG. 213 is a schematic demonstrating how to navigate a user interface to view the feedback tab of a page for an individual direct report.

FIG. 214 is a schematic demonstrating how to navigate a user interface to view feedback for an indirect report.

FIG. 215 is a schematic of a portion of a user interface displaying a feedback card containing the option to select an emoji icon as a reaction to the feedback.

FIG. 216 is a schematic of a user interface displaying a feedback page containing a feedback summary.

FIG. 217 is a schematic demonstrating how to navigate a user interface to give and request feedback.

FIG. 218 is a schematic of a user interface displaying the give feedback tab of the feedback modal containing the option to select visibility for the feedback.

FIG. 219 is a schematic of a portion of a user interface displaying feedback and the visibility of the feedback within the system.

FIG. 220 is a schematic demonstrating how to navigate a user interface to give and request feedback.

FIG. 221 is a schematic of a user interface displaying the request feedback tab of the feedback modal containing a text box for identifying recipients of the feedback request.

FIG. 222 is a schematic of a user interface displaying the request feedback tab of the feedback modal containing a private link to view the feedback request.

FIG. 223 is a schematic of a user interface displaying a page for submitting feedback in response to a feedback request.

FIG. 224 is a schematic of a confirmation page for submitting feedback for an employee.

FIG. 225 is a schematic demonstrating how to navigate a user interface to delete a pending feedback request.

FIG. 226 is a schematic of a confirmation page for deleting a feedback request.

FIG. 227 is a schematic demonstrating how to navigate a user interface to be taken to the feedback modal.

FIG. 228 is a schematic of a user interface displaying the give feedback tab of the feedback modal containing the option to decline a pending feedback request.

FIG. 229 is a schematic of a confirmation page for declining a feedback request.

FIG. 230 is a schematic demonstrating how to navigate a user interface to decline a pending feedback request from the people page.

FIG. 231 is a schematic of a portion of a user interface displaying a confirmation page for declining a feedback request.

FIG. 232 is a schematic of a user interface displaying a review page for a direct report containing a context panel listing feedback including a note to self.

FIG. 233 is a schematic of a user interface displaying a review page for a peer containing a context panel listing feedback including a note to self.

FIG. 234 is a schematic of the Slack user interface displaying a drop-down menu for selecting a user to start a direct message with.

FIG. 235 is a schematic of the Slack user interface displaying a direct message thread with the Lattice app.

FIG. 236 is a schematic of a portion of the Slack user interface displaying a direct message thread with the System's app containing the action menu.

FIG. 237 is a schematic of a portion of the Slack user interface displaying a direct message from the System's app containing a link to submit public feedback.

FIG. 238 is a schematic of a portion of the Slack user interface displaying a pop-up modal for submitting public feedback.

FIG. 239 is a schematic of a portion of the Slack user interface displaying a text box containing the /praise command and text comprising the content of public feedback for individuals.

FIG. 240 is a schematic of a portion of the Slack user interface displaying a confirmation message that public feedback has been submitted.

FIG. 241 is a schematic of a portion of the Slack user interface displaying a pop-up modal containing a drop-down menu for adding company values to public feedback.

FIG. 242 is a schematic of a portion of the Slack user interface displaying a direct message thread with the System's app containing the action menu.

FIG. 243 is a schematic of a portion of the Slack user interface displaying a pop-up modal for providing private feedback.

FIG. 244 is a schematic of a portion of the Slack user interface displaying a direct message thread with the System's app containing the action menu.

FIG. 245 is a schematic of a portion of the Slack user interface displaying a pop-up modal for requesting private feedback.

FIG. 246 is a schematic of a portion of the Slack user interface displaying a direct message thread with the System's app containing a notification of a feedback request.

FIG. 247 is a schematic of a portion of the Slack user interface displaying a pop-up modal for responding to a feedback request.

FIG. 248 is a schematic of a portion of the Slack user interface displaying a direct message thread with the System's app containing the action menu.

FIG. 249 is a schematic of a portion of the Slack user interface displaying a pop-up modal for providing a private note to self about an individual.

FIG. 250 is a schematic of a user interface displaying a feedback page containing a note to self.

FIG. 251 is a schematic of a Gmail user interface displaying the system plug-in.

FIG. 252 is a schematic of a Gmail user interface displaying an email thread containing the option to submit feedback or write a note to self.

FIG. 253 is a schematic of a Gmail user interface displaying an email thread containing the option to submit feedback, select feedback visibility, and associate a value to the feedback.

FIG. 254 is a schematic of a mobile user interface displaying a You page containing a give feedback button.

FIG. 255 is a schematic of a mobile user interface displaying a page for submitting feedback and providing associated information.

FIG. 256 is a schematic of a mobile user interface displaying a page containing feedback that has been received by the user.

FIG. 257 is a schematic of a mobile user interface displaying a page containing public feedback that an individual has received.

FIG. 258 is a schematic of a portion of a user interface displaying the option to send feedback notifications through Microsoft Teams, Slack, and/or Email.

FIG. 259 is a schematic of an email notification indicating that feedback has been requested of the user.

FIG. 260 is a schematic of an email notification indicating the user has an unfulfilled feedback request.

FIG. 261 is a schematic of an email notification indicating the user has received feedback.

FIG. 262 is a schematic of an email notification indicating a direct report has received feedback.

FIG. 263 is a schematic of an email notification indicating a user has received a nudge to complete feedback for a direct report.

FIG. 264 is a schematic of a user interface displaying a home page containing a task notification for a pending feedback request.

FIG. 265 is a schematic of a user interface displaying a feedback module.

FIG. 266 is a schematic of a portion of a user interface displaying the option to send feedback notifications through Microsoft Teams, Slack, and/or Email.

FIG. 267 is a schematic of a portion of a Microsoft Teams user interface displaying a chat window containing a notification.

FIG. 268 is a block diagram illustrating a mobile device 26800 according to an example embodiment.

FIG. 269 is a block diagram of an example computer system 26900 on which methodologies and operations described herein may be executed, in accordance with an example embodiment.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Even after deploying various tools, such as one or more HR systems, organizations may have difficulty effectively linking the data items contained in them. For example, an organization may be unable to use the HR systems (or have difficulty using the HR systems) to link and/or surface data items pertaining to reviews, one-on-ones (referred to herein as 1:1s), feedback, praise, goals, and compensation of users having various roles, including employees, managers, managers of managers, and so on, such that each user is provided with insights specific to the user and/or suggestions of one or more actions specific to the user (e.g., for improving with respect to one or more user metrics and/or to help the organization improve with respect to one or more organizational metrics).

It can be a difficult technical problem to determine how to interconnect data items related to performance of employees such that an organization can, for example, optimally celebrate and reward employees for their efforts.

The system described herein enables administrators (e.g., business leaders within an organization) to, using advanced system and/or data management tools, align their employees around their company's strategic priorities and activate every employee to execute against them. In example embodiments, the system helps an organization bridge one or more gaps between people operations and business operations through management of data items that represent or define Objectives and Key Results (OKRs) of an organization and the interlinking of such OKR data items with other data items, such as those representing performance of an employee.

In example embodiments, the system may be configured to be integrated with external systems, such as Jira and Salesforce, such that goals and OKRs are synchronized across the organization's systems, and the organization's progress measurement and reporting stays up to date in real-time without the need for manual updating.

In example embodiments, the system may provide one or more interactive graphical user interfaces (GUIs), such as Actionable Goals Home and Explore pages, that may provide frictionless management of 1:1s, updates, feedback, goals, compensation, measurement, tracking, and achievements on an elevated surface with seamless actions right in a sidebar.

In example embodiments, the system may provide reporting power tools for users. Users may be assigned one more roles or personas, such as administrator, chief of staff, employee, manager, manager of manager (“MoM”), executive, executive assistance, operations leader, department head, business leader, people manager, data consumer, and so on. Each user and/or role assigned to the user may be associated with different access rights. For example, reporting dashboards may be accessible to managers or business leaders to report on goal status and identify where they can take action to keep the company on track.

In addition to helping employees align their work success with business success, the system provides various tools to help those employees feel recognized for that success. In example embodiments, various tools are provided for recognizing and celebrating individuals for their work, which, in turn, may lead to increased satisfaction and/or productivity, and decreased turnover. Recognition may come in many forms, such as public praise or awards, increased responsibility and, of course, compensation. But employees may not just be looking out for themselves; they may also want to know their colleagues and friends are also being rewarded for their work.

In example embodiments, the system facilitates development of compensation strategies that provide flexibility to attract and reward top performers while including checks and guidance that ensure compensation practices are equitable and aren't perpetuating bias.

In example embodiments, the system provides tools that support compensation decision-making and communication. For example, the tools may help to streamline the compensation process, integrate with performance data, and provide insight into pay trends across the company. Users, such as members of one or more HR teams, may manage their compensation review process in a centralized, secure hub and seamlessly integrate an employee's performance information into the decision-making process. Other users, such as managers and company leaders, may be given more insight into individual and team-wide pay trends as well as more context to navigate salary conversations with direct reports. Additionally, employees may be able to view their own compensation information directly.

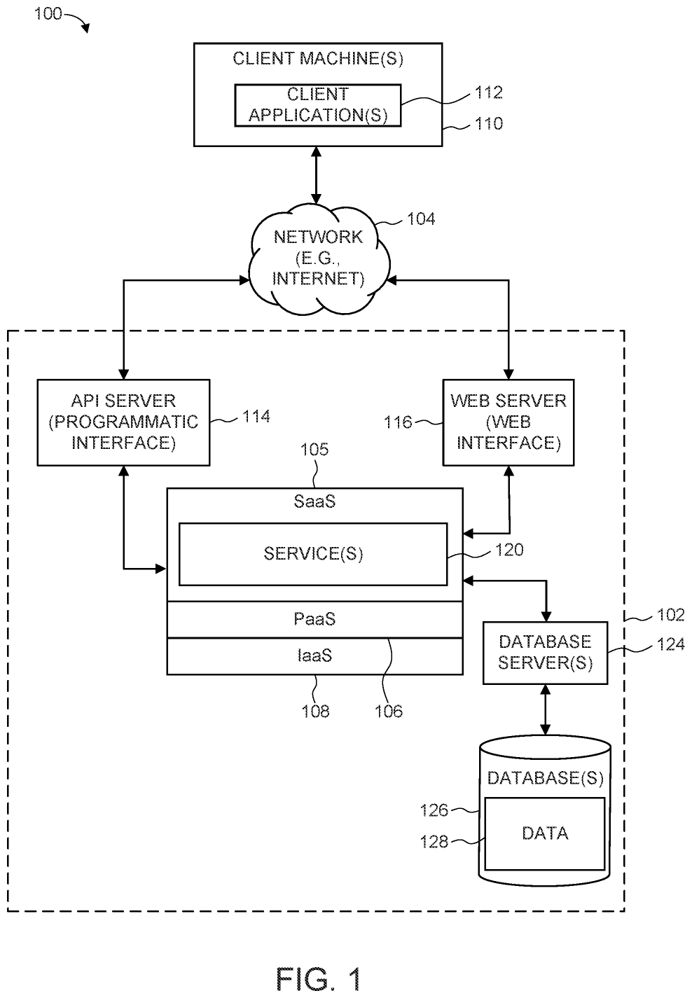

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The networked system 102 is also referred to herein as “Lattice,” the “system,” or the “platform.” FIG. 1 illustrates client application(s) 112 on the client machines 110. Examples of client application(s) 112 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications and file sharing applications. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 104. The SaaS platform 105 may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the service(s) 120 are shown in FIG. 1 to form part of the networked system 102, in alternative embodiments, the service(s) 120 may form part of a service that is separate and distinct from the networked system 102.

Further, while the system 100 shown in FIG. 1 employs a cloud-based architecture, various embodiments are, of course, not limited to such an architecture, and could equally well find application in a client-server, distributed, or peer-to-peer system, for example. The various service(s) 120 (e.g., server applications) could also be implemented as standalone software programs. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various service(s) 120 via the web interface supported by the web server 116. Similarly, native applications executing on the client machine(s) 110 may accesses the various services and functions provided by the service(s) 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The service(s) 120 may be hosted on dedicated or shared server machines (not shown) that are communicatively coupled to enable communications between server machines. The service(s) 120 themselves are communicatively coupled (e.g., via appropriate interfaces) to each other and to various data sources, so as to allow information to be passed between the service(s) 120 and so as to allow the service(s) 120 to share and access common data. The service(s) 120 may furthermore access one or more databases 126 via the database servers 124. In example embodiments, various data items are stored in the database(s) 126, such as data 128, including goals data items and/or compensation data items described herein. In example embodiments, the data 128 includes one or more data items or metadata items that are viewable and/or editable via one or more user interfaces described herein. The data 128 may include data items that are interrelated, connected, or interlinked, to, for example, provide connections between goals (and/or performances) of employees and objectives of an organization, as described in more detail herein.

Navigation of the networked system 102 may be facilitated by one or more navigation applications. For example, a search application (as an example of a navigation application) may enable keyword searches of data items included in the one or more database(s) 126 associated with the networked system 102. Various other navigation applications may be provided to supplement the search and browsing applications.

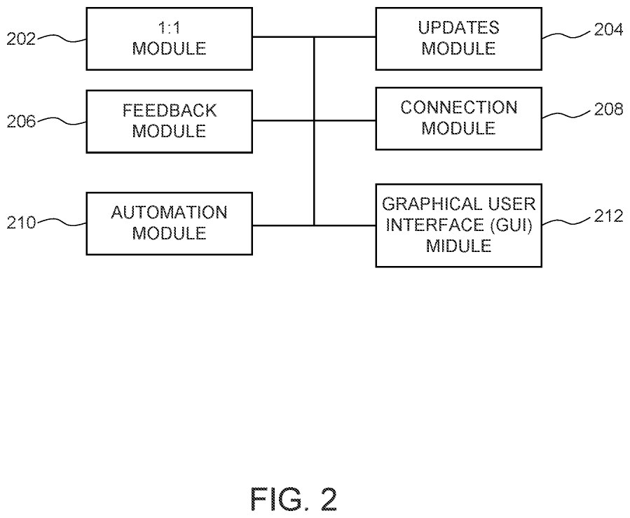

FIG. 2 is a block diagram illustrating example modules of the service(s) 120.

A 1:1 module 202 is configured to provide one or more tools to one or more types of users for managing 1:1s, as described in more detail herein. An updates module 204 is configured to provide one or more tools to one or more types of users for managing updates, as described in more detail herein. A feedback module 206 is configured to provide one or more tools to one or more types of users for managing feedback, as described in more detail herein.

In example embodiments, the 1:1 module 202 comprises instructions that when executed cause the system to generate user interfaces and functions for managing one-to-one meetings between participants. This includes generating user interfaces for creating meeting agendas, accessing prior meeting information, taking meeting notes, and integrating with calendar systems. The 1:1 module interacts with the database(s) 126 to store and retrieve information related to meetings. The automation module 210 works in conjunction with the 1:1 module 202 to provide suggested agenda items, reminders, and other automated features to enhance one-to-one meeting management.

The updates module 204 comprises instructions that when executed cause the system to generate user interfaces and functions for managing status updates. This includes interfaces for creating update templates, publishing updates, reviewing updates from team members, and accessing update analytics. The updates module leverages the connection module 208 to interlink update data with user goals and profiles from the database(s) 126. The automation module 210 works with the updates module 204 to suggest update questions and provide natural language processing to interpret update content.

The feedback module 206 comprises instructions that when executed cause the system to generate user interfaces and functions for managing group feedback. This includes interfaces for giving and requesting feedback, configuring feedback settings, and accessing feedback reports and summaries. The feedback module utilizes the connection module 208 to interlink feedback data with user profile information from the database(s) 126. The automation module 210 works with the feedback module 206 to provide automated nudges, reminders, and moderation to streamline the collection and dissemination of impactful group feedback.

A connection module 208 is configured to connect, link, or interrelate data items pertaining to 1:1s, updates, feedback, goals, or compensation with data items pertaining to objectives of the organization, as described in more detail herein. A goals module (not shown) is configured to provide users with access to goals services, including services for setting goals, integrating goals with external systems (e.g., Salesforce, Slack, and/or Microsoft Teams), acting on goal progress data in real time to keep an organization on track against key objectives, and/or increase employee engagement by connecting success of employees to success of the organization, as described in more detail herein. A compensation module (not shown) is configured to provide users with access to compensation services, including streamlining setup, launch, and tracking workflows to seamlessly include performance data in a compensation review process in a secure, centralized hub; connecting performance and compensation, including creating compensation guidelines and performance ratings, compensation ratios, and so on, to empower clarity and consistency across an organization; making compensation decisions more transparent and equitable by helping users provide context about specific recommendations and actions; and providing more transparency for users by closing out compensation reviewing, sharing outcomes with managers in just a few clicks, and generating compensation communications so that everyone can understand exactly how their compensation package is changing, as described in more detail herein.

An automation module 210 is configured to automate various tasks, such as, for example, providing various suggestions, as described herein. In example embodiments, some automation may be used in machine learning. For example, a machine-learning model may be trained to output a value (e.g., a time period, cadence, and so on) that optimizes the performance of the organization with respect to one or more objectives. The inputs to the machine-learning model may include one or more relevant data items (e.g., from data 128). The machine-learning model may then be applied to generate the value based on novel input data.

A dynamic graphical user interface (GUI) module 212 is configured to provide one or more specialized graphical user interfaces, as described herein, to, for example, allow users to manage and/or link data pertaining to goals, compensation, and/or OKRs. In example embodiments, the one or more specialized user interfaces and/or elements included in the one or more specialized user interfaces, and/or combinations thereof, are asserted to be unconventional. Additionally, the one or more specialized user interfaces described include one or more features that specially adapt the one or more specialized user interfaces for devices with small screens, such as mobile phones or other mobile devices.

The administrative services described herein, including those related to managing one-to-one meetings, managing group feedback, and managing status updates, can utilize machine learning techniques to further enhance the functionality and automation provided. Some non-limiting examples are provided below.

For managing one-to-one meetings, machine learning can be used to train models to automatically suggest relevant talking points based on analysis of user profiles and past meetings. For example, a recurrent neural network model can be trained on past meeting data to identify patterns and generate talking point suggestions. The training data can be preprocessed by extracting keywords, topics, and entities from meeting transcripts, profiles, and materials using natural language processing. The model can then learn to correlate these features with effective talking points. A machine learning model can be trained to predict how effective a scheduled one-to-one meeting will be based on analysis of participant profiles, personalities, past meetings, and meeting details. This allows for proactively optimizing meetings. A natural language processing model can be trained to listen to one-to-one meeting recordings and automatically generate notes, summaries, and action items. This automates post-meeting documentation.

For managing group feedback, machine learning can be used to automatically moderate and filter feedback. For example, a convolutional neural network model can be trained to classify feedback comments as constructive, unconstructive, off-topic, etc. The training data can consist of labeled example comments. Text embedding and other natural language processing can be used to extract semantic features from the comments during preprocessing. The model can then learn to classify new feedback comments based on the extracted features. Machine learning techniques can be used to analyze feedback comments to identify sentiment (positive, negative, neutral) and highlight portions that are especially constructive or unconstructive. Based on analysis of performance data and reviews, a machine learning model can be trained to generate suggested feedback comments for managers to give their reports. This helps managers provide meaningful, data-driven feedback.

For managing status updates, machine learning can be used to automatically suggest relevant questions to include based on previous updates. For example, a transformer neural network model can be trained to generate suggested update questions using a sequence-to-sequence approach. The training data can consist of past update questions and answers. During preprocessing, the questions and answers can be encoded into vector representations using embedding techniques. The model can then learn to correlate certain questions and answers to generate relevant suggestions for future updates. Machine learning can forecast an employee's likelihood of completing goals and tasks by analyzing past updates, productivity patterns, and other data sources. Managers can use this to proactively identify issues. A model can be trained to determine optimal timing and frequency for status update reminders based on analysis of past reminder effectiveness data. The system can then automatically send reminders optimized for each user.

In addition to machine learning techniques, large language models can also be leveraged to enhance the automation and intelligence of the administrative services for managing one-to-one meetings, group feedback, or status updates. Some non-limiting examples are provided below.

For managing one-to-one meetings, a large language model such as GPT-3 can be utilized to generate suggested talking points and relevant materials to review before a meeting. The language model can analyze the profiles and context for the meeting participants and apply its knowledge of effective one-on-one discussions to provide personalized recommendations optimized for those individuals.

For managing group feedback, a large language model can moderate and summarize feedback conversations. The model can identify and extract actionable insights from a large volume of feedback comments. It can also generate summaries highlighting the most constructive feedback and relevant themes. This enables managers to more efficiently digest and respond to group feedback.

For status updates, a large language model can be used to compose and enhance update questions and answers. For example, the model can rephrase or expand on update questions provided by managers to make them clearer and more thoughtful. The model can also assist employees in writing update answers by generating suggestions for describing progress, challenges, goals, and other details.

Such models can be fine-tuned on organization-specific data to enhance their effectiveness and alignment with company values and culture.

In example embodiments, machine learning techniques are used to automate suggestions for one-to-one meeting talking points, identify optimal timing for reminders, and/or analyze participation metrics.

For example, for generating suggested talking points, a recurrent neural network (RNN) or other artificial intelligence model can be trained on historical transcripts, agendas, and/or participant profiles from past one-to-one meetings. A corpus of training data is constructed by extracting keywords, topics, entities, and metadata from historical meeting data using natural language processing techniques like latent semantic analysis. The RNN may be configured as a sequence-to-sequence model with encoder and decoder sub-networks. The encoder network embeds the extracted features from the training data into a vector representation. The decoder network is trained to predict optimal talking points by correlating embedded features to effective past talking points. Over multiple training iterations, the model parameters are updated to minimize a loss function using backpropagation. The trained RNN model can then take new participant profiles and meeting context as inputs and output personalized suggested talking points for a future meeting.

For determining optimal timing for reminders, a regression model may be trained on historical data of reminder times and user engagement metrics like attendance rates. A regression algorithm such as Lasso regularization is used due to its ability to prevent overfitting. User data like demographics, time zone, past attendance, and/or calendar attributes are extracted as training features. The model learns to correlate these features with optimal reminder times that maximize engagement. The trained model can then predict appropriate reminder times for new users and meetings.

Participation metrics are computed by applying decision tree models. Historical meeting data is labeled with different participation criteria such as adding content, reviewing content, reactions, etc. Decision trees are trained on this labeled data to create models that can classify new user actions as satisfying particular participation criteria. The trained trees output participation classifications that are counted and aggregated for metrics.

The modules work in concert to provide cohesive and intelligent administrative services, with the connection module 208 linking data across modules and the automation module 210 enhancing each module with automated features. The modules are configured to leverage historical data and user context to provide personalized and relevant experiences.

In example embodiments, purpose-built unconventional GUIs and services are provided that facilitate 1:1 meeting management for the digital workplace, providing technological solutions to technological problems, including those related to tracking 1:1s across systems.

In example embodiments, the described modules provide the ability for both employees in a 1:1 meeting to collaborate on a shared agenda and add talking points. This provides for shared participation. In example embodiments, the described modules provide integrations with external calendar systems, like Google Calendar and Outlook, to automatically update meeting times. This keeps the platform synchronized. In example embodiments, the described modules provide mobile access to 1:1 agendas for managing meetings on-the-go. This improves accessibility. In example embodiments, the described modules provide context panels that surface relevant employee data like goals, feedback, and updates to inform 1:1 discussions. This provides insights. In example embodiments, the described modules generate recommended talking points to nudge managers to have better quality 1:1s. This drives engagement. In example embodiments, the described modules provide reporting dashboards to track 1:1 frequency and participation. This enables oversight.

In example embodiments, The feedback module 206 enables flexibility in how feedback is collected, including, for example:

Recurring automated feedback requests using the automation module 210 to send nudges on a schedule. Requests can be sent via email, Slack, etc.

Integration with third-party apps via APIs to initiate feedback requests from tools like HR systems, project management apps, code repositories, etc. The connection module 208 handles these integrations.

External feedback collection from people outside the organization by allowing requesters to input email addresses. The feedback module 206 generates a private link to a feedback form.

Public feedback shared company-wide through integrations like Slack. The connection module 208 shares public feedback to designated public channels.

Private, anonymous, and manager-only feedback options to allow confidential feedback. The feedback module 206 controls visibility settings.

Notes to self as private reminders about others. The feedback module 206 stores notes privately.

The feedback module 206 allows configuring, for example:

Permitted feedback types like public, private, manager-only. The dynamic GUI module 212 controls visibility options displayed.

Values-based feedback by defining company values. The values are stored in the database(s) 126 and attached to feedback.

External feedback permissions for employees to request external party feedback. The feedback module 206 gates external feedback abilities.

Feedback nudges to managers using the automation module 210 to send reminder notifications on a schedule. The dynamic GUI module 212 displays nudges.

Feedback visibility like allowing employees to make feedback anonymous or private. The feedback module 206 controls visibility.

Integration with performance data may include, for example:

Feedback summaries, highlights, and values analysis integrated into performance reviews and displayed via the dynamic GUI module 212.

Feedback details shown in context panels in review and goal UIs, powered by the connection module 208 linking data.

Relevant feedback automatically added as talking points in 1:1 meetings using the connection module 208.

Feedback trends and analysis provided in performance reporting using data stored in the database(s) 126.

Automated feedback features may include, for example:

Automated feedback moderation by the automation module 210 to detect inappropriate comments using natural language processing and sentiment analysis.

Feedback nudges sent by the automation module 210 when managers have not submitted feedback in a certain timeframe.

Automated reminders from the automation module 210 to complete pending feedback requests. Reminders sent via email, Slack, etc.

Digest summaries of feedback compiled automatically by the automation module 210 using natural language processing.

Analytics and reporting may include, for example:

Feedback adoption tracking and metrics visualized in the dynamic GUI module 212, powered by data in the database(s) 126.

Feedback reporting for admins and managers via dynamic GUIs showing volume, frequency, values, etc.

Exporting filtered feedback data in customizable reports by leveraging export capabilities of the database(s) 126.

Public praise wall slideshow visualization via the dynamic GUI module 212 displaying recent public feedback.

In example embodiments, the updates module 204 is configured to generate user interfaces and/or functions for managing status updates. This may include, for example:

An updates summary window that displays a limited list of the most relevant update management functions that were determined based on tracked usage patterns. The limited list provides quick access to the most used features.

In response to selections, displaying corresponding management windows related to the selected function, including a view updates window, create update window, analytics window, and assignments window.

An updates configuration window with options to customize update questions, frequency, reminders, and visibility settings.

Enabling employees to select update visibility as private or public for each update via a detailed visibility selection interface.

Tracking usage data of update functions, analyzing the frequency of use, and dynamically updating the limited list to reflect changes over time.

A machine learning model that analyzes past update data to predict optimal reminder timing for maximizing update completion rates.

The connection module 208 links update data to user profiles and goals.

The automation module 210 suggests update questions using natural language processing to interpret past update content.

The GUI module 212 generates specialized interfaces like the updates summary window and management windows.

In example embodiments, a method of implementing administrative services for managing one-to-one meetings is disclosed. A plurality of entities along a first axis and a plurality of times along a second axis are caused to be displayed in a graphical user interface (GUI). A selection of a first entity and a first time is received. responsive to the selection, an event window is caused to be displayed in the GUI. The event window is overlaid on the plurality of entities and plurality of times. The event window includes an entry field that allows an event organizer or an event participant to add content to the event window, a context panel that displays data relevant to the event participant, and a participation metrics panel. Content entries made by the event organizer or the event participant are received through the entry field. The content entries are displayed in the event window. Participation data is tracked based on the content entries. The participation data is displayed in the participation metrics panel. The event window is synchronized with an external application and changes made in the external application are automatically reflected in the event window.

In example embodiments, a method of implementing administrative services for managing group feedback is disclosed. A selection of a feedback visibility setting for a feedback message from a plurality of predefined feedback visibility settings is received via a give feedback tab of a user interface. The feedback message and a selection of one or more recipients are received via the give feedback tab. The feedback message is sent to the selected one or more recipients based on the selected feedback visibility setting. A request for feedback and a selection of one or more feedback providers are received via a request feedback tab of the user interface. The request for feedback is sent to the selected one or more feedback providers. Received feedback responses linked to a user profile of the feedback requestor are stored.

In example embodiments, a method of implementing administrative services for managing status updates is disclosed. A method of implementing administrative services for managing status updates is disclosed. A status update configuration window is provided on a graphical user interface. The status update configuration window comprises a plurality of update settings for configuring recurring status updates. A selection of update settings is received in the status update configuration window comprising an update frequency, a set of update questions, and a schedule for update reminders. The selected update settings are stored as an update template. An update summary window is caused to be displayed concurrently with the status update configuration window. The update summary window comprises a limited list of one or more selectable update management functions. A selection of an update management function is received from the update summary window. In response to the selection, information related to the selected update management function is caused to be displayed in an update management window while concurrently the update summary window is concurrently caused to be displayed.

In example embodiments, one or more of the described modules may comprise one or more corresponding administration services.

A one-to-one meeting service may be configured to, for example:
store meeting data comprising agendas, notes, and participant information in a database;
integrate with external calendar systems via application programming interfaces (APIs) to enable real-time synchronization of meeting times;
apply criteria for classifying participant interactions as meeting participation and increment participation metrics based on the criteria; or
retrieve and correlate relevant participant data from participant profiles to generate context information for display.

An updates management service may be configured to, for example:
store update templates and published updates in a database;
track analytics on usage of update features;
suggest update questions using natural language processing algorithms; or
apply analytics algorithms to generate insights on updates.

A feedback management service may be configured to, for example:
store feedback data in a database along with appropriate access controls;
moderate feedback using natural language processing and rules engines; or
control visibility settings of feedback based on administrator-defined logic.

In example embodiments, the 1:1 module includes meeting data storage and retrieval functions to save and access meeting agendas, notes, and information. This may involve interfaces to the database(s).

Synchronization algorithms and API integrations may be used by the 1:1 module to enable real-time syncing with external calendar systems.

Participation tracking in the 1:1 module may use programming logic to detect interactions, apply criteria, and increment metrics. Storage may be used for storing metrics data.

Generating the context panel view may involve data connectivity between the 1:1 module and the profiles database to retrieve relevant participant data on-demand. Related data extraction algorithms may be used.

The updates module may use data storage for update templates and published updates, as well as tracking of usage analytics. API integration for update publishing may be used.

NLP algorithms may be used in the updates module to interpret update text and suggest questions. Additional analytics algorithms may generate insights.

The feedback module may apply security logic to control the visibility settings of feedback and/or store feedback in the database(s) with appropriate access controls.

Automated moderation of feedback via NLP sentiment analysis and rules engines may be implemented in the feedback module.

The connection module may use identifiers, indexes, links, and/or other relational data constructs to interrelate data across modules, as well as API integrations (e.g., to enable data access).

In example embodiments, specialized interfaces for each administrative service, in conjunction with the supporting modules, focus on surfacing the most relevant information and actions for users. This improves efficiency and reduces complexity compared to conventional interfaces for such administrative tasks.

In example embodiments, the specialized interfaces for each administrative service, in conjunction with the supporting modules, focus on surfacing the most relevant information and actions for users. This improves efficiency and reduces complexity compared to conventional interfaces for such administrative tasks.

Examples of Specialized User Interfaces and/or Services/Functions for One-to-One Meetings

In example embodiments, the 1:1 module 202 generates an interactive meeting window overlay that participants can jointly edit and that synchronizes across devices in real-time. This provides a persistent, shared space for meeting management.

The meeting window includes specialized elements like the participation metrics panel, context panel, and entry field for adding agenda items that focus the interface on useful meeting actions.

The automation module 210 suggests talking points using machine learning trained on past meeting data to identify patterns. This keeps the meeting agenda targeted.

The GUI module 212 enables the overlay interface that can be accessed directly from a calendar view for easy meeting management without changing contexts.

Together this provides a specialized 1:1 management interface optimized for entering agenda items, tracking participation, and keeping discussions productive.

Examples of Specialized User Interfaces and/or Services/Functions for Group Feedback

In example embodiments, the feedback module 206 provides an interface for exchanging private, public, and external feedback.

Customized visibility options are displayed when giving feedback, ensuring employees understand sharing permissions.

The connection module 208 links feedback to user profiles and company values, providing context for giving meaningful feedback.

Automation features like nudges and moderation streamline the feedback process and highlight important events like new hires.

The specialized interface focuses on relevant aspects of collecting feedback, while automation handles administrative burdens.

Examples of Specialized User Interfaces and/or Services/Functions for Status Updates

In example embodiments, the updates module 204 generates the updates summary window with quick access to the most relevant management functions based on tracked usage.

In response to selections, tailored management windows are displayed while persistently showing the summary window.

The updates configuration window centralizes options for customizing updates.

The GUI module 212 adapts the interfaces to focus on key update tasks while hiding unnecessary complexity.

Automation features like suggested questions and optimal reminders further simplify update management.

The specialized interfaces and automation together provide easy access to update features and reduce the burden of status updates.

### Examples of Specialized Back-End Services

In example embodiments, the one-to-one administration services comprise storing meeting data including agendas, notes, and participant information; synchronizing meeting times with external calendar systems, classifying participant interactions as meeting participation and/or incrementing participation metrics based on criteria, and/or retrieving and/or correlating participant profile data to generate context information for display.

One or more one-to-one administration services may be further configured to analyze past meeting data to generate suggested talking points for a future meeting, detect visual review of meeting content and increment participation metrics responsive to detected visual review, generate transcripts of meeting recordings and identify action items using natural language processing, automatically reschedule meetings based on analysis of participation metrics, retrieve and/or correlate organizational hierarchy data to determine meeting participants, calculate participation metrics based on the classified participant interactions, and/or perform other operations as described herein.

One or more updates administration services may be configured to store update templates and/or published updates, track usage of update features, suggest update questions based on analysis of past updates, generate insights on updates using analytics algorithms, display a limited list of selectable update management functions, interpret sentiment of update text entries, optimize timing of update reminders using a machine learning model, control employee access to updates based on administrator-defined permissions, predict employee retention risk based on analysis of updates, and/or publish updates to external systems via application programming interfaces, and/or perform other operations as described herein.

One or more feedback administration services may be configured to store feedback data along with access control rules, moderate feedback using natural language processing and rules engines; a visibility control module configured to define feedback visibility settings based on administrator-configured logic, generate automated reminders for providing feedback based on administrator-defined schedules, detect inappropriate language in feedback text entries using machine learning models, receive feedback from external systems via application programming interfaces, extract company values from feedback text entries using natural language processing, quantify feedback sentiment trends using machine learning classifiers, and/or restrict feedback visibility based on organizational hierarchies extracted from employee profile data, and/or perform other operations as described herein.

### 1:1s for Admins

### What are 1:1s?

The 1:1s module comprises a tool that allows managers and employees to collaborate on a shared agenda for their meetings. The first step to having a productive meeting is creating an agenda and ensuring internal stakeholders are aligned. With the 1:1s tool, employees can connect either their Google or Outlook calendars to the system to always have insight into when the next 1:1 is (even if the time changes).

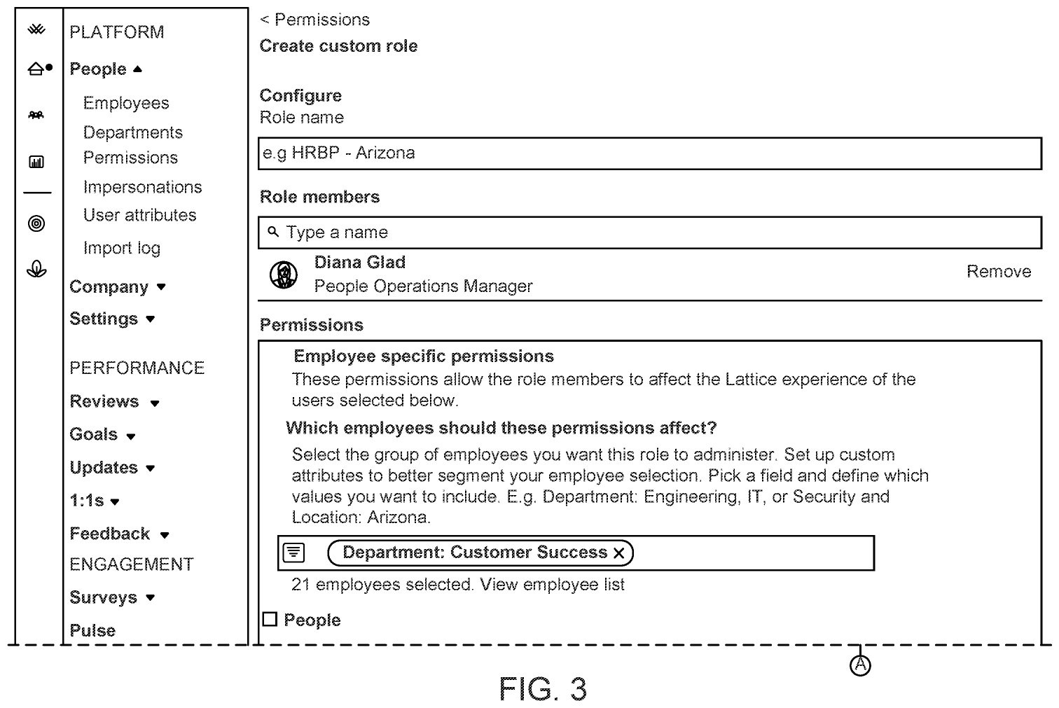

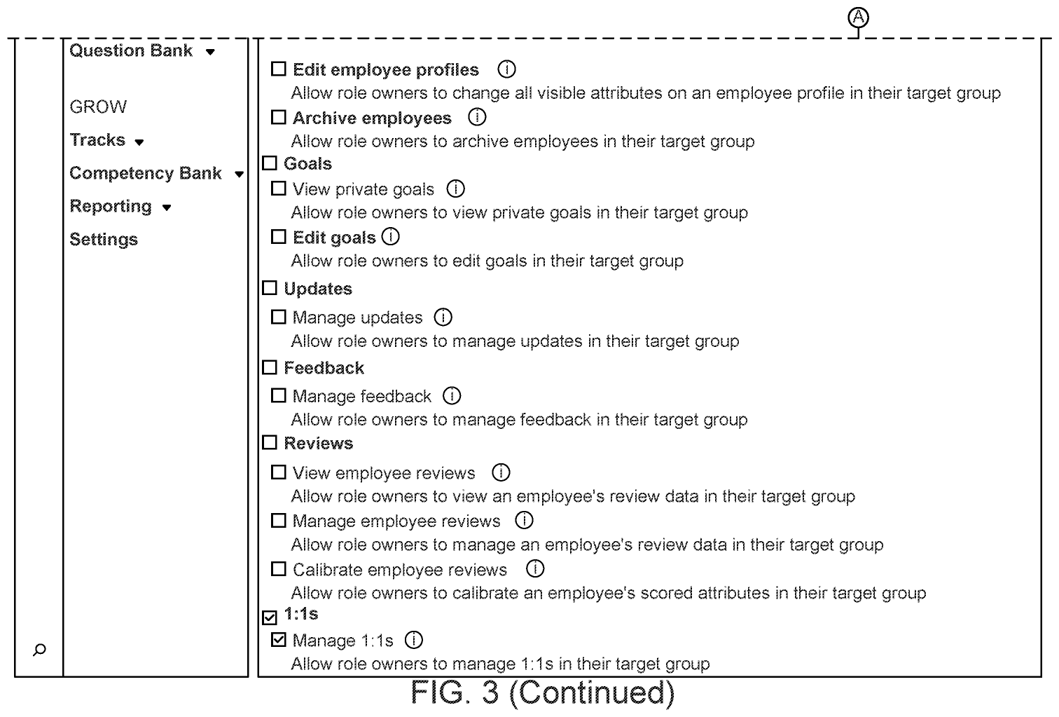

FIG. 3 is a schematic of a user interface displaying a create custom role page containing various permissions which can be granted to 1:1s.

In example embodiments, aside from the individuals in the 1:1 relationship, the 1:1 content will only be visible to Super Admins and those granted a custom role “1:1 s” permission.

After the Admin has configured the custom role, specific permissions can be granted to “1:1s.”

The permission that can be granted for 1:1s in FKI. 3 is permission to manage employee 1:1s. This permission allows the custom role to view and delete 1:1 s for employees in the selected group.

What does this Permission Look Like to the Custom Role?

The employee that is given this custom role will see an “Admin” page at the bottom of their discovery navigation. By clicking on the “Admin” page, they will see a “1:1s” section.

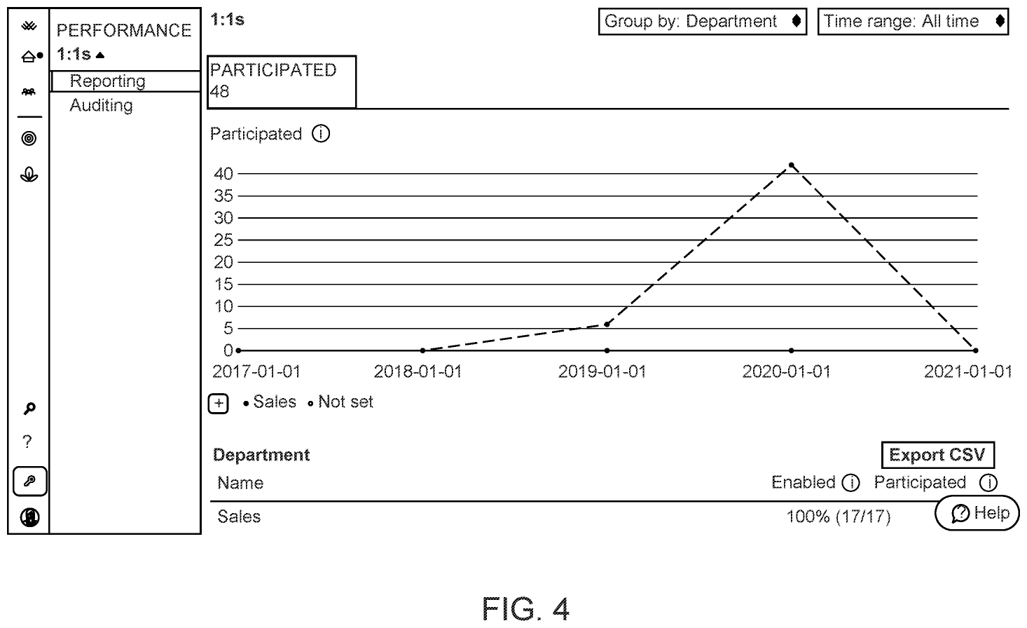

FIG. 4 is a schematic of a user interface displaying a 1:1s reporting page.

In example embodiments, these permissions only apply to the subset of employees that the Admin has selected for the role owner. The role member(s) will not have access to the private information of other employees that fall outside of this subset.

### Why Use 1:1s?

Throughout the week, both the manager and employee can go into the tool and add agenda items to be discussed. Often meetings can feel manager-dominated, but the 1:1s tool gives employees equal ownership over their meetings. Once the agenda is set, the system will send both employees a notification 2 hours before the meeting with the agenda so they can come better prepared for the meeting. Once the meeting starts, both employees can add notes to track what was discussed and any takeaways.

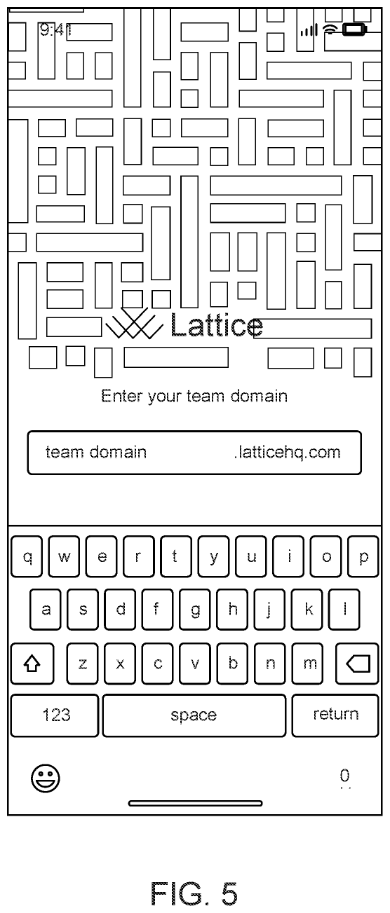

FIG. 5 is a schematic of a log in page for a mobile app.

You can also manage these 1:1s on our mobile app. With this app, you can:
Manage 1:1 s on the go and away from the computer.
Give and view feedback.
Publish, view, and edit updates.
View active goals and past 1:1s.
Write, draft, and submit your review.
Please note: You cannot approve peer reviewers in the mobile app.
View your company directory.

To access all of these great features, download the app and log in to your system account by typing your team domain!

### How to Make 1:1s Accessible to all or a Subset of Employees

The system allows you to enable 1:1s for your entire organization or a smaller group of users. The system provides the flexibility you need to help facilitate a phased rollout of the tool if you choose to do so.

In example embodiments, the activation settings will make the 1:1 tool visible to your employees. 1:1s will still need to be manually set by either a manager, report, or indirect employee.

In example embodiments, the activation settings will make the 1:1 tool visible to your employees. 1:1s will still need to be manually set by either a manager, report, or indirect employee.

Adjusting your Activation Settings

The following are steps to adjust activation settings
1. Admin>1:1s>Settings
2. Under Activation settings select whether you would like the tool turned on for all employees, a specific set of employees, or disabled altogether
3. If you choose to only enable 1:1s for specific employees, you will need to select employees by department or other user attributes. This will prevent any user who is not assigned the selected attribute from accessing the tool.
4. Save.

Company development 1:1 templates enable admins to guide and provide resources to managers in how they facilitate developmental conversations. Activating a company development 1:1 template allows managers to apply the templates to specific one-off 1:1s with their direct reports.

The following 1:1 templates are available to activate:
Introduction to the Individual Development Plan.
Individual Development Plan Check-In.
Individual Development Plan Finalization.
Ongoing Development Check-in.

In example embodiments, company development 1:1 templates are distinct from company recurring talking points and agenda 1:1 templates, which only apply recurring talking points to 1:1s. Company development 1:1 templates can only be added to single 1:1s.

### Activate Company Development 1:1 Templates

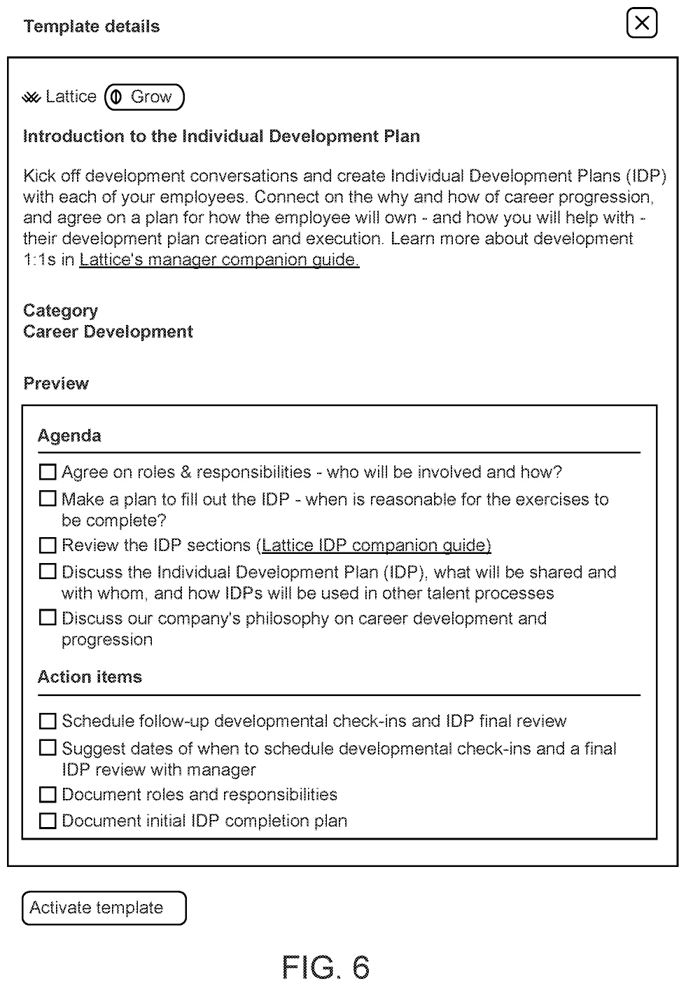

FIG. 6 is a schematic of a user interface displaying a preview of a company 1:1 template.

The following are steps to activate company development 1:1 templates:
1. Navigate to Admin>1:1s>Settings.
2. Under Company 1:1 templates, enter the Deactivated tab.
3. To preview the 1:1 agenda and action items, click on the desired template.
4. Within the preview, select Activate template—OR—click on the ellipsis within the template card and select Activate template.
5. To confirm, select Yes, activate.

Once company development 1:1 templates have been activated, an account admin can deactivate the template at any time to prevent managers from using the template during developmental conversations.

### Deactivate Company Development 1:1 Templates

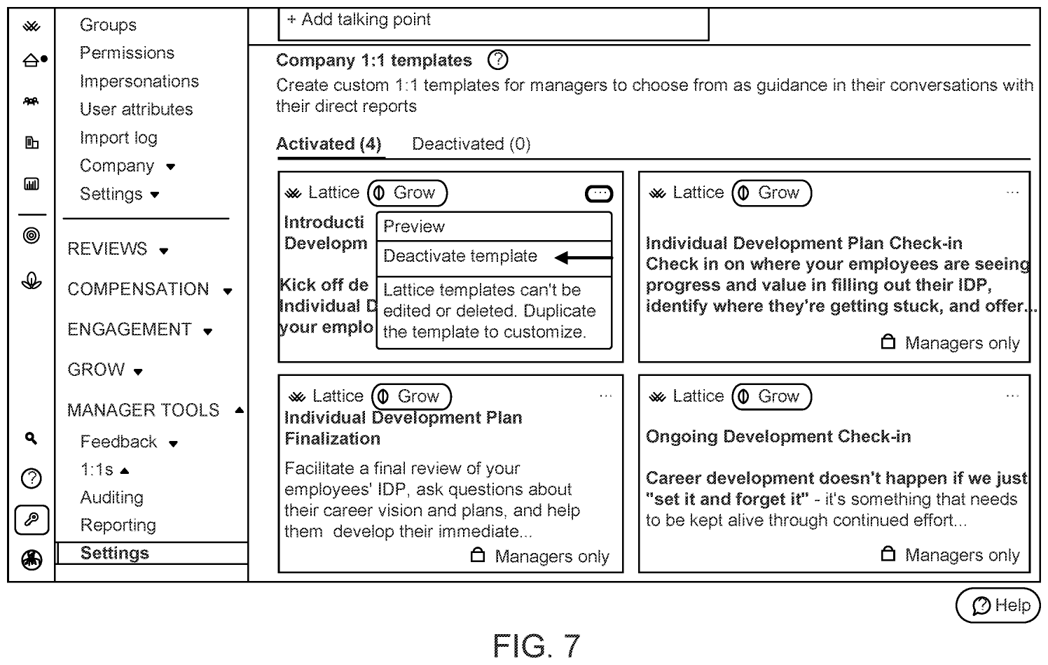

FIG. 7 is a schematic demonstrating how to navigate a user interface to deactivate company 1:1 templates from within the 1:1s settings page.

The following are steps to deactivate company development 1:1 templates:
1. Navigate to Admin>1:1s>Settings.
2. Under Company 1:1 templates, navigate to the Activated tab.
3. Within the desired template, select the ellipsis>Deactivate template

Admins can create non-recurring 1:1 templates for managers at their company to apply to any of their 1:1s.

In example embodiments:
Company 1:1 templates cannot be used as recurring agenda templates. To create recurring talking points, follow the steps in How to Create Company-Wide Recurring Talking Points for 1:1s.
Managers and employees cannot create their own non-recurring templates.
If Grow is enabled, admins will have the option to enable Grow development 1:1 templates.

### Create a Company 1:1 Template

The following are steps to create a company 1:1 template:
1. Navigate to Admin>1:1s>Settings.
2. Under Company 1:1 templates, select Create template.
3. Give the agenda template a name and an optional description.
4. (Optional) Select a category.
5. Add talking points and optional action items within your template.
6. Select Save.

In example embodiments, if Grow is enabled, selecting the Career Development template will make the template available to managers when planning development 1:1s with their direct reports. Admins can edit non-recurring 1:1 templates for managers at their company to apply to any of their 1:1s.

In example embodiments.
Changes made to company 1:1 templates will impact future uses of the template.
Company 1:1 templates cannot be used as recurring agenda templates. To create recurring talking points, follow the steps in How to Create Company-Wide Recurring Talking Points for 1:1s.
Managers and employees cannot create their own non-recurring templates.
Grow development 1:1 templates cannot be edited. However, development templates can be duplicated, edited, and then published.

### Edit a Company 1:1 Template

The following are steps to edit a company 1:1 template:
1. Navigate to Admin>1:1s>Settings.
2. Under Company 1:1 templates, select the ellipsis ( . . . )>Edit next to the desired template.
3. Make the desired changes.
4. Select Save.

Admins can duplicate and edit Grow development 1:1 templates for managers at their company to apply to any of their development 1:1s. Grow development 1:1 templates cannot be edited. However, development templates can be duplicated, edited, and then published.

In example embodiments:
Changes made to company 1:1 templates will impact future uses of the template.
Company 1:1 templates cannot be used as recurring agenda templates. To create recurring talking points, alternative steps may be used, as described herein.
Managers and employees cannot create their own non-recurring templates.

### Duplicate a Company 1:1 Template

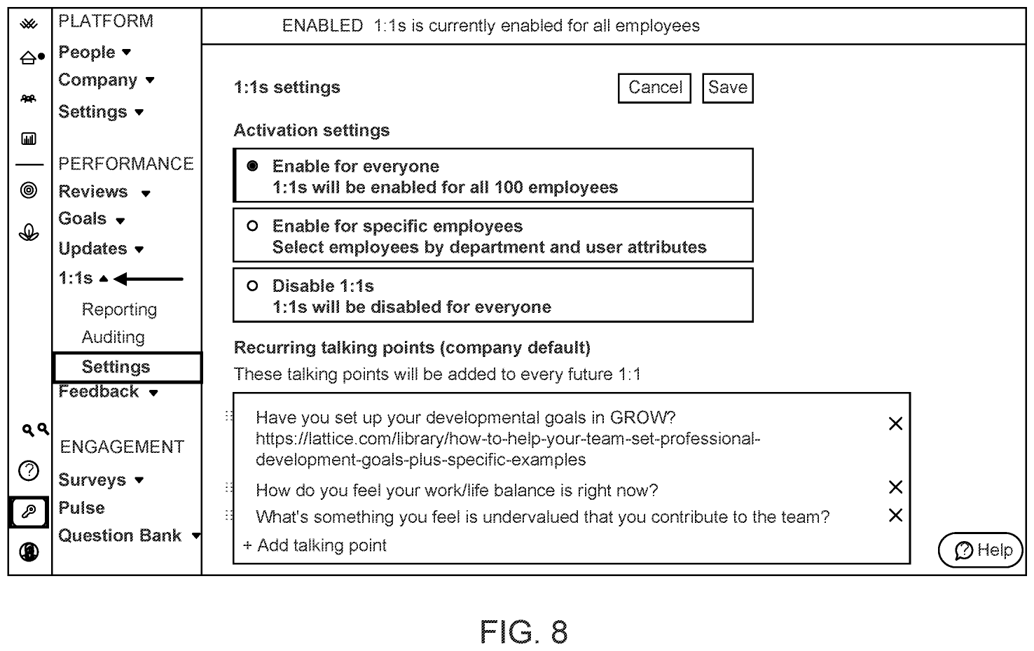

FIG. 8 is a schematic demonstrating how to navigate a user interface to be taken to the 1:1s settings page.

The following are steps to duplicate a company 1:1 template:
1. Navigate to Admin>1:1s>Settings.
2. Under Company 1:1 templates, select the ellipsis ( . . . )>Duplicate next to the desired template.
3. Make the desired changes.
4. Select Save.

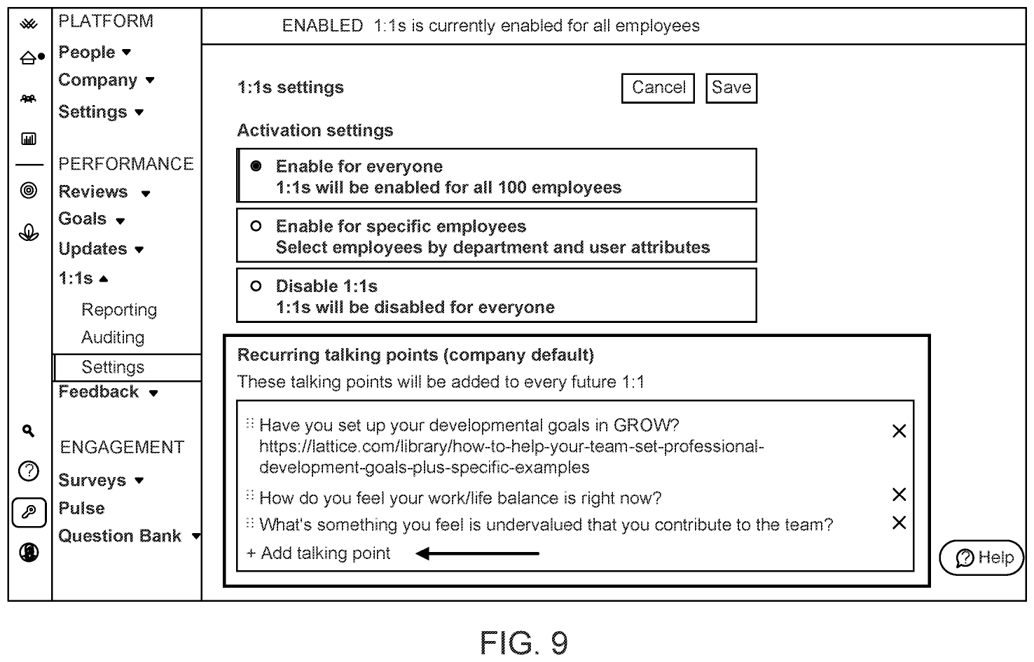

FIG. 9 is a schematic demonstrating how to navigate a user interface to add recurring talking points from within the 1:1s settings page.

An admin may want to add recurring talking points in 1:1s to create consistency, alignment, and transparency between employees and managers during 1:1s.

The following are steps to set up company-wide talking points:
1. Admin>1:1s>Settings.
2. Add any recurring talking points.

### What Each User Will See

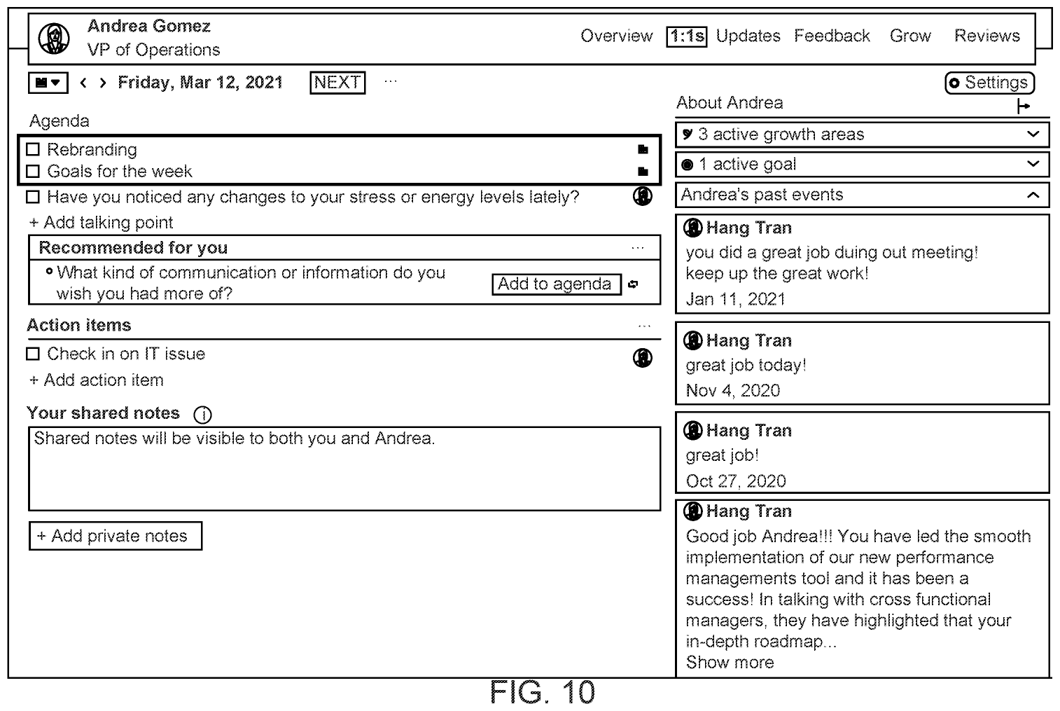

FIG. 10 is a schematic of a user interface displaying a user's 1:1s page containing recurring agenda items.

Each user will add their own talking points and check off any completed items; however, recurring agenda items will appear in every 1:1.

In example embodiments, company-wide talking points will populate into active meetings between managers and direct reports. These talking points will not populate in meetings that are not between a manager and their direct report. Company-wide talking points will appear in meetings when added in real time. Suppose employees interact with these talking points in any way (clicking, adding text, etc.), and the talking points are later removed from the admin section. In that case, they will remain in that individual meeting where they were interacted with. Only the manager in the relationship can remove these talking points.

As an admin, you can delete past 1:1s for every user in the organization.

In example embodiments:
Only admins can delete 1:1 agendas.
Deleting a 1:1 agenda is irreversible.

### Delete an Agenda

The following are steps to delete a 1:1 agenda:
1. Navigate Admin>1:1s>1:1s log.
2. Navigate to the 1:1s tab.
3. Search and find the desired 1:1 agenda.
4. Select the ellipsis ( . . . )>Delete 1:1.
5. Confirm by clicking Delete

Admins have visibility into the analytics for their organization's 1:1 meetings to ensure that managers and direct reports utilize the tool to keep up with employee progress and workplace challenges.

Who can see the 1:1 log?
Admins will have access to the company's 1:1 log from the Admin page view.
Managers will have access to their team's 1:1 log from the Reporting page via the Discovery Navigation, except for the Auditing's 1:1s tab.
Managers of Managers will see their direct and indirect report's 1:1 log from the Reporting page via the Discovery Navigation, except for the Auditing's 1:1s tab.
Employees with custom role permissions can access their assigned group's reporting view from the Admin page view.

The 1:1s log lists individual 1:1 meetings between all participants within the organization, including non-manager relationships.

### 1:1s Tab

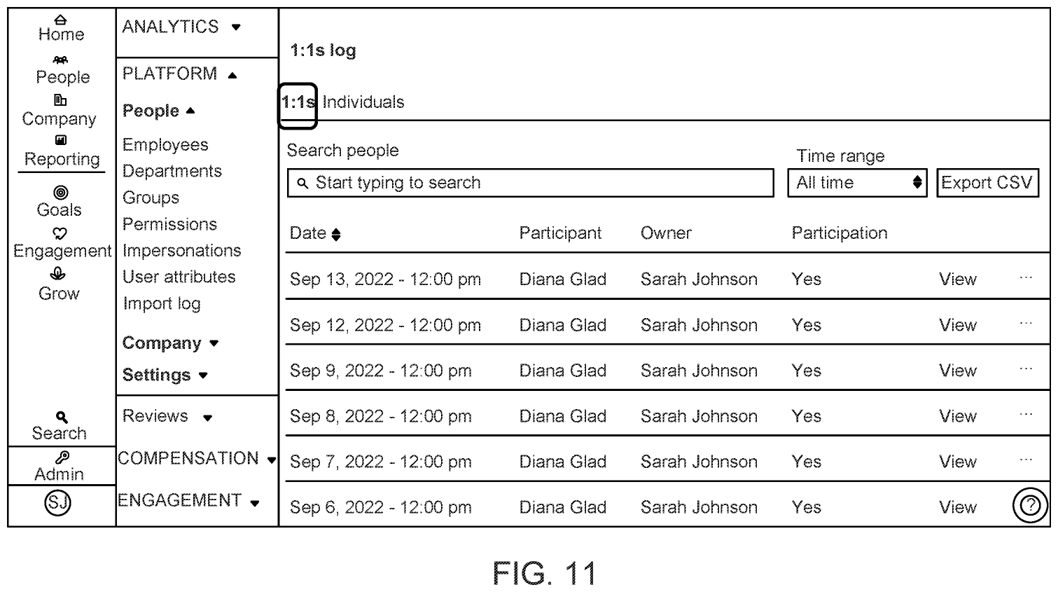

FIG. 11 is a schematic of a user interfacing displaying the 1:1s tab from within the 1:1s log.

The following information is available in the 1:1s tab:
Date: The date and time a 1:1 occurred.
Participant: The second employee who is participating in the 1:1 relationship.
Owner: The employee who created and is a participant in the 1:1 relationship.
Participation: Whether or not a meeting counts as participated based on the participation criteria.

### 1:1s Tab: Search and Filter

To take a deeper dive into your data, you can use the following in the 1:1s tab:
Search people: Use the bar to search for a specific participant or owner.
Time range filter: Filter by a particular date range the meeting occurred.

The following actions are also available in the 1:1s tab:
View agenda items, shared notes, and action items.
Delete a 1:1 agenda.
Export 1:1 data.

### Individuals Tab

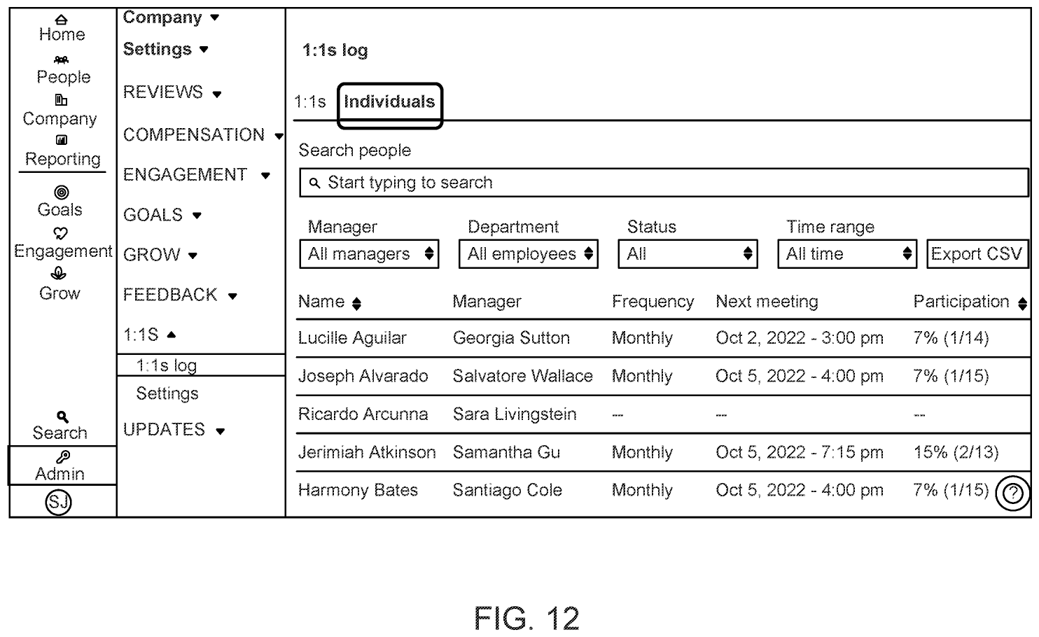

FIG. 12 is a schematic of a user interface displaying the individuals tab from within the 1:1s log.

The Individuals tab is where you can see meeting frequency, date of the next meeting, and participation rate for manager-employee relationships.

The following information is available on the Individuals tab:
Name: The name of the individual participant.
Manager: The name of the participant's manager and the second participant.
Frequency: The rate at which the employee-manager meet.
Next meeting: The date and time of the next scheduled meeting.
Participation rate: The number of meetings that are considered participated over the total amount of scheduled meetings.

The participation rate shows how many meetings have met the criteria below compared to the total amount of 1:1s that have been scheduled between direct report and manager:
Have one created talking point (non-recurring).
Have one shared note.
Have one talking point checked off.
Have one comment on any talking point.
Have an action item created in the meeting.
Have an action item completed in the meeting.
   Individuals Tab: Search and filter

To take a deeper dive into your data, you can use the following:
Search people: Use the bar to search for a specific participant or owner.
Manager: Filter by all 1:1 relationships for a particular manager.
Department: Filter by all 1:1 relationships for a particular department.
Status: Filter by active, previously active, and 1:1s relationships that were never turned on.
Time range filter: Filter by a specific date range the meeting occurred.

### Individuals Tab: Export 1:1 Data

You can export your data as a CSV which will include participants and owners, meeting frequency, next meeting date, participation rate, and participation and total meeting count.

Admins have visibility into the analytics for their organization's 1:1 meetings to ensure that managers and direct reports utilize the tool to keep up with employee progress and workplace challenges.

The following user types can see the 1:1 Adoption page.
Admins have access to the company's adoption and log views within their Admin page view.
Managers have access to their team's adoption and log views from the Reporting page via the Discovery Navigation, except for the Auditing's 1:1s tab.
Managers of Managers see their direct and indirect report's adoption and log views from the Reporting page via the Discovery Navigation, except for the Auditing's 1:1s tab.
Employees with custom role permissions access their assigned group's reporting view from the Admin page.

### 1:1s Adoption Page

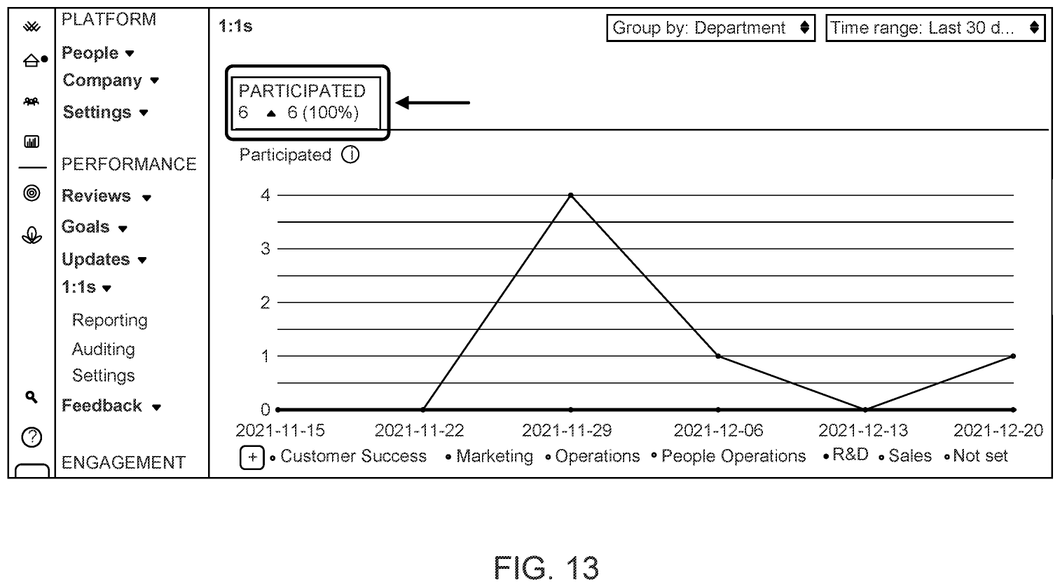

FIG. 13 is a schematic of a user interface displaying an adoption page with a graph of the participated metric.

The 1:1s adoption page will give you a high-level overview of how employees use and engage with the 1:1 tool.

To get started, navigate to Admin>Analytics>Adoption>1:1s.

The participated metric can be seen in the graph at the top of the Adoption page. The Participated metric indicates the number of 1:1s held between an employee and their manager. Note that non-employee manager relationships will not count towards the participated metric.

If one of the following criteria is true, a 1:1 will count as participated:
Have one created talking point (non-recurring).
Have one shared note.
Have one talking point checked off.
Have one comment on any talking point.
Have an action item created in the meeting.
Have an action item completed in the meeting.

The Delta metric compares the change between the previous date range interval and the current date range interval. For example, if you view the last 90 days, the delta is the difference between the metric 180-90 days ago compared to the metric from the last 90 days. If you change the date range to 30 days or 365, it's the same behavior. If your graph is set on All lime, no delta is shown.

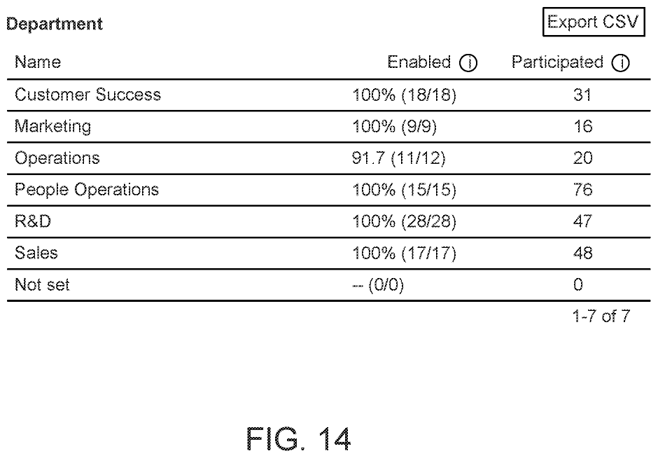

FIG. 14 is a schematic of a user interface displaying an adoption page in table view.

The table view will adjust based on the group-by filter (department, individual, manager, etc.). The view includes the following:
Enabled: The number of people in this group who have at least one 1:1 set up over the total number of people in this group
Participated: The number of 1:1s held between an employee and their manager within this group

Within the CSV import, there is an additional metric to track: Total Users Count, the total number of people that belong to the group.

Grouping and Filtering Your Data: Adjusting Groups within the Participated Graph

FIG. 15 is a schematic demonstrating how to navigate a user interface to adjust groups within the participated graph on the adoption page.

When viewing the graphs, you can add more groups by clicking on the + sign (the system defaults to the first eight options).

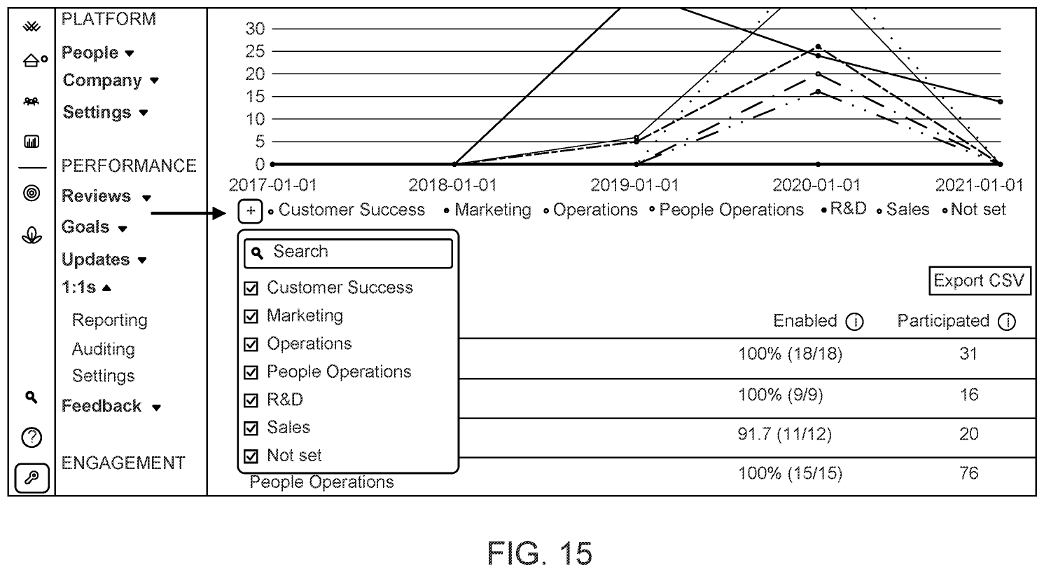

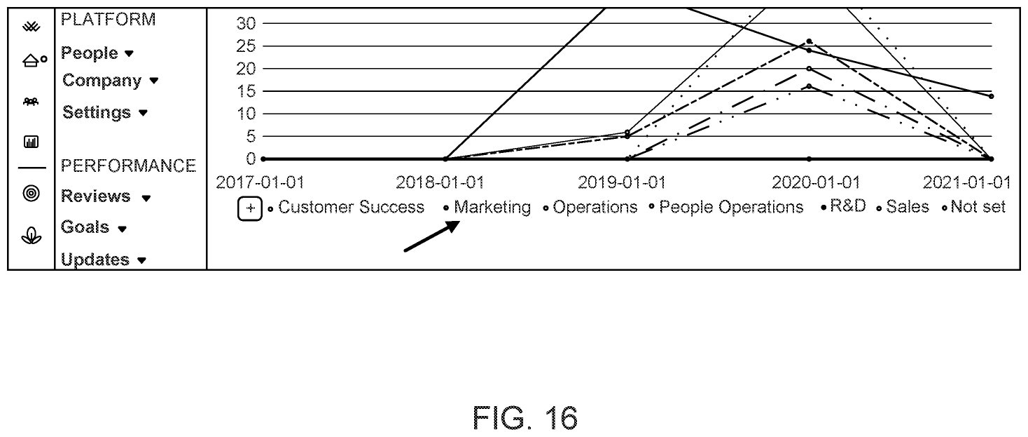

FIG. 16 is a schematic demonstrating how to navigate a user interface to make groups visible or invisible within the participated graph on the adoption page.

You can make groups visible or invisible on the graph by clicking on the grouping name.

### Filters

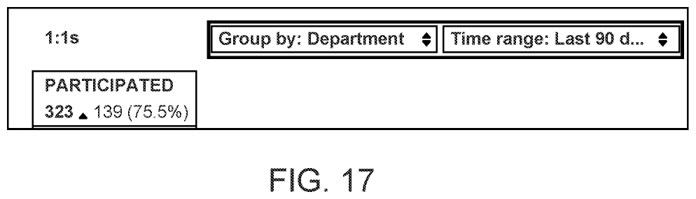

FIG. 17 is a schematic of a user interface displaying a portion of the adoption page where information may be grouped by a filter and the time frame may be adjusted.

Here's more detail on groupings and time range.
Group by: You can adjust how your information is being grouped by clicking on the Group by filter. Here, you will see a list of all employee fields currently in the system, including any custom fields you may have created. (This functionality is not available to managers.)
Time range: This allows you to adjust over what period you are analyzing the data. You can choose a different set of timeframes or a custom range.

### 1:1s for Managers

The 1:1s tool allows both managers and employees to collaborate on a shared agenda for their in-person meetings. The 1:1 meeting is an opportunity to develop employees' skills and gives the employee a chance to discuss workplace challenges.

The first step to using the system 1:1s is to set up a meeting with your direct report.

### Using Your Agenda

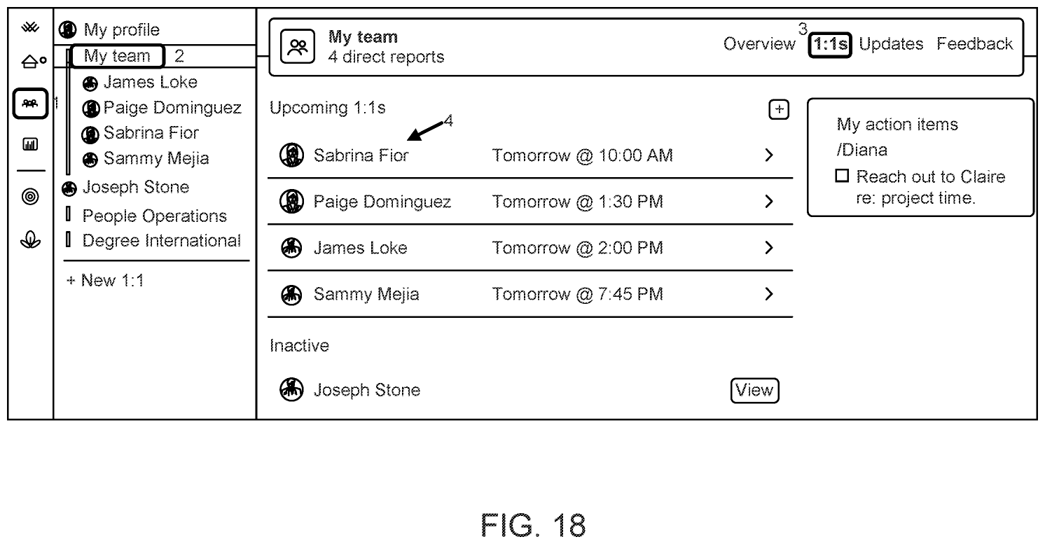

FIG. 18 is a schematic demonstrating how to navigate a user interface to enter a 1:1 agenda for a direct report.

To enter a 1:1 agenda for your direct report, navigate to People>My team>1:1s>Select a direct report.

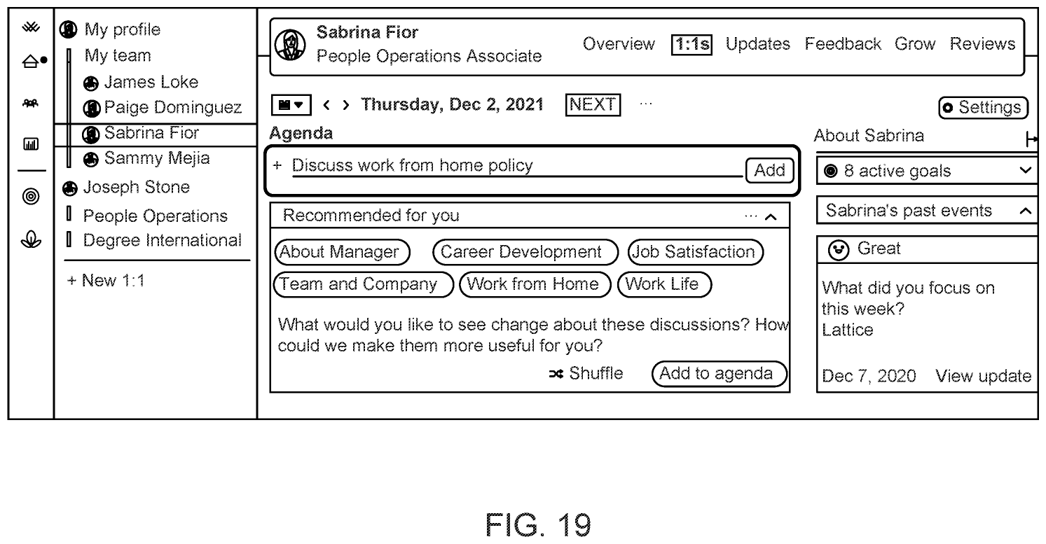

FIG. 19 is a schematic demonstrating how to navigate a user interface to add talking points to an agenda.

All 1:1 participants can add talking points to an agenda, including the direct report. To add your own talking points to the agenda, under Agenda, click into Add talking point, add your item, and click Add.

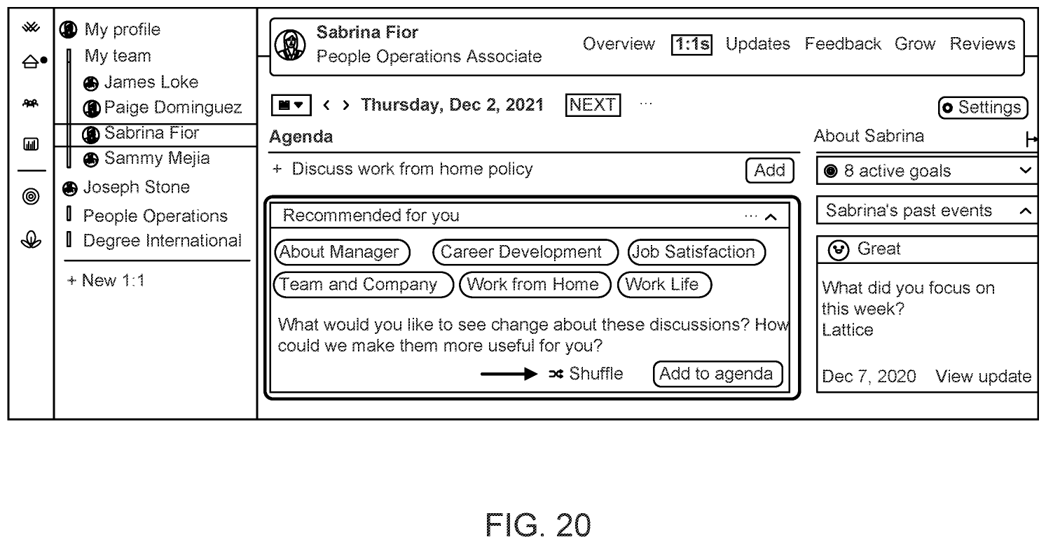

FIG. 20 is a schematic demonstrating how to navigate a user interface to shuffle through recommended talking points for a 1:1.

If you need inspiration, you can navigate through and select a system recommended talking point. To add a recommended talking point, navigate under Recommended for you, shuffle through recommendations, and select Add to agenda.

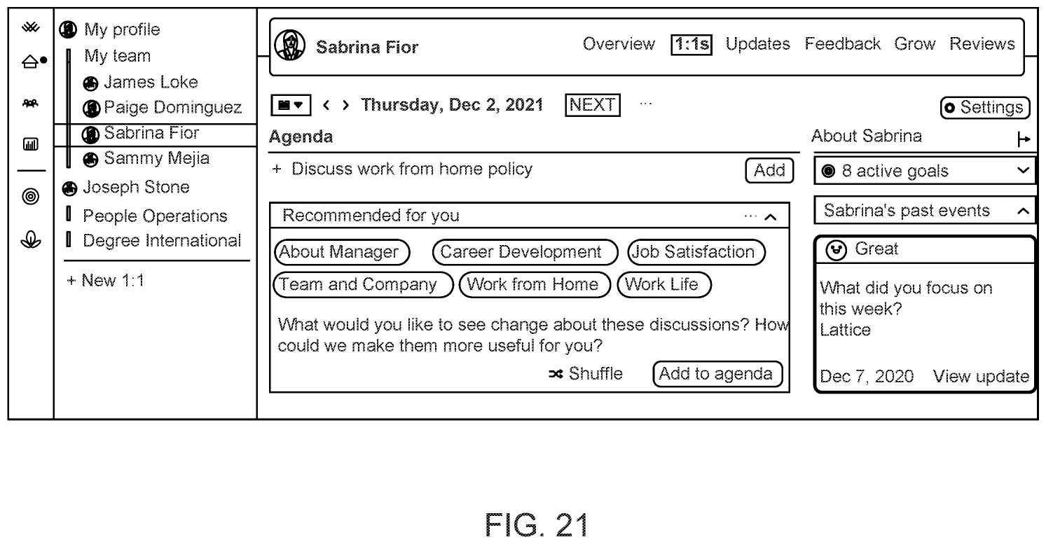

FIG. 21 is a schematic of a user interface displaying a direct report's profile page containing a 1:1 context panel.

Use the 1:1 context panel to navigate through your direct report's most recent update and growth areas and include them as talking points in your agenda.

### Navigating the 1:1 Context Panel

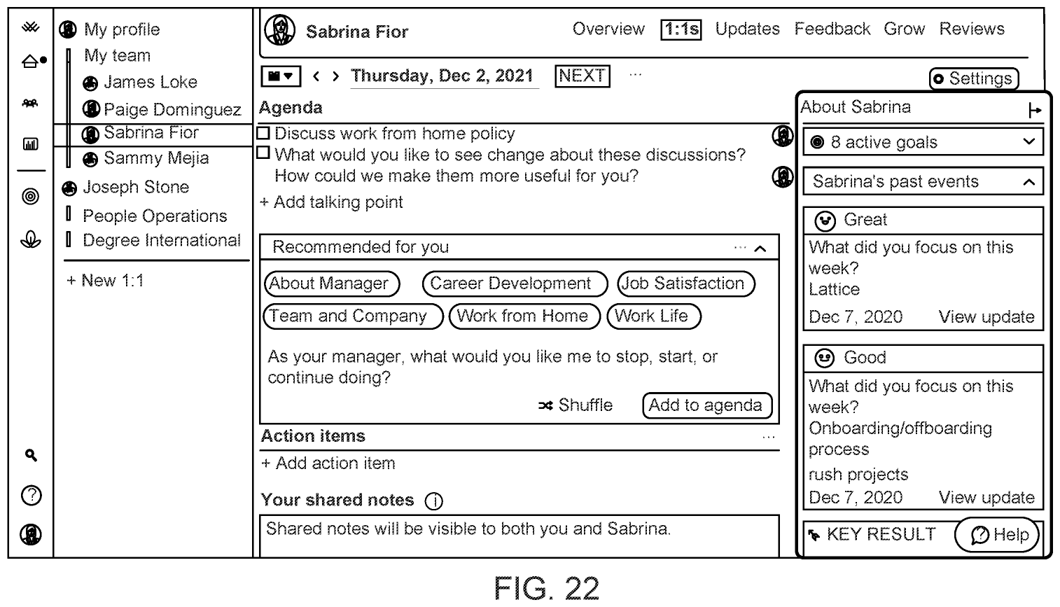

FIG. 22 is a schematic of a user interface displaying a direct report's profile page with a 1:1 context panel containing past activity.

When you view each direct report's 1:1, you will also see a context panel on the screen's right-hand side. Here, you will be able to view all past activity for your direct report. Please note: This activity will vary depending on the tools you and your admin have enabled for your direct report.

The following information may be found in the 1:1: context panel:
1. Active growth areas (if applicable). Selecting View growth plan will take you to the direct report's growth plan to view their growth areas in greater detail.
2. Active goals. This section lists the goals the direct report is an owner of. Selecting a goal will take you to the goal's details page.
3. Past events. Past events included any submitted notes to self you have submitted and the direct report's feedback, past updates, and goals.

FIG. 23 is a schematic demonstrating how to navigate a user interface to hide the 1:1 context panel.

The context panel can be hidden by clicking the arrow on its left-hand side.

### During Your Meeting

Two hours before the 1:1 meeting, both the manager and the direct report will get an email outlining what's on the agenda so that they can prepare for the meeting.

During the meeting, you can check off, comment on, and add additional talking points. After the meeting concludes, the manager will receive an email asking them to check off which items were discussed, push items that weren't covered to the next meeting, and record any notes.

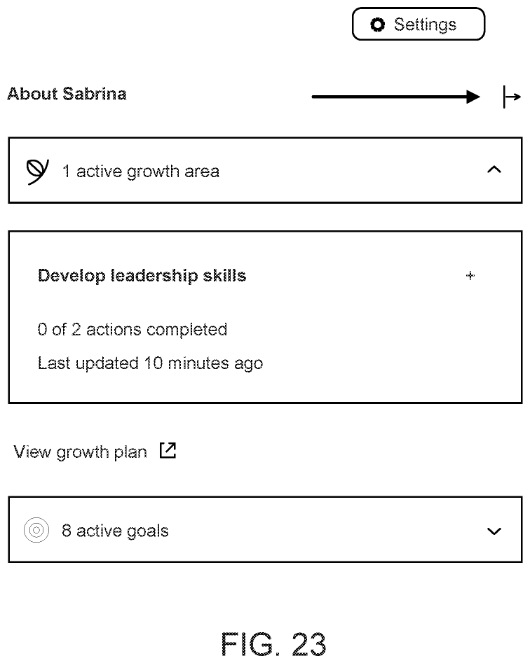

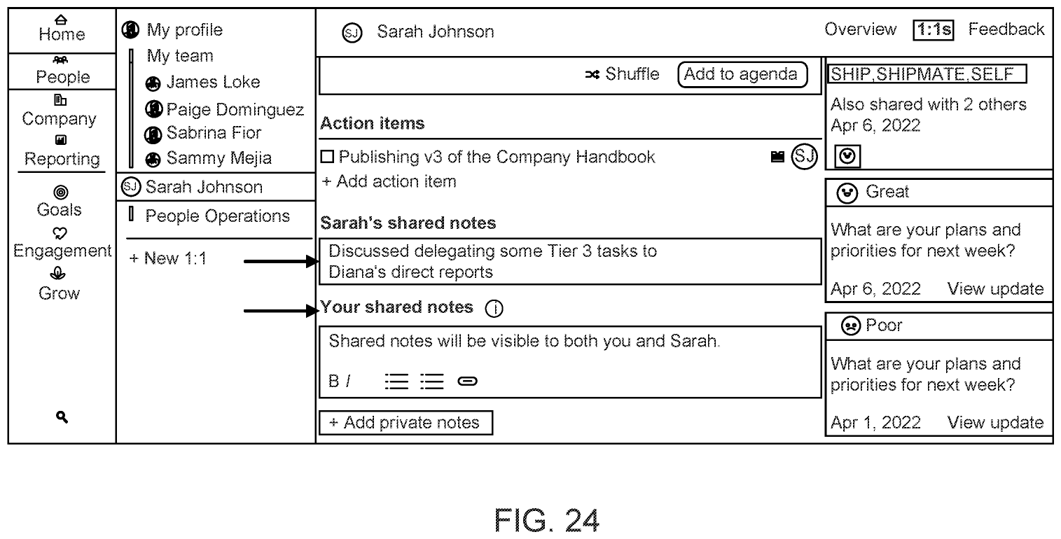

FIG. 24 is a schematic of a user interface displaying a direct report's profile page containing shared notes.

Notes can be left as both public and private. Your direct report and admin can see shared notes. Private notes will only be seen by the person writing the private note. Shared notes sync almost immediately, which means your direct report can see what you have written in real time under the [Manager's]'s shared notes section.

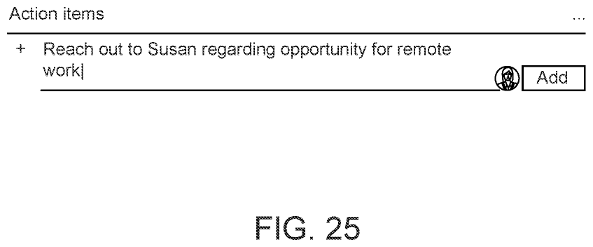

FIG. 25 is a schematic of a portion of a user interface displaying the addition of an action item.

Action items are tasks that should be followed up on before the next meeting. You can add and assign action items to yourself or the direct report.

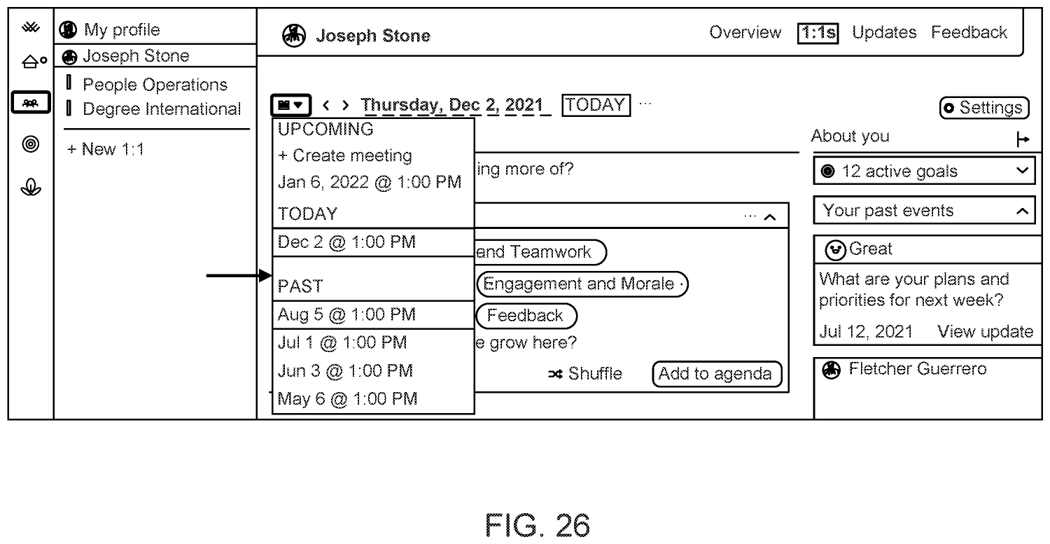

FIG. 26 is a schematic demonstrating how to navigate a user interface to view past 1:1 agendas.

You can view past 1:1 agendas with your direct report by selecting the calendar icon and choosing a date from the dropdown.

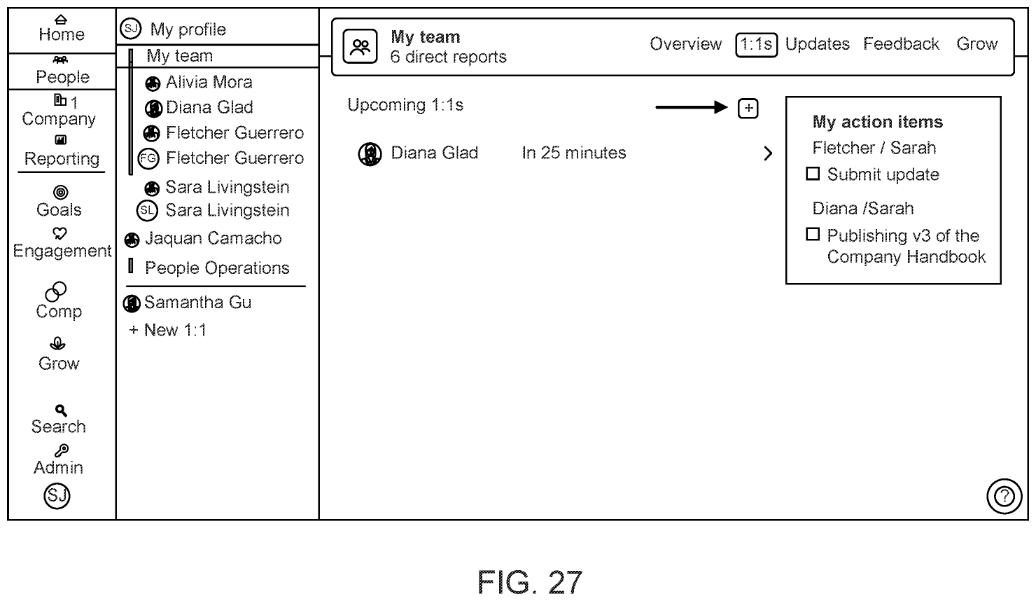

FIG. 27 is a schematic demonstrating how to navigate a user interface to turn on a 1:1 relationship for a direct report.

After the 1:1s tool has been enabled for your organization by your admin, managers can select to turn on or off 1:1s for their direct reports. To turn on a 1:1 relationship for your direct report, please refer to the following steps:
1. Navigate to the People page>My team.
2. Select 1:1s in the toolkit.
3. Click on the + sign to create a new meeting, or create a suggested 1:1 by clicking Set up 1:1.
4. If you wish to connect to your Google or Outlook Calendar, you can set up your integration here. Otherwise, manually select a time and cadence you wish to meet.
5. Toggle the On/Off switch and Save.

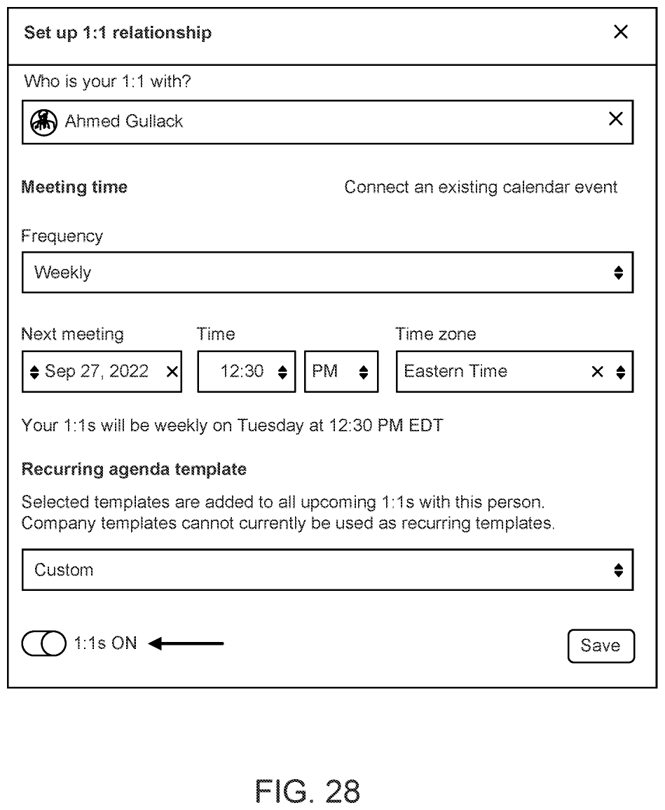

FIG. 28 is a schematic demonstrating how to navigate a user interface to complete the set up of a 1:1 relationship.

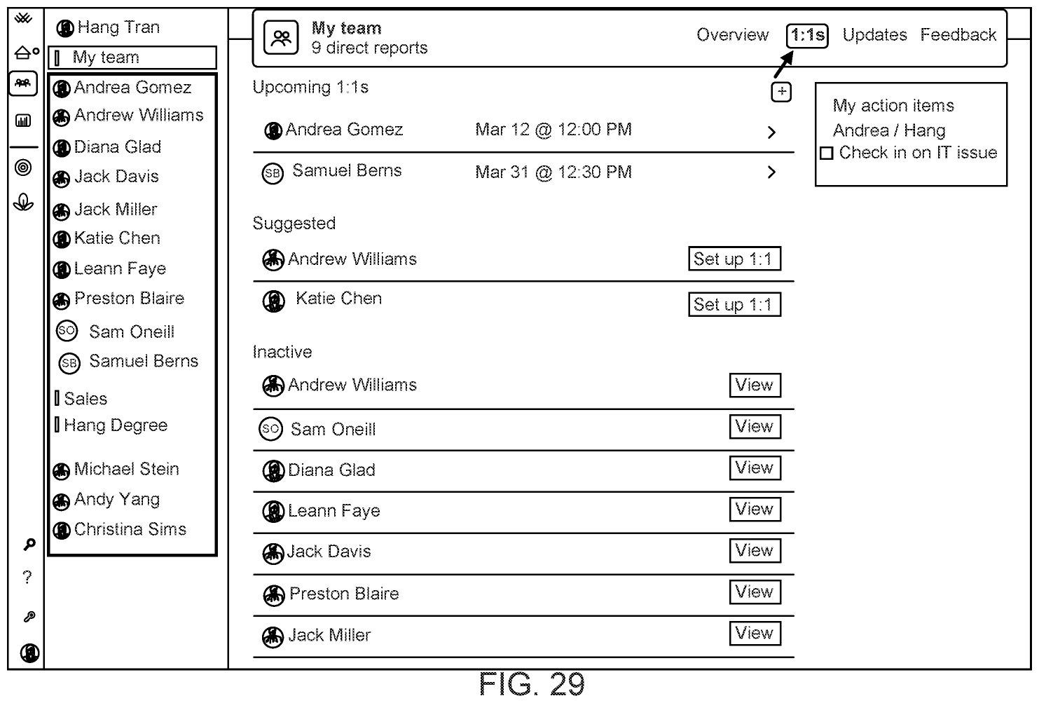

FIG. 29 is a schematic demonstrating how to navigate a user interface to view different 1:1 relationships.

As a system user, you may have multiple 1:1 relationships. To quickly navigate between your 1:1s, please follow the step below:
1. Navigate to the People page>Select the 1:1 relationship from the People navigation, as highlighted below, s—OR—Click on 1:1s in the toolkit.

### Navigating Historic 1:1s

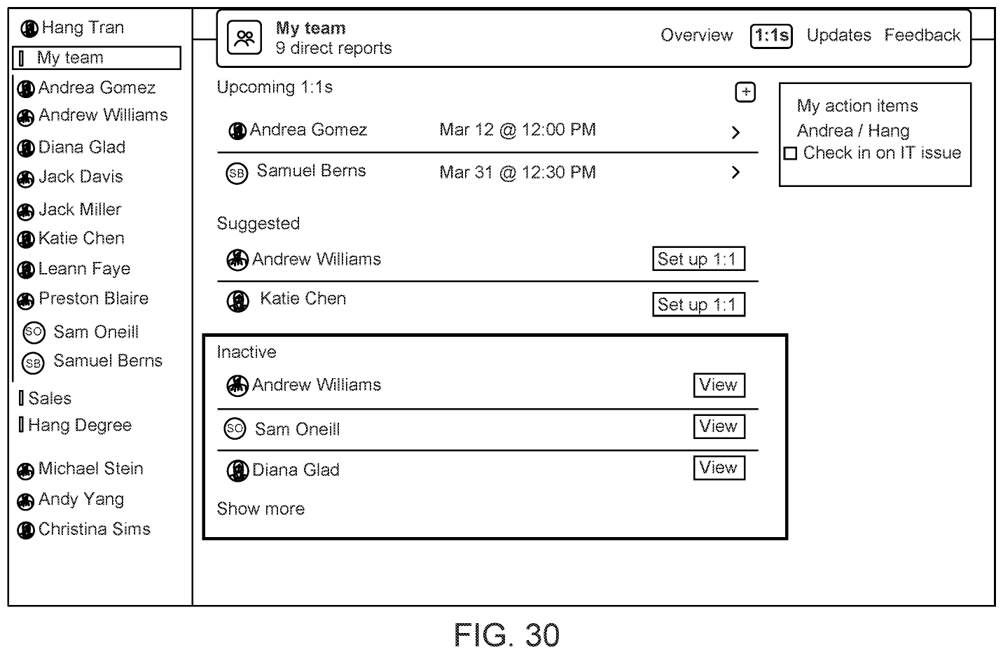

FIG. 30 is a schematic of a user interface displaying the inactive section of a 1:1s page.

In the system, you can have a 1:1 with anyone in your company. Inevitably, some people will cease to meet as work relationships change, someone leaves the company, or two people choose to stop meeting. However, you may want to reference talking points and notes that you have had from your prior 1:1s. The good news is you will still be able to!

Once a 1:1 becomes inactive, it will be visible in the Inactive section on your 1:1s page. You can select View beside the desired 1:1 relationship and have visibility into past meetings.

Employees can create customized agenda templates for agenda items they'd like to discuss regularly in their 1:1 relationships. As a manager, this allows you to efficiently plan your 1:1s and is a great way to ensure you're touching base with each of your direct reports about any team-wide projects or initiatives.

Managers can create agenda templates in two ways:
For their team.
For an individual.

### Before You Start

Non-managers can create agenda templates in their 1:1s but will not be able to edit an agenda template their manager has created.

An employee will only be able to edit the agenda templates that they have created.

Only the creator of the template will be able to view the employees the template is shared with; the direct report cannot view who the template is shared with.

### Create an Agenda for Your Team

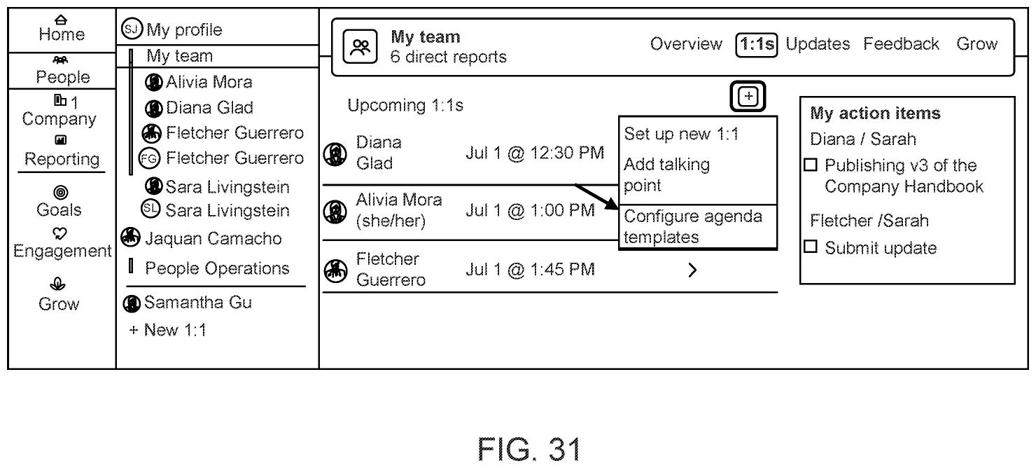

FIG. 31 is a schematic demonstrating how to navigate a user interface to create an agenda for a team.

Note: These steps will only be accessible if you already have created a 1:1 relationship.

If you'd like to assign templates, first create a relationship and then follow these steps to Create an agenda template for an individual:
1. Navigate to People>My team>1:1s.
2. Select plus (+)>Configure agenda templates.
3. Select Create agenda template.
4. Fill out the following agenda template fields:
   Name: Title of your template.
   Agenda: Talking points that will be added to 1:1 agendas the template is assigned to.
   Assigned to (Optional): The active 1:1 relationships you'd like to assign the agenda to.
5. Select Save.

### Creating an Agenda Template for an Individual

The following are steps to create an agenda template for an individual:
1. On the Home page, select Plan 1:1s.
2. Select the 1:1 relationship you'd like to add an agenda template to.
3. Within the agenda, select Settings.
4. Under Recurring agenda template, choose to assign an already created template from the dropdown.
5. (Optional) To create a new agenda template, select Add the desired talking points and select Create as template to give the template a name, assign it out to other relationships, and save.
6. Select Save.

Note: The Custom template is made up of previously added recurring 1:1 talking points for that specific 1:1 relationship. If you'd like to add additional talking points to the Custom template, add additional recurring talking points and select Create as template.

Managers can update or delete their 1:1 agenda templates. Changes made to templates will impact all future 1:1s where the template is assigned.

Note: Edits cannot be made based on individual 1:1 relationships. To adjust the agenda template for one relationship only, you will need to create a new agenda template.

### Edit or Delete an Agenda Template for Your Team

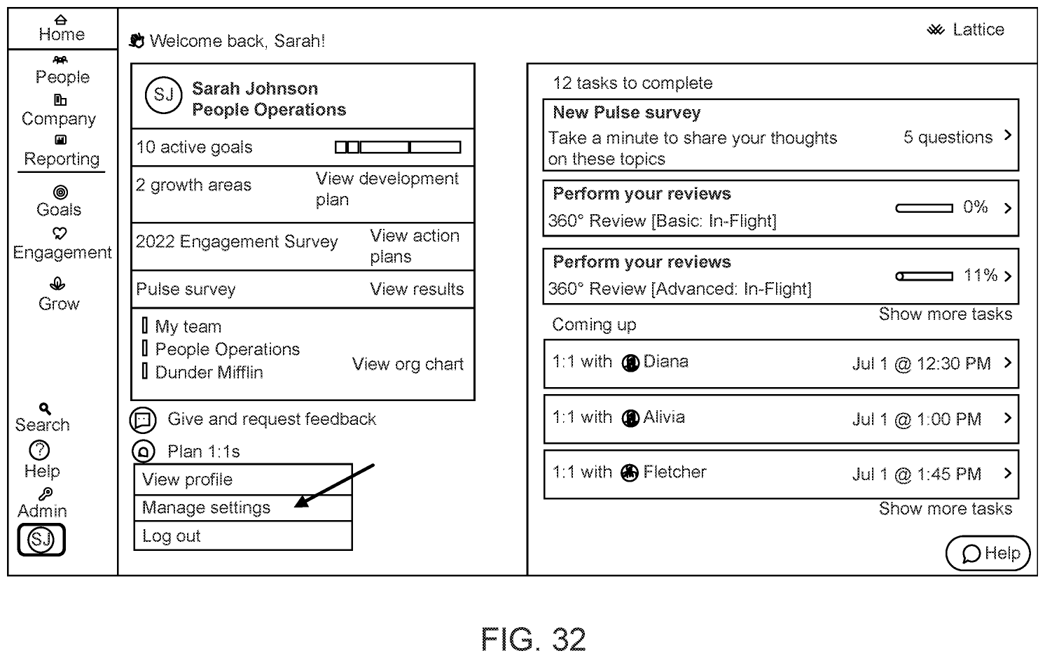

FIG. 32 is a schematic demonstrating how to navigate a user interface to manage settings for a team.

The following are steps to edit or delete an agenda template for a team:
1. Navigate to your profile icon>Manage settings.
2. Navigate to Team Settings>1:1s.
3. Next to the desired agenda, select the ellipsis ( . . . ) and choose Edit agenda template or Delete.

As a manager, you can add talking points to the agendas of multiple meetings at once. This allows you to efficiently plan your 1:1s and is a great way to ensure you're touching base with each of your direct reports about any team-wide projects or initiatives.

### Add Talking Points to Multiple 1:1s

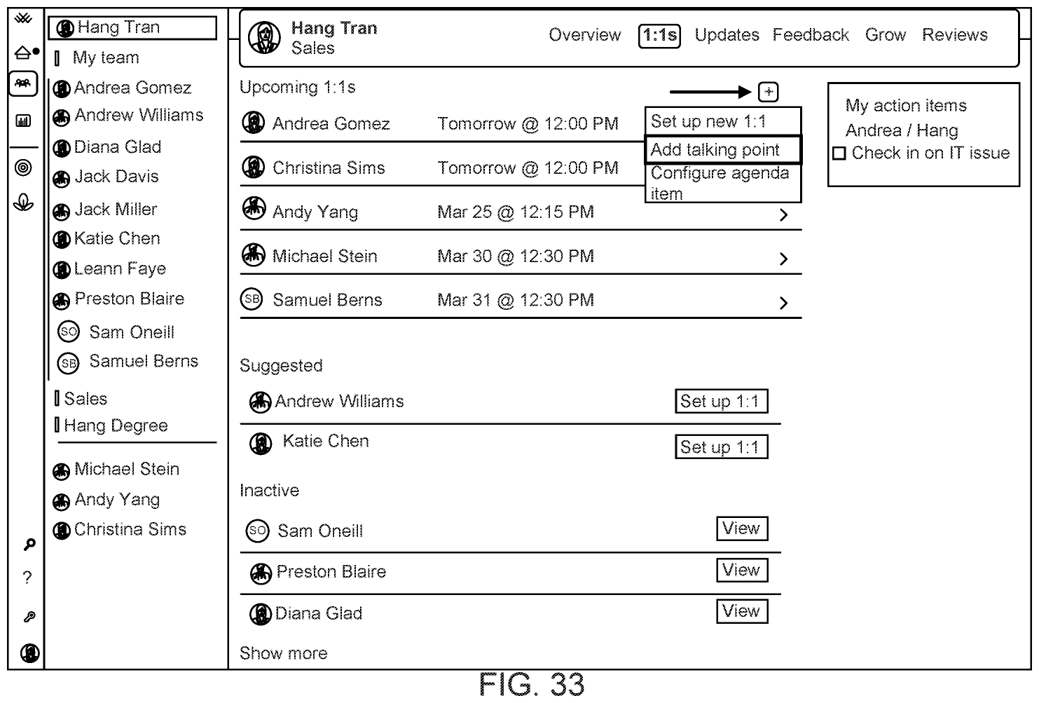

FIG. 33 is a schematic demonstrating how to navigate a user interface to add a talking point to a 1:1.

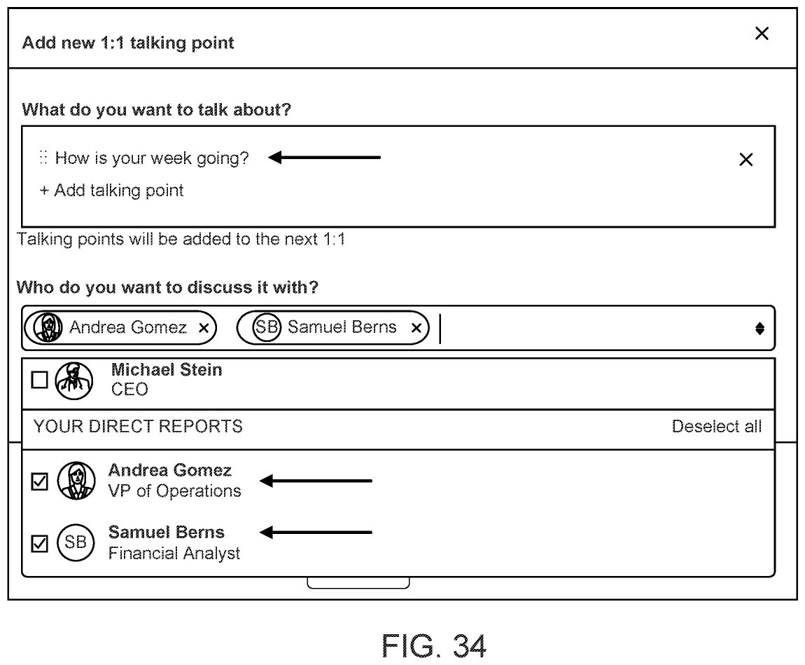

FIG. 34 is a schematic of a user interface displaying a popup modal for planning a 1:1.

The following are steps to add talking points to multiple 1:1s:
1. On your Home page, select Plan 1:1s.—OR—Navigate to People>My profile>1:1s.
2. Select the + sign, then select Add talking point.
3. A popup will appear—under What do you want to talk about?, add one or more talking points.
4. Under Who do you want to discuss it with?, select the 1:1 relationships to which you would like to add the talking points.
5. Select Add talking points—a confirmation notification will verify that they were successfully added.

Once a company 1:1 template has been created by an admin, managers can apply the company template to individual 1:1 relationships with their direct report.

In example embodiments:
Ensure your 1:1 relationship has been created before adding a template.
Company templates cannot be used as recurring templates.
Company templates will be applied to the current 1:1.
Only admins can edit company templates. However, once applied, participants can edit, remove, or add additional talking points to the agenda.

### Apply a Company Template

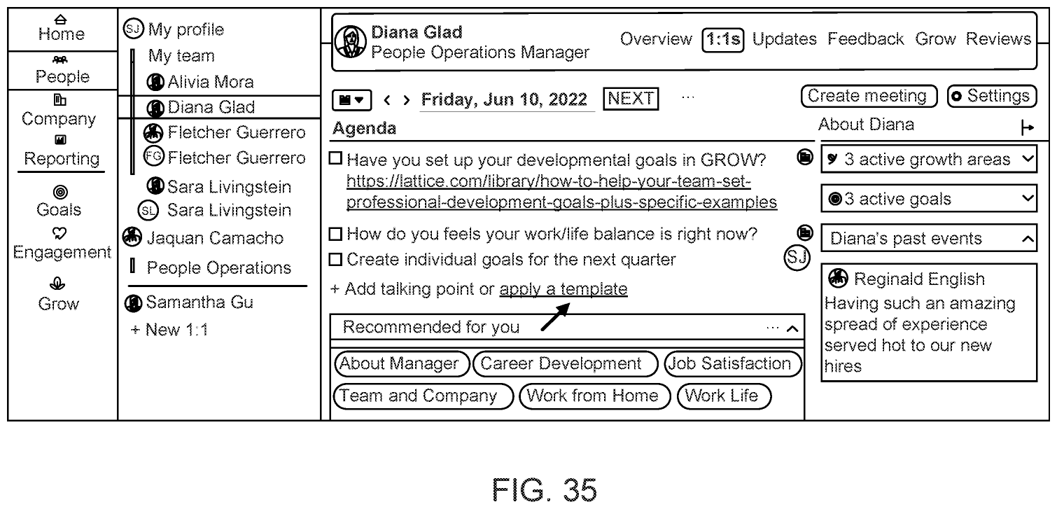

FIG. 35 is a schematic demonstration how to navigate a user interface to apply a template to a 1:1: agenda.

The following are steps to apply a template to a 1:1 agenda:
1. Navigate to People>My team>1:1s.
2. Click into the desired 1:1 relationship.
3. Within the agenda, select apply a template.
4. Within the desired 1:1 template card, select Apply.

Post-review 1:1s enable managers to facilitate productive and meaningful conversations about performance with their direct reports. If your account admin has activated 1:1 company templates, managers can apply a post-review template to make these conversations more impactful.

As a manager, there are two ways to plan a post-review 1:1:
Create a post-review 1:1 from the Reviews tool
Create a post-review 1:1 from the 1:1s tool

Before you start:
Ensure you have already set up a 1:1 relationship with your direct report before applying a 1:1 template
Managers can only apply post-review templates. Unlike agenda templates, 1:1 post-review templates are not recurring. However, adding a post-review template will not override any recurring talking points.
   Create a Post-Review 1:1 from the Reviews Tool

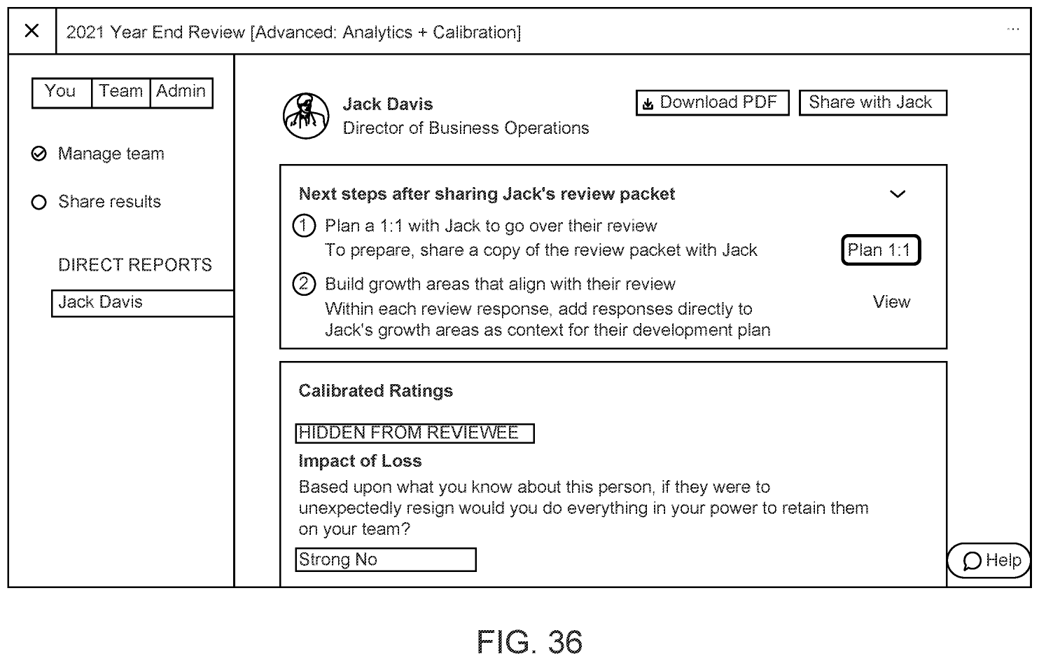

FIG. 36 is a schematic of a user interface displaying a review packet for a direct report.
1. Within the review cycle, navigate to Team>Share results.
2. Select the name of the direct report to enter their web review packet.
3. Within the blue banner labeled Next steps after sharing [Direct Report]'s review packet, select Plan 1:1.
4. Within the templates banner, select the desired post-review template by selecting Apply. Note: the system includes a default template titled Manager's guide to debriefing a performance review.
   Create a Post-Review 1:1 from the 1:1s Tool

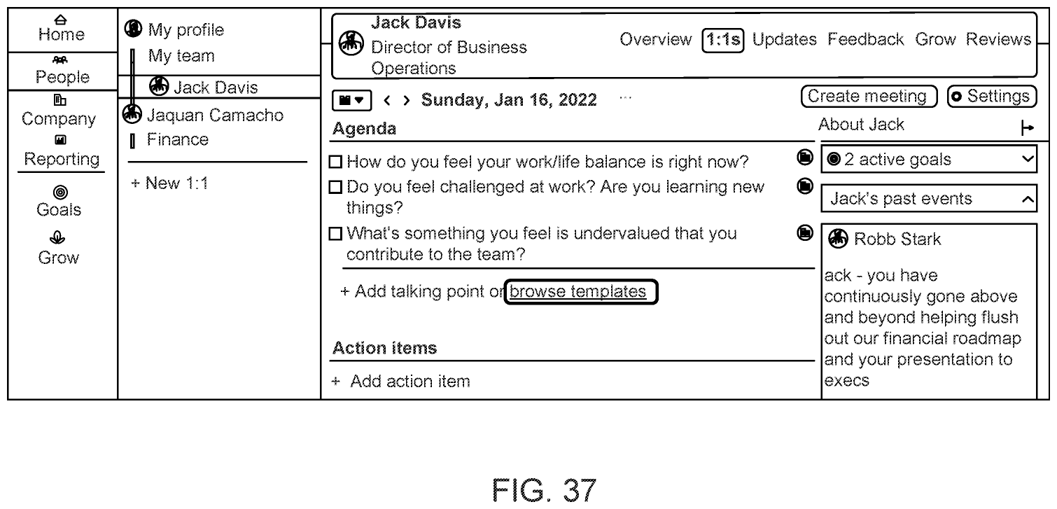

FIG. 37 is a schematic of a user interface displaying a direct report's 1:1s page.

The following are steps to create a post-review from the 1:1s tool:
1. Navigate to People>My team>1:1s.
2. Select the desired 1:1 relationship.
3. Within the 1:1 agenda, select Browse templates to open the template library.
4. Navigate to the desired template and select Apply. Note: the system includes a default template titled Manager's guide to debriefing a performance review.
5. Customize the agenda by adding or removing talking points and action items.

Post-review 1:1s enable managers to facilitate productive and meaningful conversations about performance with their direct reports. If your account admin has activated 1:1 company templates, managers can apply a post-review template to make these conversations more impactful.

As a manager, there are two ways to plan a post-review 1:1:
Create a post-review 1:1 from the Reviews tool
Create a post-review 1:1 from the 1:1s tool

Before You Start:
Ensure you have already set up a 1:1 relationship with your direct report before applying a 1:1 template.
Managers can only apply post-review templates Unlike agenda templates, 1:1 post-review templates are not recurring. However, adding a post-review template will not override any recurring talking points.
   Create a Post-Review 1:1 from the Reviews Tool

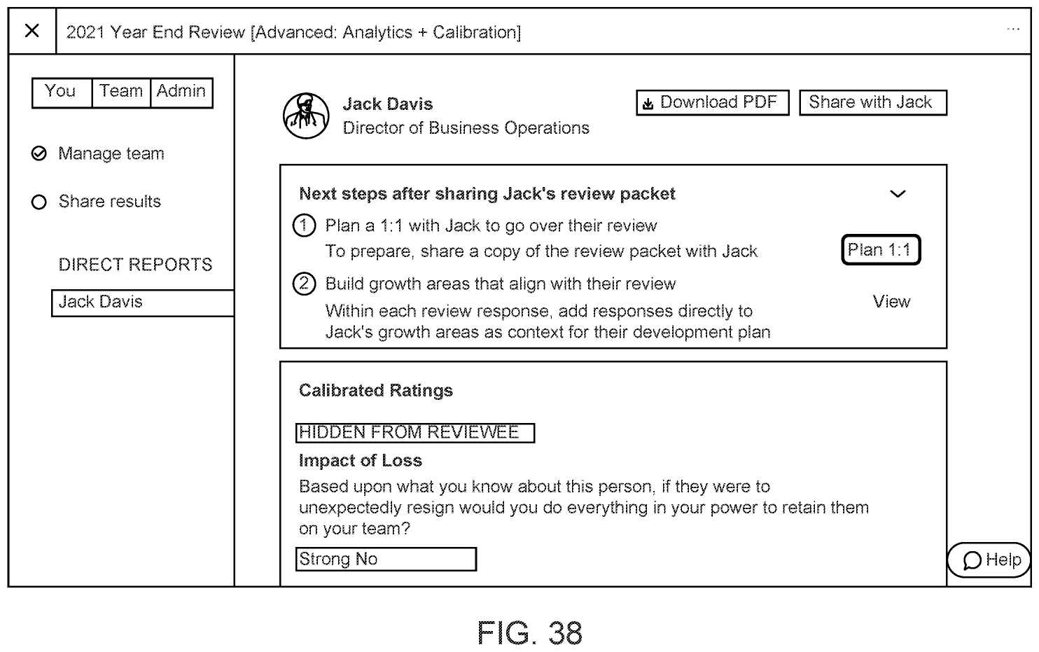

FIG. 38 is a schematic of a user interface displaying a direct report's review packet containing the option to plan a 1:1.
1. Within the review cycle, navigate to Team>Share results.
2. Select the name of the direct report to enter their web review packet.
3. Within the blue banner labeled Next steps after sharing [Direct Report]'s review packet, select Plan 1:1.
4. Within the templates banner, select the desired post-review template by selecting Apply. Note: the system includes a default template titled Manager's guide to debriefing a performance review.
   Create a Post-review 1:1 from the 1:1s Tool

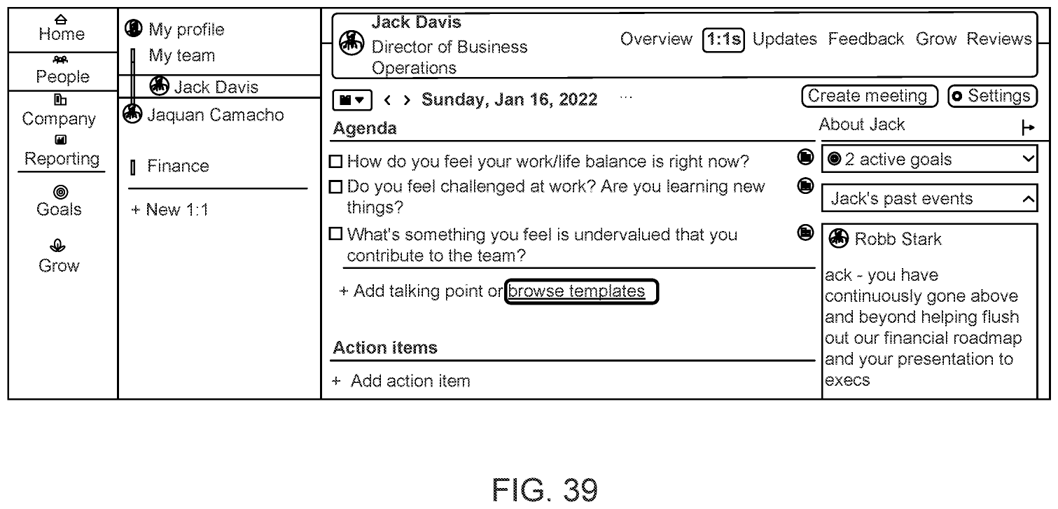

FIG. 39 is a schematic of a user interface displaying a direct report's 1:1s page containing the option to browse 1:1 templates.
1. Navigate to People>My team>1:1s.
2. Select the desired 1:1 relationship.
3. Within the 1:1 agenda, select Browse templates to open the template library.
4. Navigate to the desired template and select Apply. Note: the system includes a default template titled Manager's guide to debriefing a performance review.
5. Customize the agenda by adding or removing talking points and action items.

Recommended talking points nudge managers with questions to add to their 1:1 conversations that are made specifically to identify what matters to employees, understand their problems or concerns, and support them more effectively. The recommendations are drawn from a proven list of questions and conversation-starters to drive alignment and engagement.

In example embodiments, recommended talking points can only be used for manager/direct report relationships. Direct reports can view their own recommended talking points.

### Turn on and Use Recommended Talking Points

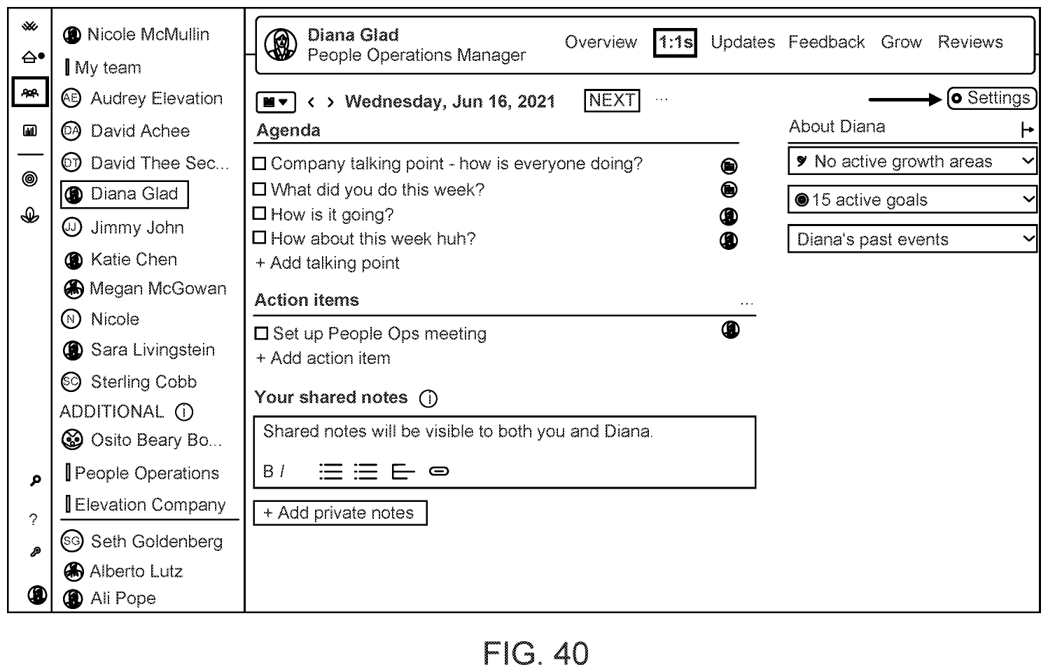

FIG. 40 is a schematic demonstrating how to navigate a user interface to be taken to the settings page for a 1:1 with a direct report.

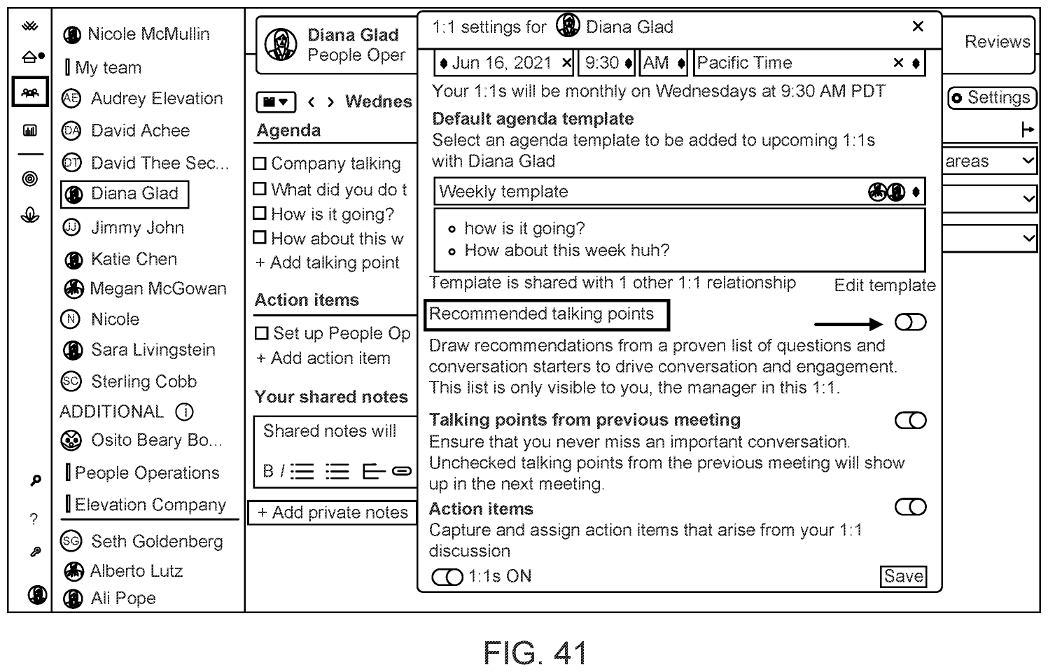

FIG. 41 is a schematic demonstrating how to navigate a user interface to toggle recommended talking points on/off from within a settings page for a 1:1 with a direct report.

The following are steps to turn on and use recommended talking points:
1. On your Home page, select Plan 1:1s.
2. Select a direct report's name to enter the 1:1 and then select Settings.
3. Toggle on Recommended talking points.
4. To add a recommended talking point, select Add to agenda. To see a new recommendation, select the shuffle icon to the right.

When you navigate to your 1:1 for your direct report, you will see the recommended talking points.

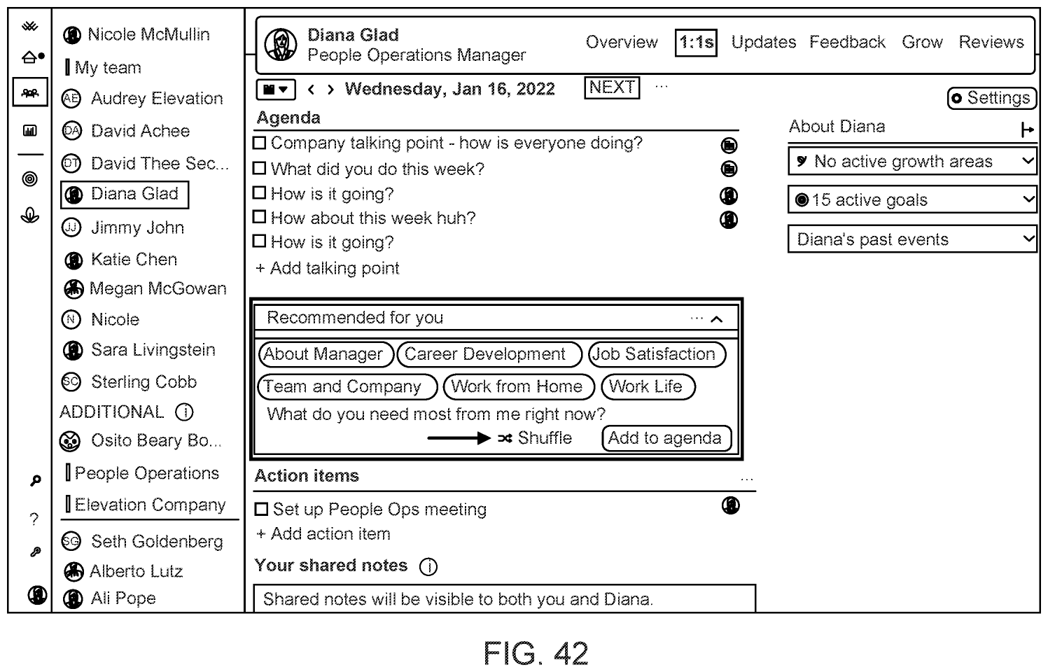

FIG. 42 is a schematic of a user interface displaying a 1:1 page for a direct report containing the option to shuffle recommended talking points.

The recommended talking points inspire managers with optional questions to add to their 1:1s. These questions may be drawn from content in a system library. In example embodiments, these questions may be gathered and vetted by HR experts and researchers in organizational behavior. Others have come from business and people leaders who publish their content publicly, explicitly identifying what matters to employees, understanding their problems or concerns, and supporting them more effectively.

The following are examples of recommended talking points for a Manager:
As your manager, what would you like me to stop, start, or continue doing?
At what point in the past week were you most frustrated with or discouraged by your work? What can I do to help you manage that?
Do you feel you're getting enough feedback? Why/why not?
How could I do a better job communicating with you?
How can I make your days more fulfilling?
What can I do as a manager to make your work easier?
What is the one thing that you need the most from me?
What would you like to see change about these discussions? How could we make them more useful for you?
Which areas would you like more or less direction from me on your work?
What challenges or roadblocks do you need help with?

The following are examples of career development talking points:
Are there any projects you'd really like to work on if you were given the opportunity?
What are the new things you learned at work lately? What are the areas you want to learn about?
Do you feel like we're helping you advance your career? What can I be doing to help grow your career?
How is your current work helping or hurting your professional development?
What is one aspect of your job you would like more help or coaching with?
Which career or development goals do you feel like you're not able to focus on right now?
Who in the company would you like to learn from? What do you want to learn?
A year from now, what do you want to have accomplished?

The following are examples of recommended job satisfaction talking points:
Do you feel over-worked, under-worked, or just the right workload?
Do you feel like you're growing in your role? What makes you say that?
Are you happy with your recent work? Why or why not?
Can you name three things we can do to help so you can enjoy your job more?
What is the best accomplishment you had since you are here? Do you feel appreciated for it?
Do you feel challenged at work? Are you learning new things?
What is your least favorite part of your role? How does that affect your overall performance?
What are your biggest concerns about your current project(s)?
What aspect of your current work is most interesting to you? Why?
What do you like most about working with your team?
What do you think you could be doing differently?
What drives you? What motivates you to come to work each day?
What feedback/praises have you been getting about your current priorities?
What's a recent situation you wish you handled differently? What would you change?
What's an area of your work you want to improve? How can we work together on that?
What part of your job do you wish you didn't have to do?
What's your No. 1 problem right now? How are you feeling about it?
When was the time you enjoyed working here the most?
Which areas make you feel like your hands are tied or you are unable to reach your full potential?
What do you want to do but don't feel like you have the time for?

The following are examples of other talking points:
What would you be doing right now if we weren't having this meeting? How do you feel about being taken away from that task?
What's one thing we could change about work for you that would improve your personal life?

The following are examples of team and company talking points:
Are there any meetings or discussions you feel you should be a part of that you're not? Are you included in any you don't want to be a part of?
Are you uncomfortable giving any of your peers constructive criticism? If so, why?
How would you describe the division of work among team members?
How would you rate our communication as a team?
How would you say we're doing at working together as a team? What makes you say that?
What are we doing that you think we should stop doing, and why?
What are we not doing that we should be doing? What makes you say that?
What kind of communication or information do you wish you had more of?
What sort of resources could you use right now to make things more manageable?
What's one thing we'd be crazy not to do in the next quarter?
Which areas would you like more feedback on?
Who inspires you in the team? Whose opinions do you respect? What have they done?
What's the biggest opportunity that we aren't thinking about?

The following are examples of work-life talking points:
What are the most important things you will focus on before we meet next?
What do you do when you feel low energy or unmotivated?
What is an ideal, productive day at work for you? Walk me through the day . . . .
What makes you excited and motivated to work on a project?
What part of your work routine do you find is working best? What area do you want to improve?
What were your biggest time wasters or roadblocks since we last met?

1:1 participants have the ability to disable any 1:1 relationship they created. Disabling a relationship will allow you to keep your notes and restore any content if you decide to re-enable the relationship.

Ending a 1:1 relationship will not delete agendas or meeting notes. To permanently delete an agenda, users may be required to reach out to a system admin.

### Disable a 1:1

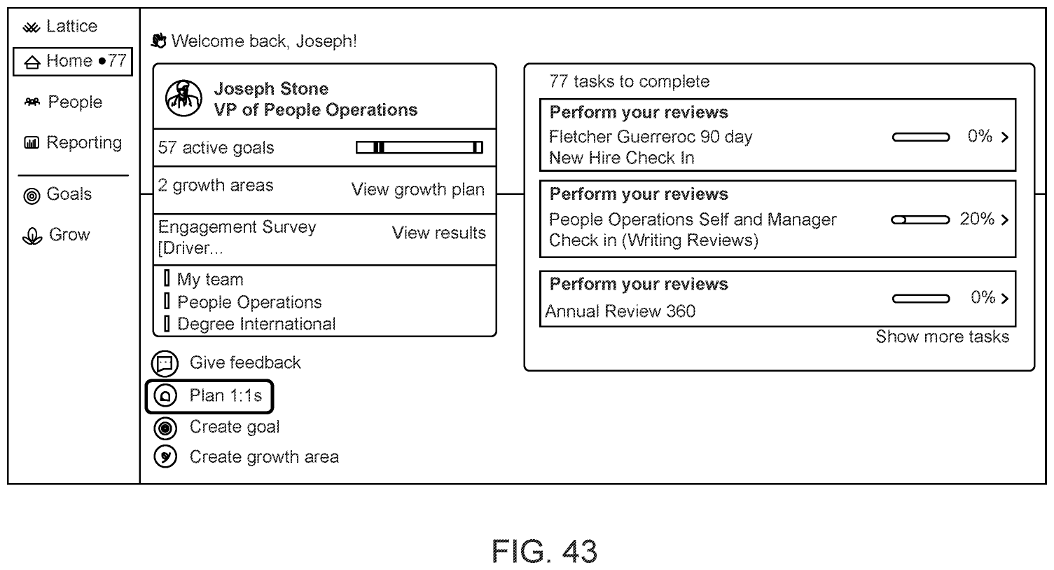

FIG. 43 is a schematic of a user interface displaying a home page with the option to plan 1:1s.

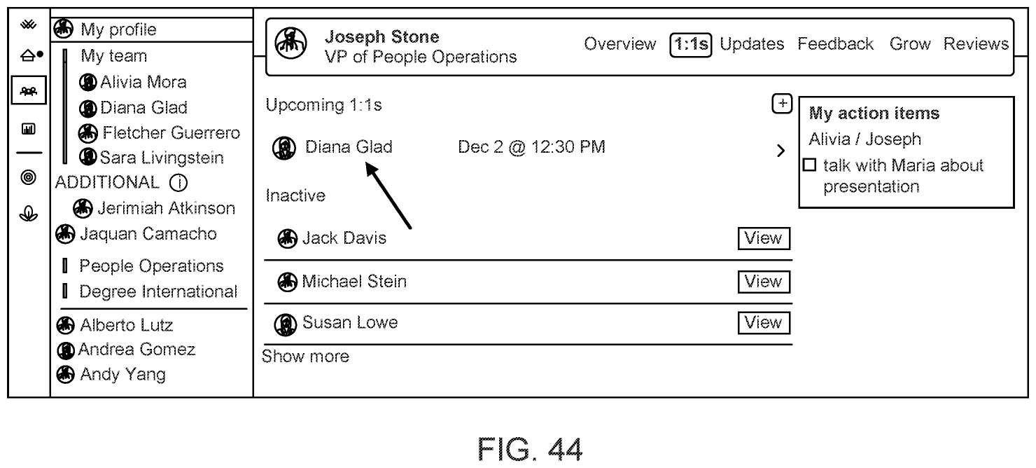

FIG. 44 is a schematic of a user interface displaying a list of upcoming and inactive 1:1s on a 1:1s page.

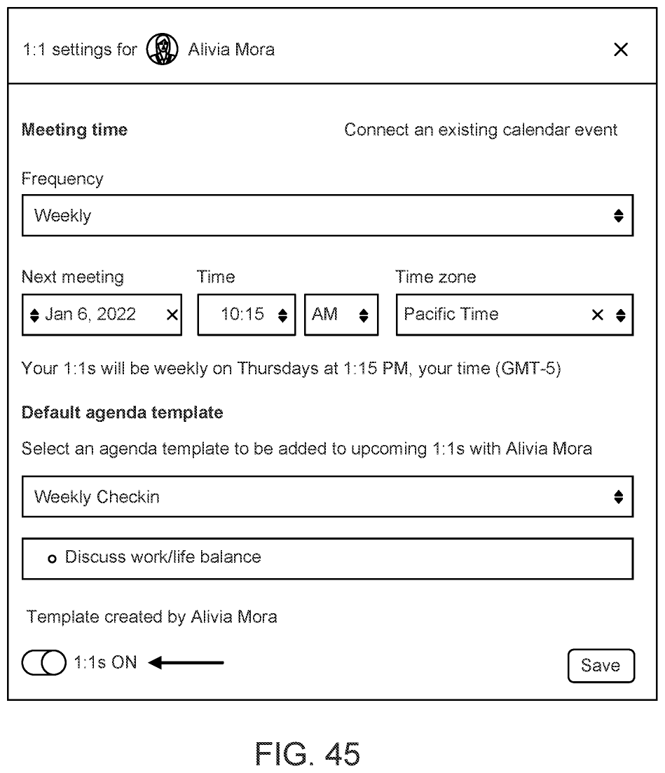

FIG. 45 is a schematic of a user interface displaying a settings modal for a 1:1 with the option to toggle off 1:1s.

The following are steps to disable a 1:1:
1. On your Home page, select Plan 1:1s.—OR—Navigate to People>My profile>1:1s.
2. Under Upcoming 1:1s, select the 1:1 you would like to disable.
3. Within the 1:1, select Settings—the Settings modal will appear.
4. Toggle off 1:1s ON and Save.

### Where to View Inactive 1:1s

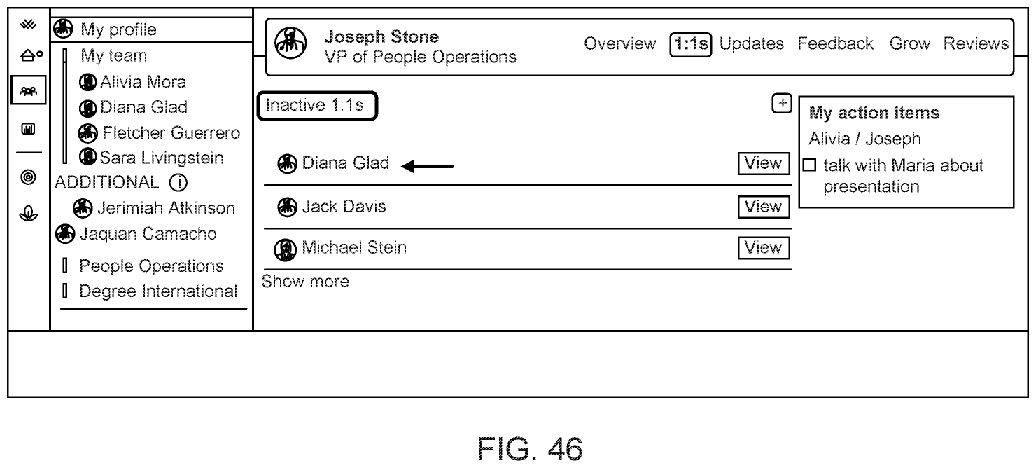

FIG. 46 is a schematic of a user interface displaying the inactive 1:1s section of a 1:1s page.

Disabled 1:1s can be viewed under the Inactive 1:1s section. Agenda items and meeting notes will be restored if the 1:1 relationship is reactivated.

When an employee changes managers in the system, the 1:1 relationship with the former manager will move to an Inactive relationship. The former direct report can view their inactive 1:1 by clicking into Plan 1:1s from their Home page.

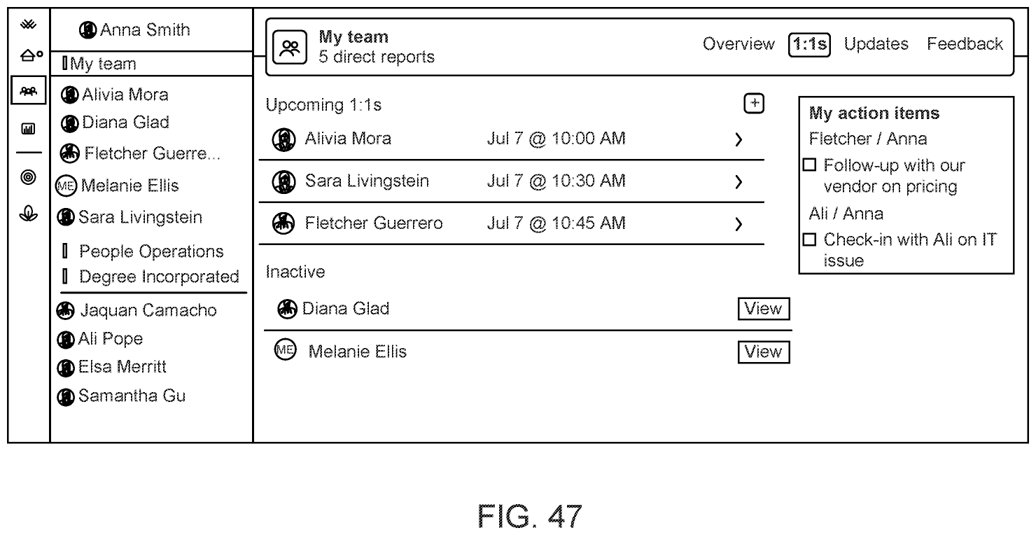

FIG. 47 is a schematic of a user interface displaying a 1:1s page containing a list of upcoming 1:1s and inactive 1:1s.

The new manager will not have visibility into past 1:1s meetings of their new direct report.

The system's Google Calendar integration will automatically update the system when rescheduling or canceling your 1:1 event within Google Calendar. The system will automatically schedule the next 1:1 for the next scheduled meeting.

Before you start Google Calendar integration, take note of the following:
The Google integration is a one-way integration with the system. The system will use Google as the source of truth for 1:1 scheduling but will not add notes or create an event within Google.
Dates and times will update in the system if the change is made at least 10 minutes before the time the original 1:1 is scheduled to take place.
Calendar changes can take up to 1 hour to display changes in the system
The following criteria must be met for successful integration:
   In Google Calendar, the 1:1 event must be set to recurring and unending and already exist within your calendar.
   The Google Calendar event must be scheduled no more than four months into the future to prevent disconnection.
   The system's calendar integration does not support calendar events created by third-party applications such as Clockwise and Reclaim.ai.
      Integrate with Google Calendar

The following are steps to integrate Google Calendar with the system:
1. Navigate to your 1:1 relationship:
   If you are creating this 1:1 relationship for the first time: Navigate to Home>Plan 1:1s. Select the plus sign (+)>Set up new 1:1 Connect to an existing calendar event.
   If you already have a 1:1 relationship in the system: Navigate to Home Plan 1:1s. Select the participant's name to open the agenda and select Settings>Connect to an existing calendar event.
2. Under Connect to an existing calendar, select Google Calendar. You may be asked to sign in to your Google account.
3. Select Allow to authorize the system integration.
4. Select the calendar that manages the event you want to integrate and click Select calendar.
5. Select the existing recurring event that will sync to your 1:1 and click Select event.

The system allows you to sync your 1:1 relationships with your Outlook calendar. The system's Outlook Calendar integration will automatically update the system when rescheduling or canceling your event within Outlook.

Before you start Outlook Calendar integration, take note that the Outlook integration is a one-way integration with the system. The system will use Outlook as the source of truth for 1:1 scheduling but will not add notes or create an event within Outlook

The following must be met for the integration to be successful:
The Outlook account must be hosted on Microsoft servers and not self-hosted.
The Outlook account must be integrated using the Microsoft web login, not the desktop version.
In Outlook, the 1:1 event must be set to recurring and unending and already exist within your calendar.
The Outlook event must be scheduled no more than four months into the future to prevent disconnection
Calendar events created by third-party applications such as Clockwise and Reclaim.ai aren't supported by Lattice's calendar integration.

### Connecting Your Calendar

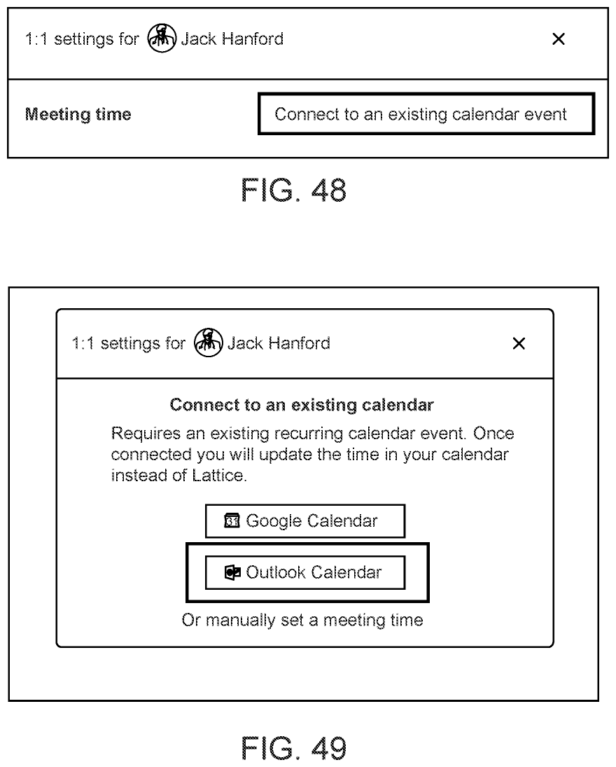

FIG. 48 is a schematic of a portion of a user interface displaying a 1:1s setting page with an option to connect to an existing calendar event.

FIG. 49 is a schematic of a user interface displaying a popup for connecting a calendar provider.

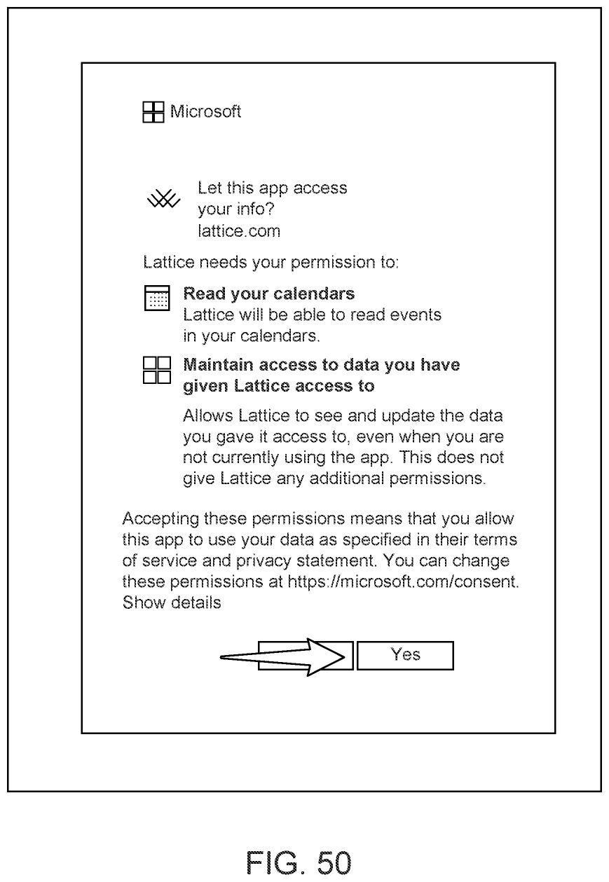

FIG. 50 is a schematic of a user interface displaying a popup modal requesting permission for Outlook to sync with the system.

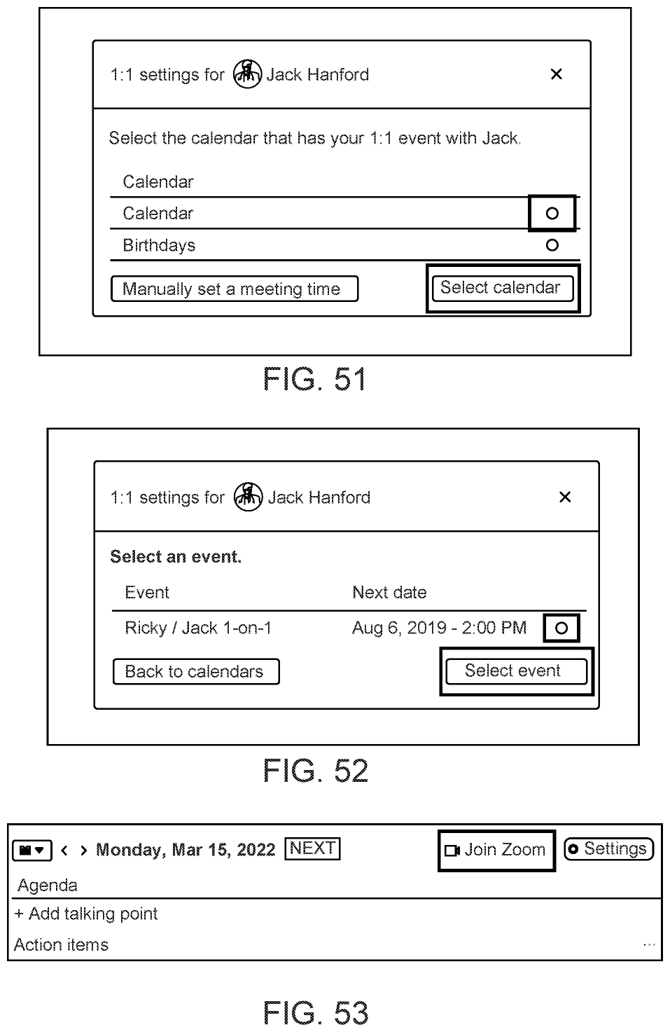

FIG. 51 is a schematic of a user interface displaying a popup modal for selecting a calendar to integrate.

FIG. 52 is a schematic of a user interface displaying a popup modal for selecting an event to integrate.

The following are steps to connect a calendar to Outlook:
1. To connect your calendar, make sure you already have
   a recurring meeting set in Outlook.
      If you are creating this 1:1 relationship for the first time, navigate to Home>Plan 1:1s. Select the plus sign (+)>Set up new 1:1>Connect to an existing calendar event.
      If you already have a 1:1 relationship in the system, navigate to Home>Plan 1:1s Select the participant's name to open the agenda and select Settings>Connect to an existing calendar event.
2. You will be prompted to choose your calendar provider (Outlook).
3. If you have not given Outlook permission to sync with the system, you will be taken to a screen to do so. To sync your Outlook with the system, click Yes and follow the instructions for integration.
3. Select the calendar that manages the event and select the specific event you would like to integrate.
   Join Zoom Directly from the 1:1

Participants can join Zoom from the agenda as long as the link is found in the Location field in Outlook.

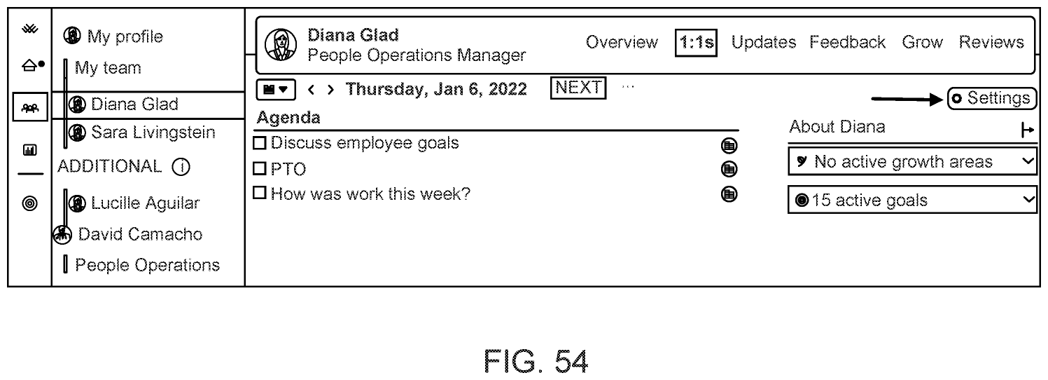

FIG. 53 is a schematic of a portion of a user interface displaying an Outlook calendar with a link to join Zoom.

Please note: Join Zoom will not show up in the system if the Zoom link is only available in the invite description. In example embodiments, the system only supports Zoom meetings without any location/conference room added. Otherwise, you may encounter a Meeting ID error when joining.

### Change the Time of Your 1:1s

Once you have synced your Outlook calendar with the system, every time you change the event on your calendar, the system will be automatically updated.

Once your 1:1 has passed on your calendar, the system will automatically schedule the next 1:1 for the following week. If you missed this 1:1 meeting, update the meeting time in Outlook to the new correct time for your make-up meeting.

### Disconnect Outlook

FIG. 54 is a schematic of a user interface displaying a 1:1s page containing a link to settings.

To disconnect Outlook from the system, navigate to your 1:1>Settings>Disconnect from calendar event.

Once you disconnect, you have the ability to reconnect by following the steps above.

### Disconnecting Your Calendar

You may want to change the event that your 1:1 in the system is connected to. To do this, you will need to disconnect your calendar event for that direct report and then reconnect to the new event. To disconnect your calendar, please follow the steps below:

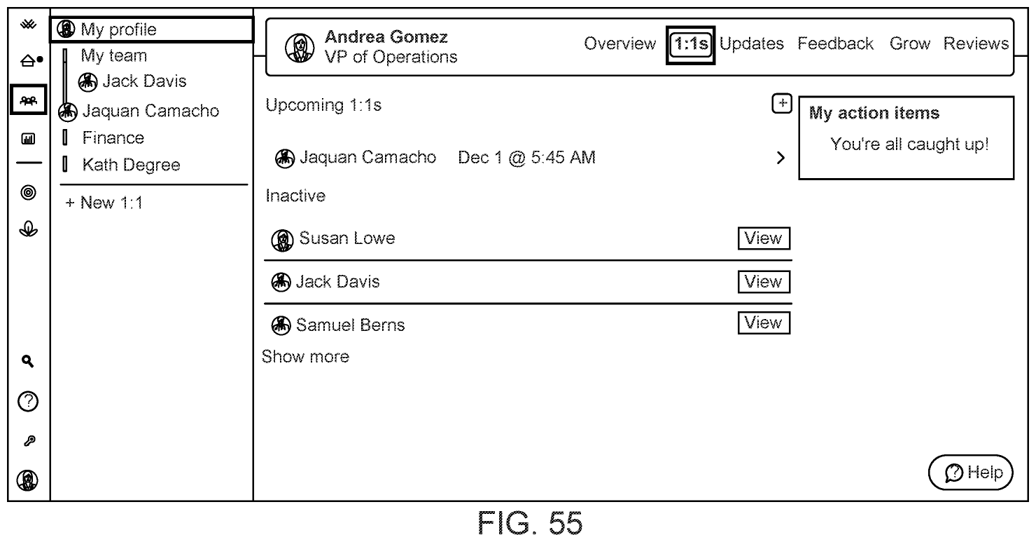

FIG. 55 is a schematic demonstrating how to navigate a user interface to view the 1:1s page.

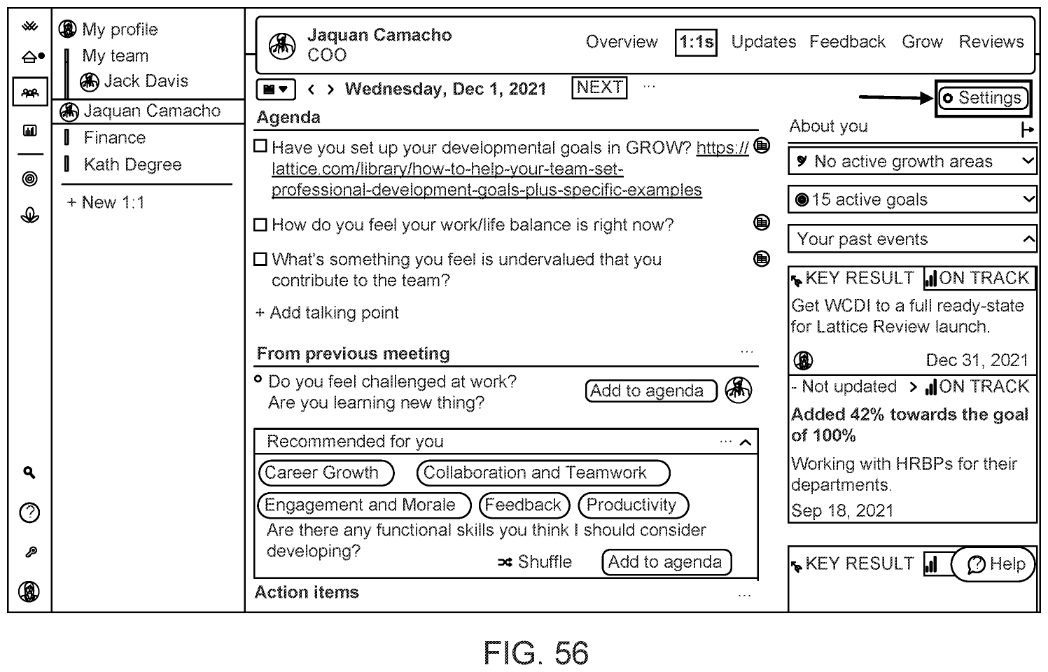

FIG. 56 is a schematic demonstrating how to navigate a user interface to view settings for a 1:1 relationship.

The following are steps for disconnecting your calendar from a 1:1 relationship:
1. People page>My profile>1:1s.
2. Select the 1:1 relationship you'd like to disconnect your calendar from>Settings.
3. Choose Disconnect from calendar event.

The system makes it easy to sync your 1:1s in the system with the recurring meetings on your Google Apps Calendars. To do so, the system uses the Google Calendar API to request read-only access to calendar data from your Google Apps Account. After integrating your account, whenever you update the timing of a synced event in your calendar, the time will also be updated in the system.

The system uses Google's OAuth authentication flow to acquire API access for individual users.

The Google Calendar API v3 scopes requested are:
https://www.googleapis.com/auth/calendar.readonly
https://www.googleapis.com/auth/calendar.events.readonly

With the above access, the system can read a list of calendars and the events on those calendars the user has access to. This includes any calendars shared with the user.

The system does not store any user calendar information except the API keys needed to access the APIs and individual event references that the user has explicitly linked to a 1:1 in the system. The system does not have the ability to create, delete, or make any changes to any events on user calendars.

System users can revoke Lattice's access to calendars at any time in the Googles Apps dashboard.

### 1:1s for Employees

As a direct report, you may want to schedule 1:1 time to meet with your manager. If your manager has not yet turned on your 1:1s tool, you can follow the steps below to initiate 1:1s.

### Set Up a 1:1 Relationship

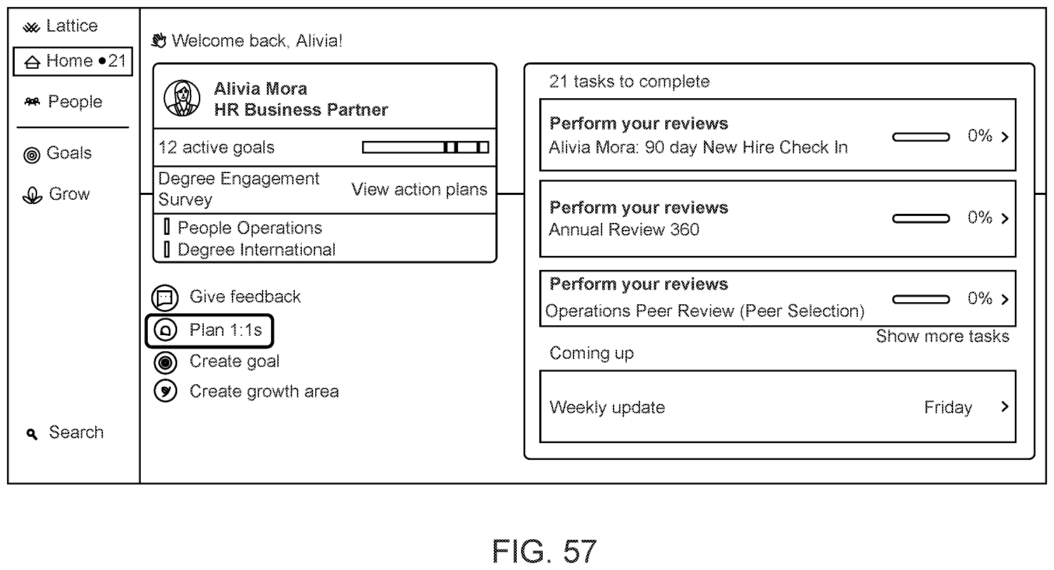

FIG. 57 is a schematic of a user interface displaying a home page with a link to the plan 1:1s page.

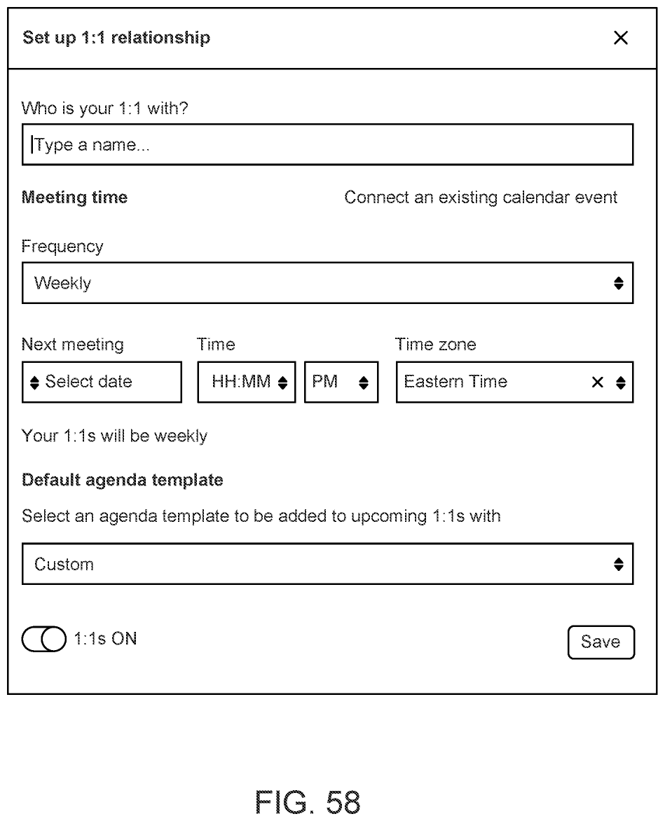

FIG. 58 is a schematic of a user interface displaying a set up page for a first 1:1 meeting.

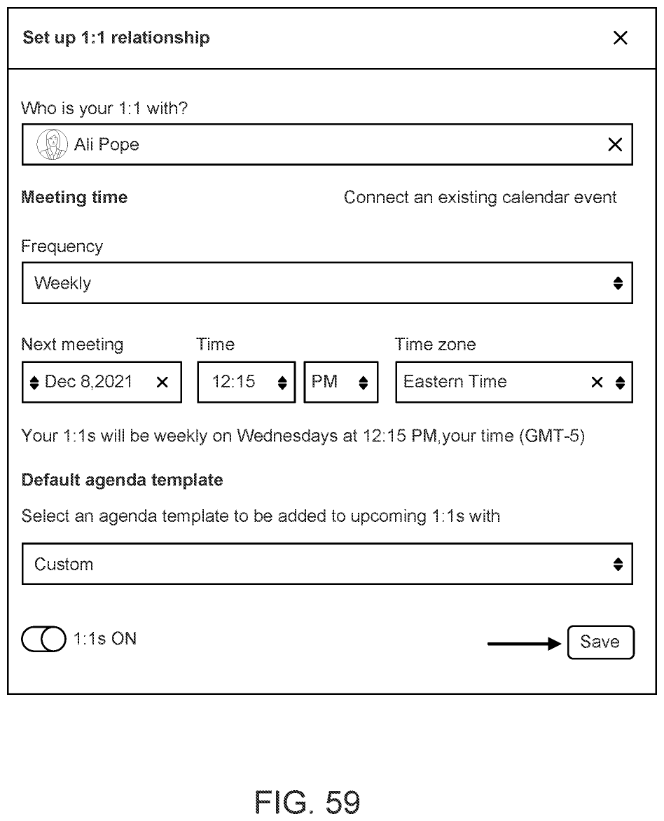

FIG. 59 is a schematic of a user interface displaying a completed set up page for a first 1:1 meeting.

The following are steps to set up a 1:1 reminder:
1. On your Home page, select Plan 1:1s.—OR—Navigate to People>My profile>1:1s.
2. (optional): If this is your first 1:1 meeting, you will be prompted to Set up your first meeting.
3. If you already have set up 1:1s with other participants, select the + sign to create a new 1:1 or turn on a suggested meeting by clicking Set up 1:1 next to your manager's name.
4. Under Who is your 1:1 with?, enter and select your manager's name.
5. If you would like to connect your calendar to system 1:1s, select Connect to an existing calendar. You will have the option to choose either Google or Outlook.—OR—Manually set up your 1:1 by setting the meeting frequency, next meeting date, time, and time zone.
6. (optional): Set recurring talking points in your 1:1 by creating an agenda template.
7. Allow talking points from previous meetings to automatically appear and include action items by toggling these options on.
8. Save.

The system's 1:1s are not only for manager-employee relationships. You can set up a 1:1 with any other user in your account. Non-manager 1:1 relationships are a great way to keep up with a mentorship, stay on top of projects, and check in on employee feedback.

Set Up a 1:1 with a Teammate

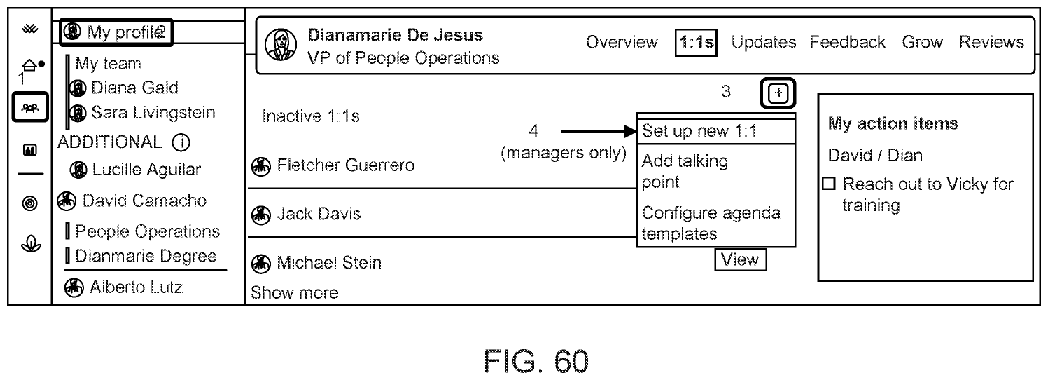

FIG. 60 is a schematic demonstrating how to navigate a user interface to set up a 1:1 with a teammate.

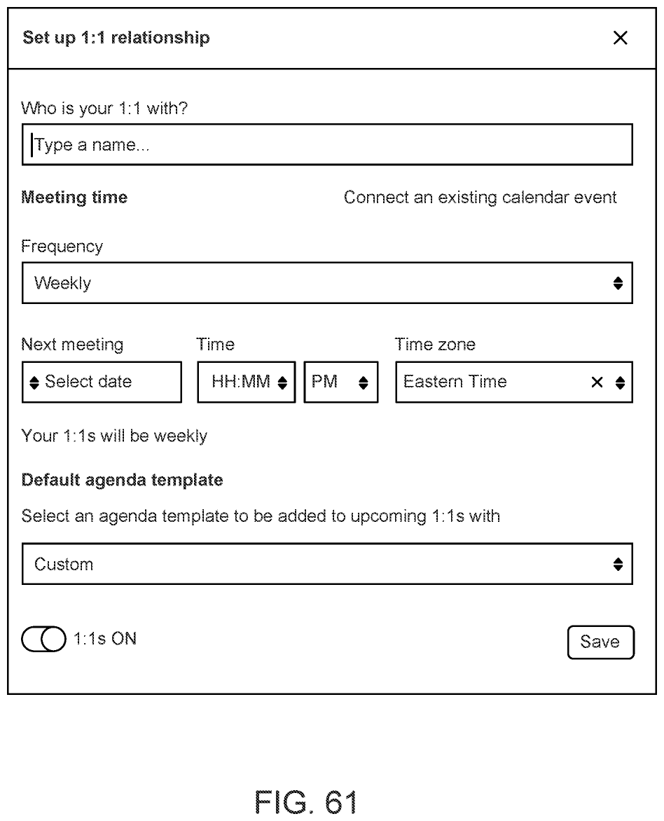

FIG. 61 is a schematic of a user interface displaying a page for setting up a 1:1.

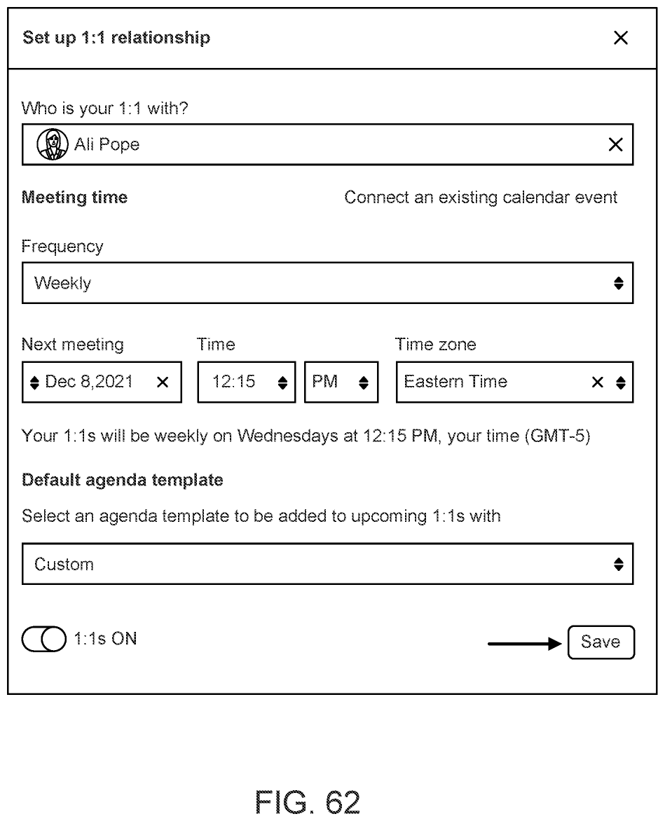

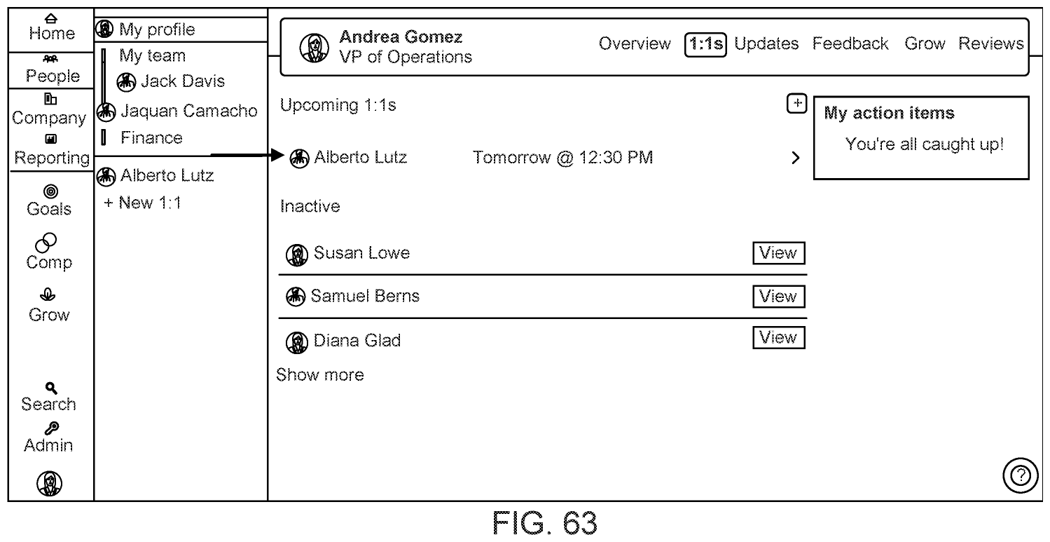

FIG. 62 is a schematic of a user interface displaying a completed set up page for a 1:1.

Managers will not have access to your 1:1 meetings with other participants. Admins can view non-manager relationships from within the 1:1s Log page.

The following are steps for setting up a 1:1 with a teammate:
1. Navigate to Home>Plan 1:1s.—OR—Step 1: Navigate to People>My profile>1:1s.
2. Select the +(plus) sign to create a new relationship. (if you are a manager select+(plus)>Set up new 1:1.)
3. Under Who is your 1:1 with?, enter and select the participant's name.
4. If you would like to connect your calendar to 1:1s, select Connect to an existing calendar You will have the option to choose either Google or Outlook.—OR—Manually set up your 1:1 by setting the meeting frequency, next meeting date, time, and time zone.
5. (optional): Set recurring talking points in your 1:1 by creating an agenda template.
6. Allow talking points from previous meetings to automatically appear and include action items by toggling these options on.
7. Save.

### Access a 1:1 Participant's Profile

FIG. 63 is a schematic demonstrating how to navigate a user interface to access the profile of a 1:1 participant from the 1:1s page.

To view the 1:1 relationship created, navigate to People>My profile>1:1s.

Users can create an ad hoc 1:1 meeting without disrupting the cadence of any current 1:1 relationship or creating a recurring relationship with a participant. Ad hoc meetings allow for 1:1s to occur when needed.

Create an Ad Hoc Meeting from an Existing Relationship

The following are steps for creating an ad hoc meeting from an existing relationship:
1. On your Home page, select Plan 1:1s.—OR—Navigate to People>My profile>1:1s.
2. Select the name of the employee you want to create an ad hoc 1:1 with to enter the 1:1 agenda.
3. Select Create meeting.
4. (Optional) A new agenda will be created with today's date. To change the date and time, select the date and customize the day and time of the ad hoc meeting. Select Save.

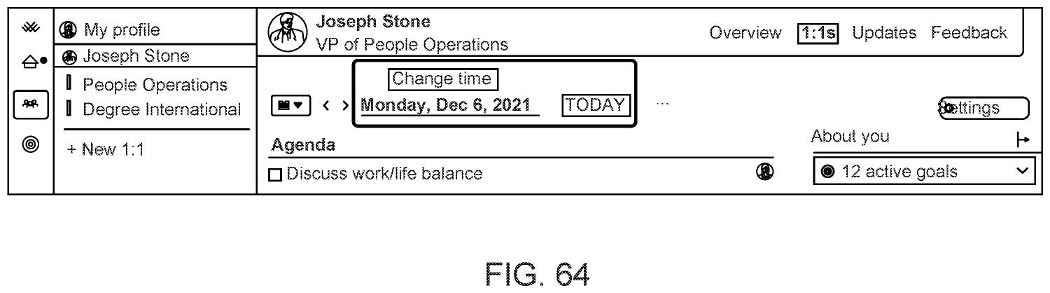

FIG. 64 is a schematic of a portion of a user interface displaying a 1:1 agenda with a date and time.

Note: The day and time of the ad hoc meeting must be a time in the future.

Create an Ad Hoc Meeting from a Non-Existing Relationship

You can create ad-hoc meetings with employees with whom you do not have a 1:1 relationship. To do so, please follow the following steps:
1. On your Home page, select Plan 1:1s.—OR—Navigate to People>My profile>1:1s.
2. Select the +(plus) sign to create a new relationship. (if you are a manager select+(plus)>Set up new 1:1.)
3. Under Who is your 1:1 with?, enter and select the participant's name.
4. Set the frequency to Once (not recurring). After you have filled out all fields, save your changes.

### Notifications

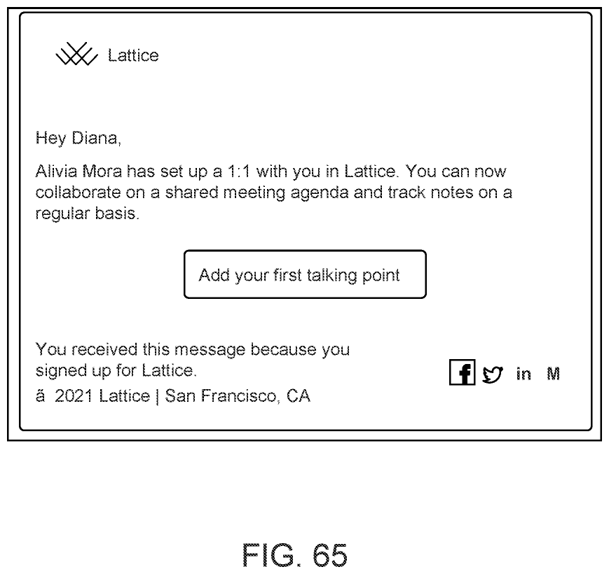

FIG. 65 is a schematic of a user interface displaying an email notification that a 1:1 relationship was created.

The second participant will be notified that a relationship was created via email. Directly from this email, the participant can navigate to the agenda and add talking points.

The 1:1s tool allows both managers and employees to collaborate on a shared agenda for their in-person meetings. The 1:1 meeting is an opportunity to develop employees' skills and gives the employee a chance to discuss workplace challenges.

### Using Your Agenda

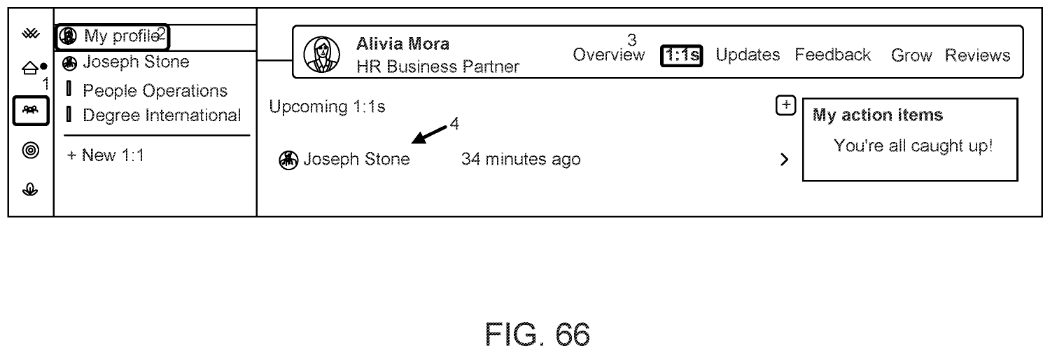

FIG. 66 is a schematic demonstrating how to navigate a user interface to enter a 1:1 agenda with a manager from the 1:1s page.

The first step to using 1:1s is to set up a meeting with your manager or have your manager set up the meeting for you.

To enter the 1:1 agenda with your manager, navigate to Home>Plan 1:1s>Select manager—OR—People>My profile>1:1s>Select manager.

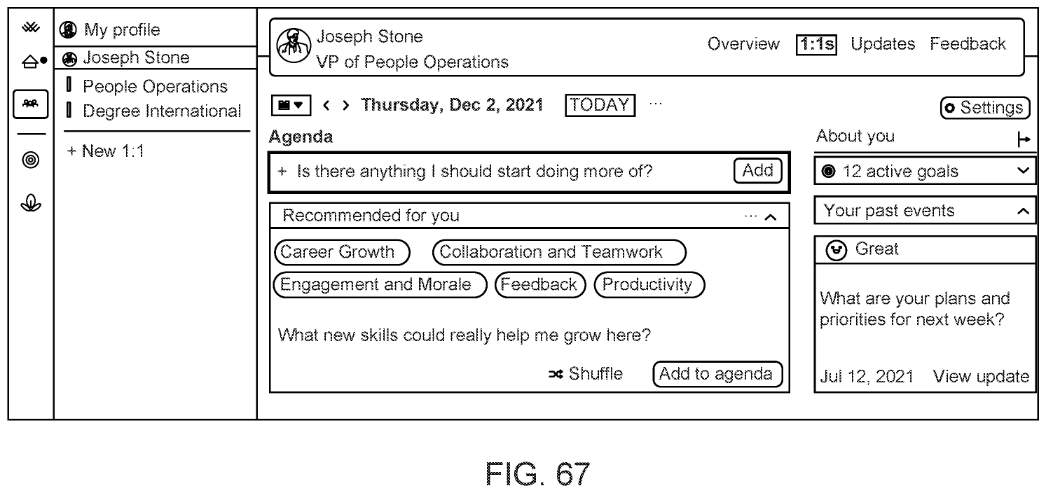

FIG. 67 is a schematic of a user interface displaying a 1:1 agenda with the option to add a talking point.

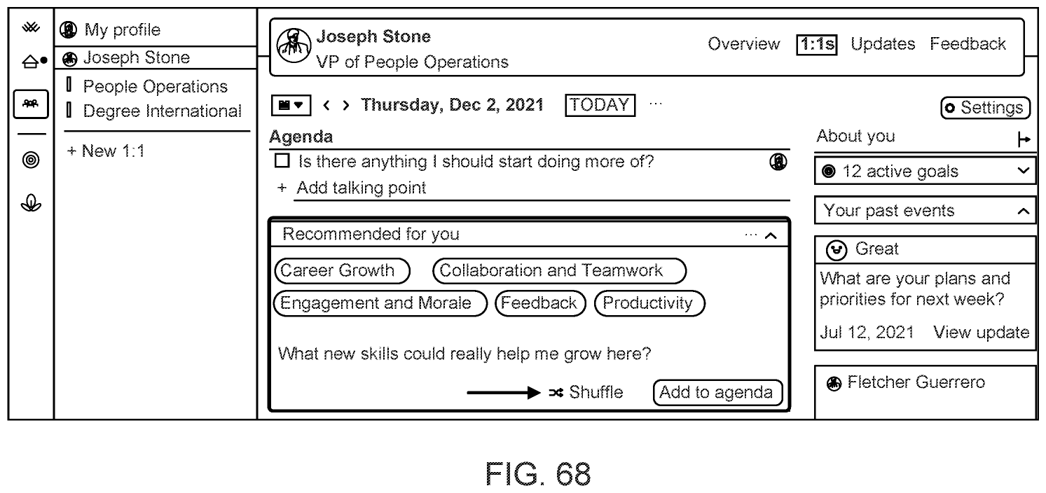

FIG. 68 is a schematic of a user interface displaying a 1:1 agenda with the option to add a system recommended talking point.

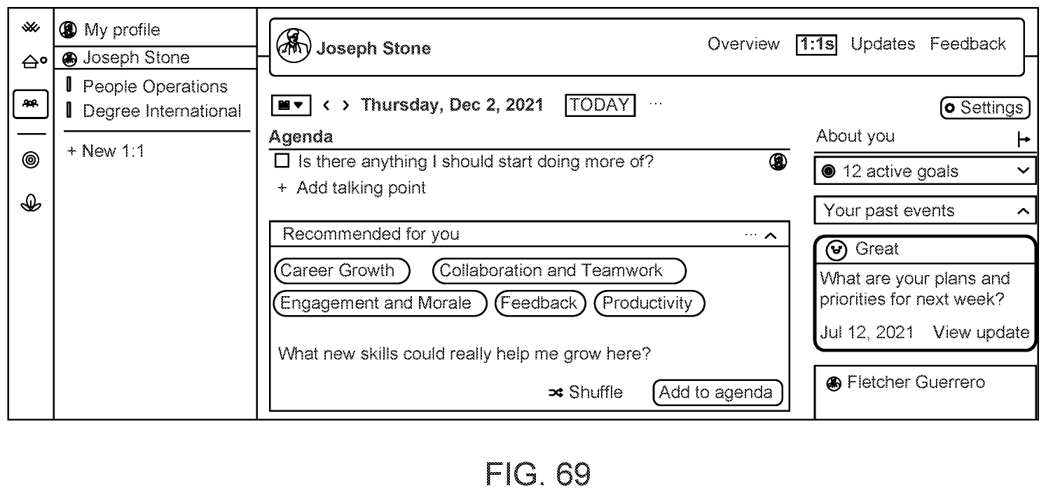

FIG. 69 is a schematic of a user interface displaying a 1:1 agenda page containing a 1:1 context panel.

All 1:1 participants can add talking points to an agenda, including the direct report.

To add your own talking points to the agenda, under Agenda, click into Add talking point, add your item, and click Add.

If you need inspiration, and if enabled, you can navigate through and select a system-recommended talking point. To add a recommended talking point, navigate under Recommended for you, shuffle through recommendations, and select Add to agenda.

Use the 1:1 context panel to navigate through your most recent update and growth areas and include them as talking points in your agenda. Your manager will have visibility to a similar context panel with your past events within their agenda.

Additionally, you will be able to complete the following actions:
Remove talking points you or your manager have added.
Comment on talking points.
Add incomplete items from previous 1:1s to the agenda.
Mark talking points as complete.
Rearrange talking points
Add shared notes.
Add private notes.

### Navigating the 1:1 Context Panel

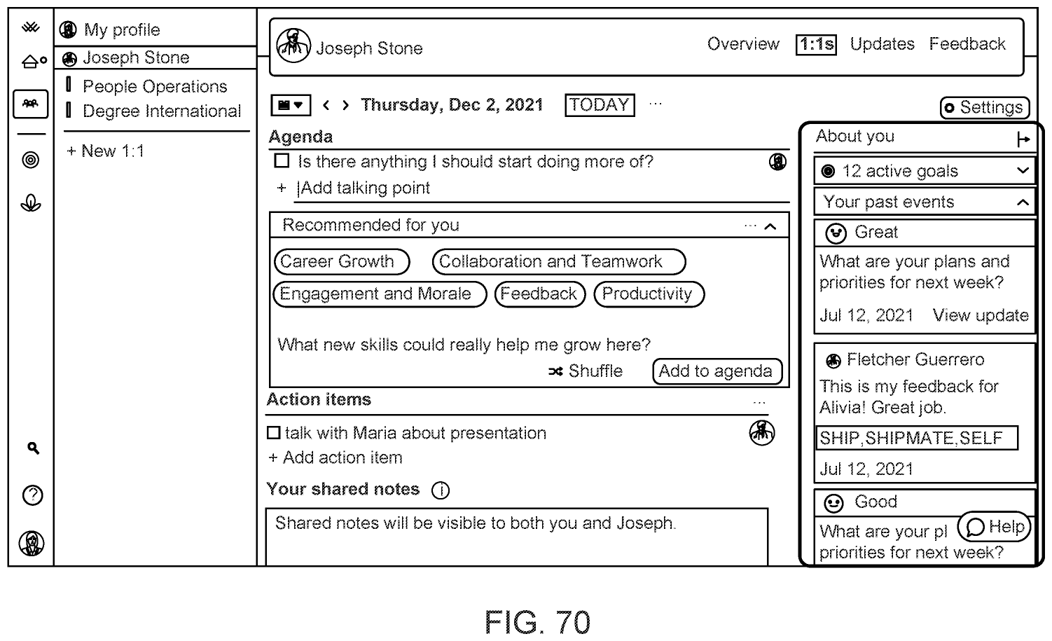

FIG. 70 is a schematic of a user interface displaying a 1:1 agenda page containing a 1:1 context panel.

When you enter a 1:1, you will also see a context panel on the right-hand side of the screen. Here, you will be able to view your past activity. This activity is also viewable from your manager's end; however, it will not be visible for 1:1s with non-manager participants.

Please note: This activity will vary depending on the tools that your manager and your admin have enabled for you.

The following sections will be displayed in the 1:1 context panel:
1. Active growth areas (I applicable). Selecting View growth plan will take you to your growth plan to view your growth areas in greater detail.
2. Active goals. This section lists the goals you are an owner of Selecting a goal will take you to the goal's details page.
3. Past events. Past events included any notes to self you have submitted and your past feedback, past updates, and goals.

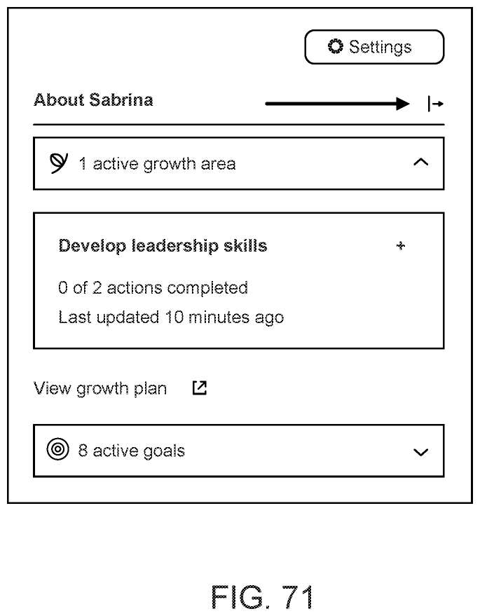

FIG. 71 is a schematic of a portion of a user interface displaying a 1:1 context panel with the option to hide the panel.

The context panel can be hidden by clicking the arrow on its left-hand side.

### During Your Meeting

Two hours before the 1:1 meeting, both the manager and the direct report will get an email outlining what's on the agenda so that they can prepare for the meeting.

You can check off, comment on, and add additional talking points during the meeting. After the meeting concludes, the manager will receive an email asking them to check off which items were discussed, push items that weren't covered to the next meeting, and record any notes.

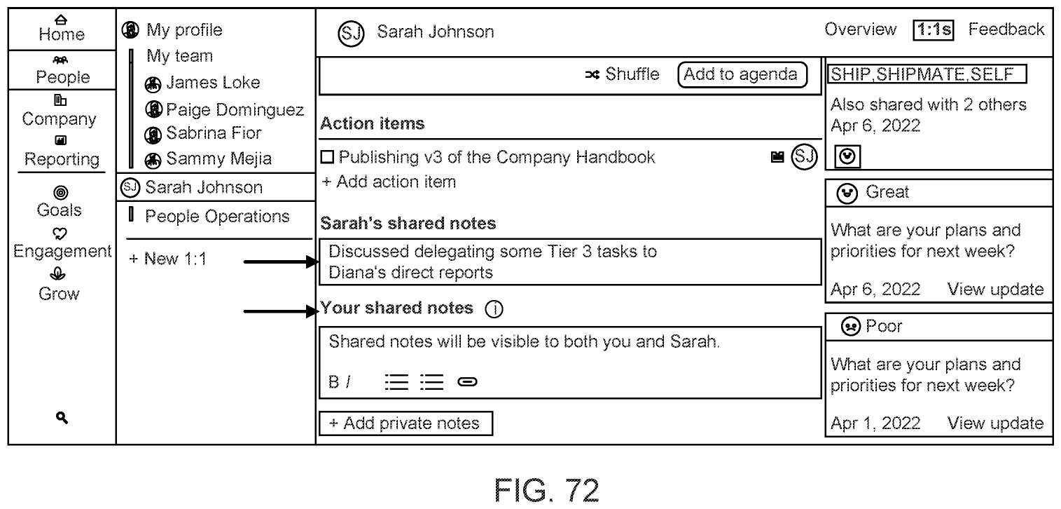

FIG. 72 is a schematic of a user interface displaying a 1:1 agenda page containing shared notes.

Notes can be left as both public and private. Your manager and admin can see shared notes. Private notes will only be seen by the person writing the private note. Shared notes sync almost immediately, which means your manager can see what you have written in real-time under the [Employee]'s shared notes section.

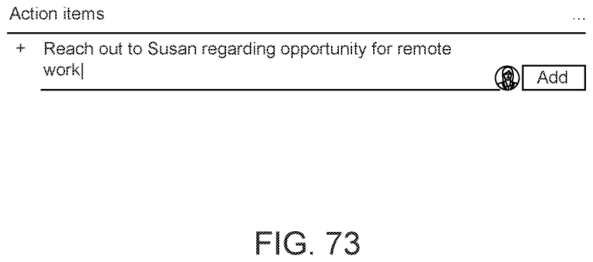

FIG. 73 is a schematic of a portion of a user interface displaying an action item.

Action items are tasks that should be followed up on before the next meeting. You can add and assign action items to yourself or your manager.

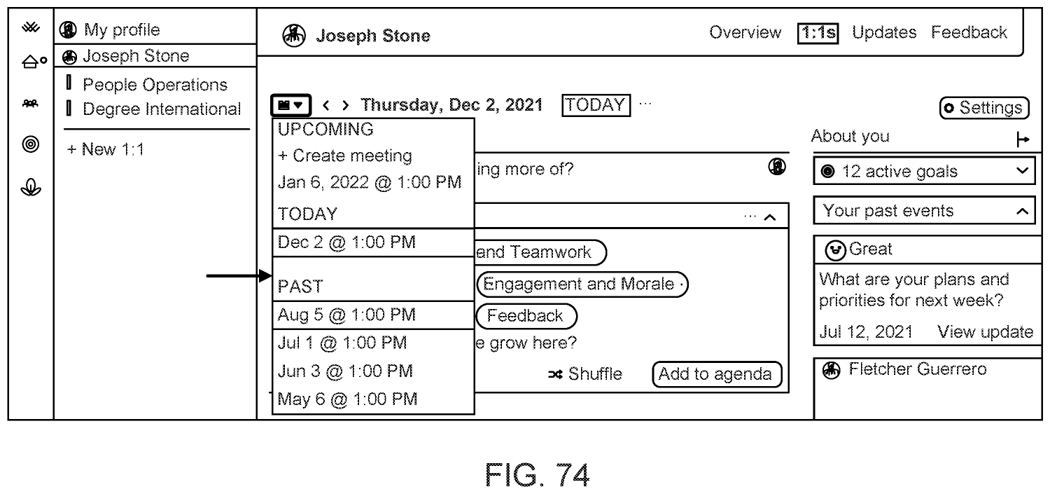

FIG. 74 is a schematic of a user interface displaying a 1:1 agenda page containing a drop-down with upcoming and past 1:1 agendas.

You can view past 1:1 agendas with your manager by selecting the calendar icon and choosing a date from the dropdown.

Employees can create customized agenda templates that include talking points they'd like to discuss regularly in their 1:1 relationships. Agenda templates are an organized way to add recurring talking points to your 1:1 meetings.

### Set an Agenda Template

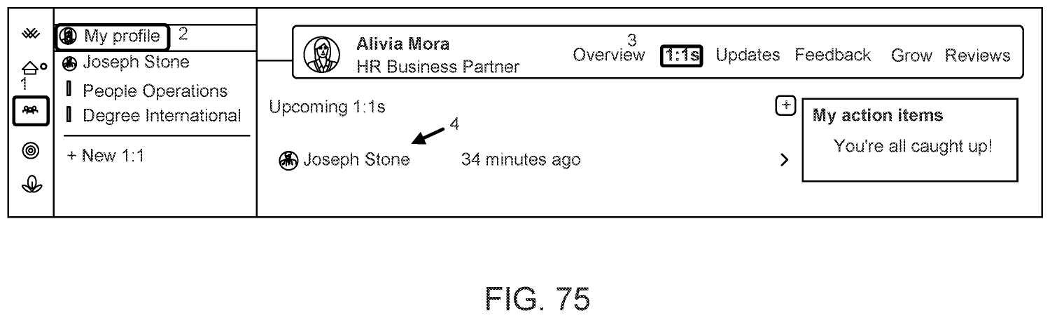

FIG. 75 is a schematic demonstrating how to navigate a user interface to be taken to a desired 1:1 agenda.

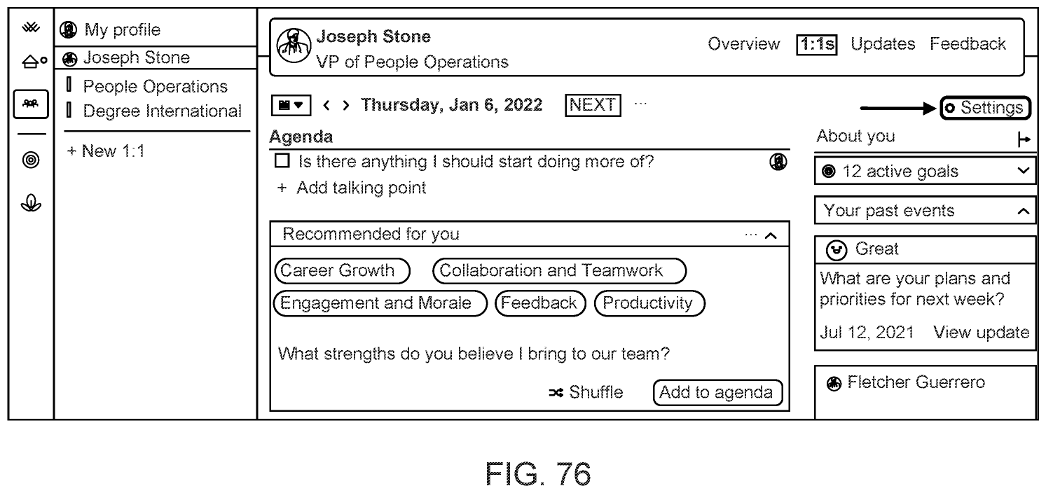

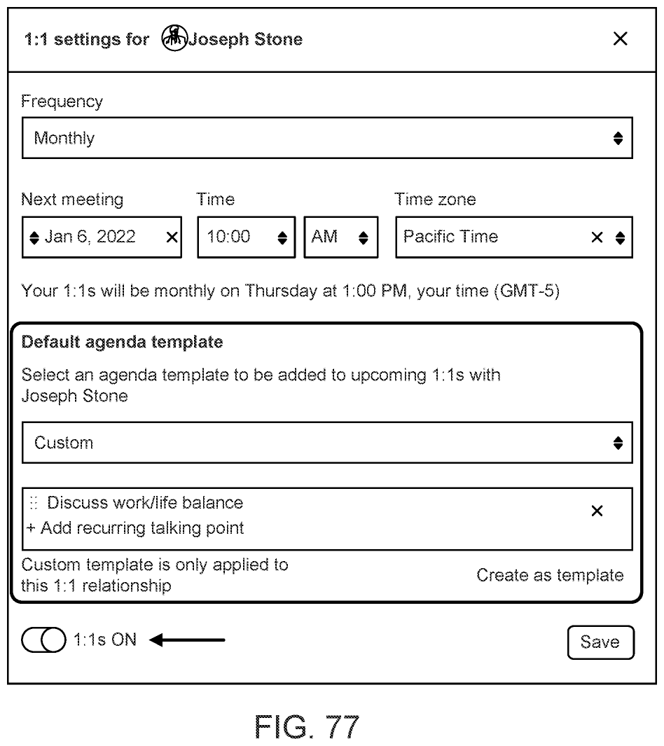

FIG. 76 is a schematic demonstrating how to navigate a user interface to be taken to settings from a 1:1 agenda page.

FIG. 77 is a schematic of a user interface displaying a 1:1 settings page with the option to select an agenda template.

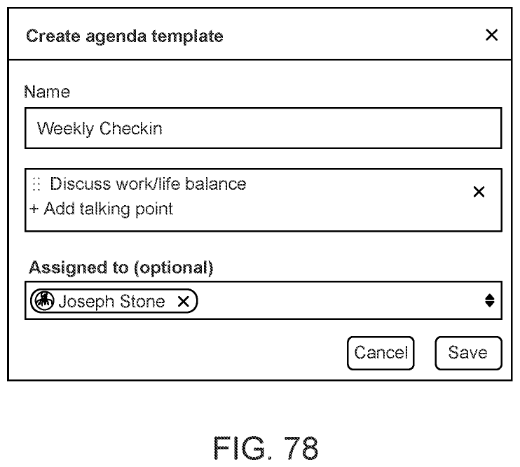

FIG. 78 is a schematic of a user interface displaying a create agenda template page.

Non-manager agenda templates are set on an individual 1:1 basis.

The following are steps for setting an agenda template:
1. Navigate to the desired 1:1 agenda by navigating to Home>Plan 1:1s>Select the desired 1:1—OR—Step 1: Navigate to the desired 1:1 agenda by navigating to People>My profile>1:1s Select the desired 1:1.
2. Within the 1:1 agenda, select Settings.
3. Under Default agenda template, you will have three options for your upcoming 1:1: keep the Custom template, select a different agenda template you created, create a new template.
4. Save the 1:1 settings to save the new agenda.

The custom template comprises any previously added recurring 1:1 talking points for that specific 1:1 relationship. If you would like to add to the agenda, add additional talking points and select Create as a template. This will create an additional agenda template.

Please note: the second participant may have already selected a template for your 1:1. You will have the option to choose a different agenda; however, you will be unable to edit or add to their template.

To select a different agenda, use the dropdown to select an agenda you created from the list.

To create a new template, add new talking points and click Create as a template. Name and assign your template to the desired participants.

### View a 1:1 Agenda on Mobile

The system's mobile app focuses on the 1:1 experience, giving both managers and employees the ability to document 1:1s on the go and away from the computer.

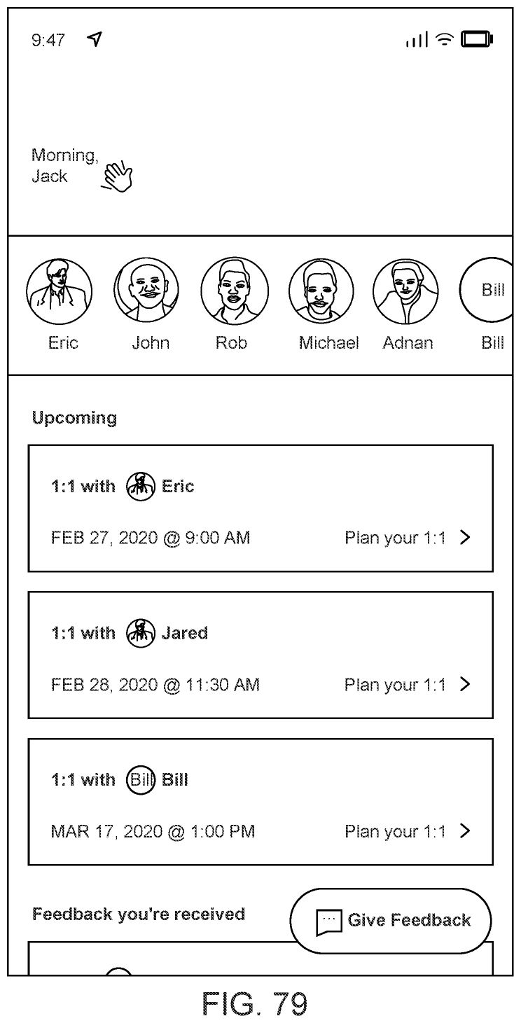

FIG. 79 is a schematic of a mobile user interface displaying the you page containing all 1:1 relationships.

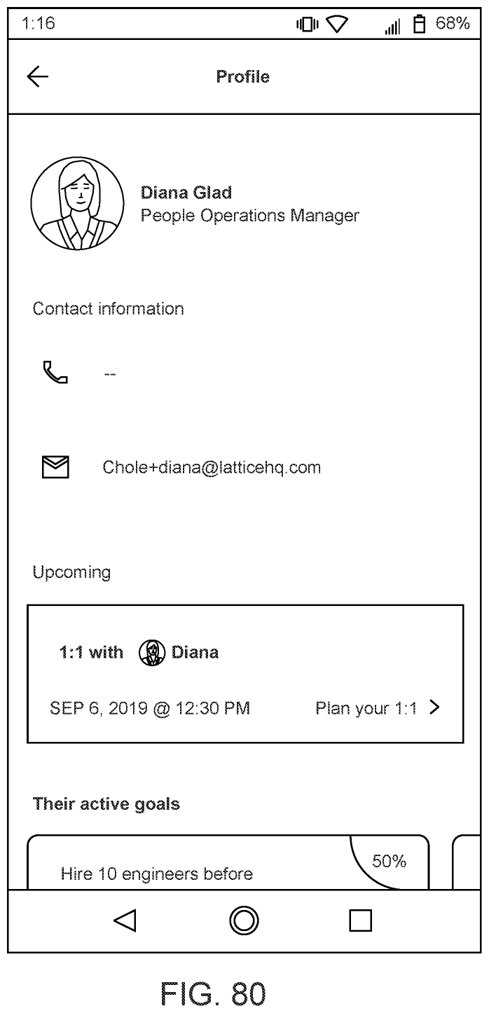

FIG. 80 is a schematic of a mobile user interface displaying the employee profile of a 1:1 relationship.

Within the system's mobile app, you can view your 1:1 relationships within the following pages:
1. You page: View all relationships.
2. The employee profile: View individual relationships.

If you view the profile of a colleague that you're in a 1:1 relationship with, you'll see a link to your next upcoming 1:1.

Navigating through the 1:1 agenda will allow you to do the following:
Add and remove talking points
Add and remove comments.
Add shared notes.
Add private notes.
View past 1:1s.
View participant goals.

Private notes are only visible to yourself, not your manager or admin, so feel free to jot down anything personal but important to discuss in that field. Shared notes are visible to the 1:1 participants and admin.

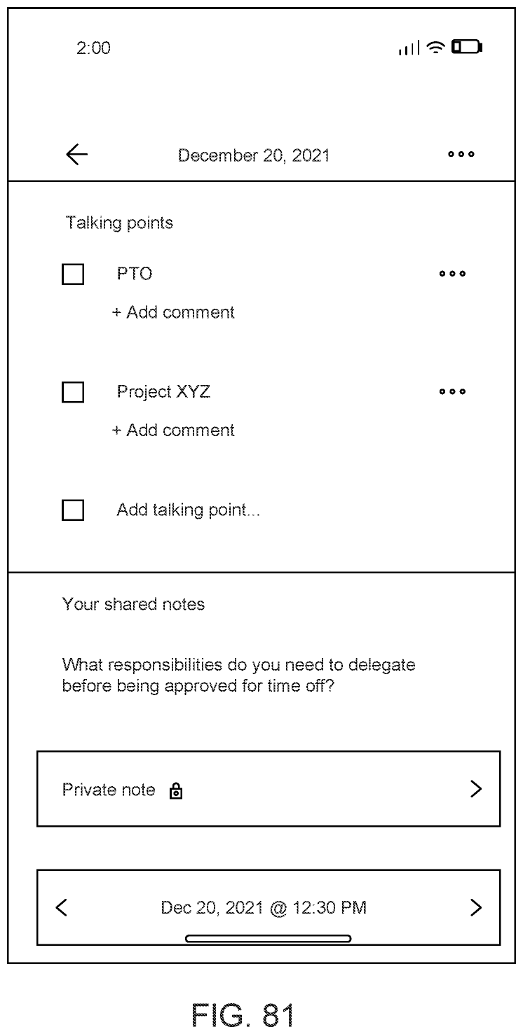

FIG. 81 is a schematic of a mobile user interface displaying a past 1:1 page.

To view past 1:1s from the agenda: Click the grey arrows (< >) at the bottom of the screen to navigate through past agendas.—OR—Select the ellipsis ( . . . ) next to the meeting date>Past 1:1s.

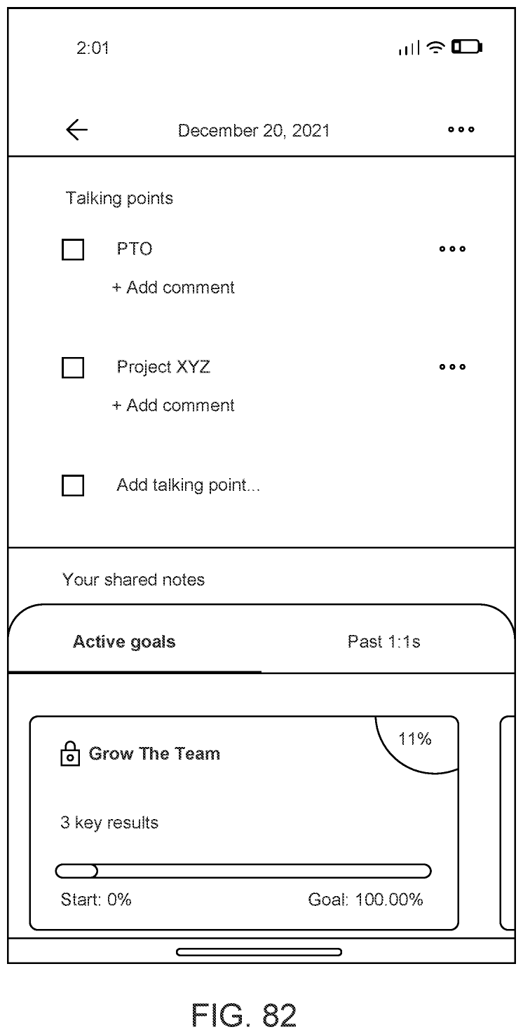

FIG. 82 is a schematic of a mobile user interface displaying the detailed view of a goal for a 1:1 participant.

Managers can view their direct report's goals while non-managers can view the second participants' public goals.

The following are steps to view the participant's goals:
1. Navigate to the ellipsis ( . . . ) next to the meeting date>Active goals.
2. Click into each goal for a detailed view of goal progress and notes.

### During and After the Meeting

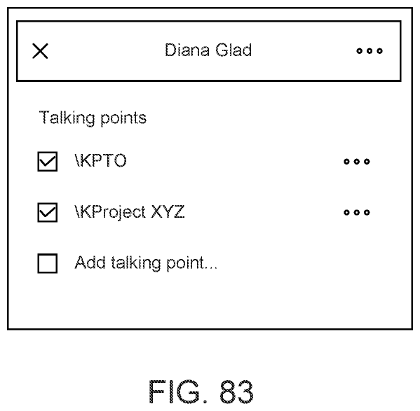

FIG. 83 is a schematic of a mobile user interface displaying completed talking points for a 1:1 meeting.

During a 1:1 meeting, you can:
Check off talking points as they're discussed.
Add additional talking points.
Add shared notes.
Add private notes

### Navigate to the Slack App

The system's Slack app helps streamline the 1:1 process by allowing users to add talking points directly from Slack. The system makes it easy to maintain your agenda without having to leave one of the tools you use most.

An admin must first integrate the Slack app with your company Slack instance.

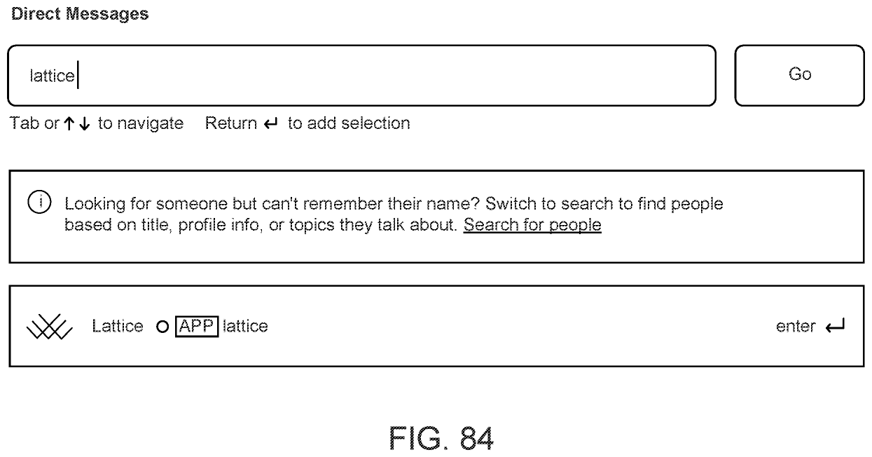

FIG. 84 is a schematic demonstrating how to start a direct message with the system in Slack.

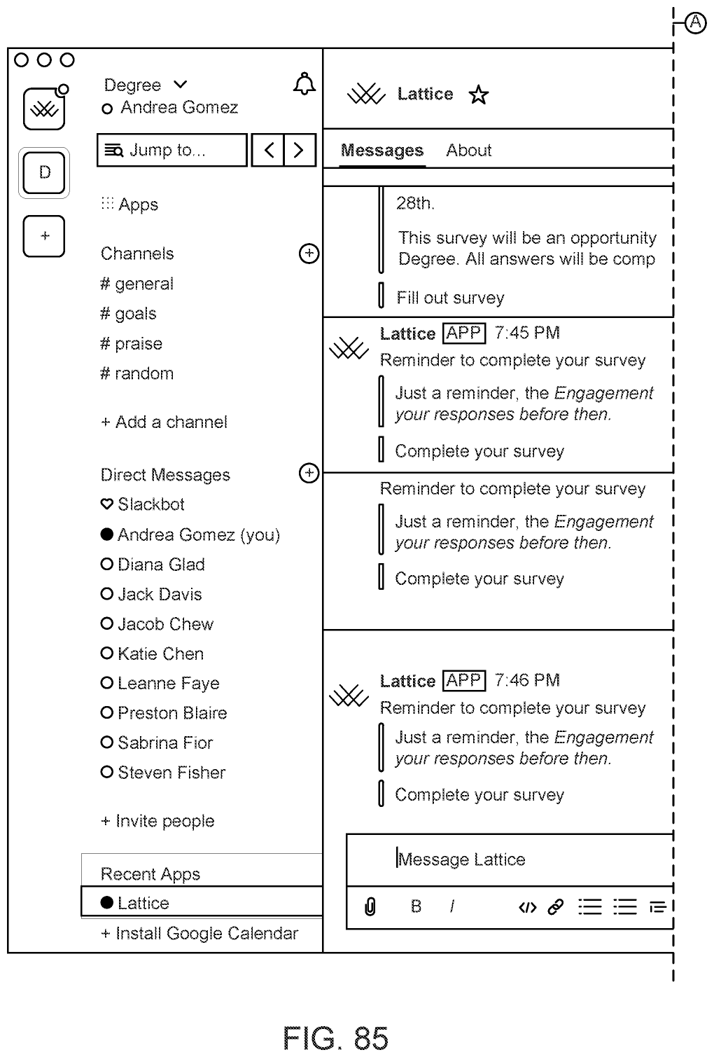

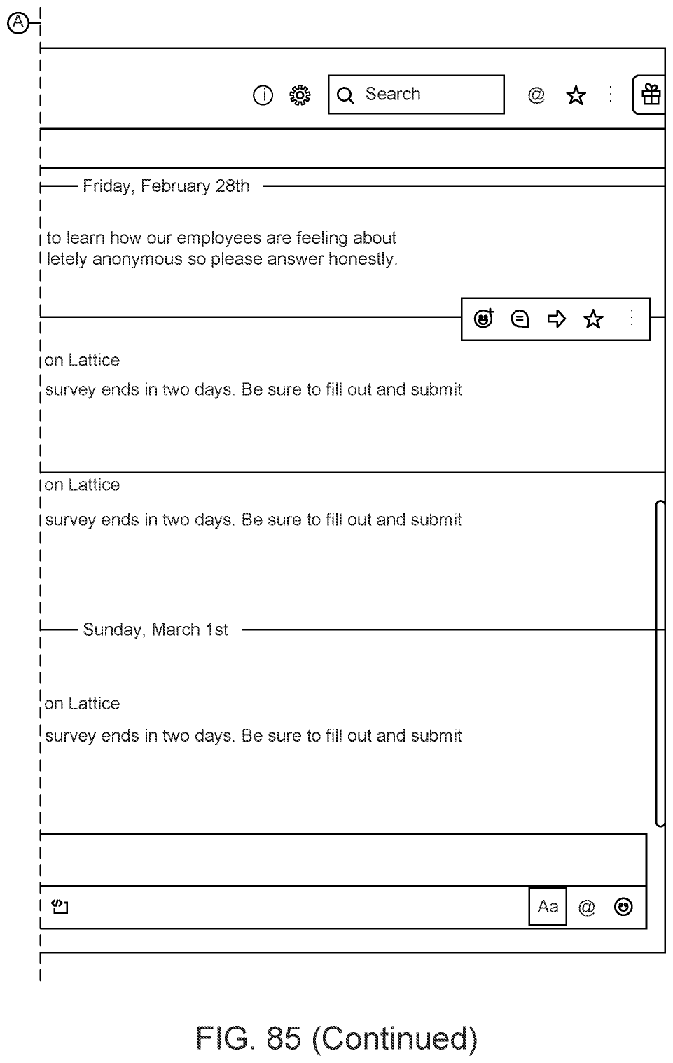

FIG. 85 is a schematic demonstrating how to select the system in Slack.

There are two places in Slack you can access the app:
1. Start a direct message with the system.
2. Under Apps, select the system to open the app and begin a direct message.

Note: The system's app will not appear under Apps until you receive your first system notification.

### Add 1:1 Talking Points

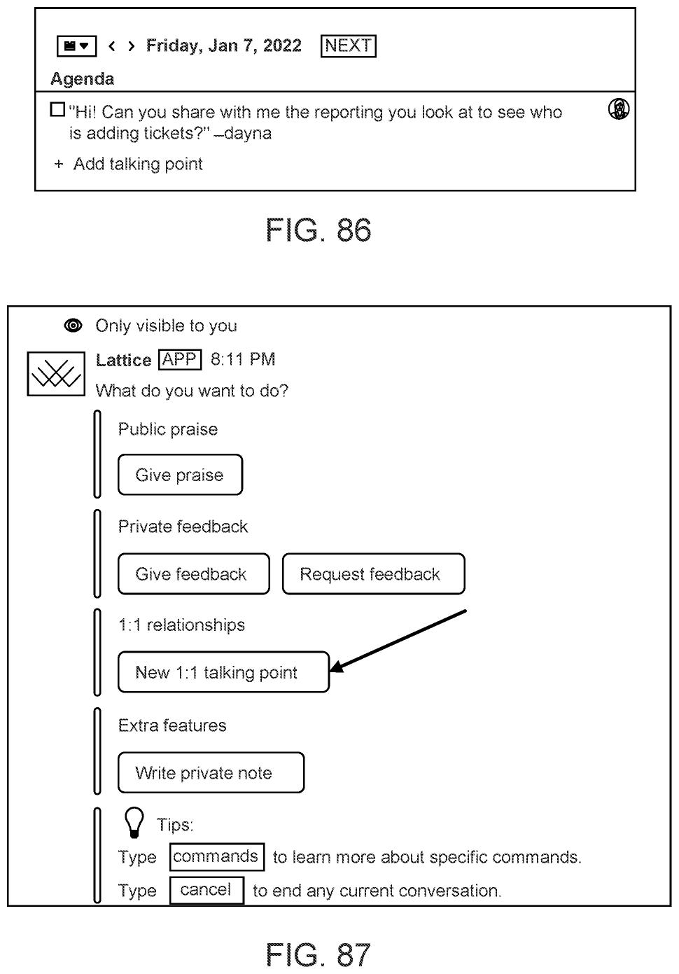

FIG. 86 is a schematic of a portion of a user interface displaying a 1:1 agenda with a Slack conversation added as a talking point.

The Slack app allows you to add conversations from any channel or direct message directly to your 1:1 agenda as a talking point.

Please note the following when adding talking points from Slack:
You can add any message to a 1:1 agenda, no matter the sender.
You can only add talking points to agendas where a relationship already exists.
Hyperlinks in Slack will appear as the full link URL in your agenda

FIG. 87 is a schematic of the Slack Bot displaying a list of system actions including adding a new 1:1 talking point.

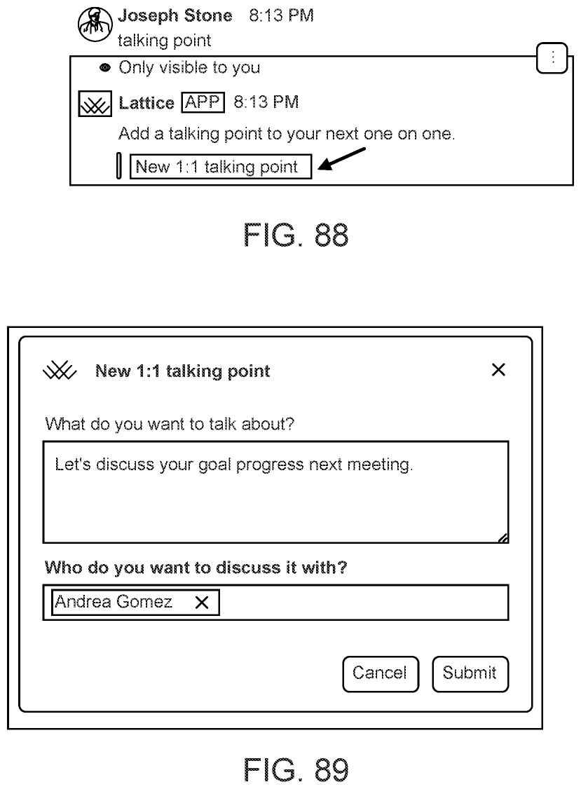

FIG. 88 is a schematic of the Slack Bot displaying the option to be taken to the 1:1 agenda to create a new 1:1 talking point.

FIG. 89 is a schematic of a modal for adding a new 1:1 talking point.

The following are steps to add talking points via the system's Slack Bot:
1. Start a direct message with the system.
2. Type Help for a list of system actions or type Talking Point to immediately be taken to the 1:1 action.
3. Select New 1:1 talking point-a modal will appear.
4. Under What do you want to talk about?, add your talking point and select the user you want to discuss it with from the dropdown menu.
5. Select Submit.

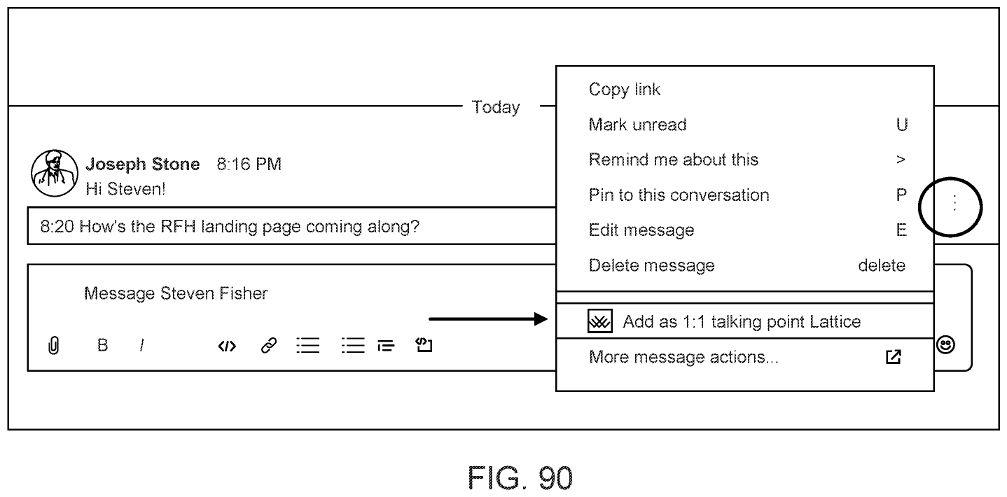

FIG. 90 is a schematic demonstrating how to navigate a user interface to add a 1:1 talking point via message action.

The following are steps to add talking points via message action in any Slack channel or direct message:
1. In Slack, select the ellipsis ( . . . ) to the right of the message you wish to include as a talking point.
2. Select Add as 1:1 talking point in the system.
3. Under What do you want to talk about?, add your talking point and select the user you want to discuss it with from the dropdown menu.
4. Select Submit.

### Navigate to 1:1 Action Items

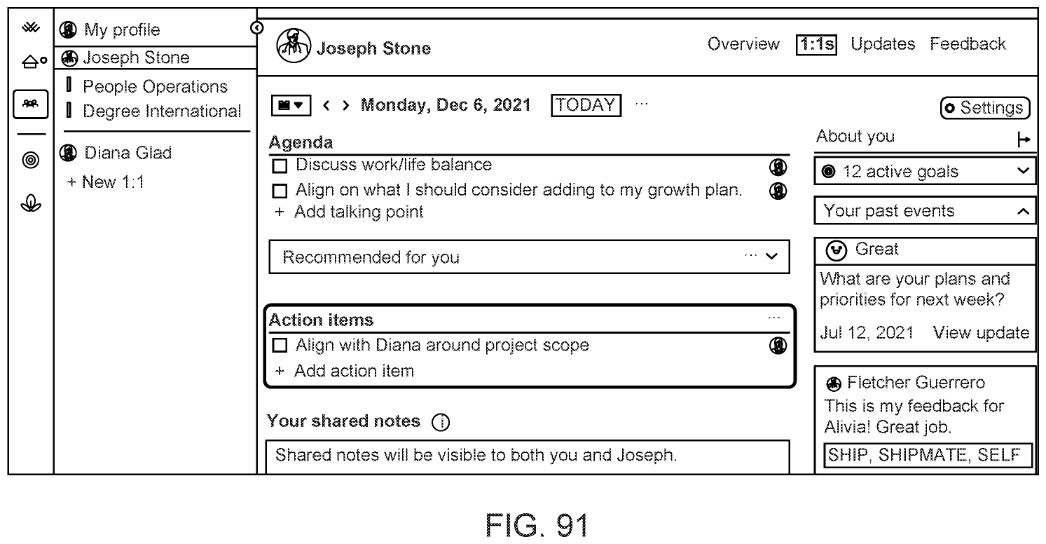

FIG. 91 is a schematic of a user interface displaying a 1:1 agenda containing action items.

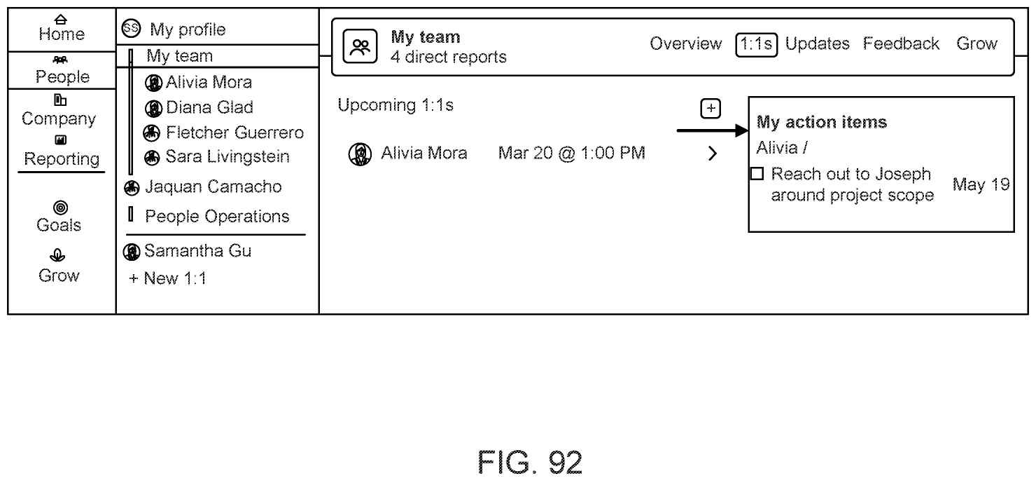

FIG. 92 is a schematic of a user interface displaying a 1:1s page containing action items.

When conducting 1:1s, there are often follow-up tasks that come about as a result of the meeting. The action items section allows users to keep track of these tasks within the 1:1 without leaving the system.

Action items can be managed in the 1:1 agenda above the shared notes section.

Action items assigned to you can also be found within the 1:1 tab in your system toolkit.

To view your action items navigate to People>Your profile>1:1s>My action items.

### Add an Action Item

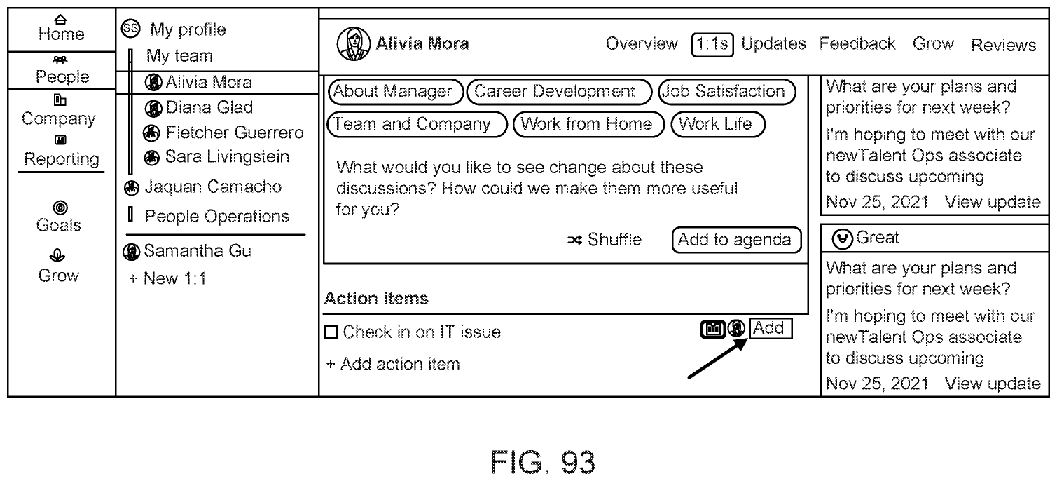

FIG. 93 is a schematic of a user interface displaying a 1:1 agenda containing the options to add an action item and schedule a due date.

The following are steps to add an action item:
1. Navigate to Action items within the 1:1 agenda.
2. Select+Add action item and add your action.
3. (optional): Schedule a due date by selecting the calendar icon.
4. Select Add.

Note: Due dates are “soft” deadlines. The 1:1 reminders will include assigned action items and their respective due dates.

### Assign an Action Item

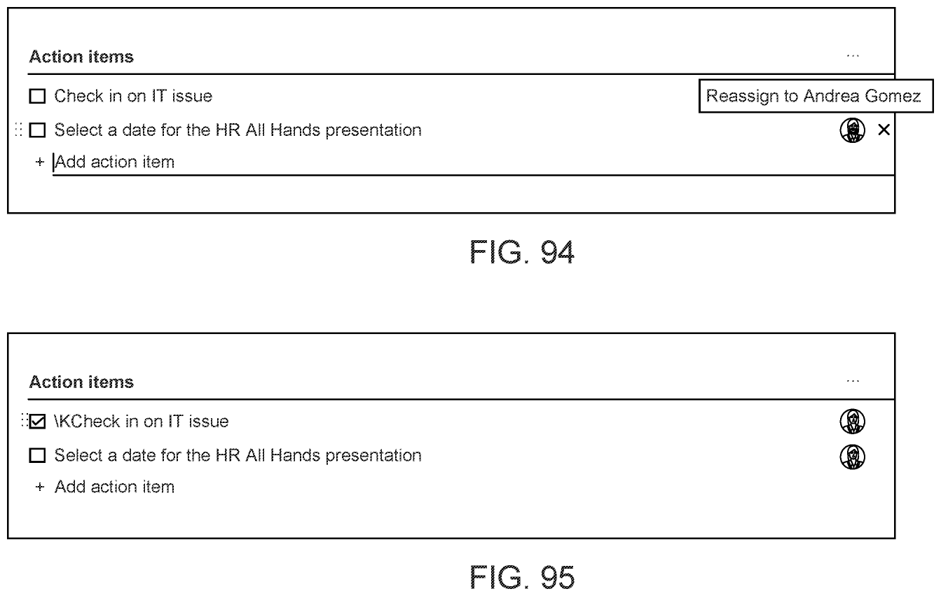

FIG. 94 is a schematic of a user interface displaying a list of action items.

When adding action items, they will default to be assigned to the creator. You can tell who is assigned the action item by viewing the avatar to the right.

To reassign the action item, click on the avatar, and it will be assigned to the other person included in the 1:1.

### Complete an Action Item

FIG. 95 is a schematic of a portion of a user interface displaying a 1:1 agenda containing list of complete and incomplete action items.

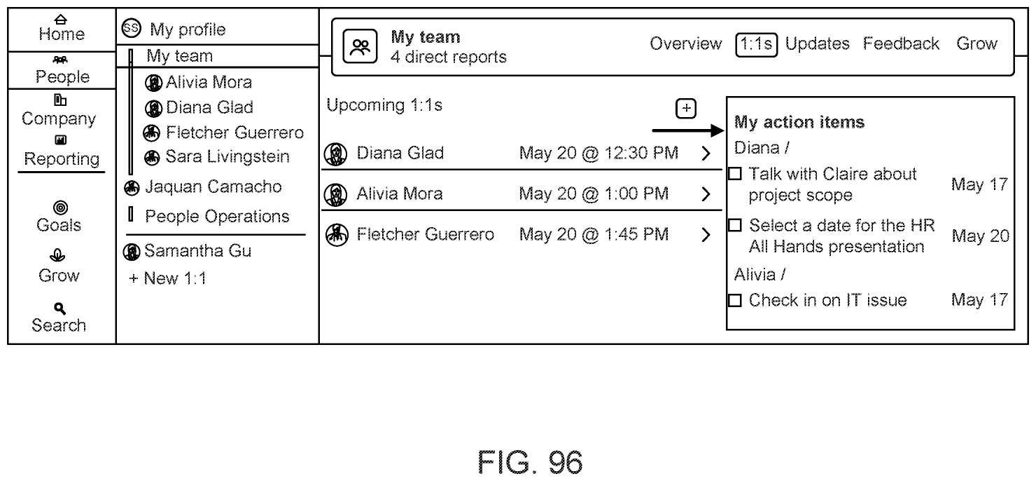

FIG. 96 is a schematic of a user interface displaying a 1:1s page with the option to mark action items as complete.

As with talking points, once an action item is completed you can check them off using the box to the left of the task. Action items will carry over from meeting to meeting until they are checked off as complete.

You can complete an action item from the 1:1 agenda or within the 1:1 tab in your system toolkit.

### Disable Action Items

If you don't intend to use action items, you can turn them off. Note, action items need to be disabled on an individual basis.

The following are steps to turn off action items:
1. Within the 1:1 agenda, navigate to Action items.
2. Select the ellipsis ( . . . )>Turn off action items.

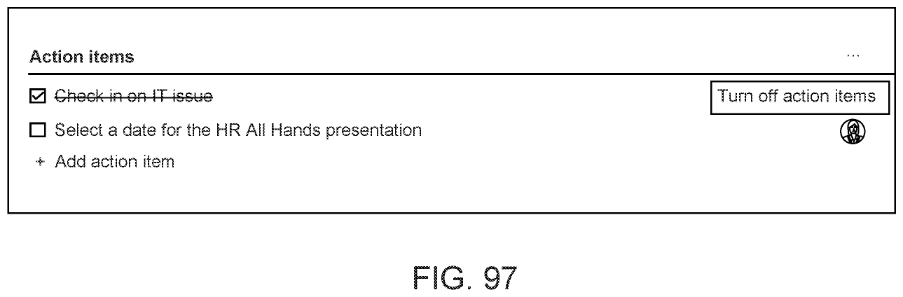

FIG. 97 is a schematic of a portion of a user interface displaying a 1:1 agenda containing the option to turn off action items.

### How to Turn on and Use Recommended Talking Points

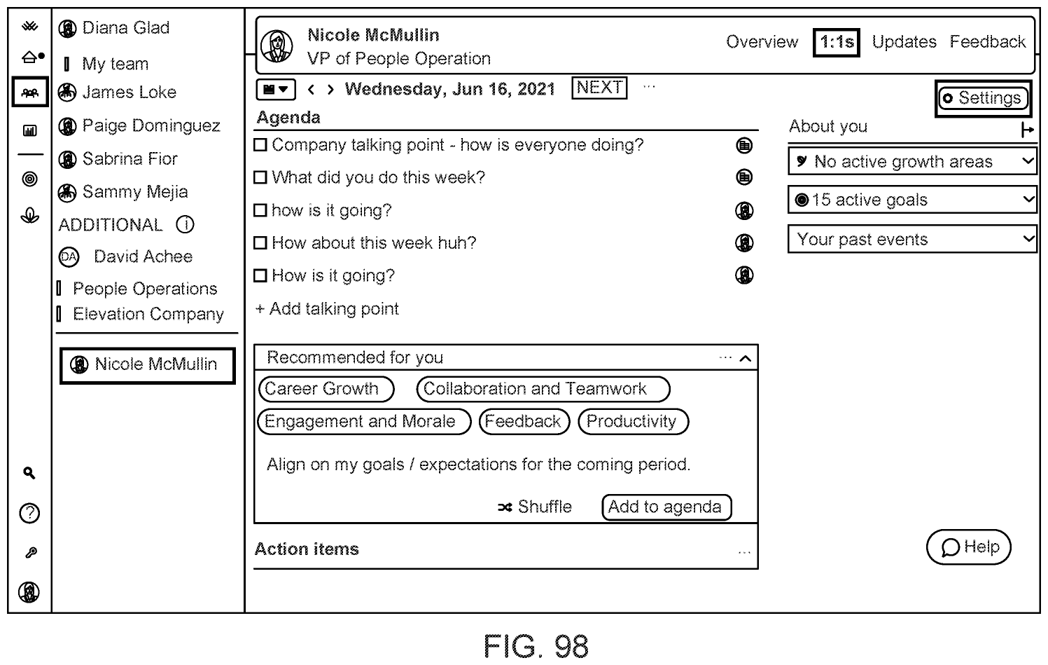

FIG. 98 is a schematic demonstrating how to navigate a user interface to be taken to the settings page for a 1:1 agenda.

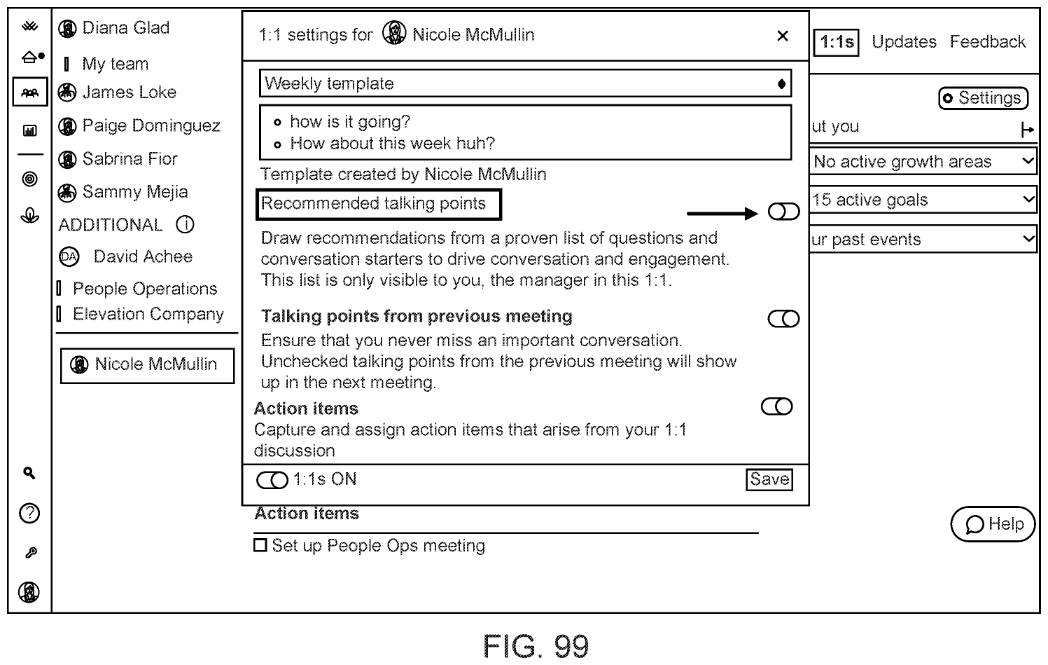

FIG. 99 is a schematic of a user interface displaying the settings page for a 1:1 agenda with the option to toggle on/off recommended talking points.

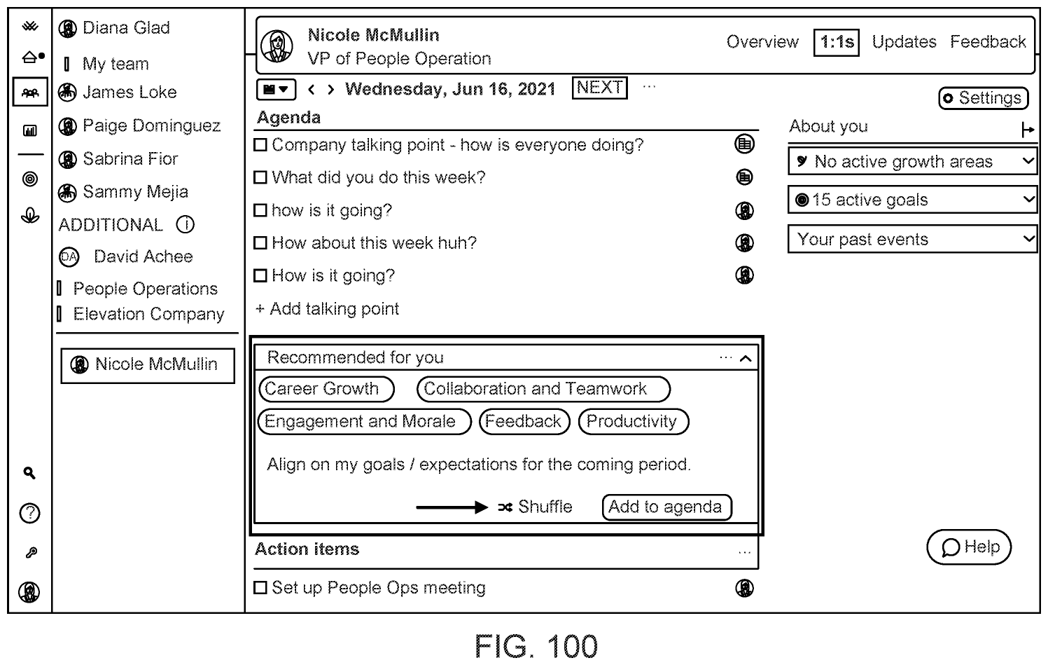

FIG. 100 is a schematic of a user interface displaying a 1:1 agenda page containing recommended talking points.

Recommended talking points nudge direct reports with suggested questions to add to their 1:1 conversations with their managers. These recommended talking points serve to help direct reports navigate their career by creating more meaningful, productive conversations with managers.

The recommendations are drawn from a proven list of questions and conversation starters to drive alignment and engagement.

Recommended talking points are only available for manager-employee relationships.

The following are steps to turn on and use recommended talking points:
1. On your Home page, select Plan 1:1s.
2. Select your manager's name to enter the 1:1 agenda and click Settings.
3. Toggle on Recommended talking points.
4. When you navigate to your 1:1 with your manager, you will now see the recommended talking points.
5. To add a recommended talking point, select Add to agenda. To see a new recommendation, select the shuffle icon to the right.

The recommended talking points inspire direct reports with optional questions to add to their 1:1s. These questions may be drawn from content in a system library. The questions may be gathered and vetted by HR experts and researchers in organizational behavior. Others have come from business and people leaders who publish their content publicly, made specifically to identify what matters to employees, understand their problems or concerns, and support them more effectively.

The following are example talking points regarding engagement and morale:
How are you doing?
Looking ahead, what are you most hopeful for and worried about?
Any tips or advice on how to avoid burnout?

The following are example talking points regarding productivity:
What's your highest priority right now? How can I help?
Align on my top priorities
What's more important right now, quality or quantity?
What is a process or project that I could start owning?
What are your long-term goals for the team?
What are your plans for team size and composition?
Any tips or advice on time management?
How well do you think we're tracking our goals?
Is there anything I should prepare ahead of our next one-on-one?

The following are example talking points regarding collaboration and teamwork:
Who would you like me to start talking to or working with more?
What's the best way to get your input on my work?
What part of my job would you like more visibility into?
What's your preferred way to receive updates?
What should I be mindful of when working with other teams or team members?
Review how tasks and responsibilities are currently distributed across our team.

The following are example talking points regarding career growth:
Align on what I should consider adding to my growth plan.
Any recommendations on upcoming conferences or events I should attend?
Are there any functional skills you think I should consider developing?
What strengths do you believe I bring to our team?
What skill gaps do you see on our team?
Are there professional development resources that you would recommend for me?
What new skills could really help me grow here?
What could I do to accelerate my career development?
What are some books you'd recommend for developing my career?
What do you think it takes for someone to succeed at this company?
Align on what the next phase of my career here might look like.
Align on my goals/expectations for the coming period.
Review progress on my goals and align on expectations.

The following are example talking points regarding feedback:
Is there anything I should be doing differently? (Please provide examples)
Who on our team should I be asking for feedback?
How could I better contribute to our team meetings? (Please provide examples)
What should I be more mindful of? (Please provide examples)
Is there anything I should start doing more of? (Please provide examples)
What's something I should consider changing? (Please provide examples)
What feedback do you have for me, positive and/or constructive? (Please provide examples)
What is something that I can improve on? (Please provide examples)
What's a recent situation that you think I could have handled differently?
What is an area that you think I could use coaching on? (Please provide examples)
What is one thing that I could be doing that I'm not? (Please provide examples)
Where have I had the most impact over the past few months? (Please provide examples)
What kinds of things do I have a habit of missing or dismissing too quickly? (Please provide examples)
What's something I did recently that highlights a strength or a weakness?

### Add Your Update to a 1:1

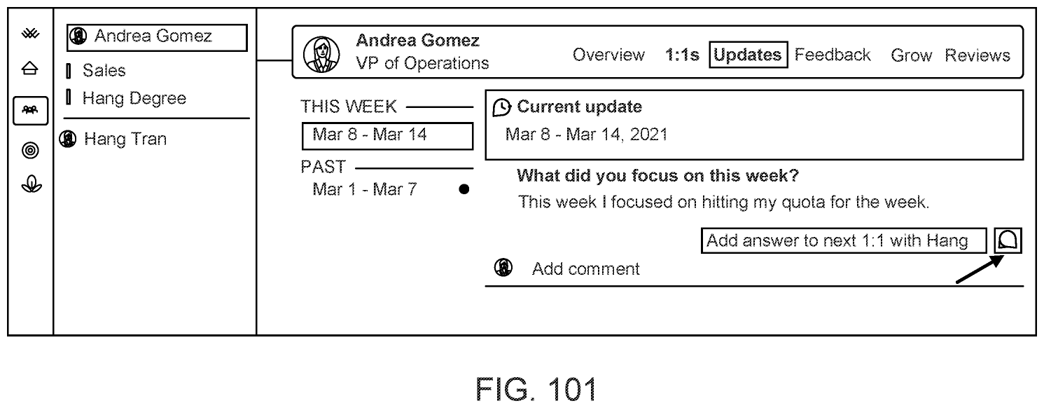

FIG. 101 is a schematic of a user interface displaying the updates tool containing the option to add a question to an update.

The system allows participants to add updated comments to a 1:1 agenda for discussion. Adding updates to your meeting helps managers digest and respond to status updates and allows employees to discuss roadblocks and become more effective.

Updates can only be added to agendas for manager-employee relationships.

The following are steps to add updated comments to a 1:1 agenda:
1. Publish your update.
2. Within your update, hover your cursor over the answer to the question you'd like to add.
3. Select the chat bubble icon that appears to add the question to your 1:1.
4. (optional): To remove a comment from the 1:1 meeting, re-click the chat bubble icon

### Add Your Direct Report's Update to Your 1:1

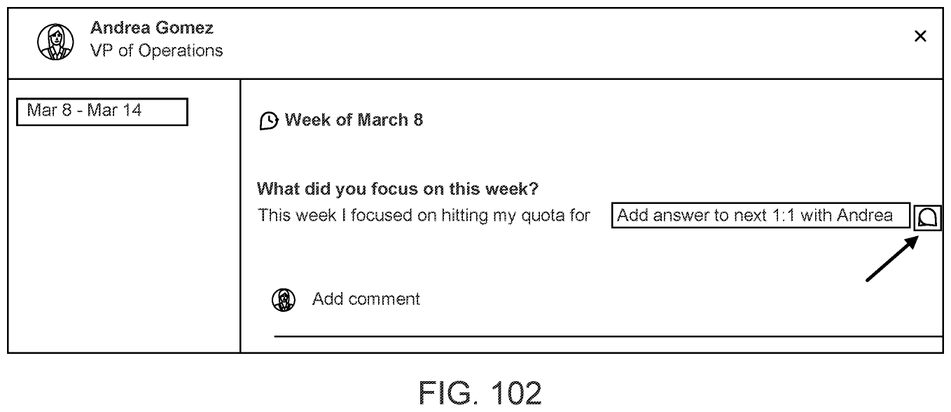

FIG. 102 is a schematic of a user interface displaying the updates tool containing the option to add a question from a direct report to an upcoming 1:1 agenda.

If you're a manager, you can also add questions from your direct reports' updates to your upcoming 1:1 meetings:

The following are steps to add an update comment from the updates tool:
1. When reviewing a direct report's update, hover your cursor over a comment you'd like to add to a 1:1.
2. Select the chat bubble icon that appears to add the question to your 1:1.
   Add an Update Comment from the 1:1 Tool

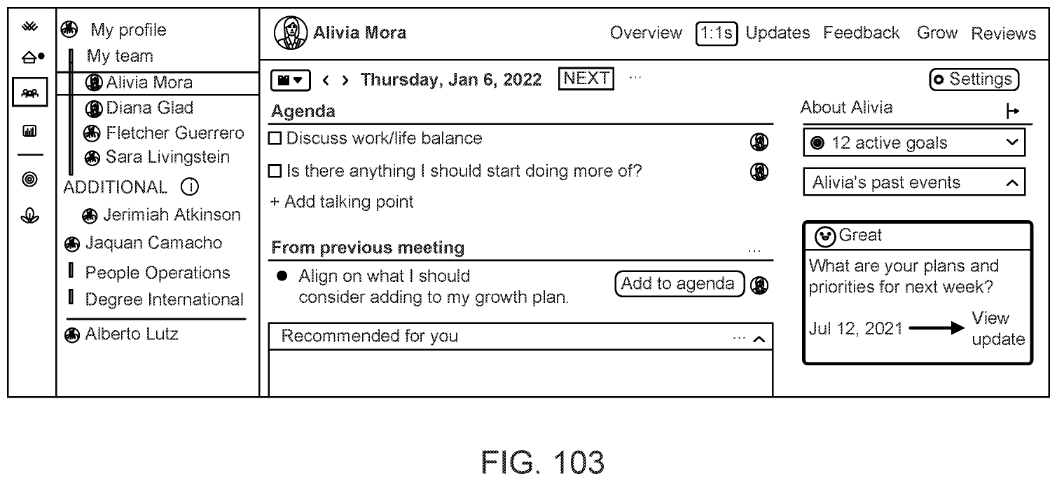

FIG. 103 is a schematic of a user interface displaying a 1:1 tool containing a context panel with the option to view update.

The following are steps to add an update comment from the 1:1 tool:
1. To enter a 1:1 agenda for your direct report, navigate to People>My team>1:1s>Select a direct report.
2. Within the 1:1 context panel, select View update.
3. Hover your cursor over a comment you'd like to add to a 1:1.
4. Select the chat bubble icon that appears to add the question to your 1:1.

### View Update Comments in Your 1:1

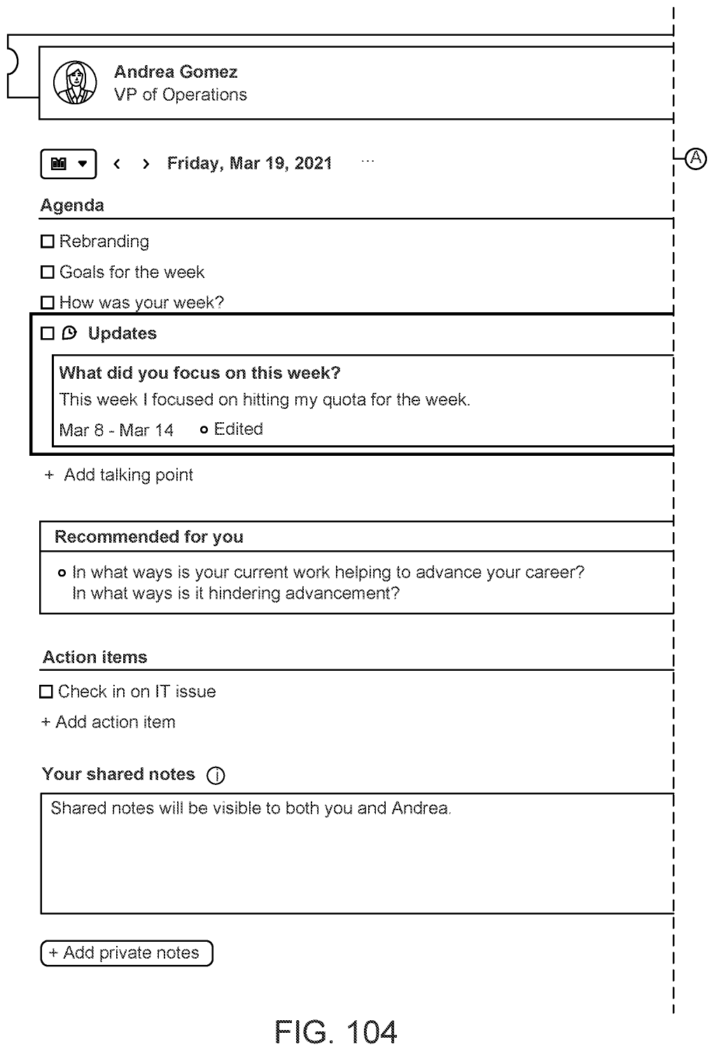

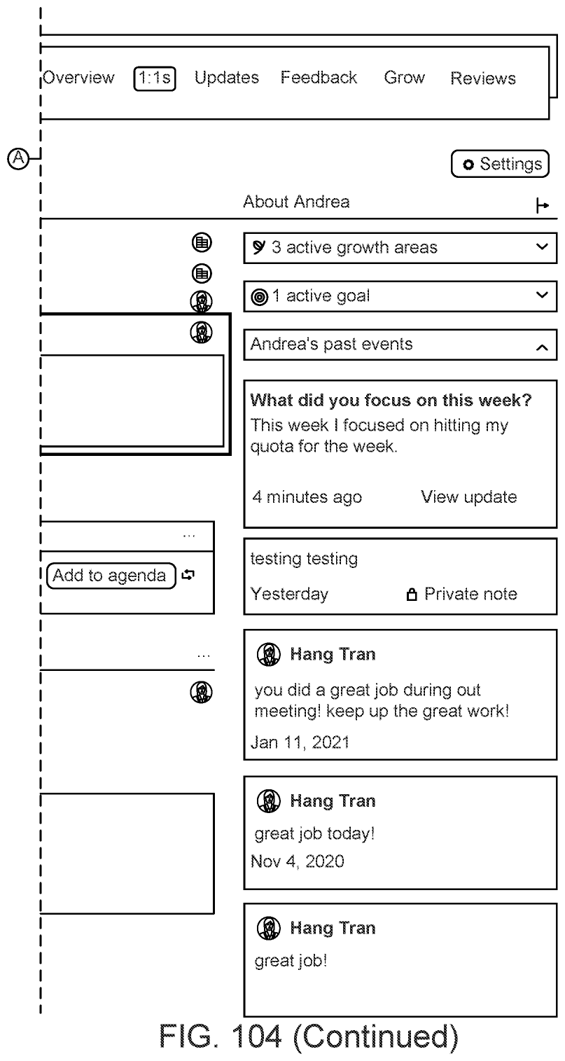

FIG. 104 is a schematic of a user interface displaying a 1:1 containing an update comment.

When you enter your next upcoming 1:1 meeting, you'll see your Update question on the meeting agenda.

Like other talking points, the Update talking point can be re-ordered in the agenda by clicking and dragging the six dots to the left up or down and marked complete by checking the box.

### Update Talking Point Behaviors

Update talking points can only be deleted from the agenda by the person who added them.

If an update answer is edited, that edit will be reflected in the 1:1 with (edited) appearing after the update talking point.

If you try to delete an update containing a question that has been added as a talking point, the system will:
If the 1:1s in the past: warn you that the update is linked to a talking point, and it will impact 1:1 history when deleted (and then remove the talking point from the historic 1:1 upon deletion)
If the 1:1 added is in the future: the update talking point will be removed without a warning message.

### Add a Growth Area to Your 1:1

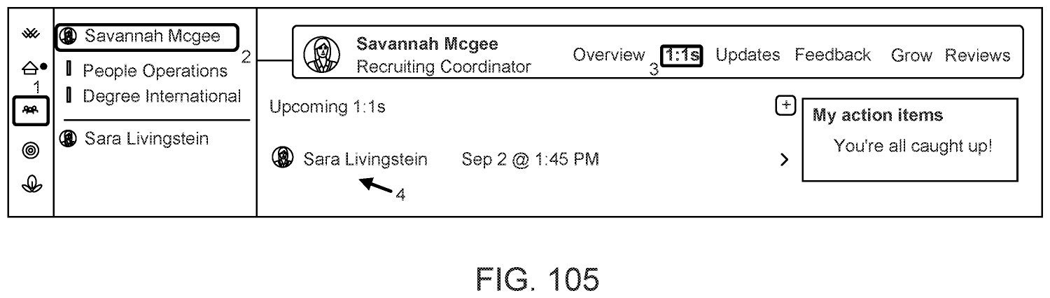

FIG. 105 is a schematic demonstrating how to navigate a user interface to view a 1:1 agenda from the 1:1 tool

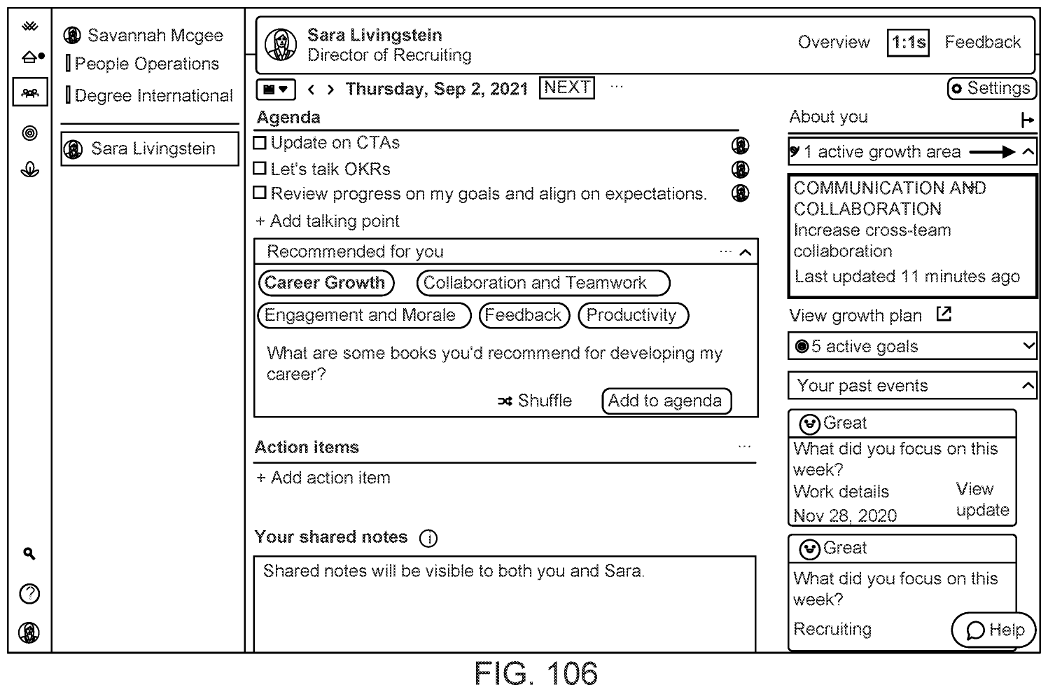

FIG. 106 is a schematic of a user interface displaying a 1:1 agenda containing a context panel with active growth areas

Growth areas are collaborative spaces for managers and their direct reports designed to facilitate career development.

The following are steps to view and update growth areas:
1. Navigate to People>your Profile>1:1s.
2. Enter your manager/employee 1:1 agenda.
3. Within the context panel, under Active growth area(s), click on the plus (+) next to the growth area you wish to discuss in your 1:1.

### Update Your Growth Area in a 1:1

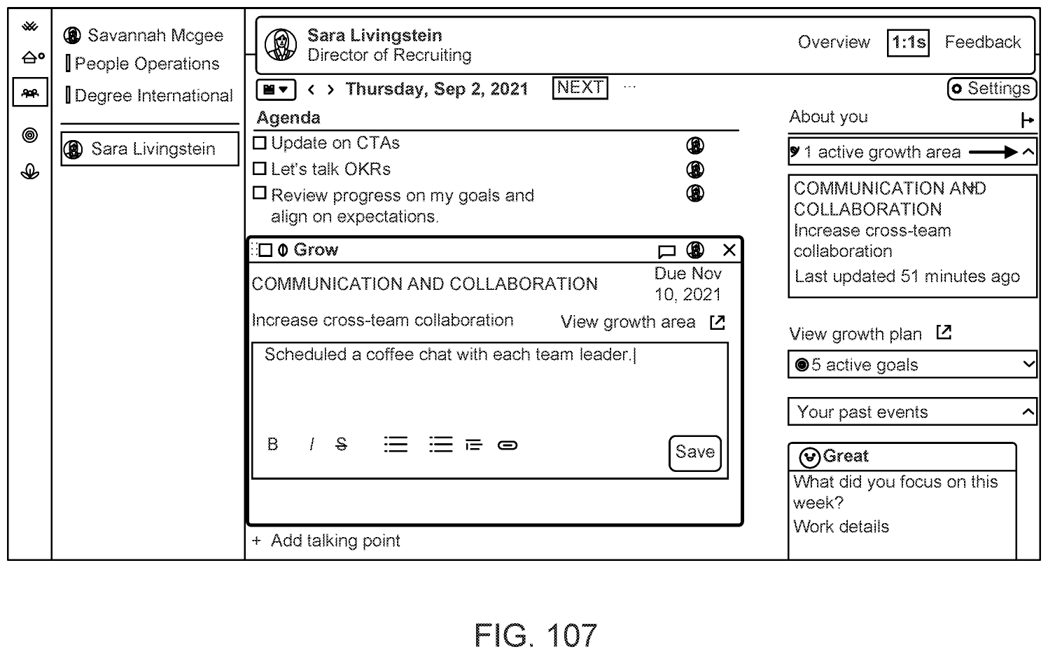

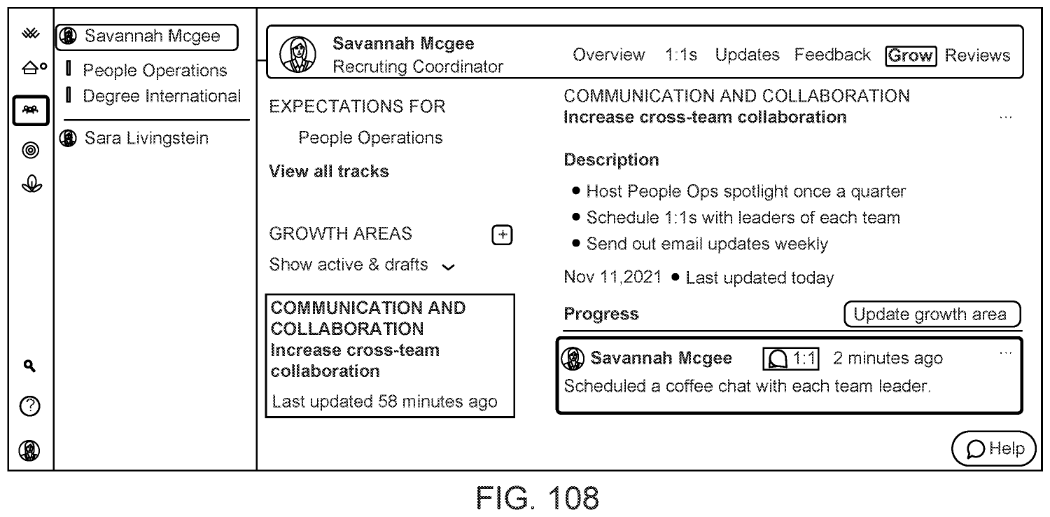

FIG. 107 is a schematic of a user interface displaying a 1:1 agenda containing a text box to add a progress description to a growth area.

Once your growth area has been added as a talking point, you and your manager will have the ability to update the growth area directly within the agenda

The following are steps to add progress to a growth area:
1. Enter a description of your progress in the text box.
2. Click Save.

FIG. 108 is a schematic of a user interface displaying a grow tool containing a growth area update beneath a progress heading.

Any updates made will be reflected beneath the Progress heading within your growth area. We display the profile picture of the user that posted the update so you can differentiate between the progress posted by you or your manager.

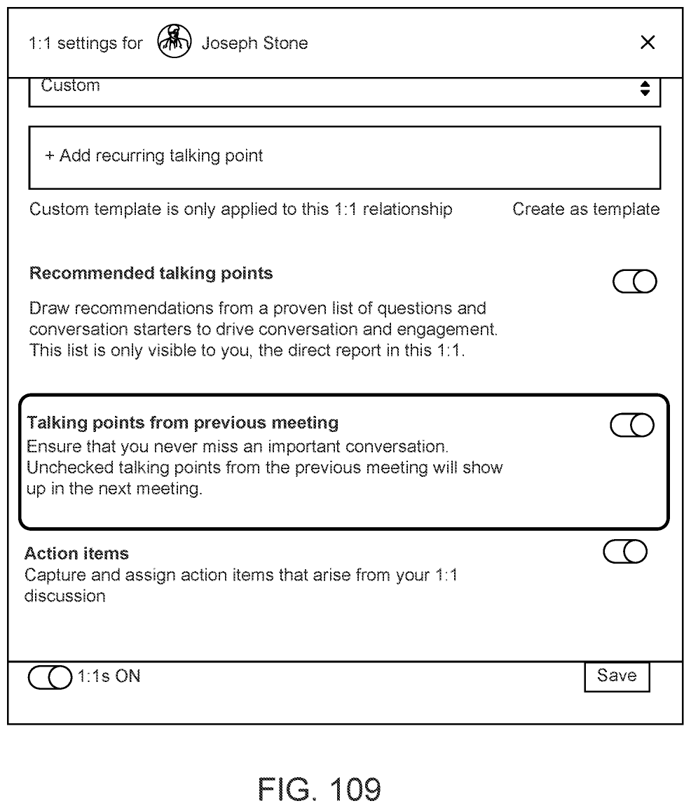

FIG. 109 is a schematic of a user interface displaying a 1:1 settings page containing the option to toggle on/off rolling over unchecked talking points

If there are talking points that you did not get to in your 1:1, you have the ability to roll them over to your next meeting.

In example embodiments:
Previous talking points must be enabled for the 1:1 relationship before you can pull them into your most recent agenda.
Both participants have the option to add unchecked talking points to the next agenda.
Unchecked talking points from the previous meeting will only show up for the next meeting and not future agendas.
Comments left on unchecked talking points generated by a recurring agenda template will not appear for the next meeting Add Previous Talking Points

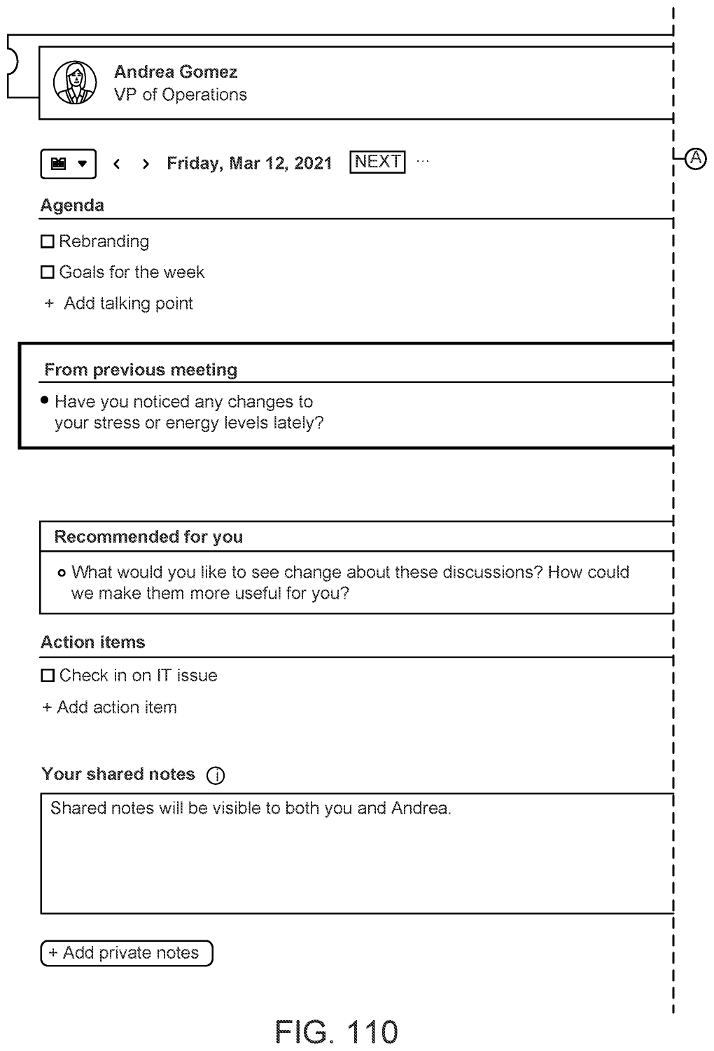

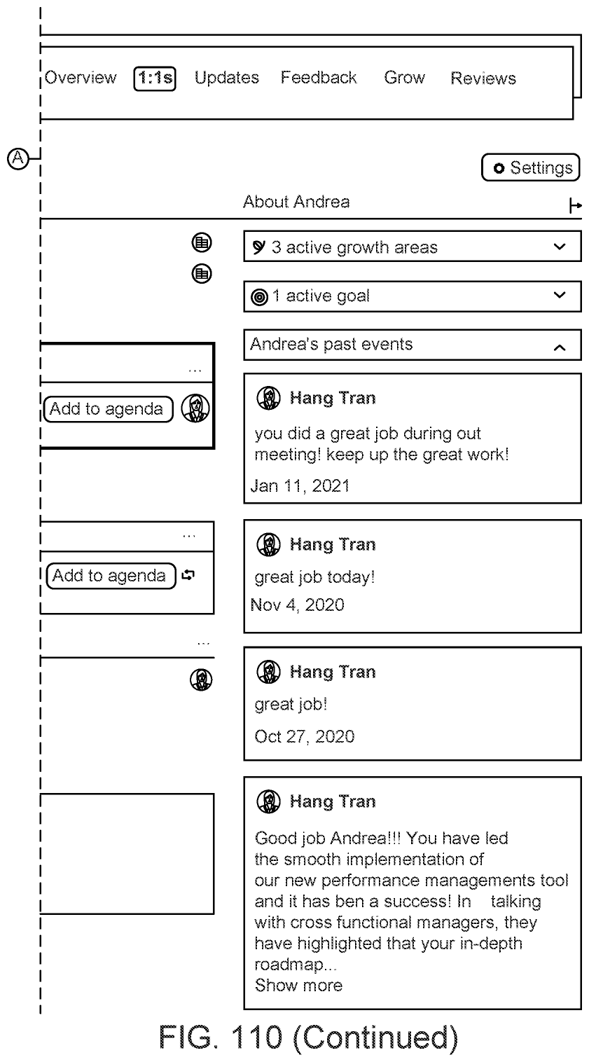

FIG. 110 is a schematic of a user interface displaying a 1:1 agenda containing talking points from a previous meeting.

Any talking points left unchecked during the meeting will roll over to the next agenda. When you go into plan your next 1:1, you will see any items that were not crossed off will be surfaced and easily able to be added to the current agenda.

Select Add to agenda to add the talking point to your agenda.

1:1 participants can adjust the time of their 1:1 meetings at any point during the relationship.

### Adjust Time for an Individual Meeting

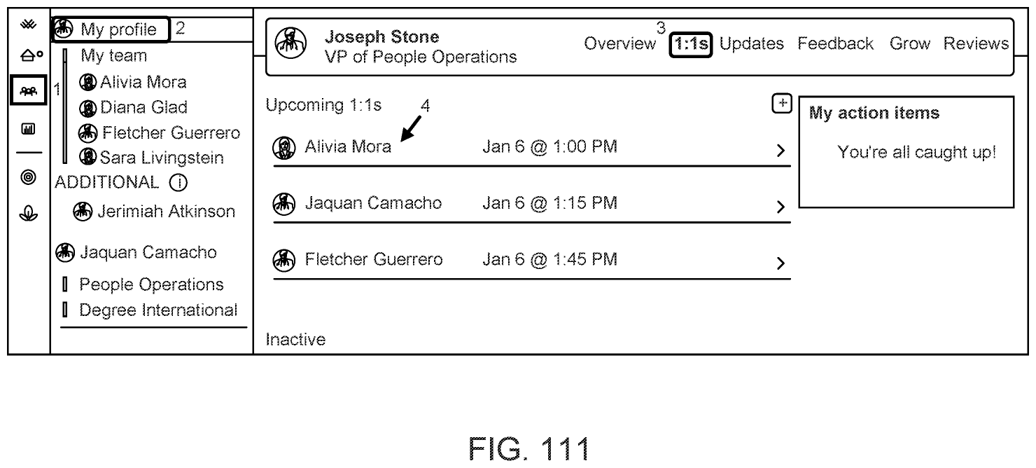

FIG. 111 is a schematic demonstrating how to navigate a user interface to select a 1:1 meeting from the 1:1 tool.

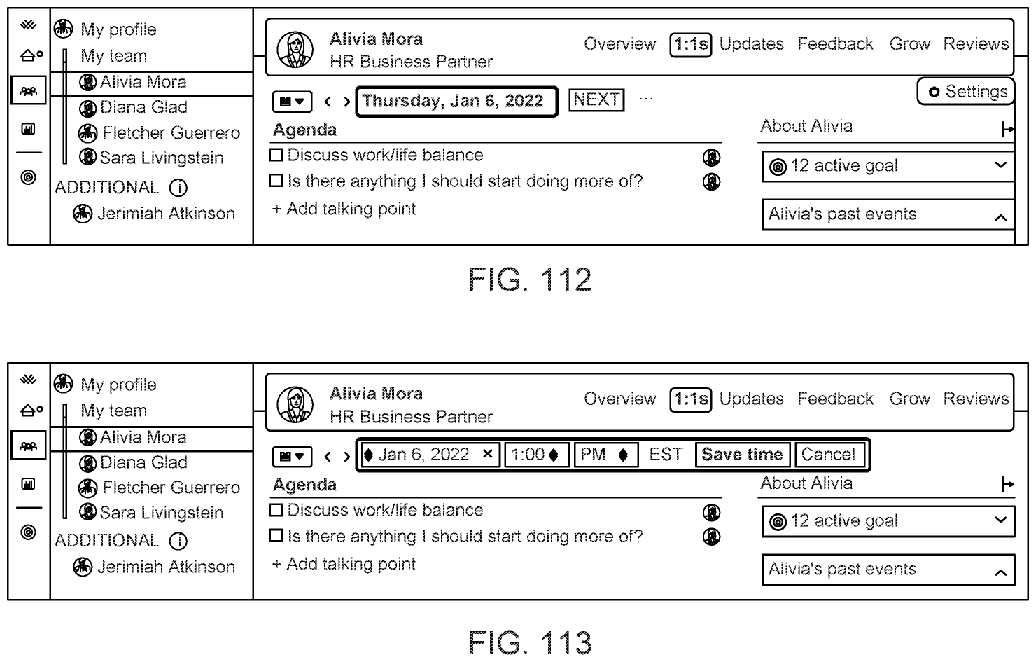

FIG. 112 is a schematic of a portion of a user interface displaying a 1:1 agenda containing the date of the 1:1.

FIG. 113 is a schematic of a portion of a user interface displaying a 1:1 agenda containing fields for adjusting the date and time of a 1:1.

The following are steps to adjust the date and time of a 1:1:
1. Step 1: Navigate to Home>Plan 1:1s.—OR—Navigate to People>My profile>1:1s.
2. Select a 1:1 meeting by clicking on the participant.
3. To edit, click on the date of the 1:1 and adjust the date and time.
4. Step 4: Select Save time.

### Adjust Time for All Future Meetings

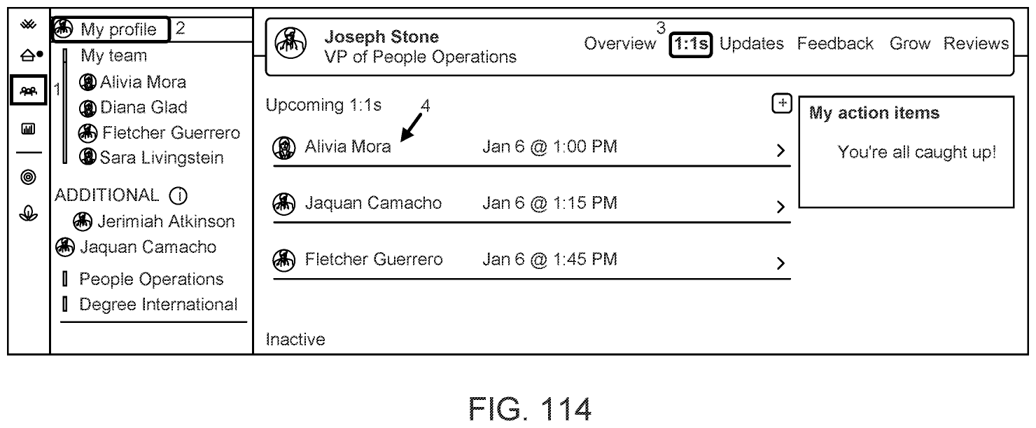

FIG. 114 is a schematic demonstrating how to navigate a user interface to select a 1:1 meeting.

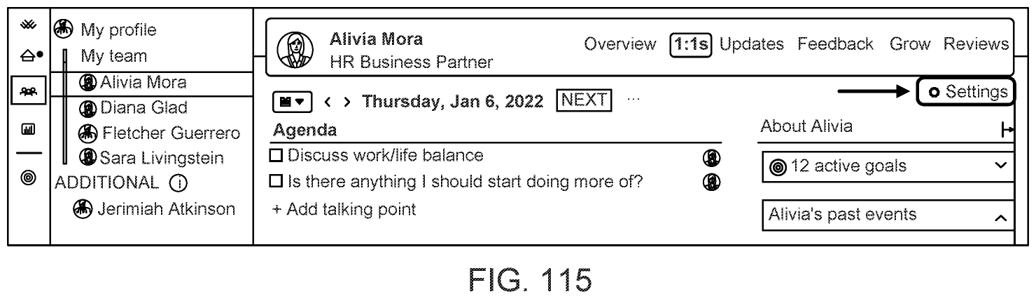

FIG. 115 is a schematic demonstrating how to navigate a user interface to view settings for a 1:1 meeting from a 1:1 agenda.

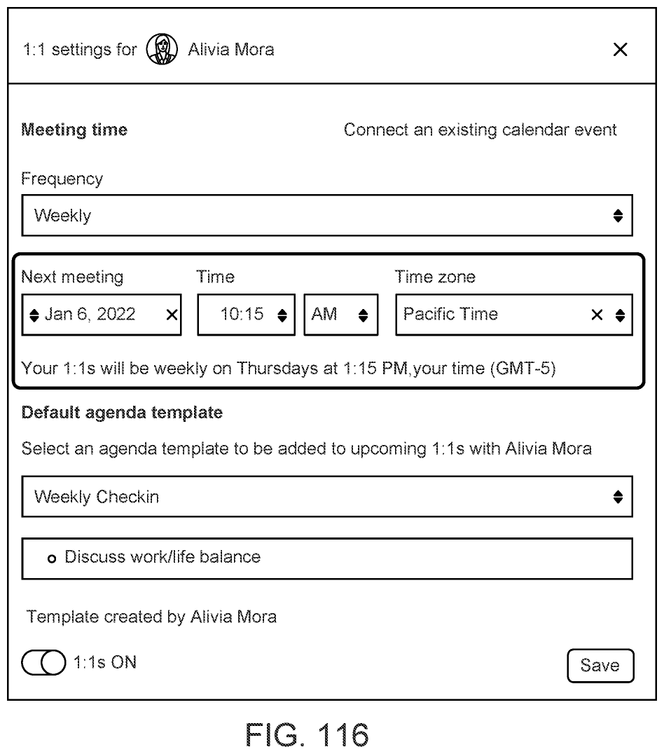

FIG. 116 is a schematic of a user interface displaying a 1:1 settings page with the option to adjust the time and date of a following 1:1.

The following are steps to adjust the date and time for all future 1:1s:
1. Navigate to Home>Plan 1:1s.—OR—Navigate to People>My profile>1:1s.
2. Select a 1:1 meeting by clicking on the participant.
3. Select Settings.
4. Under Next meeting, adjust the time and date of the following 1:1. The system will automatically adjust the future dates based on this new selection and frequency.

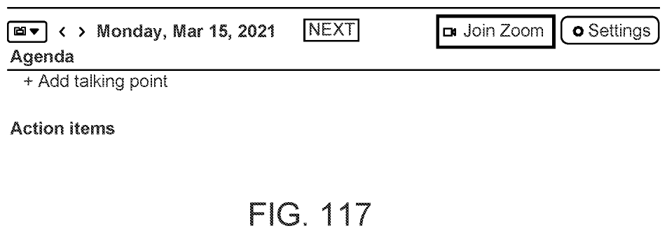

FIG. 117 is a schematic of a portion of a user interface displaying the option to join Zoom from within the 1:1 agenda.

If your 1:1 relationship is integrated with your calendar, participants will be able to join the Zoom meeting directly from the 1:1 agenda.

Note: The Zoom link should be listed in the Location field of the calendar event; otherwise you will be unable to join the meeting from within the 1:1 agenda or you will encounter a Meeting ID error.

The following are steps to join Zoom from within a 1:1 agenda:
1. Navigate to Home>Plan 1:1s.
2. Select the desired 1:1 relationship.
3. Within the 1:1 agenda, select Join Zoom.

### 1:1s Notifications

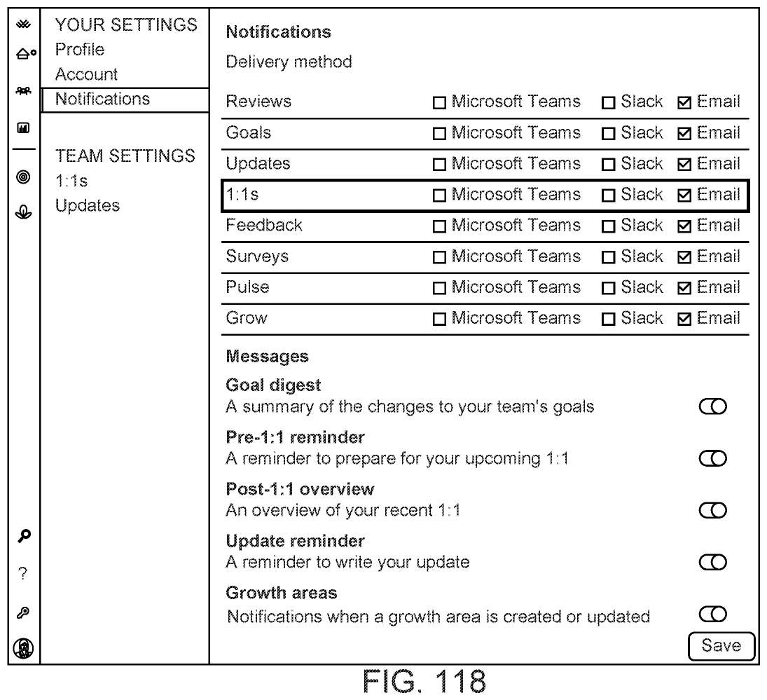

FIG. 118 is a schematic of a user interface displaying a notification center with the option to select a delivery method for 1:1 notifications.

Once you have navigated to the Notification Center, there are three options for how notifications can be sent when it comes to our 1:1s tool—Slack, Microsoft Teams, and/or email.

Note: Slack and Microsoft Teams notifications are sent via the system's app. 1:1s email notifications as follows:
When a new 1:1 relationship is set up.
A few hours before a 1:1 meeting.
A few hours after a 1:1 meeting.

To send these through Slack, Microsoft Teams, or email, you can check on the boxes to the right of 1:1s, as shown below. Make sure to press the blue Save button when you're finished.

### Initiating a New 1:1 Relationship

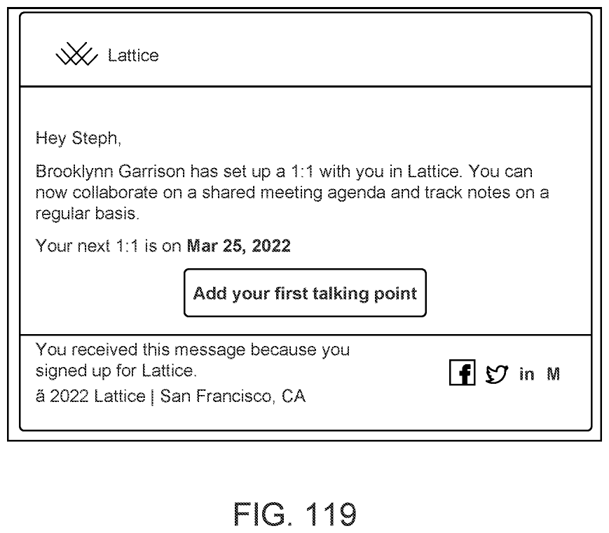

FIG. 119 is a schematic of a notification indicating that a 1:1 relationship has been set up.

When someone has set up a 1:1 in the system, the other participant will receive a message making them aware of the meeting and encouraging them to set talking points. This same message will be sent to managers if one of their direct reports requests a 1:1 meeting with them.

Note: This notification cannot be disabled; however, you can choose your preferred delivery method.

### Pre- and Post-Meeting Notifications

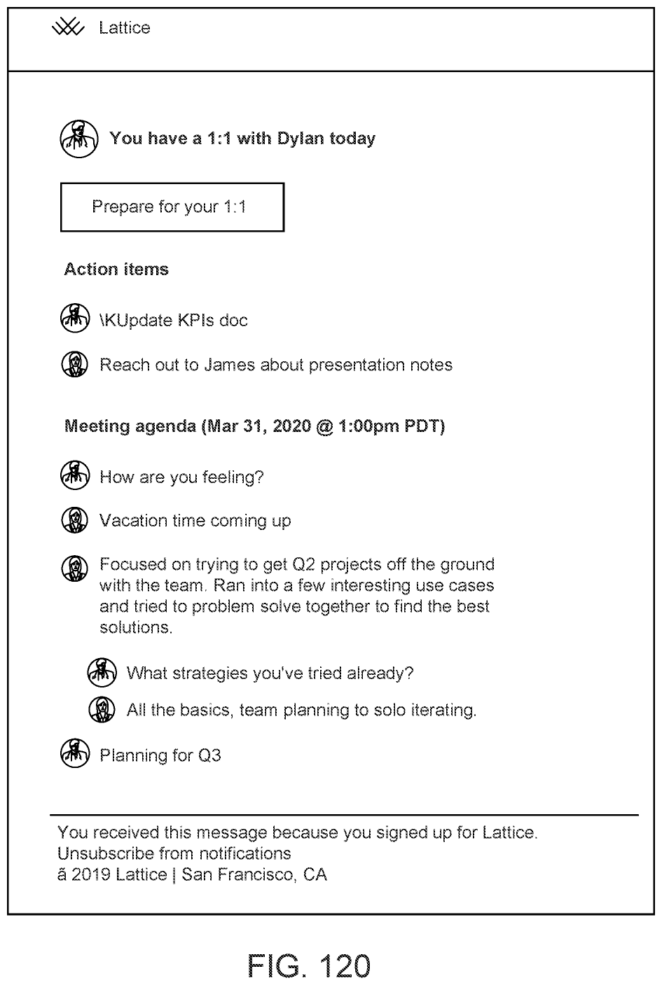

FIG. 120 is a schematic of a notification containing the agenda for an upcoming 1:1.

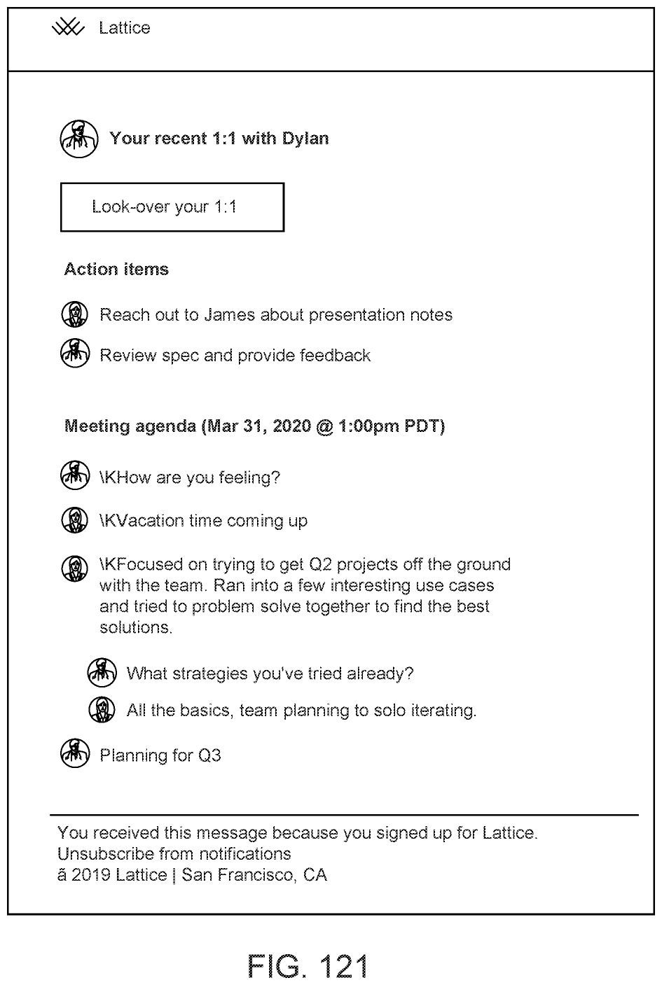

FIG. 121 is a schematic of a notification containing the agenda for a past 1:1.

You will get a notification before and after your 1:1:
2 hours before your 1:1 meeting, you will get a reminder to update the meeting agenda.
2 hours after the 1:1 meeting, both participants will get a reminder to cross off completed agenda items and add any new comments.

Note: Post 1:1 notifications will not be sent if the 1:1 is revisited before notifications are sent out.

For a post-meeting notification to be sent out the meeting must contain either:
An active talking point (one that is not checked oft).
An action item that was created in that meeting.
A note.

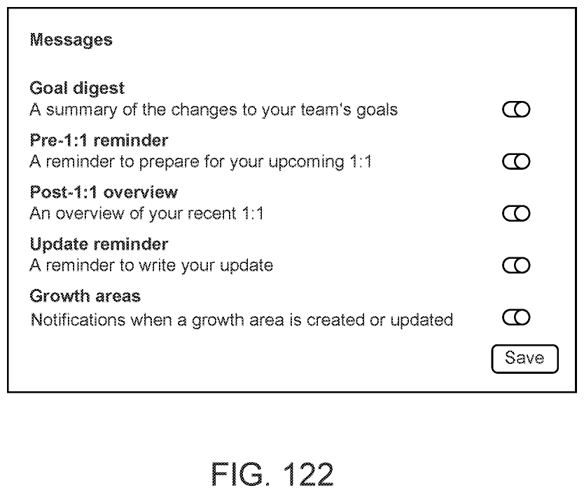

FIG. 122 is a schematic of a user interface displaying a notifications settings page with the option to enable or disable pre- and post-meeting notifications.

Individual users have the power to enable or disable pre- and post-meeting notifications. To enable or disable the pre-1:1 reminder or post-1:1 overview notifications, navigate to Account>Manage Settings>Notifications and toggle on/off for each reminder.

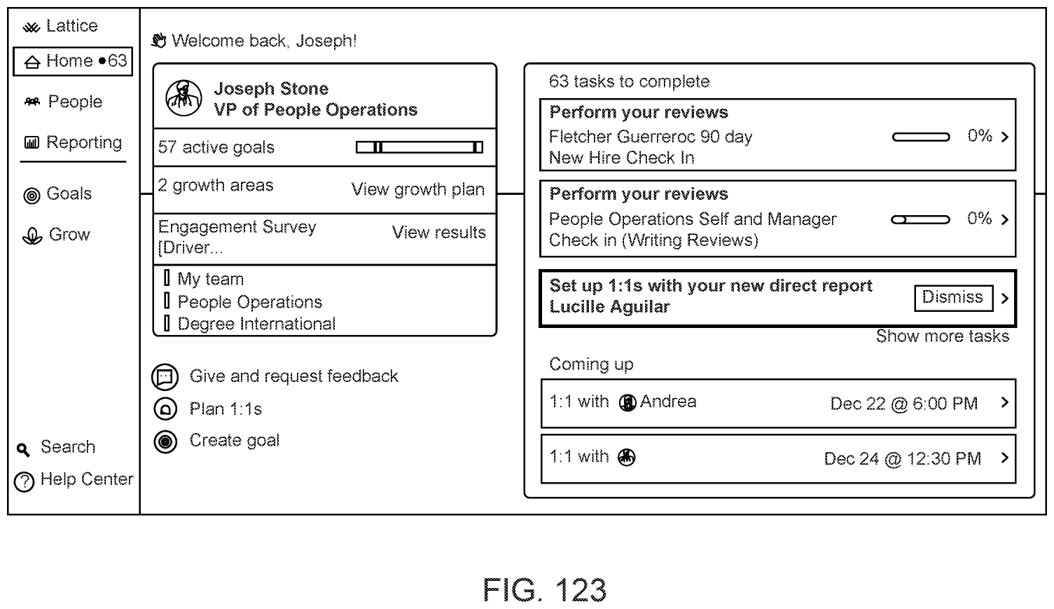

FIG. 123 is a schematic of a user interface displaying a home page with a set up 1:1s with your new direct report task.

Managers will receive the Set up 1:1s with your new direct report task when a new direct report has been assigned to them. This task can be dismissed without completing the action.

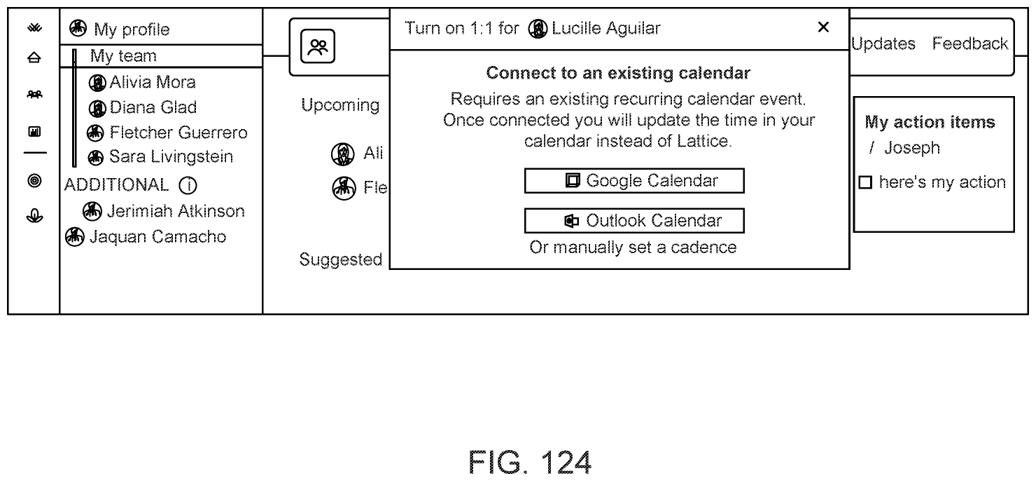

FIG. 124 is a schematic of a user interface displaying a 1:1 setup modal.

If a manager elects to set up 1:1s from the task, the system will bring them into the 1:1 set up modal where they can begin to create the 1:1 relationship.

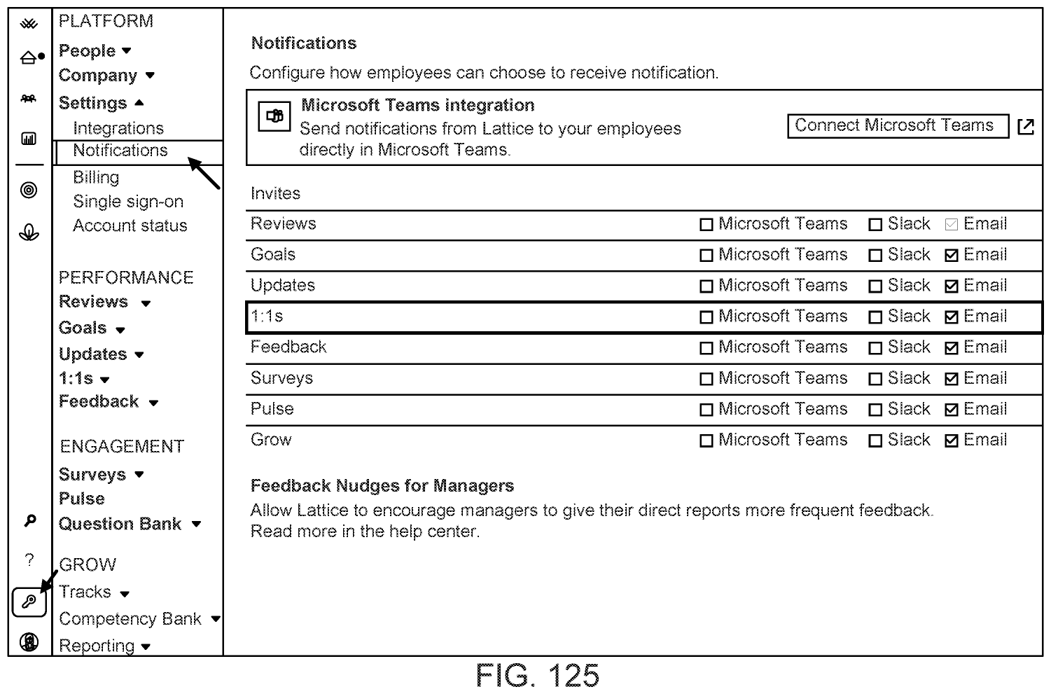

FIG. 125 is a schematic demonstrating how to navigate a user interface to send 1:1s notifications from the notification center.

Once you have navigated to the Notification Center, there are a few options for how notifications can be sent when it comes to our 1:1s tool—through Slack, Microsoft Teams, and/or email.

1:1s notifications are sent as follows:
When you initiate a new 1:1 relationship.
A few hours before a 1:1 meeting.
A few hours after a 1:1 meeting.

To send these through Slack, Microsoft Teams, or email, you must check on the boxes to the right of 1:1s, as shown in FIG. 125. Make sure to press the blue Save button when you're finished.

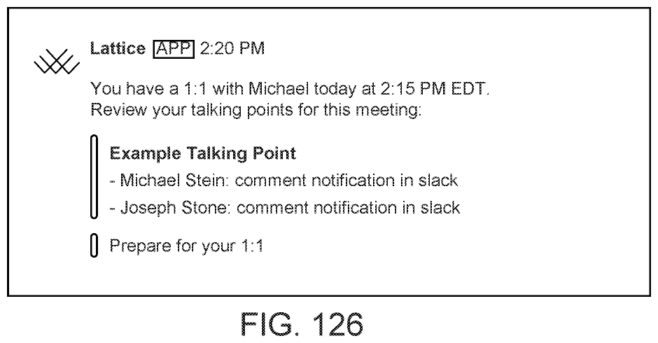

FIG. 126 is a schematic of a slack notification regarding a 1:1 meeting.

Slack notifications are sent in a direct message via the system's app, and appear as shown in FIG. 126.

### Updates for Admins

The Updates tool allows managers to set up a customized template sent to employees at a cadence of their choosing (weekly, biweekly, or monthly). Employees checking in with their manager weekly are often using the Updates tool as a monthly status report to inform the manager what they are working on and where they could use help.

### Why Use Updates?

Updates are an excellent tool for employees and managers who struggle to find time in person. For example, it can help teams with remote employees, traveling employees, or new hires. Employees who check in with their manager monthly are generally using the Updates tool as a mini self-review. It's a way to look back at your performance over the past month and is generally more developmentally based.

For companies that do not have frequent reviews, there can be months when an employee does not receive formalized feedback, and the Updates tool is a great way to gather more feedback. Regardless of the cadence, the system will automate the process. Hence, it runs regularly, and managers will always have the opportunity to provide comments on updates, closing the loop with their employees.

### What Can Admins Do With Updates?

As an admin, you'll view the Update's content and who is using the tool. Additionally, you can provide transparency to your senior leaders by turning on a feature that allows managers of managers to see the updates of their indirect reports. You also can turn on updates for all employees and select the default cadence and questions to drive accountability.

The system allows you to enable Updates for your entire organization or a smaller group of users. The system provides the flexibility you need to help facilitate a phased rollout of the tool if you choose to do so.

### Adjusting Your Activation Settings

The activation settings will make the Updates tool visible to your employees. Updates will still need to be manually set or turned on for each individual by either a manager or admin. If the individual does not have a manager, in the case of a CEO, they will only be able to post public Updates.
1. Navigate to Admin>Updates Settings.
2. Under Activation Settings, select whether you would like to enable Updates for all employees, a specific set of employees, or disable the tool altogether.
3. If you choose to only turn on Updates for a subset of employees, you will need to select employees by department or user attributes. This will prevent any user who is not assigned the selected attribute from having visibility into the tool.
4. Save.

### Turning on Updates for Individuals

As an admin, you will first need to enable the Updates tool for all or a subset of your employees. After this feature is enabled, you will have the additional ability to turn on/off Updates for specific employees. To do this, please refer to the steps below:
If the individual does not have a manager, they will only be able to post public updates.
If an admin turns on Updates for an employee that has never submitted an update before, the employee will receive a notification. If the employee has had Updates turned on in the past and submitted an update, then the employee will not receive a notification when the feature is turned on again.
Managers are not notified when Updates are enabled for their direct report.
When an employee's manager changes within the system, the Updates status will be automatically turned off. It is up to the new manager or the admin to turn on Updates once more for this employee.

The following are steps to turn on updates for individuals:
1. Navigate to Admin>Updates>Updates log.
2. Navigate to the Individuals tab.
3. Select Turn on for all to turn on Updates for all Updates-enabled employees with managers. Note: You can also select to filter this list and click Turn on for all for only the filtered individuals.
4. (Optional) To enable this feature without filtering, or turning it on for all, toggle on the Status for specific employees.

If you're having trouble figuring out what questions you want to ask your direct reports every week, look no further! Below are suggested questions you may use to set up your update questions with your direct reports.
1. What did you focus on this week?
2. What are your plans and priorities for next week?
3. What challenges or roadblocks do you need help with?
4. Is there anything else on your mind you'd like to share?
5. What's on your mind?
6. What's something that isn't on our radar that we should start focusing on?
7. Anything I can partner with you on?
8. Who was your MVP this week?
9. What are you most worried about?
10. What are you most excited about?
11. Where did you come up short?
12. What were your big wins? Small wins?
13. Any there any projects you'd really like to work on if you were given the opportunity?
14. How have you advanced your career or personal goals this week?
15. What's the main thing standing in the way of hitting your goals?
16. How can I help with your goals?
17. What new thing did you learn this week?
18. On a scale of 1-10, how productive have you been? If you wanted to move up a number, what would it take?

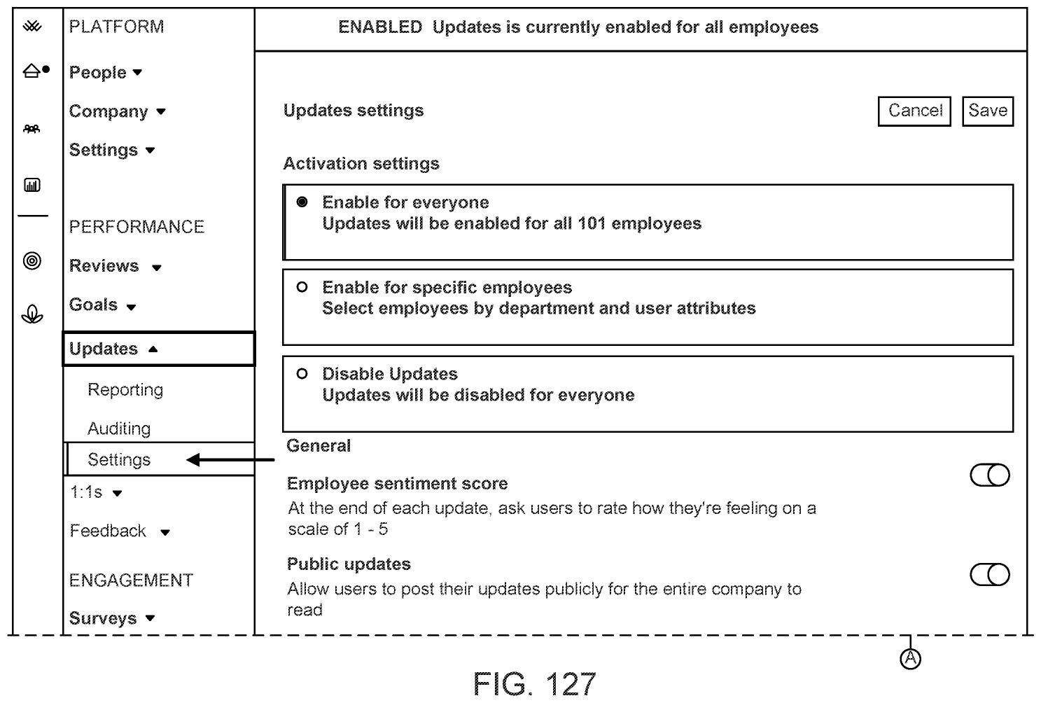

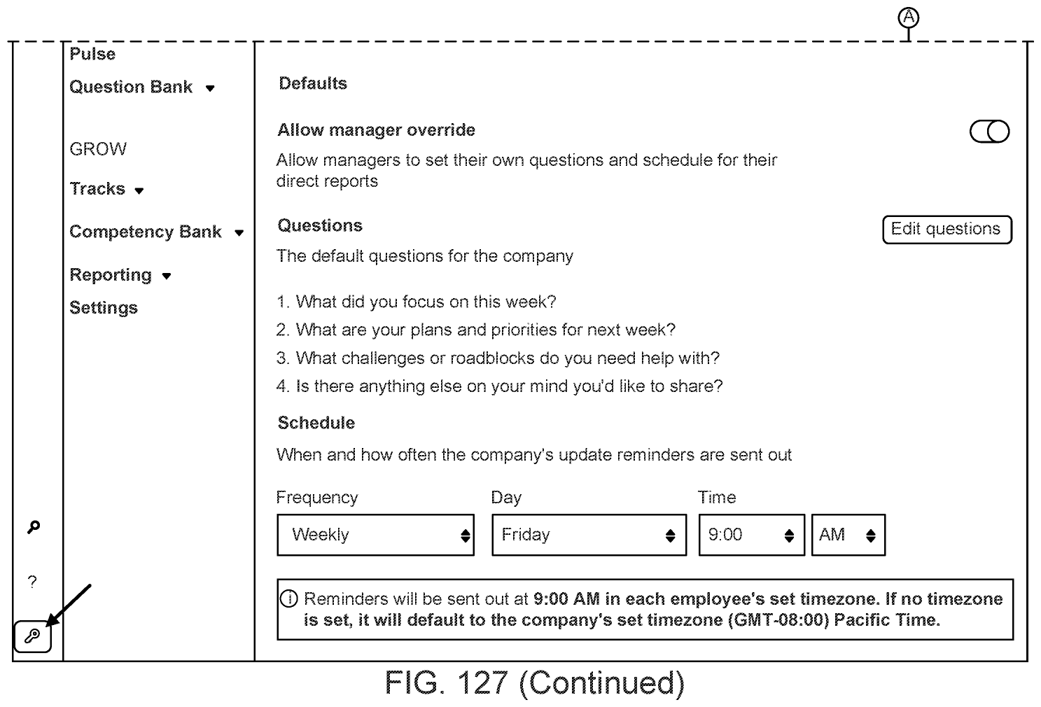

FIG. 127 is a schematic demonstrating how to navigate a user interface to be taken to the updates settings page.

In the Updates Settings page, admins can manage the Updates tool for their organization. On this page, admins can accomplish the following tasks:
Enable or disable the Updates tool.
Toggle on/off the employee sentiment score.
Toggle on/off public updates.
Allow managers to set their own settings for updates.
Set the default questions and schedule for updates.

To access this page, head to the Admin page>Updates>Settings.

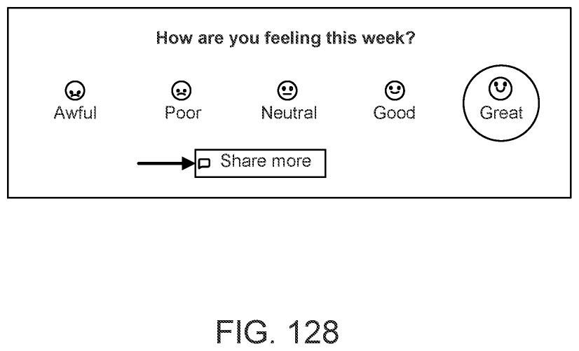

FIG. 128 is a schematic of a user interface displaying an employee sentiment score rating with the option to add context through the share more button.

If the employee sentiment score is toggled on, alongside the usual update questions, every user will be asked to rate “How are you feeling this week?” on a scale from 1-5. Employees can also add context to their rating by clicking the Share more button.

Turning on public updates allows users to choose whether their update will be seen by just their manager or publicly by the whole company.

Note: Generally, smaller companies use public updates to give status reports, while larger companies use private updates to keep details between managers and employees.

### Default Updates Questions and Cadence

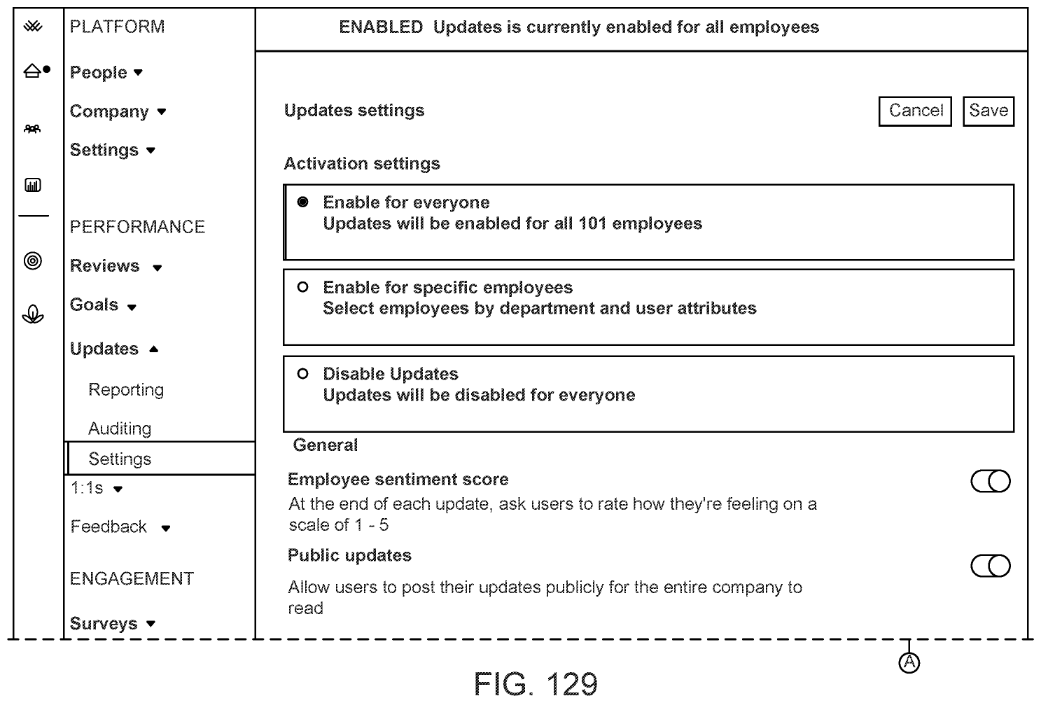

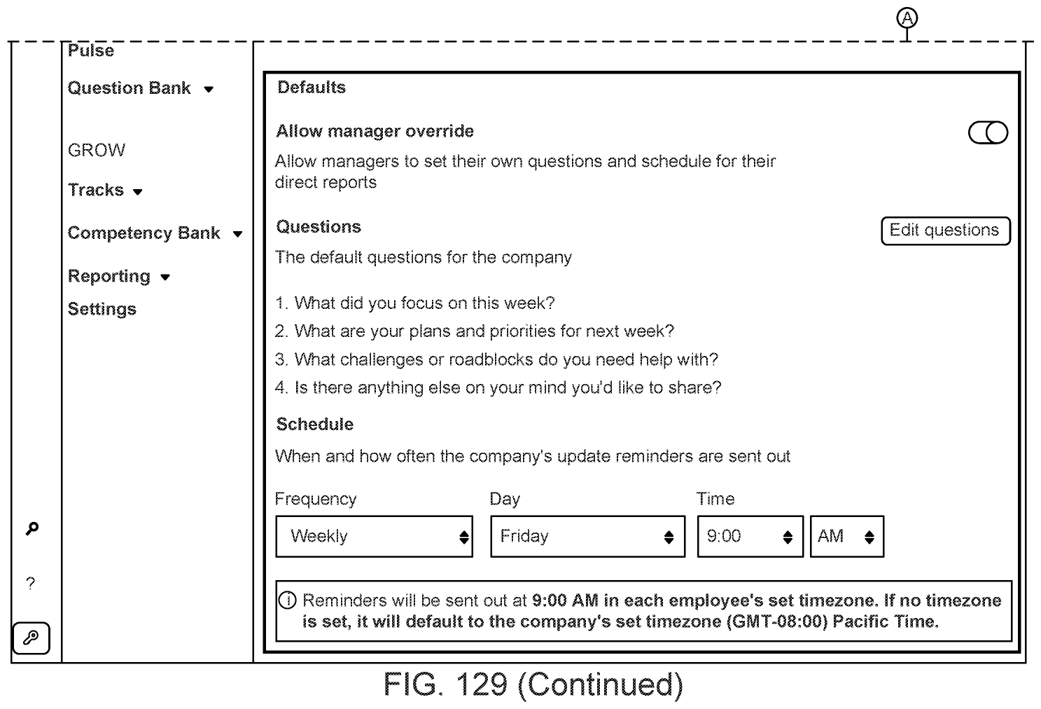

FIG. 129 is a schematic of a user interface displaying an updates settings page containing default updates settings.

Admins can also configure what questions are asked in the update, how often they should be asked, and when the reminder notification is sent.

If you want your entire organization to use these default settings, toggle off the Allow Manager Override setting. If Manager Override is enabled, managers will have the option to set their own questions and cadences for their team.

Once a manager has set customized questions for their direct reports, changing the company default questions will not affect the questions that those direct reports are being asked.

Helpful tip: If an employee's manager changes, the new manager will not have access to the private updates between their new direct report and the direct report's old manager. Updates Adoption and Log pages will provide admins with a high-level overview of how employees use and engage with the Updates tool. The Updates Adoption page provides admins with a high-level overview of how employees use and engage with the Updates tool.

To access the Updates Adoption page, navigate to Admin>Analytics>Adoption>Updates.

Who can see the Updates Adoption page?
Admins will have access to this in the Admin page>Adoption.
Managers will have access to this on the Reporting page.
Managers of managers will see this on the Reporting page.
Employees with custom role permissions will see this in the Admin page>Adoption.

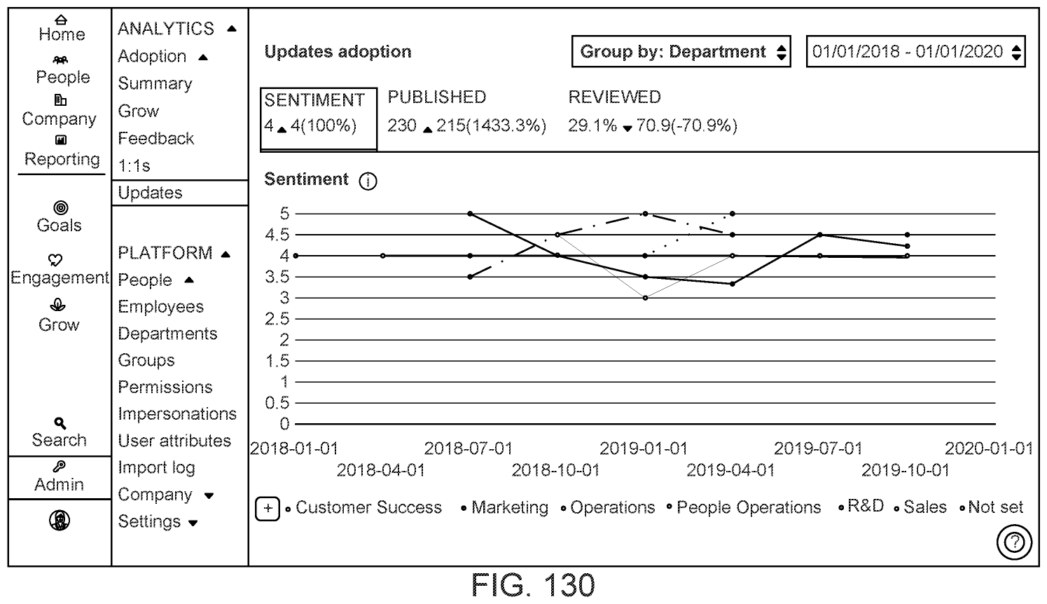

FIG. 130 is a schematic of a user interface displaying an updates adoption page containing a graph of sentiment metrics.

Three metrics can be seen in the graph at the top of the Adoption Reporting page:
Sentiment: The Sentiment graph will show the average sentiment per group over a period of time.
Published: The Published graph will show the number of updates published per group over a period of time
Reviewed: The Percentage Reviewed graph will show the number of updates that managers reviewed for a specific group divided by the total number of updates published by that group of people.

To navigate between these metrics and see the different graphs, click on the metrics above the graph.

When viewing a graph, the delta metric at the top compares the change between the previous date range interval and the current date range interval. For example, if you select to view the last 90 days, the delta is the difference between the metric 180-90 days ago and the metric from the previous 90 days. The same logic applies if you change the date range to 30 days or 365. If your graph is set on All Time, there is no delta shown.

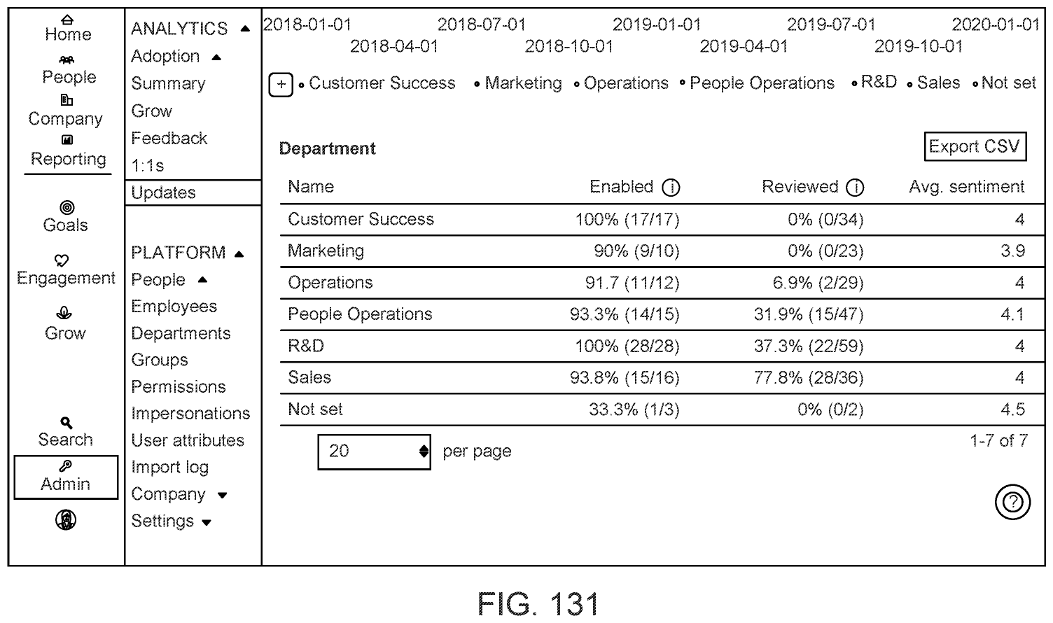

FIG. 131 is a schematic of a user interface displaying a table view of the data shown in the graph of sentiment metrics.

Below the graphs, you will find a table view of the data shown in the graph:

FIG. 132 is a schematic demonstrating how to navigate a user interface to make groups visible or invisible on the graph within the updates adoption page.

When viewing the graphs, you can create groups to combine your data by clicking on the + sign (the system defaults to the first eight options). You can make groups visible or invisible on the graph by clicking on the grouping name.

### Filters

There are two main ways to filter metrics in the reporting page:
Group by: You can adjust how your information is grouped by clicking on the Group by filter. Here, you will see a list of all employee fields currently in the system, including any custom fields you may have created. (This functionality is not available to managers.)
Time range: This allows you to adjust for which period of time you analyze the data. You can choose a different set of timeframes or a custom range.

As your organization uses Updates, admins can get an overview of their organization's engagement or usage of the tool from the Updates Log.

To access the Updates Log, navigate to Admin>Updates>Updates log.

### The Updates Log

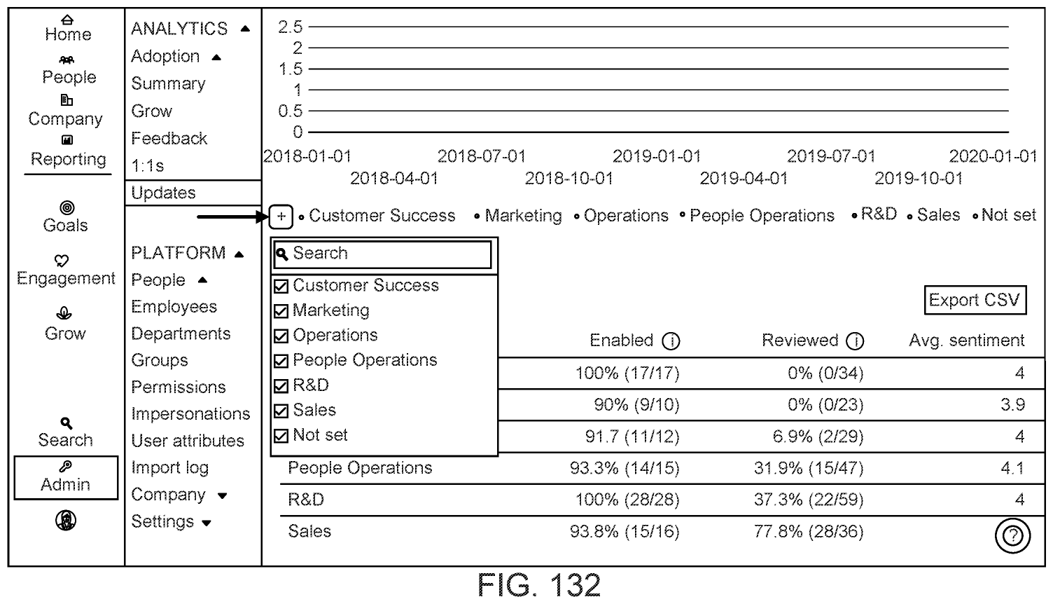

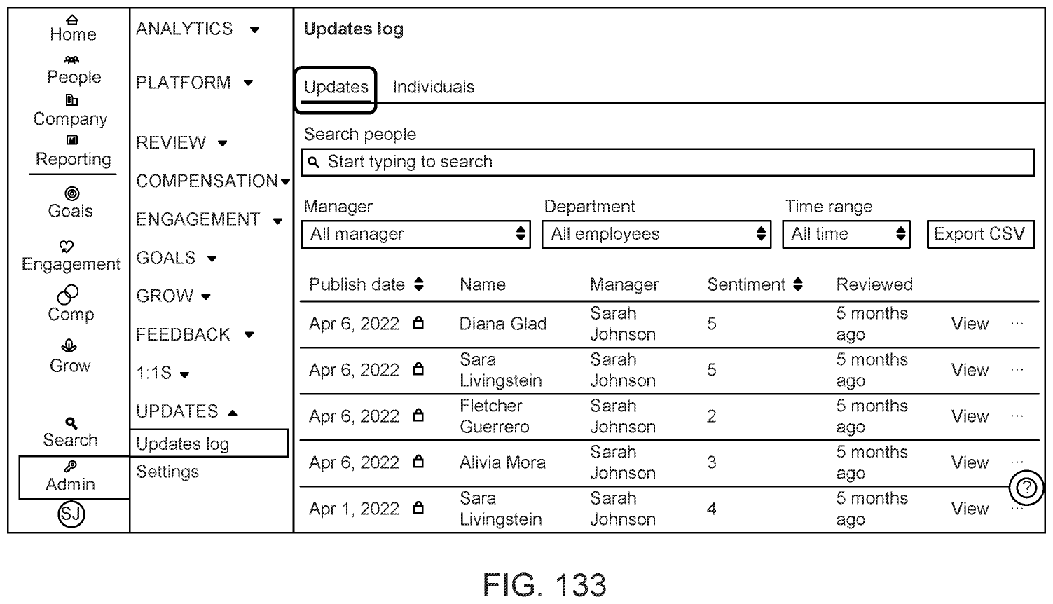

FIG. 133 is a schematic of a user interface displaying the updates tab of the updates log.

The Updates tab lists every update submitted between a manager and their direct report.

The following information is available in the Updates tab:
Publish date: The date the update was submitted.
Update visibility: A lock icon next to the publish date indicates the update submitted is private (only visible to admins, the manager, and the publisher).
Name: The update publisher.
Manager: The manager of the publisher.
Sentiment: The sentiment score submitted by the publisher.
Reviewed: Whether the update was reviewed by the publisher's manager.

The following actions are available in the Updates tab:
View each update
Delete an update
Export the Update log table

### Update Tab: Search and Filter

You can filter by the individual or manager. If you filter by manager, you can select All managers in the dropdown or select a specific manager, resulting in a list of all updates submitted by that manager's team. You can also filter by department and by time range.

FIG. 134 is a schematic of a user interface displaying the individuals tab of the update log.

The Individuals tab is where admins manage the overall Updates tool for each individual.

You can turn Updates on or off between a manager and their direct report by toggling on (blue) or off (grey) in the Status column. You can do this on an individual basis, or you can select to Turn on for all, which will make Updates available to everyone in your organization.

The following information is available in the Individuals tab:
Name: The update publisher.
Manager: The manager of the publisher.
Frequency: The update frequency set by the publisher's manager or admin.
Avg. Sentiment: The average sentiment score for the publisher.
Last update: The date the last update was submitted by the publisher.
Status: Whether Updates is turned on for the individual.

### Updates for Managers

Managers can use the Updates tool to get weekly insight on their direct reports. If your organization allows, Managers can further customize this experience for their teams. You will be able to set your own update settings and create questions that you can apply on a team-wide or an individual level.

Turning on/Off Updates for Your Direct Reports

As a Manager, you can turn on or off Updates for your direct reports. To do this, please refer to the steps below:
1. Navigate to the People page.
2. Click on the desired employee's name from the My team section.
3. Enter the Updates tab within the toolkit.
4. Click Turn on Updates for [direct report].

### Customizing on a Team Level

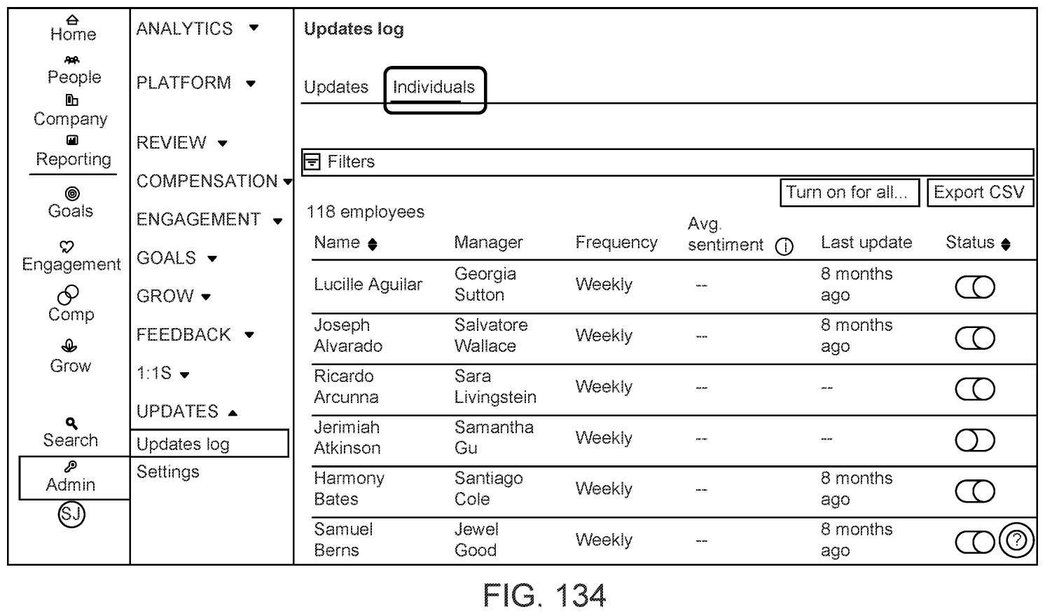

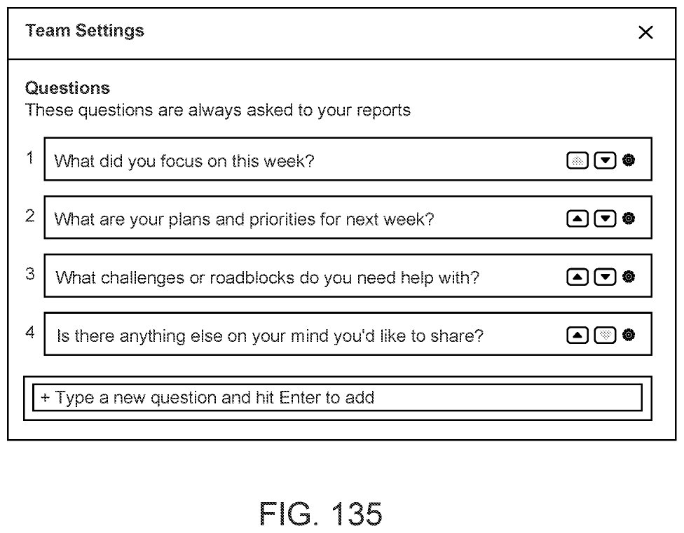

FIG. 135 is a schematic of a user interface displaying a team settings page containing default questions and the option to input custom questions.

To set custom questions on a team level, go to the My team section>Updates>Settings.

From the team settings screen, you can choose either Company default settings or Custom team settings. If you select Custom team settings, you can change the update cadence, the time the reminder is sent out, and edit the questions asked for everyone on your team.

The system provides a set of default questions that you can ask, but you can input your own questions by deleting the default ones and adding your own.

Please note: any changes made to update questions are reflected in the current week's updates for those who have not saved a draft or published their update yet.

You can also choose how often you ask your team for updates to weekly, biweekly, or monthly, as well as change the week's day and time that the reminders are sent out. Employees will be able to publish one Update per frequency setting.

Please note: reminders will be sent out at the selected time in each employee's set time zone. If no time zone is set, it will default to the company's set time zone.

### Customizing on an Individual Level

FIG. 136 is a schematic demonstrating how to navigate a user interface to be taken to an update settings page.

To set custom questions on an individual level, go to the My Team section>click on the desired direct report's name>Updates tab. If Updates are enabled, you will see the option to View update settings.

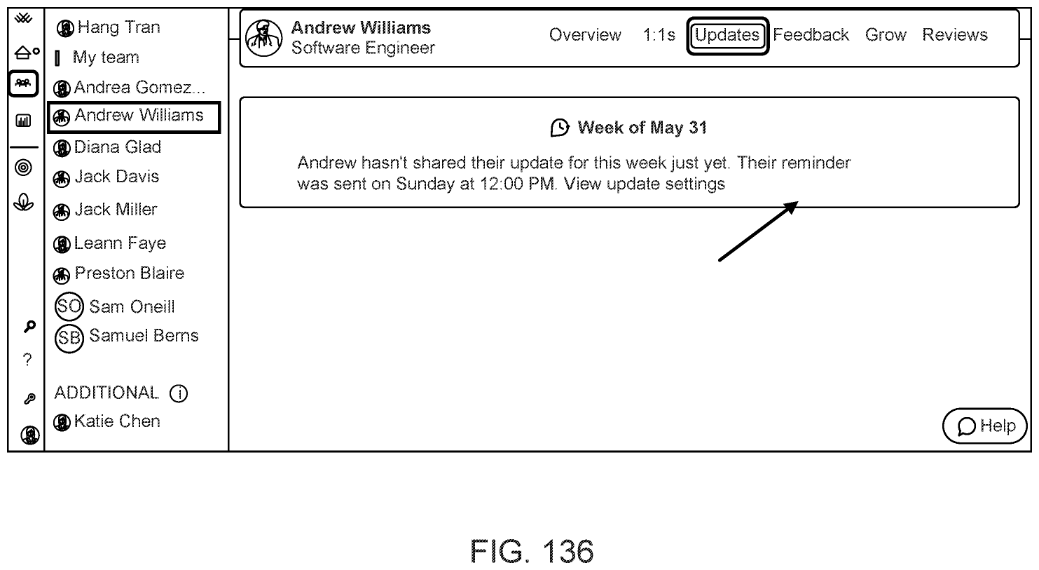

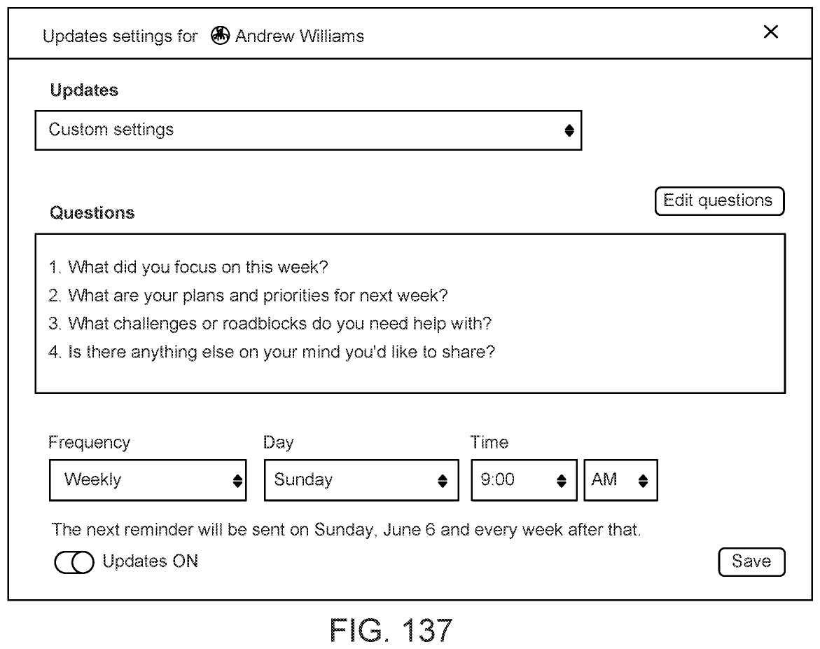

FIG. 137 is a schematic of a user interface displaying an update settings page for a specific employee.

From here, choose Custom settings from the dropdown to customize both the questions and cadence for that specific employee.

After you've set individualized questions for an employee, changing your team questions will not affect the questions that they are asked.

After your direct report completes an update, you will be able to view and comment on the update.

FIG. 138 is a schematic demonstrating how to navigate a user interface to be taken to the people page from a home page.

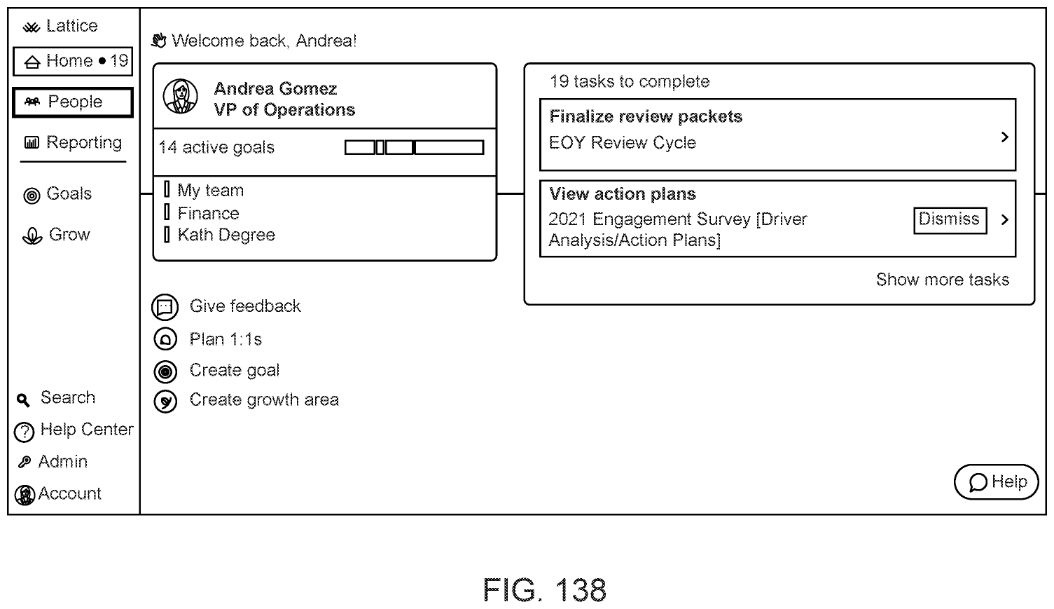

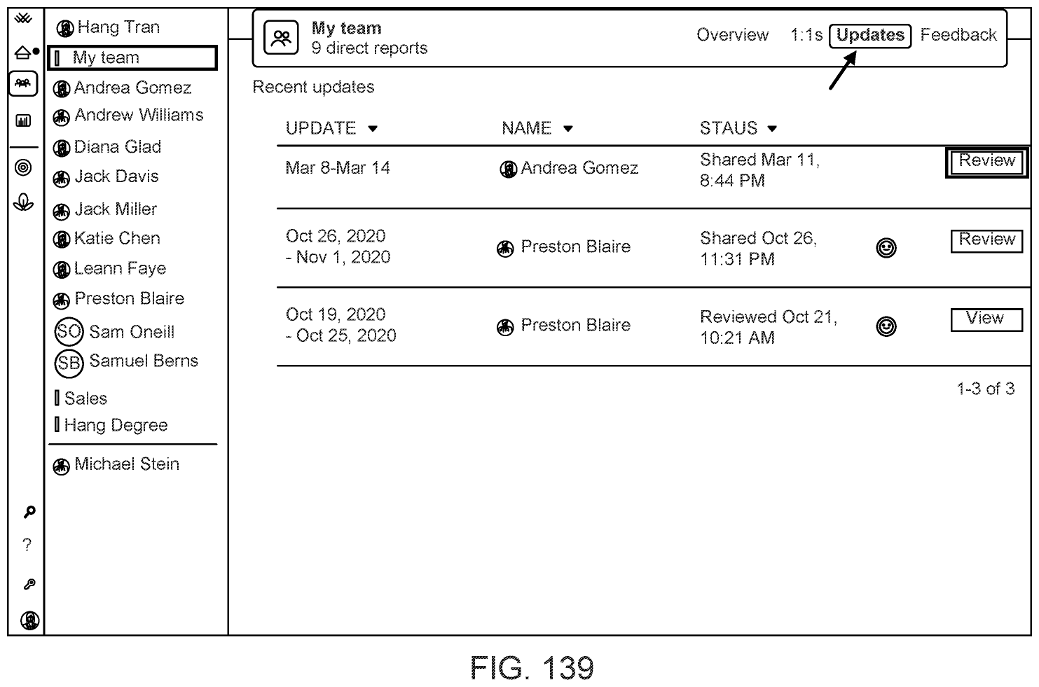

FIG. 139 is a schematic demonstrating how to navigate a user interface to review an update from the updates page.

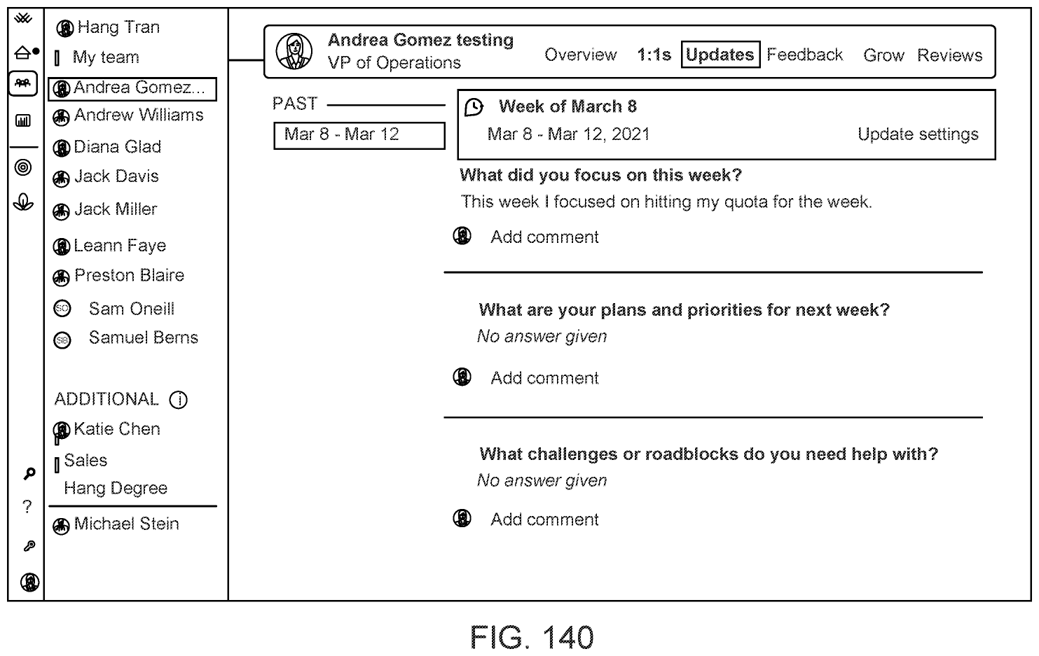

FIG. 140 is a schematic of a user interface displaying an updates page for reviewing an update.

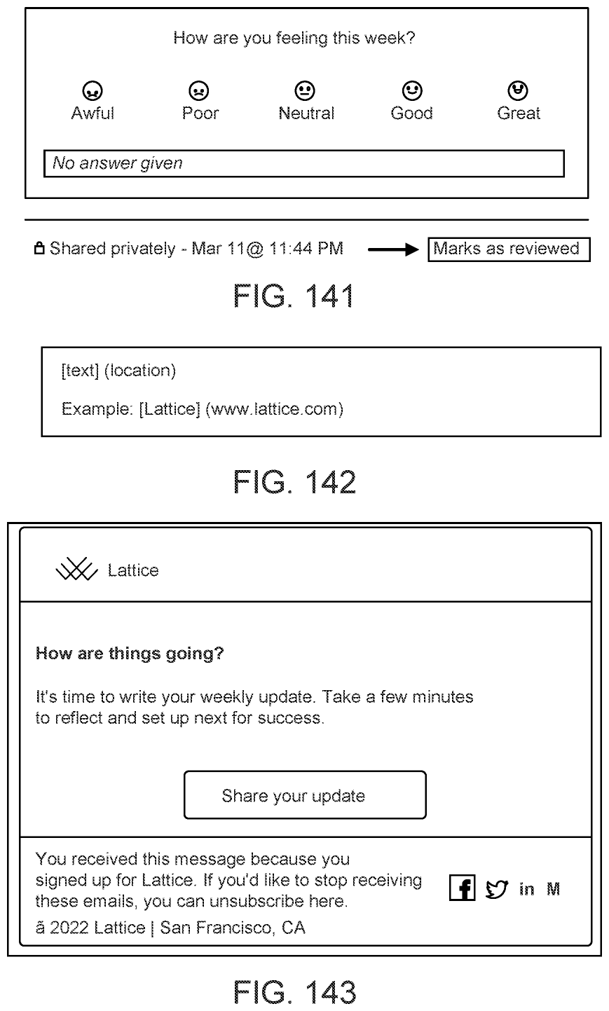

FIG. 141 is a schematic of a user interface displaying a rating system for an update with the option to mark the update as reviewed.

The following are steps for viewing and commenting on an update:
1. On your Home page, select People.
2. Select My team>Updates>Review beside your direct report's update.
3. Review the update and add comments.
4. Click Mark as reviewed, which will share any comments provided with your direct report.

Please note: Once an update is marked as reviewed, Managers will not be able to edit their submissions.

FIG. 142 is a schematic of the format for attaching a link within the comment section of an update.

To attach a link within the comment section when filling out your update, use the format as indicated in FIG. 142.

Updates help managers understand what their direct reports are doing and what issues are top-of-mind. They're also beneficial for keeping up to date with remote teams.

### Turn on Updates

Follow these manager instructions to turn on Updates for your team. If your company does not have Updates enabled for your company yet, ask your HR admin if they can enable the feature.

### Customize Update Questions and Frequency

If your organization has enabled the “manager override” function, you can follow these instructions to set your Update questions and frequency for your team.

If you have selected a weekly cadence, it may be advisable that the questions set are short and easy to answer. Writing updates should be simple for your direct reports to ensure high completion rates.

If you would like to make updates more reflective, the system may suggest setting your cadence to Friday. That way, your team can reflect on everything they have accomplished over the week.

If you would like to make updates more directed on the week ahead, the system may suggest setting your weekly cadence to Monday. That way, your direct reports will focus more on what they want to work on for the coming week while still reflecting on the last week's Monday update to see what it is that they weren't able to accomplish.

If you want longer updates with an employee development focus, consider switching to a monthly cadence and schedule follow-up meetings to review updates with employees.

Here are some examples of employee development questions that better fit in a monthly update:
1. What accomplishment are you most proud of this past month?
2. What has been going well for you for your career development?
3. What is your manager doing well? Where can they improve?

### Introducing Updates to Your Team

Meet with your team to explain the Updates tool and the benefits of writing updates Weekly updates help keep you informed about what's going on and gives your team the opportunity to reflect on what they accomplished that week and what they plan to do next week.

Here are some best practices from managers that have the best employee update rates on the system

### Encourage Public Updates

Encourage everyone to write public updates regularly (or just department heads). You can then connect these to an org-wide Slack channel. It's a great way to keep track of what departments/individual employees are working towards!

### Keep Updates Short

Employees should write updates quickly so it doesn't feel like a chore. Please encourage them to keep answers to one or two sentences and use bullet points. Employees should not spend more than 15 minutes on an update.

Be careful if an employee starts writing long, detailed updates. Thank them for putting in the extra detail but encourage them to be more concise to keep them from burning out on the practice.

### Provide Guidance on the Early Updates

Help your direct reports as they learn where to go in the tool to write an update. Additionally, provide your team with guidance on what kind of information you're looking for, as everyone will wonder what to write at first.

When you first start, provide lots of feedback on how you'd like them to structure answers and how much information to include.

### Read, Respond, and Remind

Schedule time each week, preferably near the start of the week, to read over your team's updates. Write comments to offer guidance, address concerns, or congratulate them on their wins. Show employees that you are getting value from reading their updates.

The most effective managers recommend following up with employees that miss an update. If your direct report forgets to submit an update and you fail to remind them, that tells the employee that updates aren't important to you, and it becomes much easier to skip the next update.

### Updates for Employees

The system empowers you to update your manager by filling out a few reoccurring questions on a weekly, biweekly, or monthly basis.

Please note that if an update has not been submitted after two weeks, the system will delete the scheduled update from your list.

### Accessing Your Update

FIG. 143 is a schematic of an email reminder that an update is due.

The system will send out a reminder email when your update is due. You can access your update page by clicking on the Share your update button in your email.

You can also access your Updates page by logging into the system and clicking on the People page>Selecting your name or profile at the top of the People navigation>Updates tab in the toolkit.

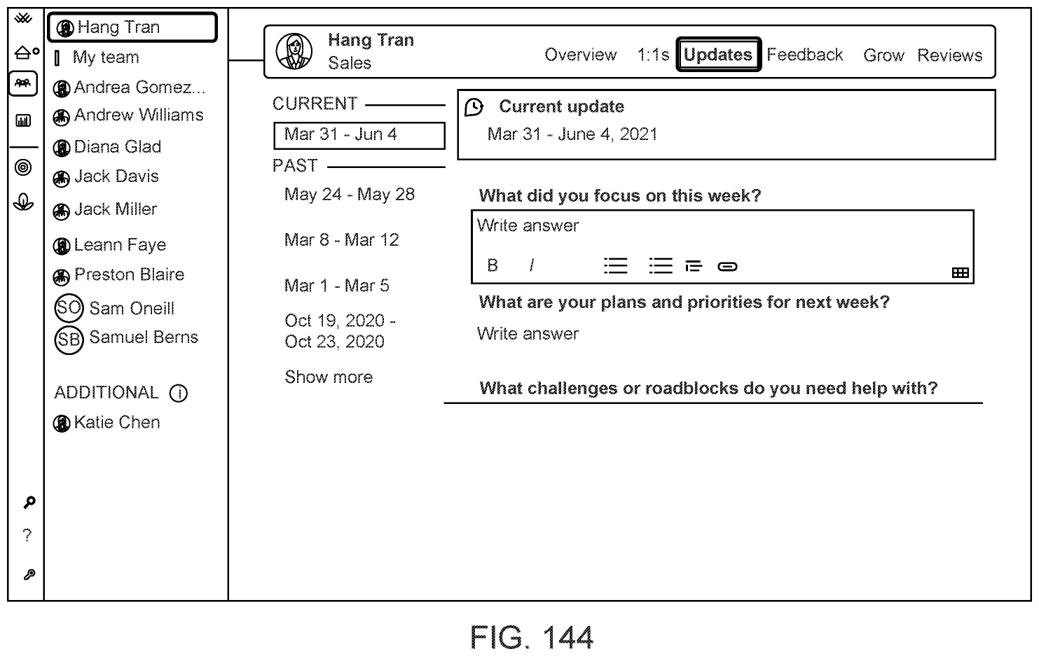

FIG. 144 is a schematic demonstrating how to navigate a user interface to access an updates page from the people page.

### Filling Out Your Update

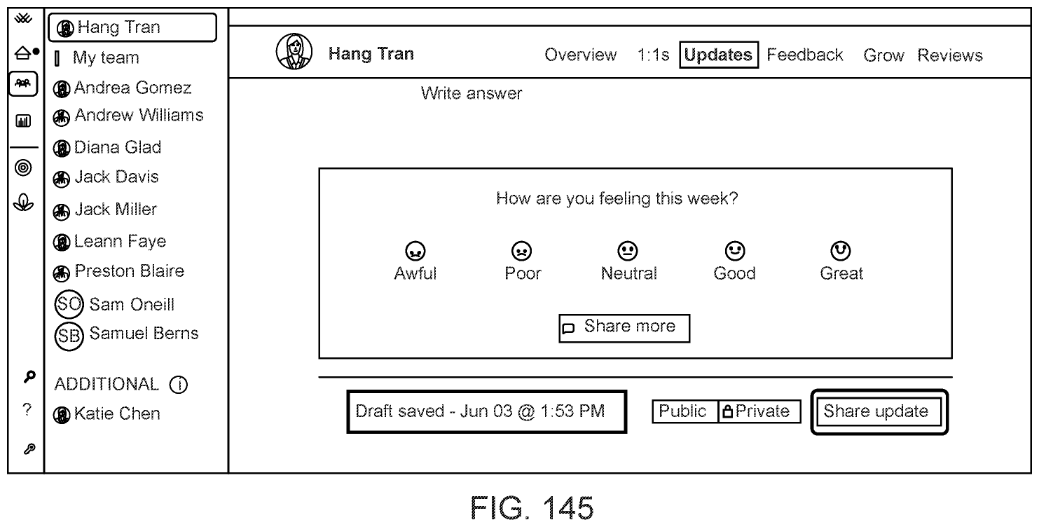

FIG. 145 is a schematic of a user interface displaying an updates page indicating the last time the draft update was auto saved.

In addition to publishing an update, you can access past updates on the lefthand side. As you complete your update, your draft will auto-save as soon as you start typing. You can see the last time the draft was auto-saved in the bottom left corner. When you're ready to submit, click the Share update button at the bottom of the Updates page. Your manager will be able to see and respond to your update.

Please note, some companies will allow employees to publish their updates publicly as well as privately. It will look like the image below.

The default will be Private, which means only you and your manager will be able to see the update. If you select Public, your update will be shared with the entire company.

Please note, if your update has already been reviewed by your manager, you will not be able to make any edits.

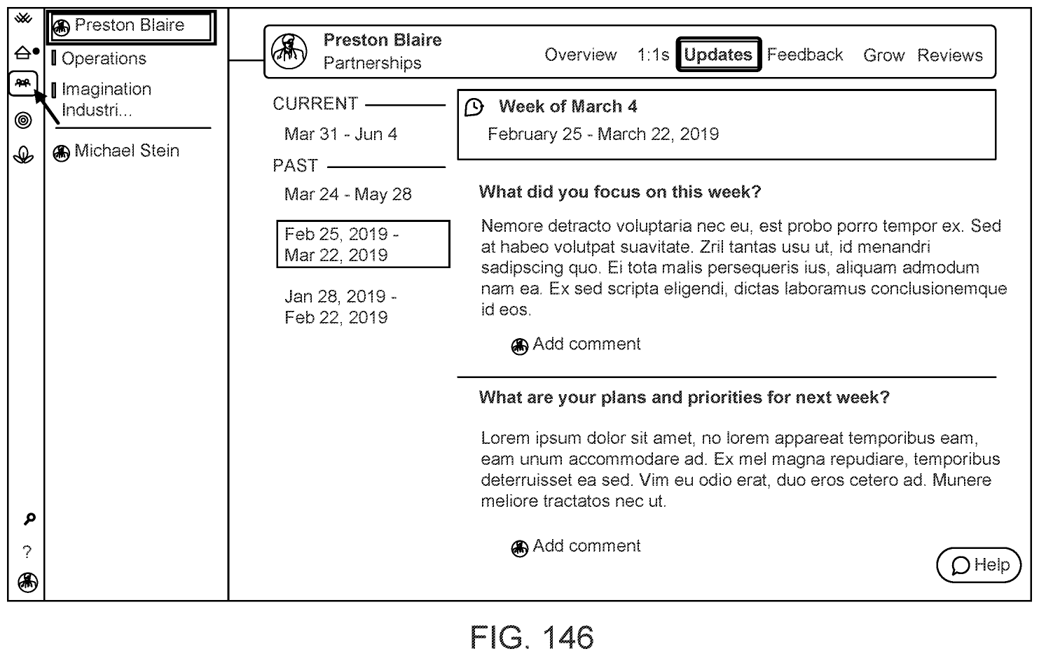

FIG. 146 is a schematic of a user interface displaying an updates page containing a list of updates which may be edited.

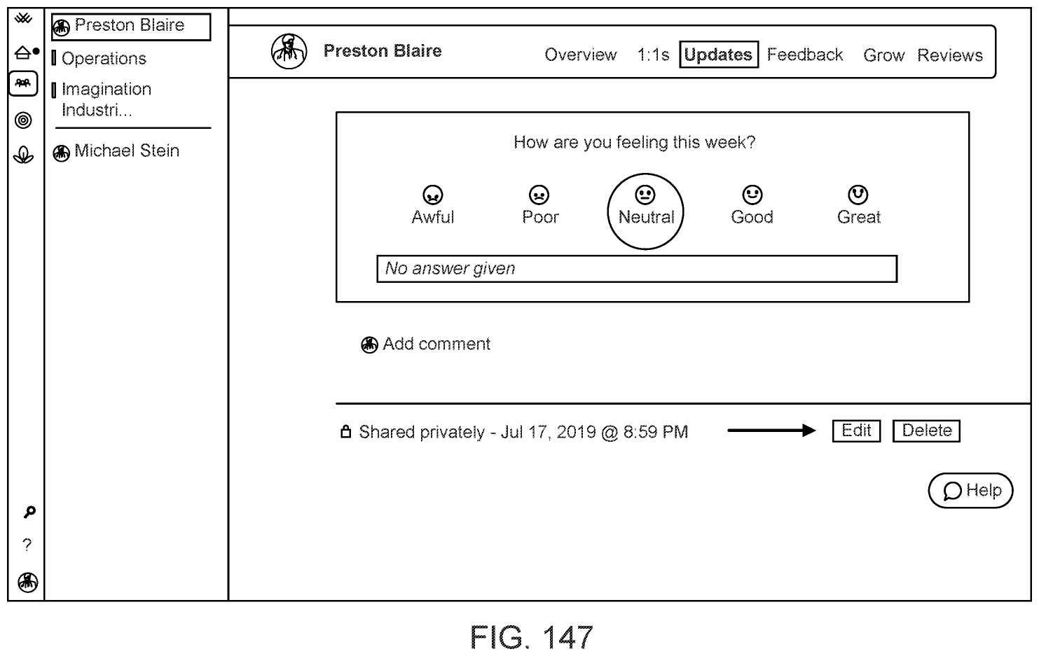

FIG. 147 is a schematic of a user interface displaying an updates page with the option to edit the update.

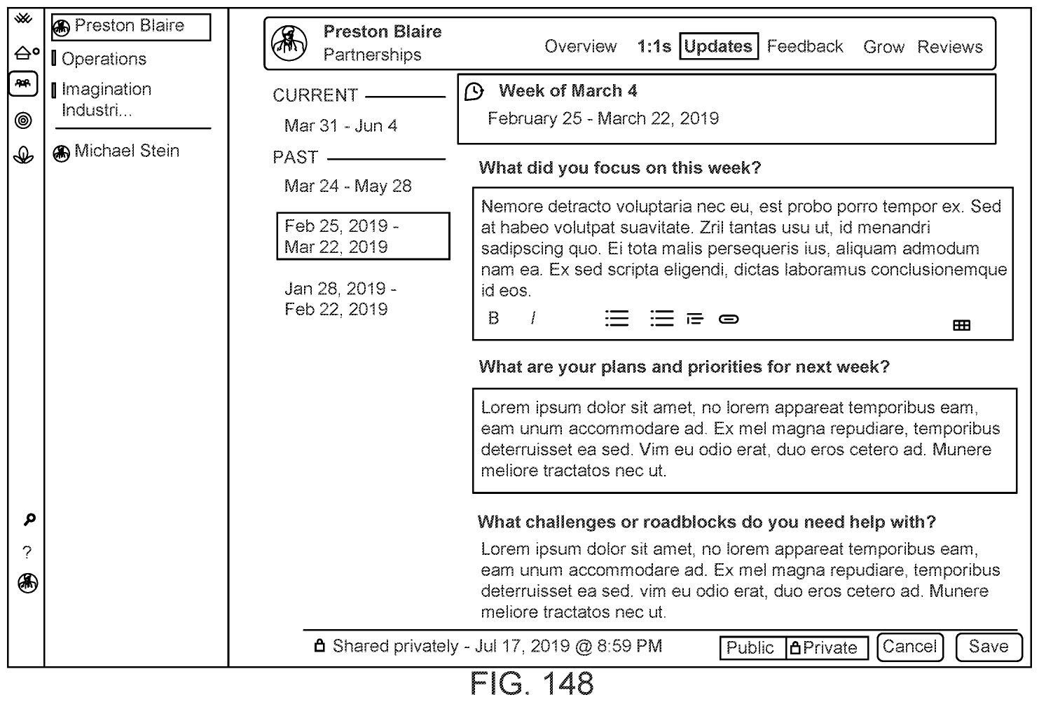

FIG. 148 is a schematic of a user interface displaying a page for editing an update.

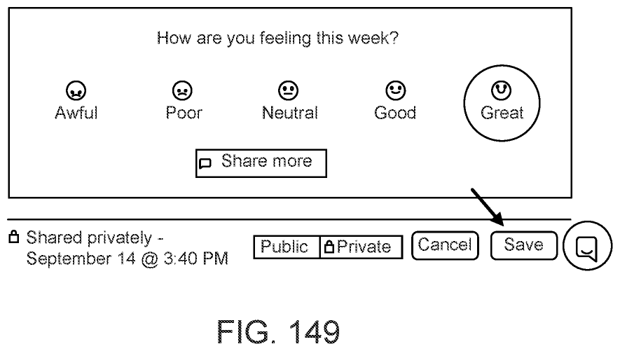

FIG. 149 is a schematic of a portion of a user interface displaying the option to save edits to an update.

The following are steps to edit a submitted update:
1. On your Home page, select People.
2. Click on Updates from the Performance toolkit and select an update you would like to edit.
3. Scroll down on the update and click on Edit. From here, you can edit what you have written, change the rating on your sentiment score, and/or make the update public or private.
4. Once you have made all of the necessary changes, click Save.

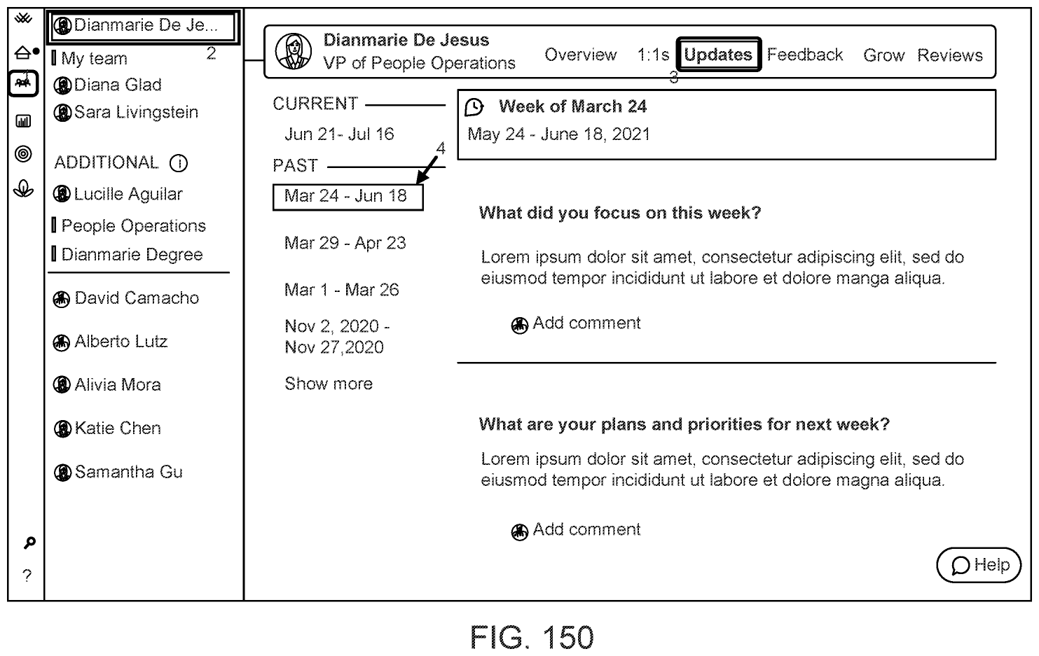

FIG. 150 is a schematic demonstrating how to navigate a user interface to select an update from the updates page.

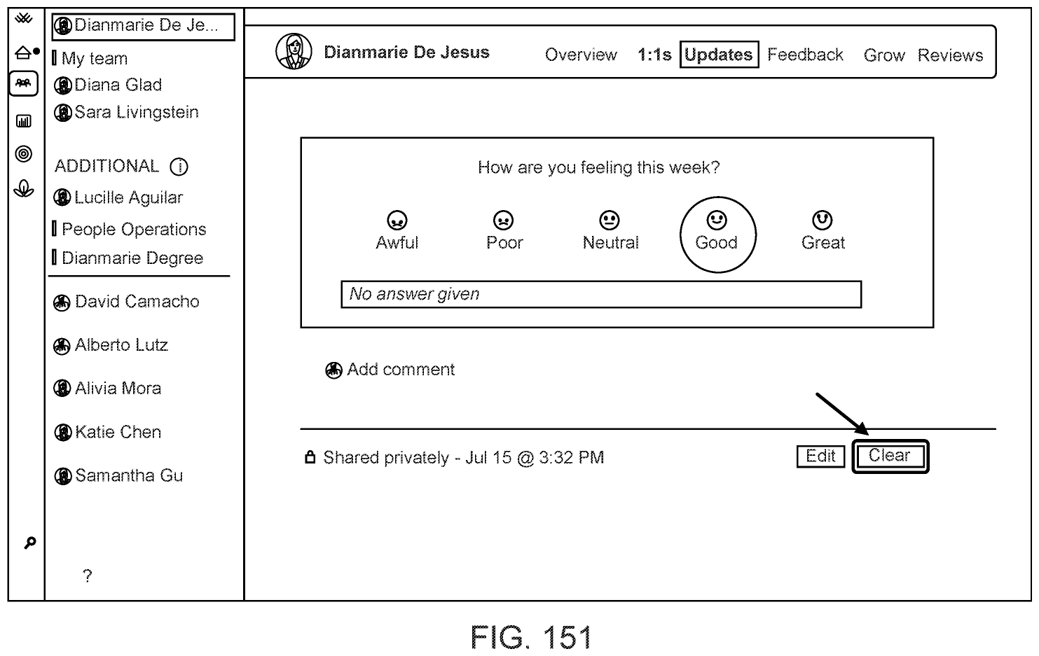

FIG. 151 is a schematic of a user interface displaying an update page containing the option to clear the update.

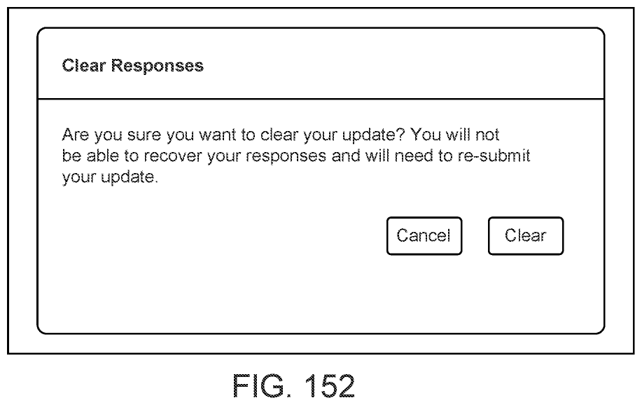

FIG. 152 is a schematic of a confirmation message for clearing an update.

While editing allows you to change a submitted update, clearing will completely remove all text from your update. You will no longer be able to access your previous submission, so please be sure that you intend to remove this update before clearing it.

Please note, you will only be able to clear an update that your manager has not reviewed.

The following are steps to delete an update:
1. Navigate to People>Your Profile>Updates and click on the desired update.
2. Click on the Clear button at the bottom of your update.
3. A confirmation message will appear-select Clear to confirm.
4. Resubmit your update.

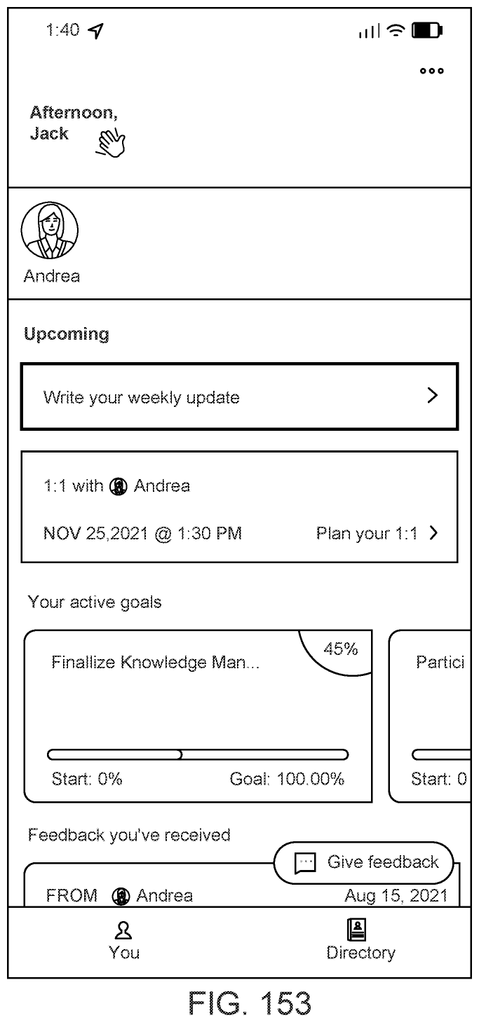

FIG. 153 is a schematic of a mobile user interface displaying a home page containing the option to access the updates toolkit.

You can access the Updates tool from your Home page within the system's mobile application. Click anywhere within the white box that says, “Write your weekly update and view your updates.”

### Writing Your Update

After clicking the Write your weekly update button, you'll see the Update template that your admin or manager has assigned for you to complete. Click into each of the text boxes to write your answers

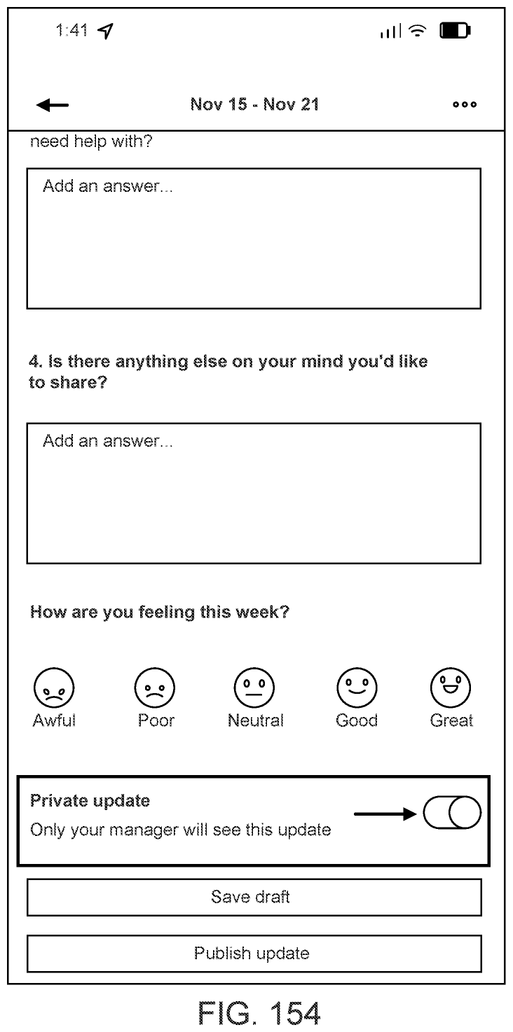

FIG. 154 is a schematic of a mobile user interface displaying the updates toolkit with privacy turned on for the update.

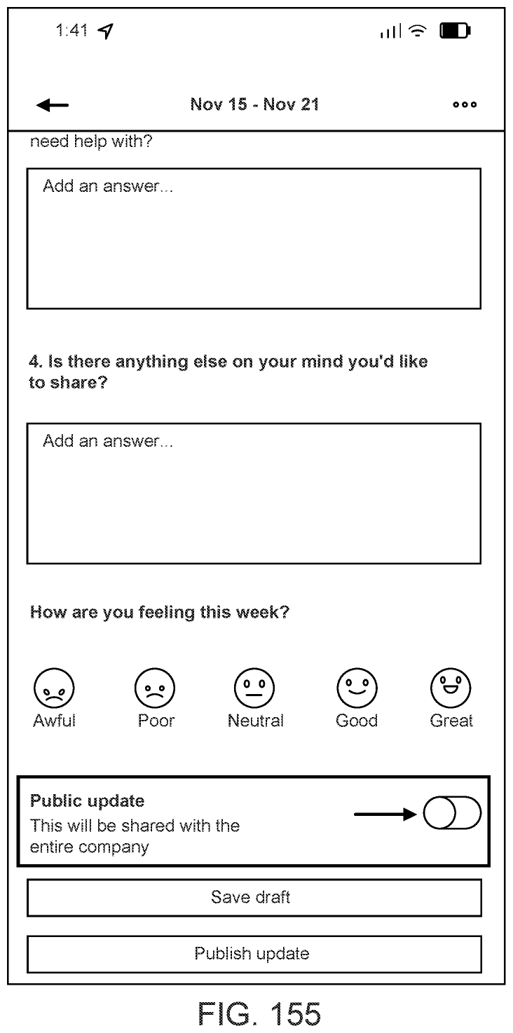

FIG. 155 is a schematic of a mobile user interface displaying the updates toolkit with privacy turned off for the update.

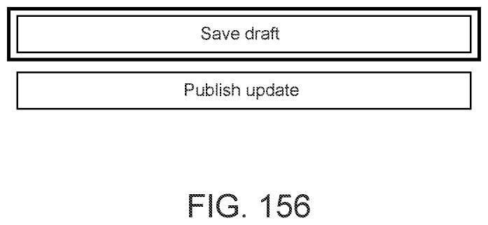

FIG. 156 is a schematic of a portion of a mobile user interface displaying the option to save an update as a draft.

If your company allows, you'll be able to either share your update publicly or privately.

If you're not ready to publish your update, you can select to save what you've written as a draft:

This will take you to a page containing the option to view a past update:

How are You Feeling this Week?

You may or may not be able to share how you're feeling depending upon your admin's configuration of the Updates tool. If you can choose a sentiment score, simply click the smiley face that best describes how you're feeling that week.

### Visibility and Drafting/Publishing

Click the toggle button to determine the visibility of your update. Private updates are only shared with your manager. Public updates will be visible to your entire company. When you've finished writing your update, click either the “Save Draft” button to save your progress for future editing or the “Publish Update” button to submit it.

### Previous Updates

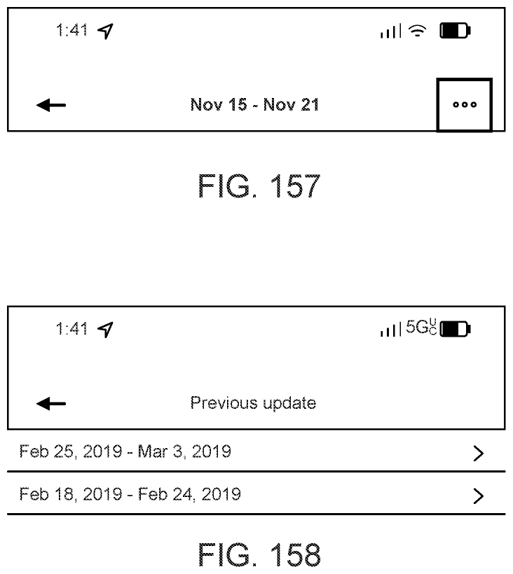

FIG. 157 is a schematic of a portion of a mobile user interface displaying the option to select to view previously published updates.

FIG. 158 is a schematic of a portion of a mobile user interface displaying a list of previous updates.

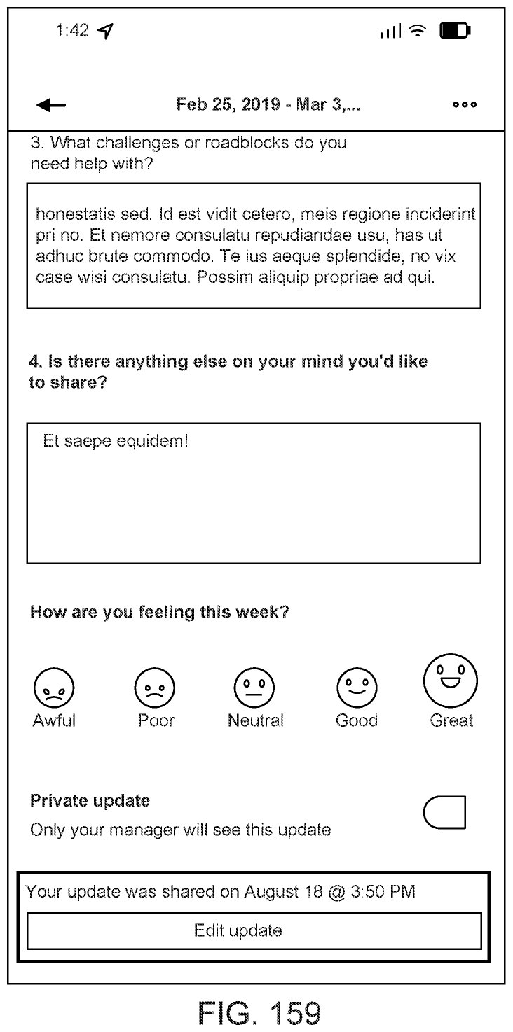

FIG. 159 is a schematic of a mobile user interface displaying a page for editing an update

To navigate to previously published updates, you can select the . . . along the top of your update.

To view a previous update, click anywhere in the row containing the date of the update.

To edit an update, click into the text box and you'll be able to change your response. Be sure to click the blue Edit Update button at the bottom of the page to save your changes.

### Updates Notifications

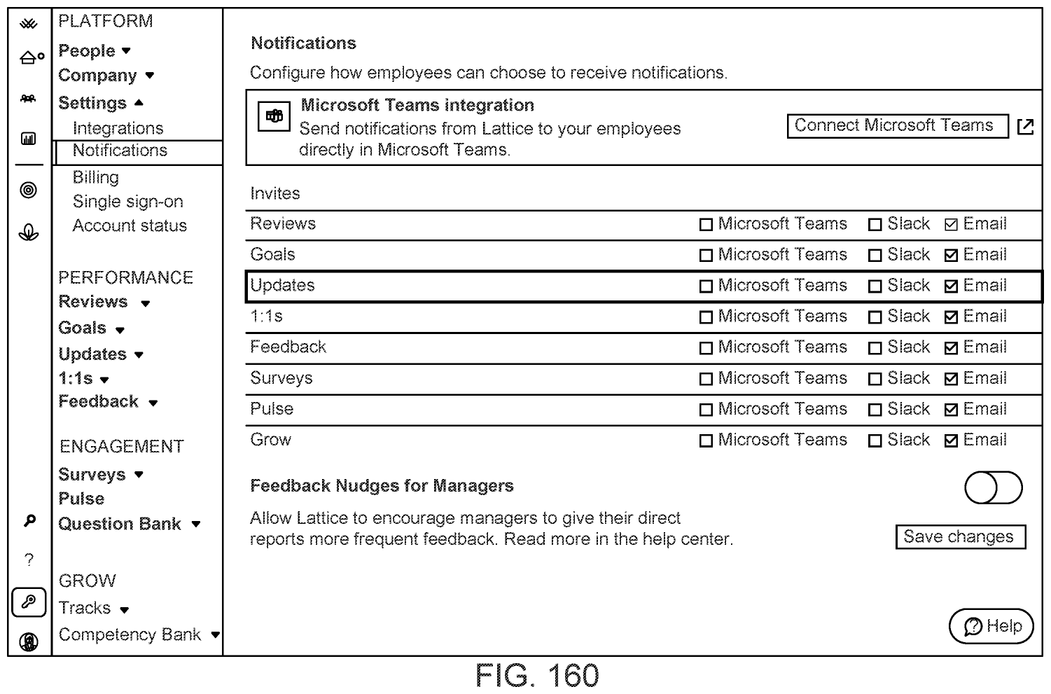

FIG. 160 is a schematic of a user interface displaying a notifications center containing the option to select Slack, Microsoft Teams, or email for updates notifications.

Once you have navigated to the Notification Center, there are a few options for how notifications can be sent when it comes to our Updates tool—through Slack or Microsoft Teams and/or through email.

Updates notifications are sent as follows.
When Updates are first enabled.
When your direct reports submit updates.
When your updates have been reviewed by your manager.
When you haven't submitted an update within the set cadence.
When you receive a comment on an update.

To send these through Slack/Microsoft Teams or email, you can check on the boxes to the right of Updates, as shown in FIG. 160.

Please note. Slack notifications are sent via the system's app. The system's Microsoft Teams App will appear on your Microsoft Teams apps.

### Turning on Updates

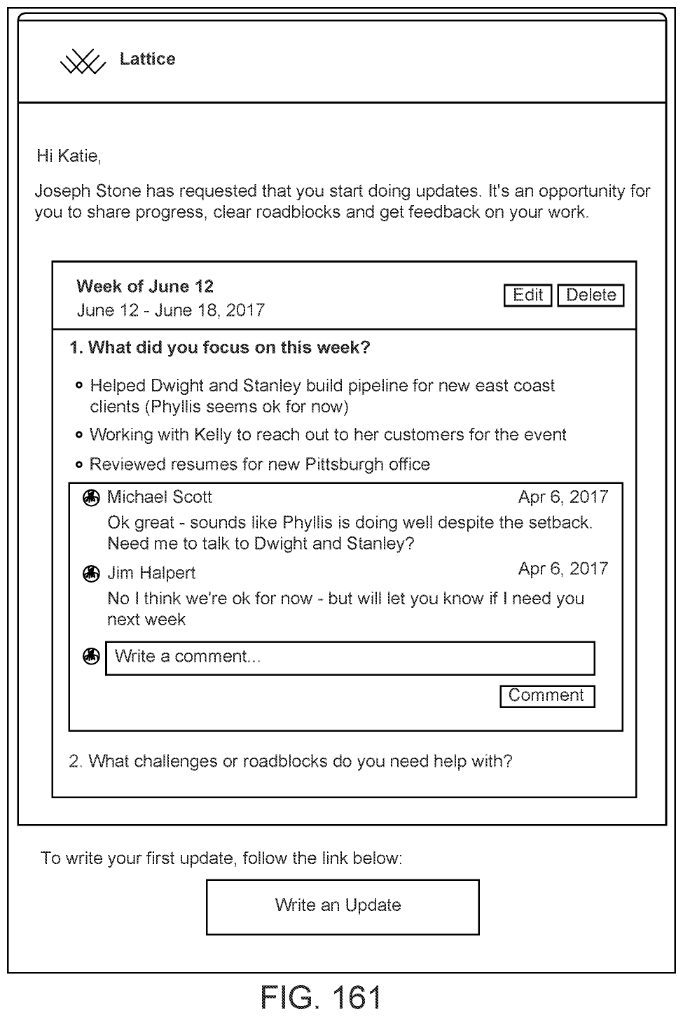

FIG. 161 is a schematic of an email notification indicating that updates have been turned on for an employee.

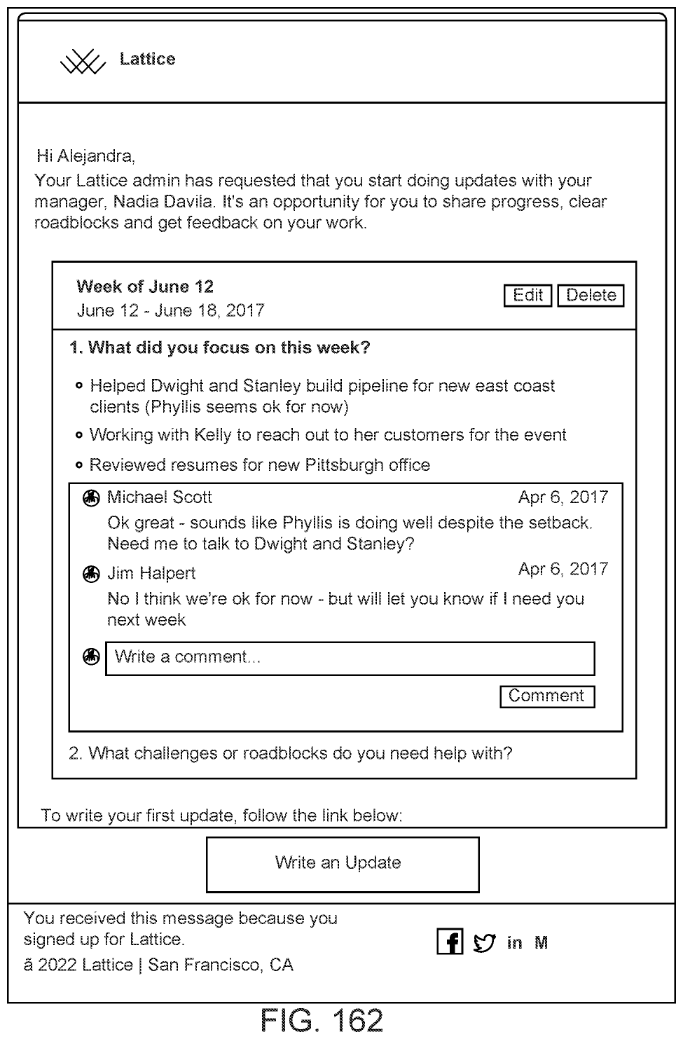

FIG. 162 is a schematic of an email notification indicating that updates have been turned on for an employee who has not had updates turned on before.

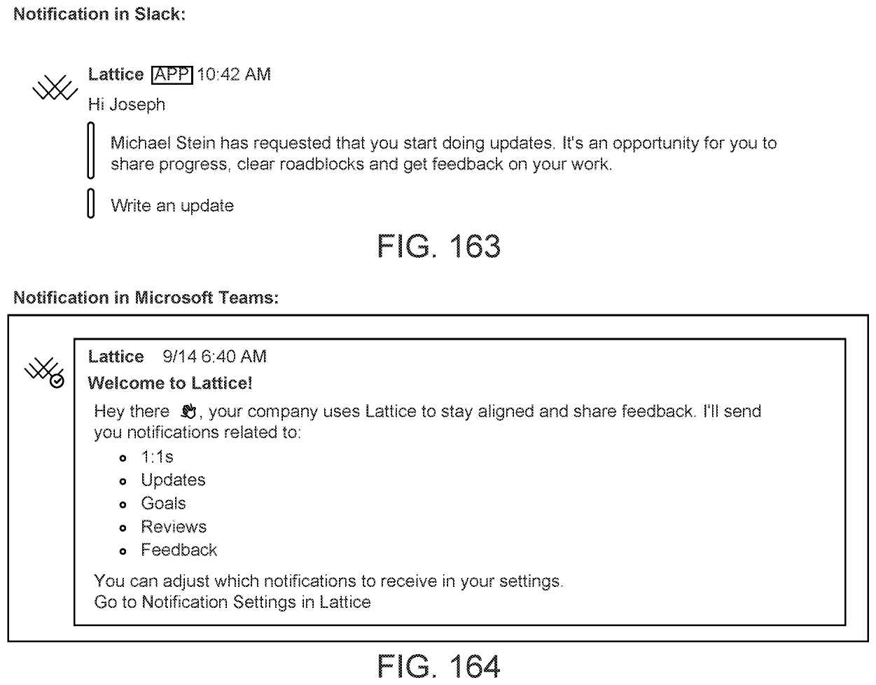

FIG. 163 is a schematic of a Slack notification indicating that updates have been turned on for an employee.

FIG. 164 is a schematic of a Microsoft Teams notification indicating that updates have been turned on for an employee.

Once a manager turns on Updates for their employees, the employee will receive the notification displayed in FIG. 161.

If the admin turns on Updates for employees that haven't had Updates turned on before, the employee will receive the notification displayed in FIG. 162.

### Direct Report Submits an Update

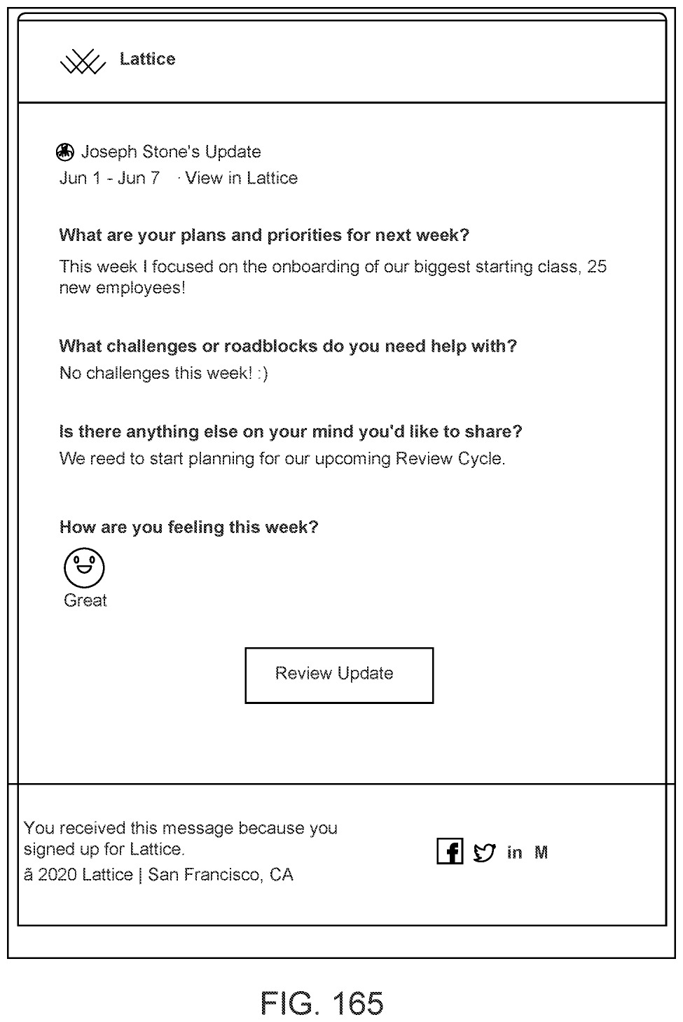

FIG. 165 is a schematic of an email notification containing a link to view an update submitted by an employee.

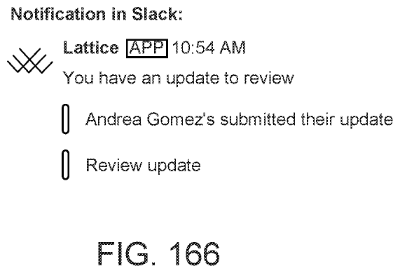

FIG. 166 is a schematic of a Slack notification containing a link to view an update submitted by an employee.

Once the employee has submitted the update, the manager will receive a notification with a link to the submitted responses.

Update has been Reviewed by a Manager

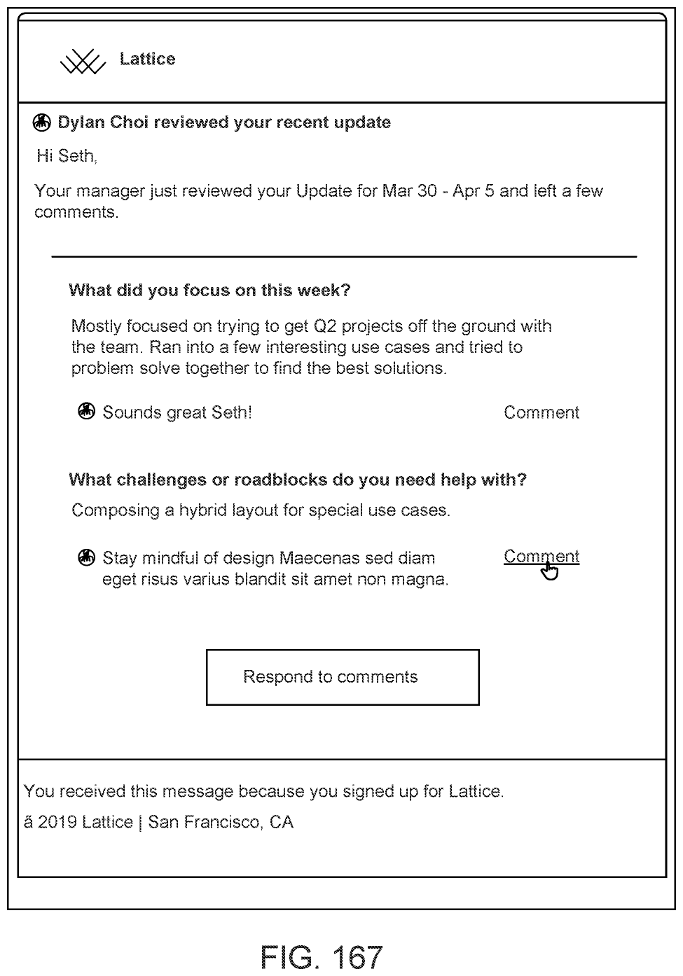

FIG. 167 is a schematic of an email notification indicating that a manager has reviewed an update made by an employee.

Reports will receive a notification letting them know that their manager reviewed their update.

### Update Reminders

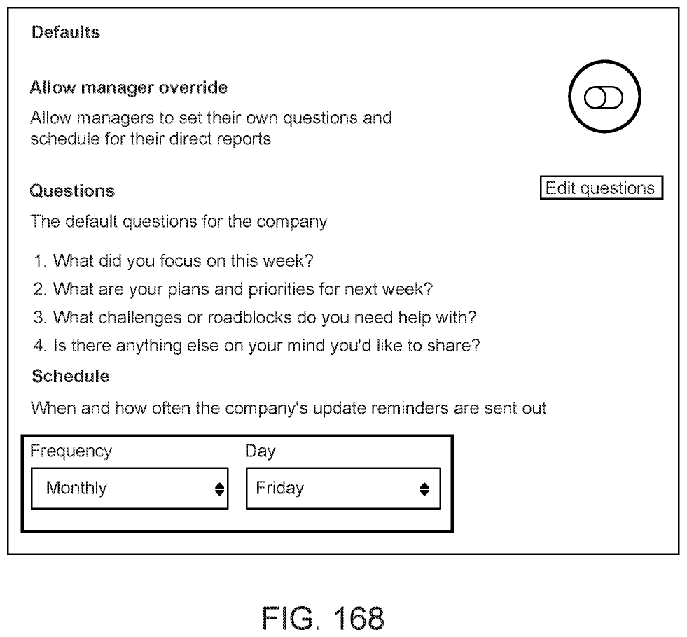

FIG. 168 is a schematic of a user interface displaying an updates settings page containing the option to set a cadence for updates reminders.

Employees will receive a reminder through the system to complete their updates.

Update reminder notifications will only go out to the employee if they have not submitted an update by the day the notification is set to go out. For example, if the notifications are set for Fridays, but an update is submitted before Friday, then the user will not receive the reminder notification

Additionally, the date the reminder is set to go out does not determine when the update itself is generated. All updates are generated on Mondays.

Update reminders can be set at a few different levels. Currently, Update reminders are sent at 9 AM PST. If the manager override is of then everyone at the company will receive reminders based upon the cadence set in the Updates settings in the Admin page.

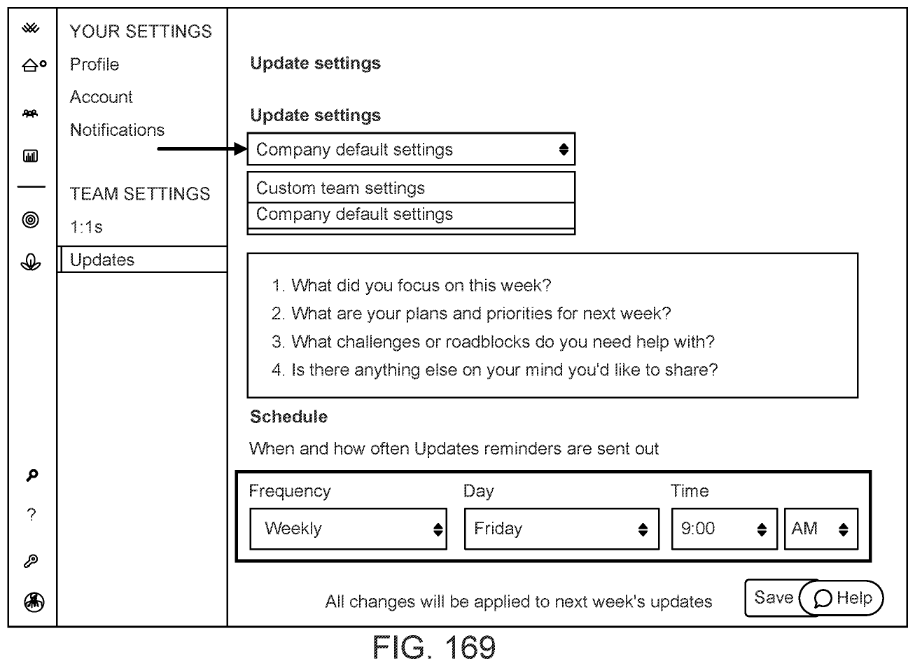

FIG. 169 is a schematic demonstrating how to navigate a user interface to update updates settings when manager override is on.

If the manager override is on, managers can set a team-wide default in their Update Settings section by navigating to People>My team>Updates>Settings. They will also have the option to switch to the company defaults.

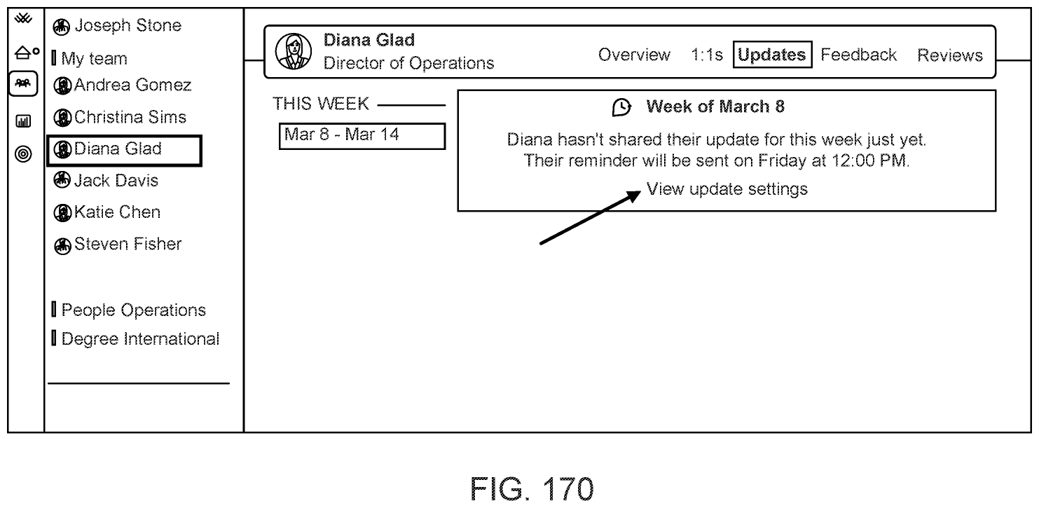

FIG. 170 is a schematic of a user interface displaying an updates page for an employee containing a link to view updates settings.

Managers can set custom settings for the cadence of reminder updates for each of their direct reports by navigating to the ellipsis next to their name on the People page.

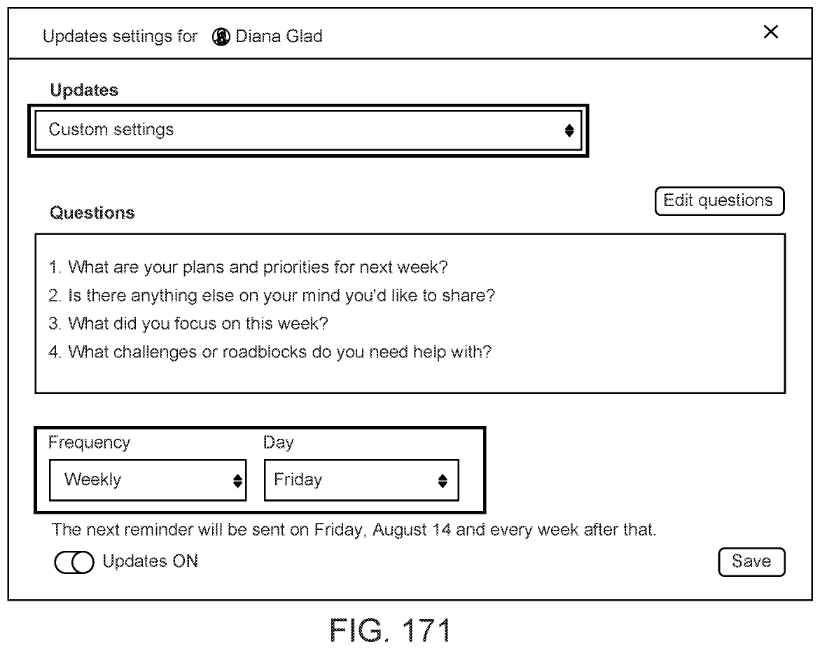

FIG. 171 is a schematic of a user interface displaying an updates settings page for an employee.

From the updates settings page you can select to manage the update settings, select custom settings, and set the cadence.

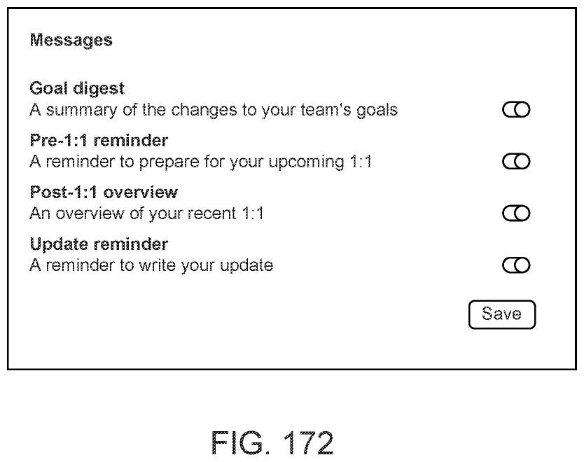

FIG. 172 is a schematic of a portion of a user interface displaying a notifications settings page with the option to toggle on/off the update reminder.

Individual users have the power to enable or disable Update reminders for themselves. To enable or disable the Update reminder notifications, navigate to Account>Manage Settings>Notifications and toggle on/off the Update reminder.

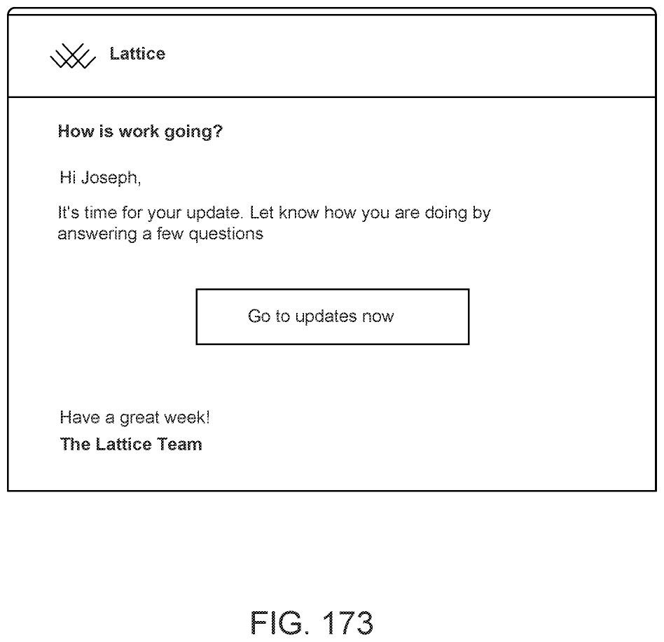

FIG. 173 is a schematic of an email notification containing a reminder to submit an update.

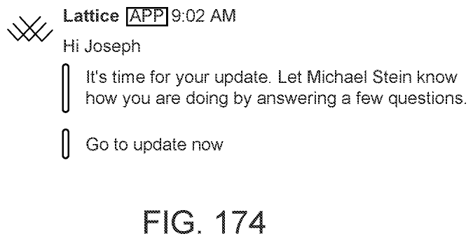

FIG. 174 is a schematic of a Slack notification containing a reminder to submit an update.

### Receiving a Comment on an Update

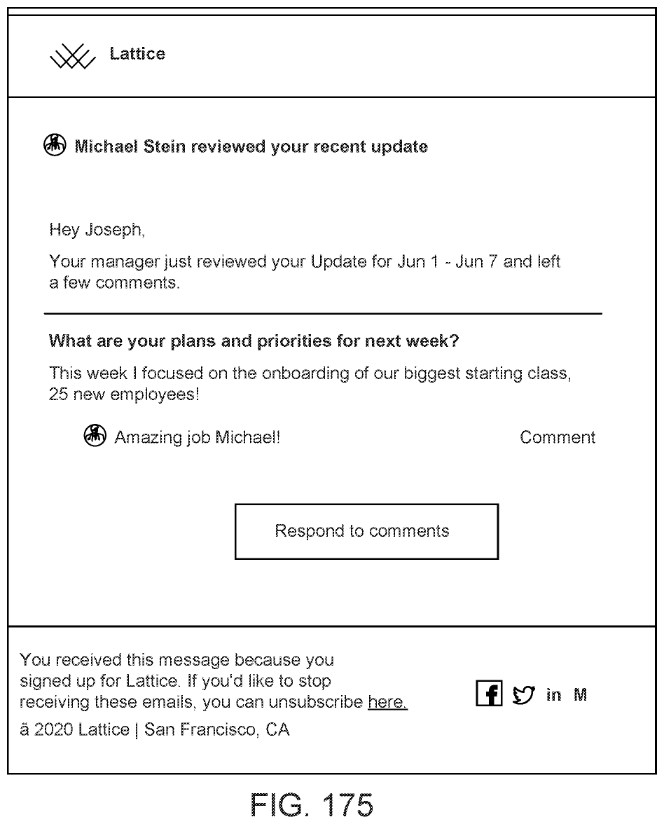

FIG. 175 is a schematic of an email notification indicating that a manager left a comment on an update made by an employee.

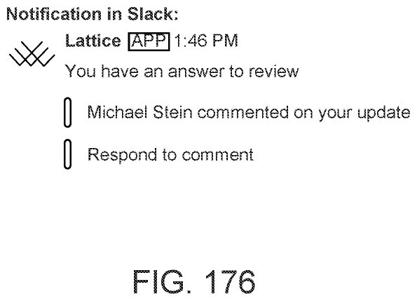

FIG. 176 is a schematic of a Slack notification indicating that a manager left a comment on an update made by an employee.

If the employee and/or manager comment back and forth on the update, then the notification shown in either FIG. 175 or 176 will be sent to the relevant recipient.

Set Up Updates with Your New Direct Report

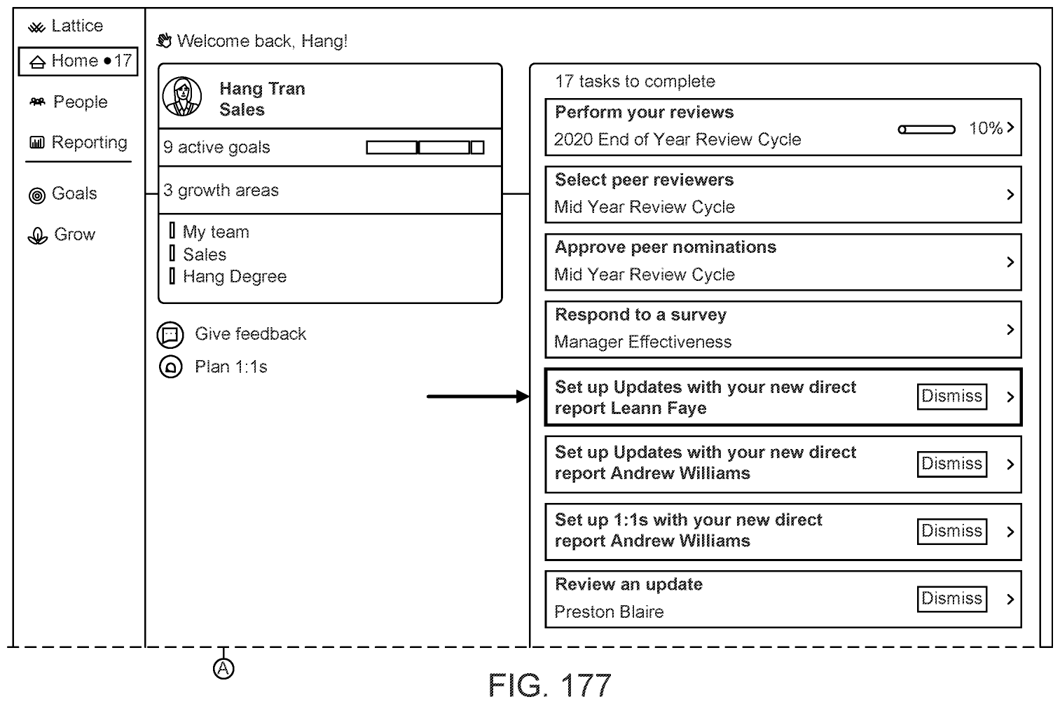

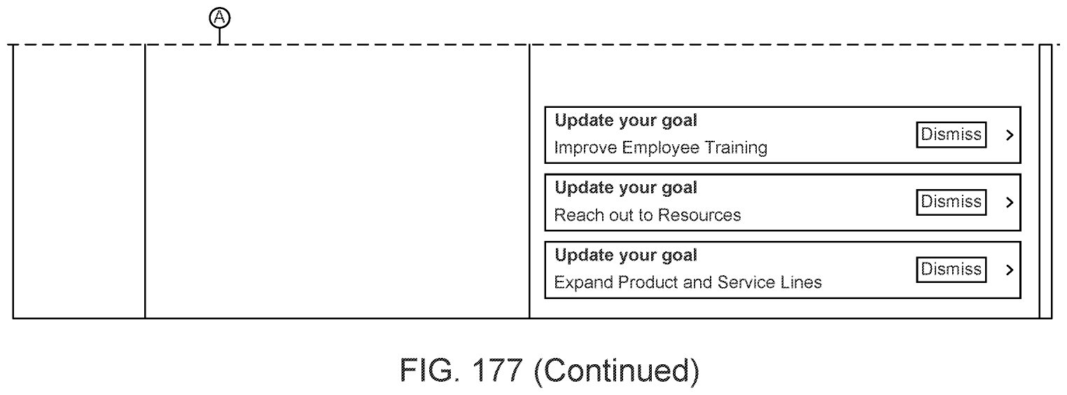

FIG. 177 is a schematic of a user interface displaying a task list for a manager including a task prompting the manager to set up updates with a new report.

A manager will receive a task for updates in two scenarios:
1. The manager has a new direct report.
2. A direct report has submitted an update.

Managers will receive a task when a new hire joins the team as a new direct report. This task will prompt managers to set up updates with their new report. This notification is dismissible, meaning you can dismiss the task without completing the action.

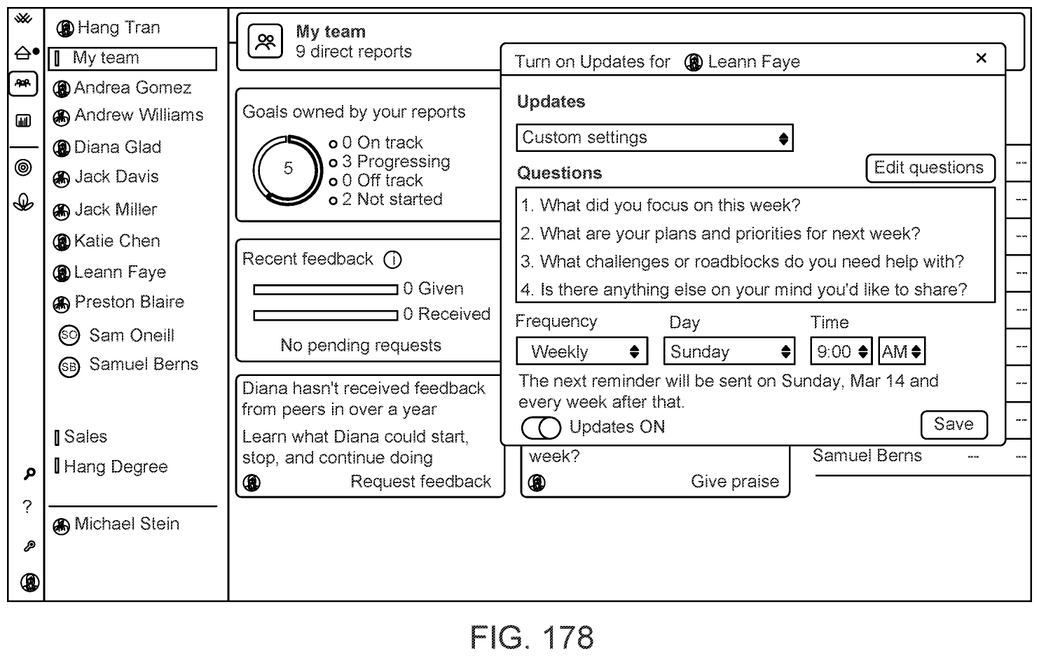

FIG. 178 is a schematic of a user interface displaying a modal containing the option to set up questions and settings for a new report.

When a manager selects this task, they will be taken into a modal where they can set up the questions and settings for their new hire.

### Review an Update

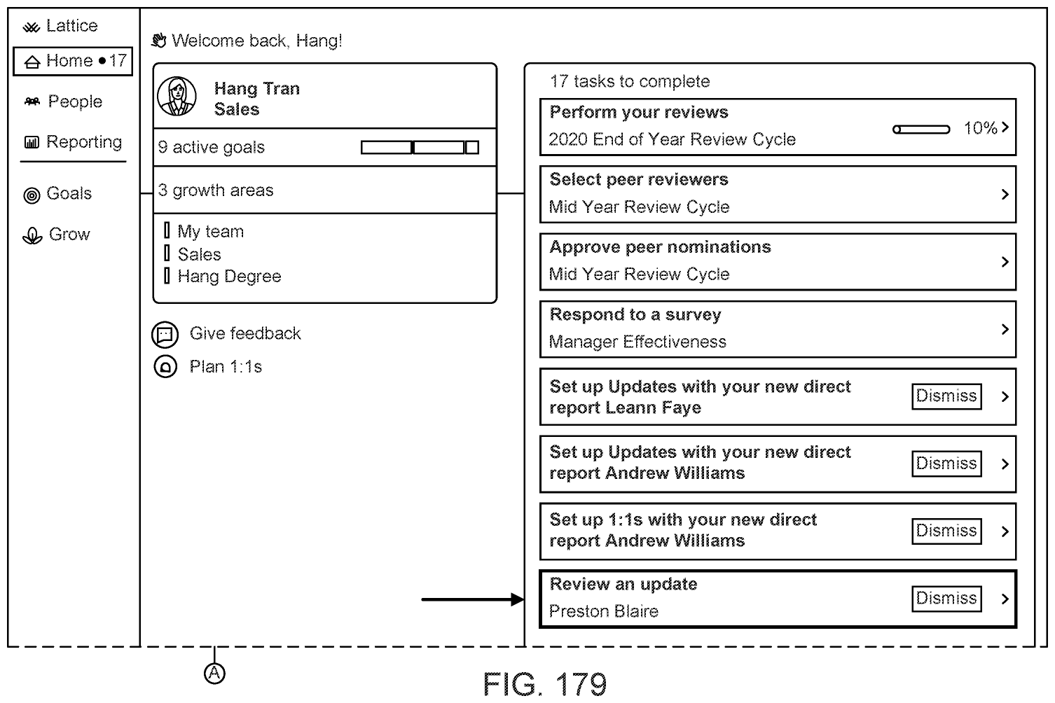

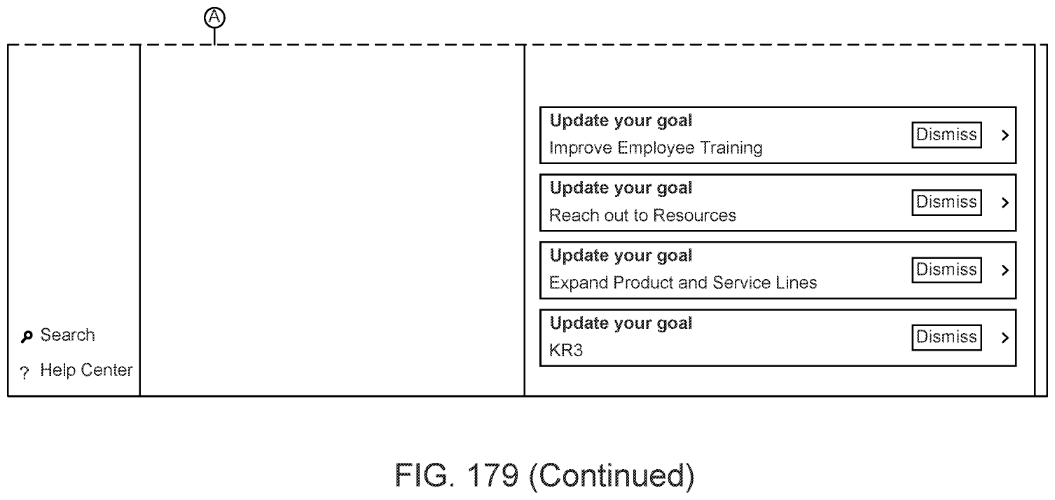

FIG. 179 is a schematic of a user interface displaying a task list for a manager including a task prompting the manager to review an update.

Once an employee has submitted their update, the manager will get a task in the system titled “Review an update.” This task prompts managers to interact with their report's submitted update. Like the prior task for updates, this task is also dismissible.

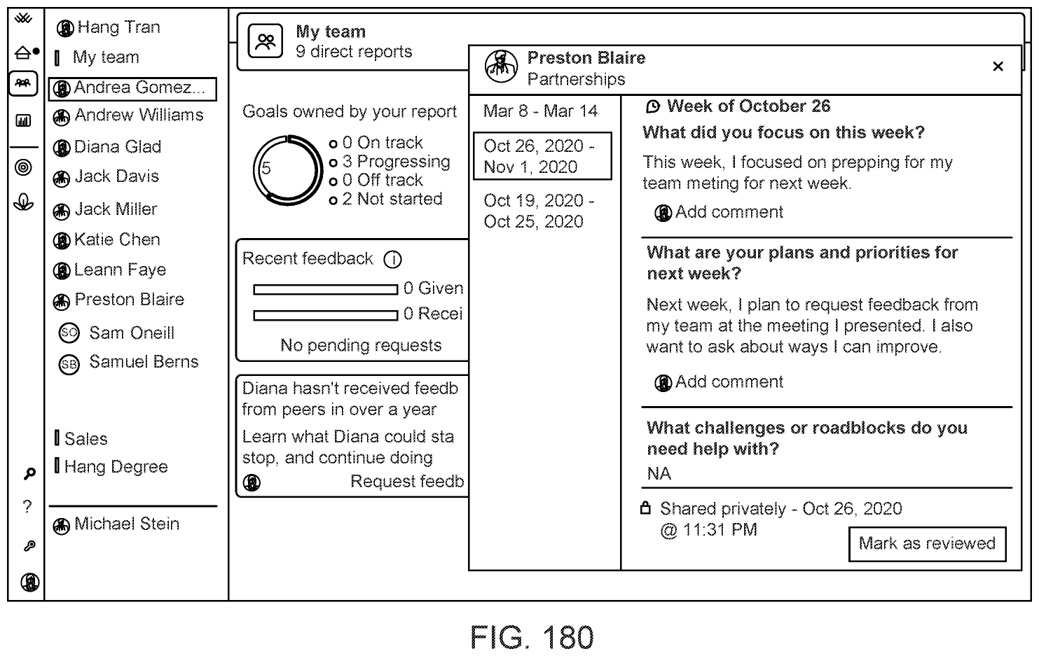

FIG. 180 is a schematic of a user interface displaying a modal for reviewing an update submitted by an employee.

Once you select Review an update, a modal will open where you're able to review the update.

### Feedback for Admins

The system allows you to turn on feedback for your entire organization or a smaller group of users. The system provides the flexibility you need to help facilitate a phased rollout of the tool if you choose to do so.

In example embodiments, if you disable feedback, employees will still have visibility into any previously shared feedback, and admins will still have access to reporting.

### Adjust Your Activation Settings

The following are steps to adjust activation settings.
1. Navigate to Admin>Feedback>Settings.
2. Under Activation Settings, select whether you would like the tool enabled for all employees, a specific set of employees, or disabled altogether.
3. If you choose to only turn on feedback for a subset of employees, you will need to select employees by department or user attributes. This will prevent any user not assigned the selected attribute from having visibility into the tool.
4. Select Save

FIG. 181 is a schematic demonstrating how to navigate a user interface to view feedback settings.

The Feedback Settings is a centralized location for feedback settings Controls within the settings are quickly and easily accessible to enable the Feedback tool, adjust visibility, and more.

Admins can find the Feedback Settings by navigating to Admin>Feedback>Settings.

The following can be accomplished within the Feedback Settings page:
Enable or disable the Feedback tool.
Customize feedback visibility options.
Enable external feedback.
Enable feedback nudges.
View the public praise wall.

Employees can give each other public or private feedback directly in the system. As an admin, you have the option to customize the permitted feedback types for your organization.

### Feedback Types

The following visibility options are available for employees when giving feedback:
Public: Praise visible to the entire company.
Private: Only visible to the recipient of the feedback
Private+manager: Only visible to the recipient and their manager.
Manager only: Only visible to the recipient's manager.

Note: When customizing options, you must enable at least one form of private feedback.

### Customize Feedback Types

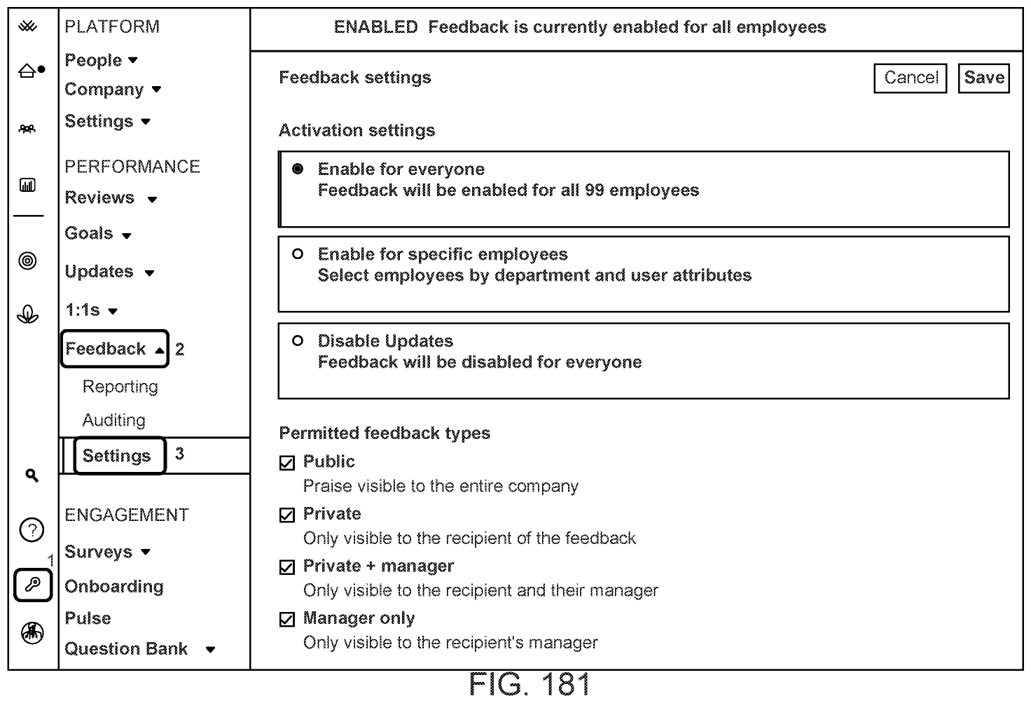

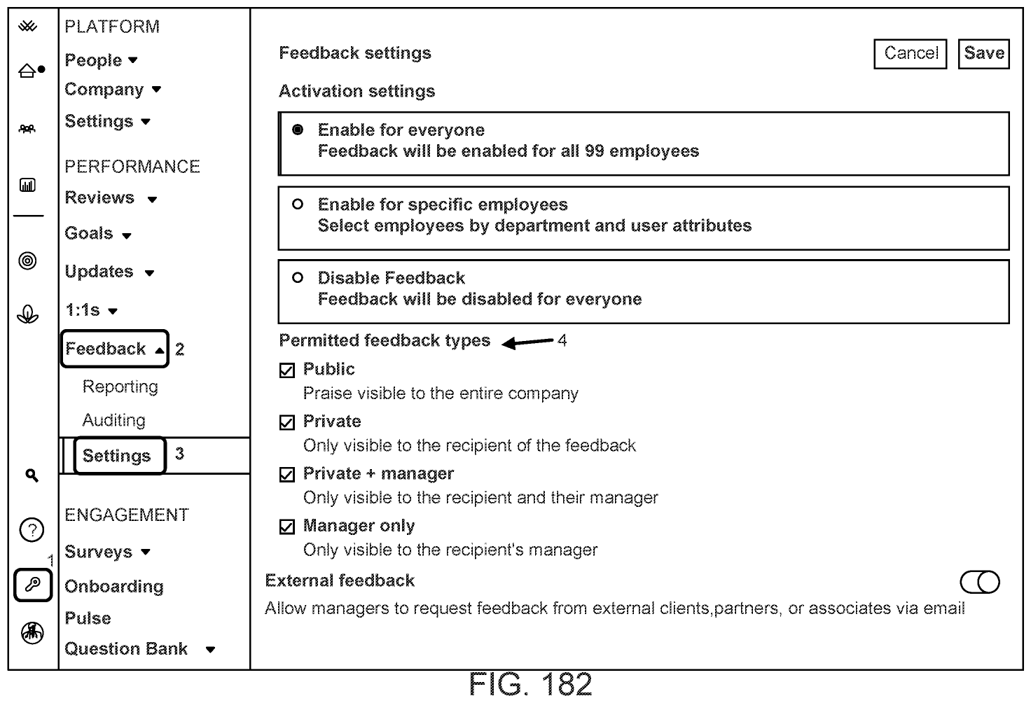

FIG. 182 is a schematic demonstrating how to navigate a user interface to customize feedback types.

The following are steps to customize feedback types:
1. Navigate to Admin>Feedback>Settings.
2. Under Permitted feedback types, check the boxes for the types of feedback available to employees.
3. Select Save.

### Giving Feedback: Employee View

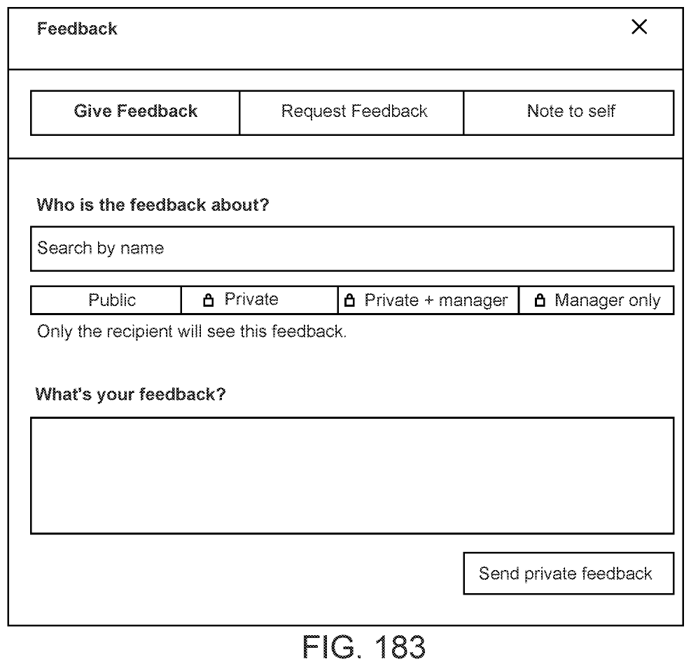

FIG. 183 is a schematic of a user interface displaying a feedback tool containing the option to select the visibility of feedback.

If you have all types of feedback on, employees will be able to select the visibility when using the Feedback tool.

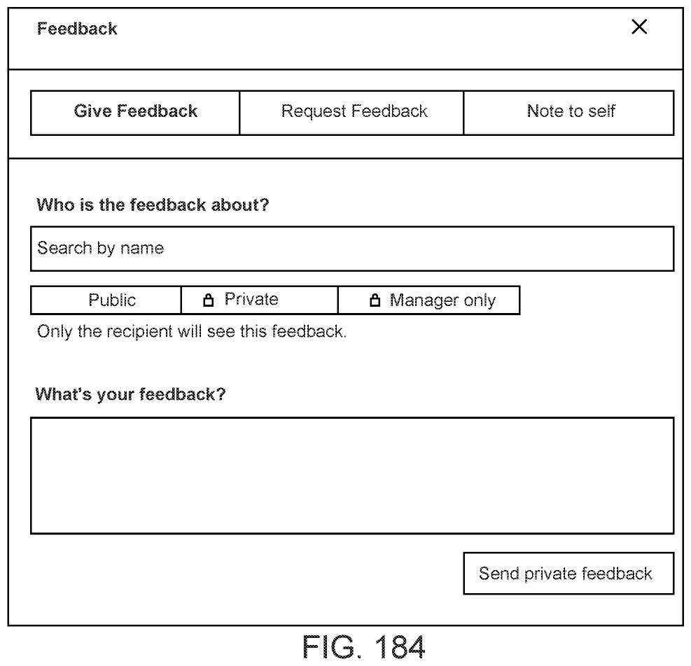

FIG. 184 is a schematic of a user interface displaying a feedback tool with the private+manager feedback type disabled

If you have not selected a specific type of feedback, that option will not be available to employees when giving feedback. The example below shows the Feedback tool if the Private+Manager type was disabled.

### Enable External Feedback

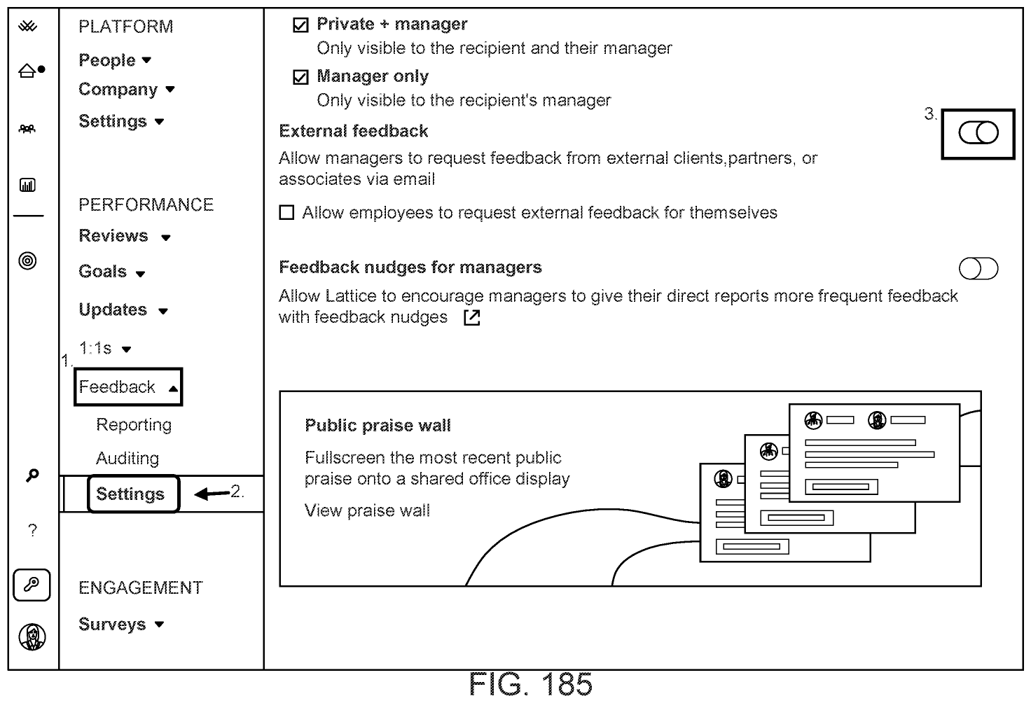

FIG. 185 is a schematic demonstrating how to navigate a user interface to toggle on/off external feedback.

As an admin, you have the option to enable (or disable) external feedback for your organization. If your company crowdsources feedback from external partners or associates, you can use the external feedback functionality to have managers and admins request feedback via email to those external individuals.

The following are steps to enable or disable external feedback for your organization:
1. Navigate to Admin>Feedback>Settings.
2. Under External feedback, toggle on or off the switch to enable or disable external feedback.
3. (optional): Check the checkbox to allow employees to request external feedback for themselves.

### Feedback Nudges

Feedback nudges are automated notifications sent to managers encouraging them to submit public feedback about their direct reports.

If a manager receives a nudge and does not submit public feedback, they will not receive additional follow-up reminders. They will receive their next nudge after another 60 days without praise has passed.

### Why Use Nudges?

It's important to praise publicly to maintain a positive company culture. Encouraging your managers to submit praise as public feedback in the system will ensure that they are actively reinforcing their team members' positive behaviors. The occasional nudge will motivate managers to set an example that fosters a culture of public praise.

If enabled by an admin, there are two conditions that will generate notifications:
1. Three weeks have passed since an employee's start date
2. 60 days has passed since a direct report has received praise from their manager.

Note: Feedback given in the system can be referenced during 1:1 meetings and reviews. In those contexts, it provides a valuable point of reference for employee performance and behavior.

### Enable Nudges

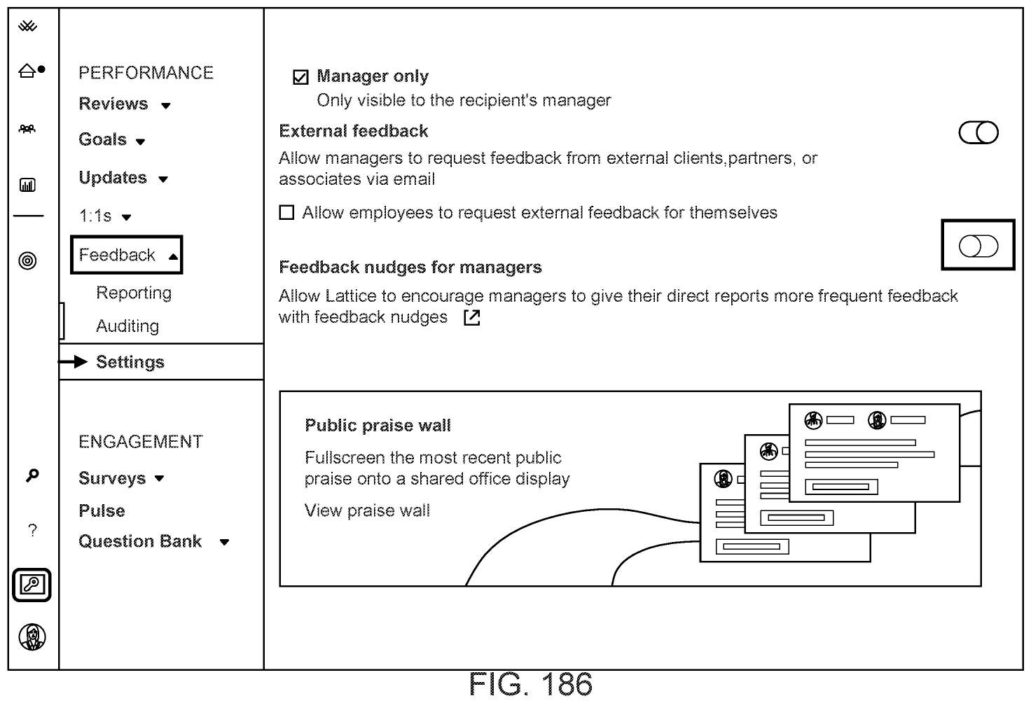

FIG. 186 is a schematic demonstrating how to navigate a user interface to toggle on/off feedback nudges for managers.

The following are steps to enable feedback nudges from the Feedback Settings page:
1. Navigate to Admin>Feedback>Settings.
2. Under Feedback nudges for managers, turn the toggle on.
3. Click Save.

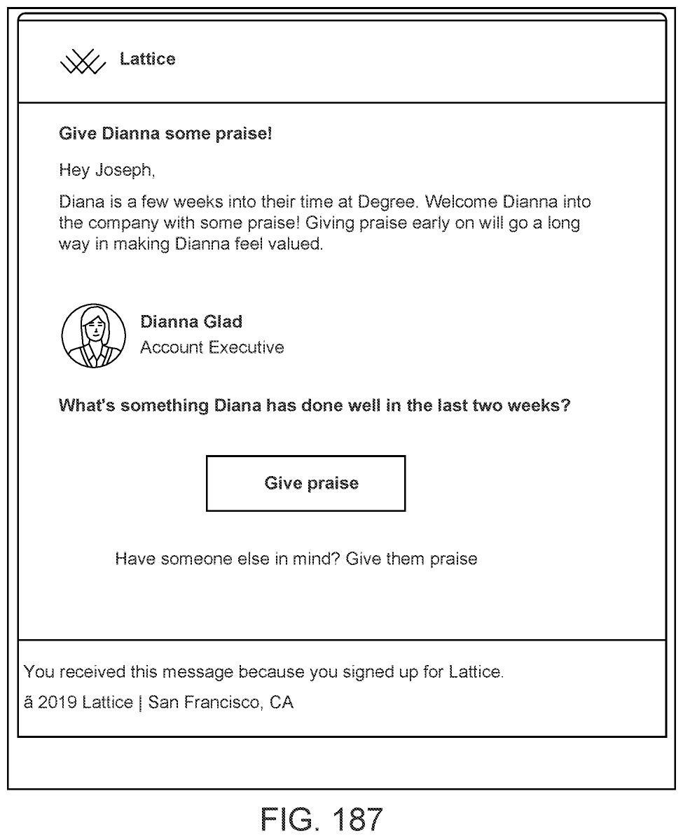

FIG. 187 is a schematic of an email notification containing a nudge given three weeks after an employee's start date.

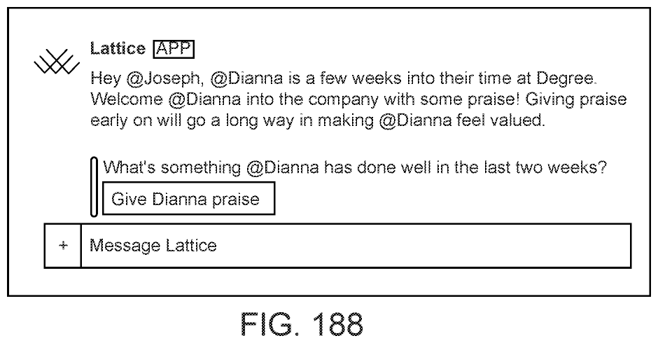

FIG. 188 is a schematic of a Slack notification containing a nudge given three weeks after an employee's start date.

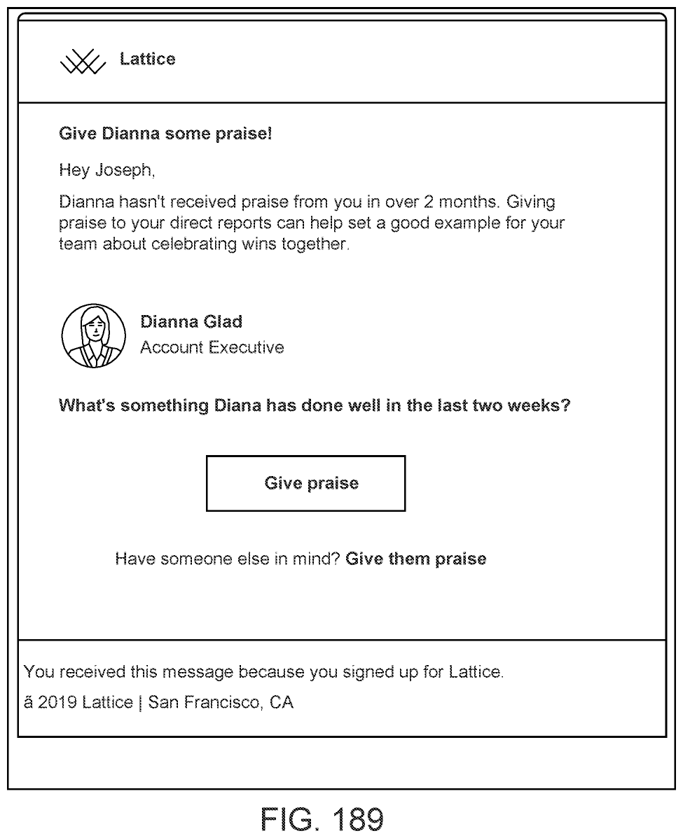

FIG. 189 is a schematic of an email notification containing a nudge given if a direct report has not received praise in 60 days.

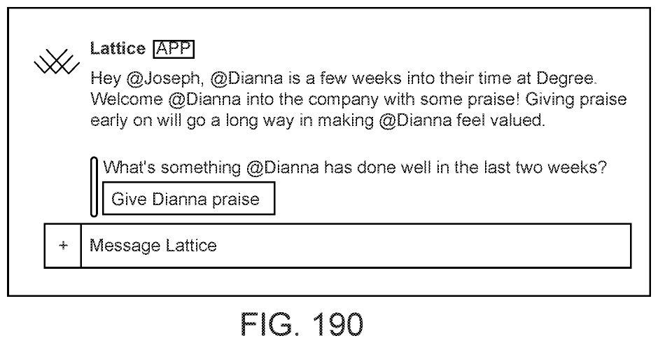

FIG. 190 is a schematic of a Slack notification containing a nudge given if a direct report has not received praise in 60 days.

### Display Public Praise

To cast your praise wall, an HDMI cable may be used. Your account may be mirrored through a wireless connection if your computer and smart TV have the capability.

Please note: You must be logged into the system to display the public praise wall.

Non-admins can access the praise wall by heading to [DOMAIN].latticehq.com/wall where the domain is your organization's company domain. Ex: Where degree is the company domain in degree.latticehq.com.

Note, you will need to be logged into the system to access the praise wall.

FIG. 191 is a schematic demonstrating how to navigate a user interface to access the praise wall as an admin.

The following are steps to access the praise wall as an admin
1. Navigate to Admin>Feedback>Settings.
2. Scroll down and select View praise wall.

From there it will bring you to a slideshow presentation of feedback to display publicly. The wall will cycle through the 20 most recently submitted pieces of public feedback in your system domain.

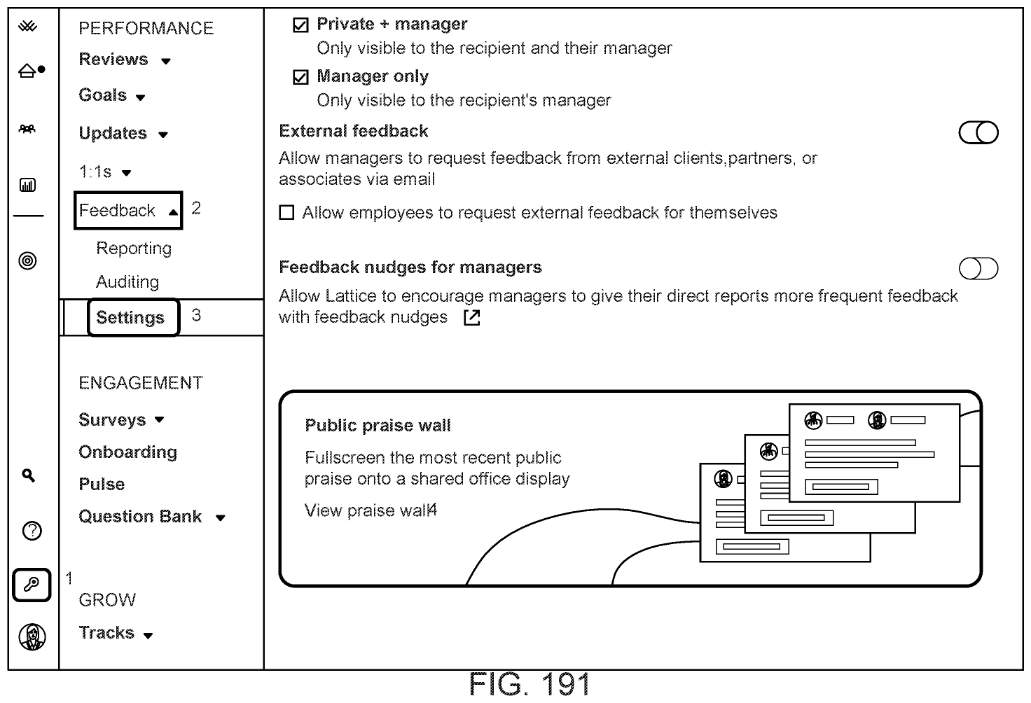

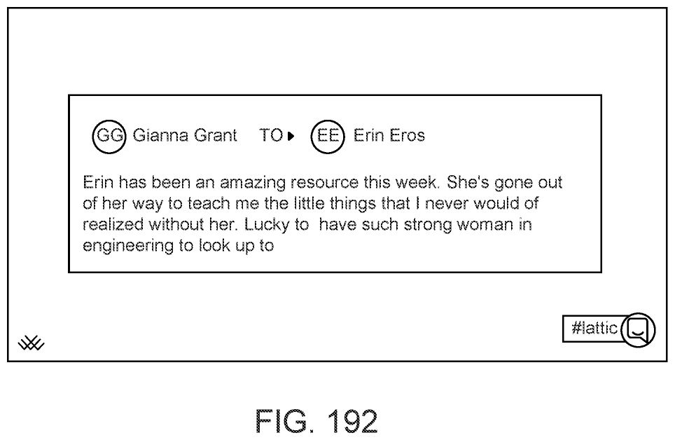

FIG. 192 is a schematic of an example slide from the praise wall slideshow presentation.

Admins have visibility into the analytics for their organization's feedback to ensure that managers and direct reports utilize the tool to help maintain your company's feedback culture.

The following users can see the Feedback Adoption page:
Admins will have access to the company's adoption page from the Admin page view
Managers will have access to their team's reporting and auditing views from the Reporting page via the Discovery Navigation, except for the Auditings Pending requests tab.
Managers of managers will see their direct and indirect report's reporting and auditing views from the Reporting page via the Discovery Navigation, except for the Auditings Pending requests tab.
Employees with custom role permissions can access their assigned group's reporting view from the Admin page.

### Feedback Adoption Page

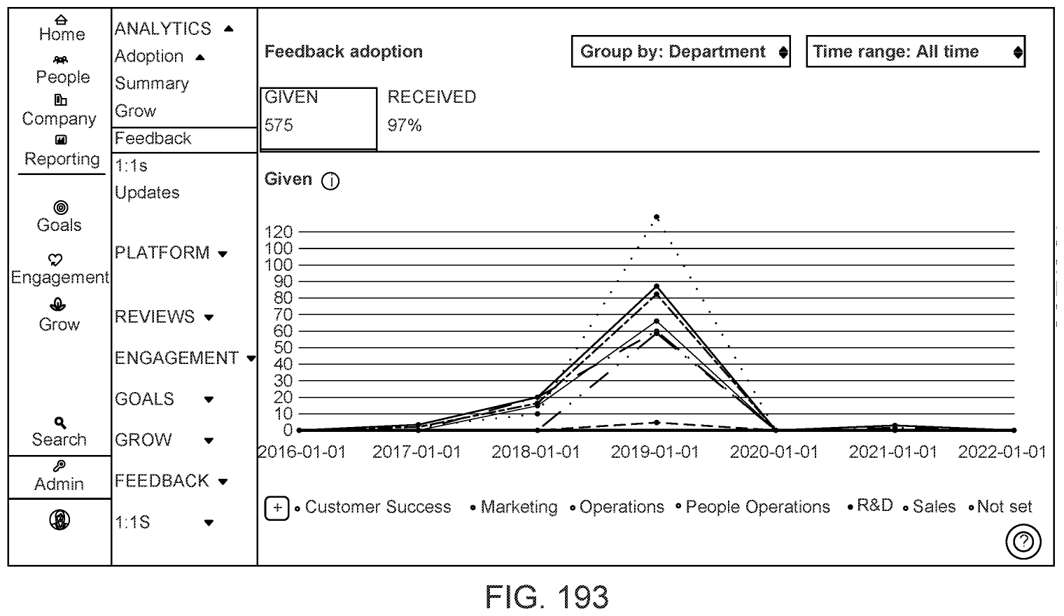

FIG. 193 is a schematic of a user interface displaying a feedback reporting page containing a graph of given feedback adoption.

The Feedback reporting page will give you a high-level overview of how employees use and engage with the Feedback tool.

Two metrics can be seen in the graph at the top of the Reports page:
Given: The number of feedback written and shared by this group.
Received: The percentage of people who received at least one piece of feedback.

To get started, navigate to Admin>Analytics>Adoption>Feedback.

When you view a graph, the delta metric at the top compares the change between the previous date range interval and the current date range interval. For example, if you view the last 90 days, the delta is the difference between the metric 180-90 days ago compared to the metric from the last 90 days. If you change the date range to 30 days or 365, it's the same behavior. If your graph is set on All Time, there is not a delta shown.

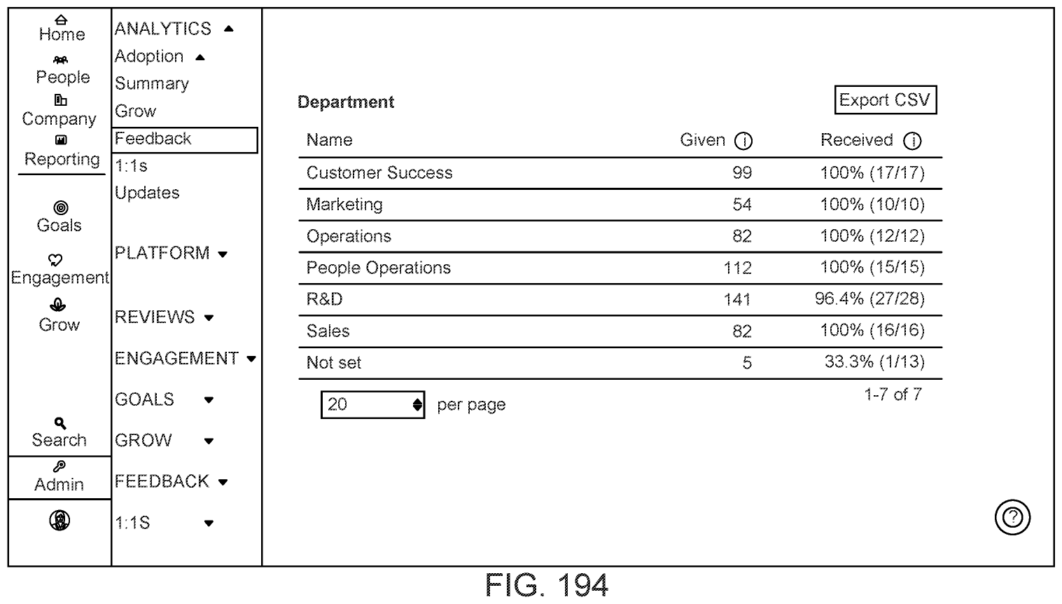

FIG. 194 is a schematic of a user interface displaying a feedback reporting page containing a table view of given feedback adoption.

Below the graphs, you can also find a list view of the data from FIG. 193:

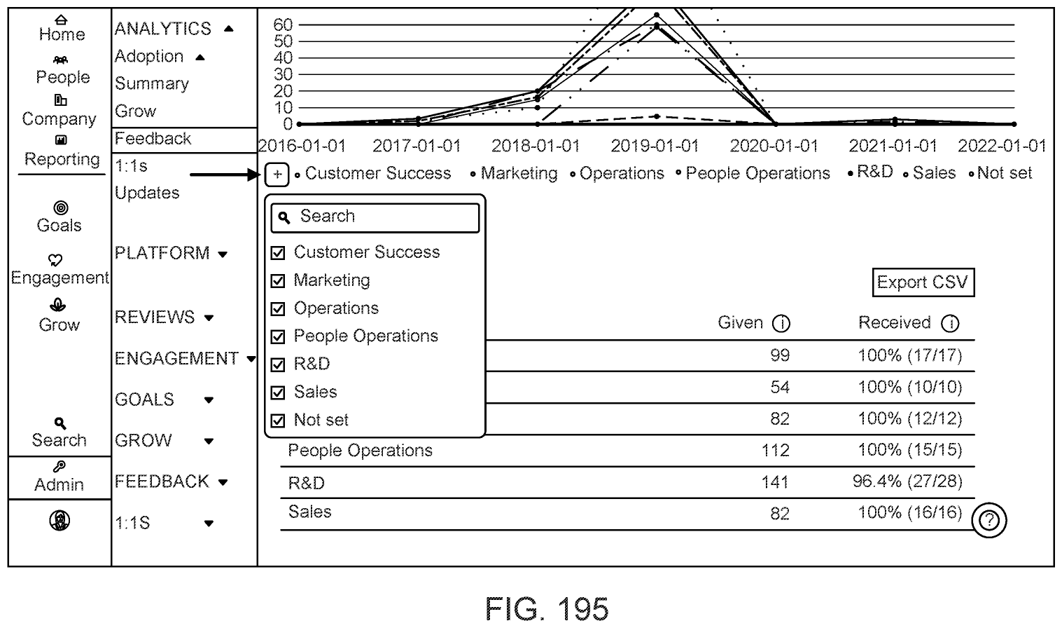

FIG. 195 is a schematic of a user interface displaying a feedback reporting page containing a drop-down menu for making groups visible or invisible.

When viewing the graphs, you can add more groups by clicking on the + sign (Lattice defaults to the first eight options). You can also make groups visible or invisible on the graph by clicking on the grouping name.

The following filters can be applied to the feedback adoption data:
Group by: You can adjust how your information is grouped by clicking on the Group by filter. Here, you will see a list of all employee fields currently in the system, including any custom fields you may have created. (This functionality is not available to managers.)
Time range. This allows you to adjust over what period of time you are analyzing the data. You can choose a different set of timeframes or a custom range.

Admins can view how dynamic their organization is when using the Feedback tool. You can export Feedback data directly from the Auditing page.

### The Feedback Log

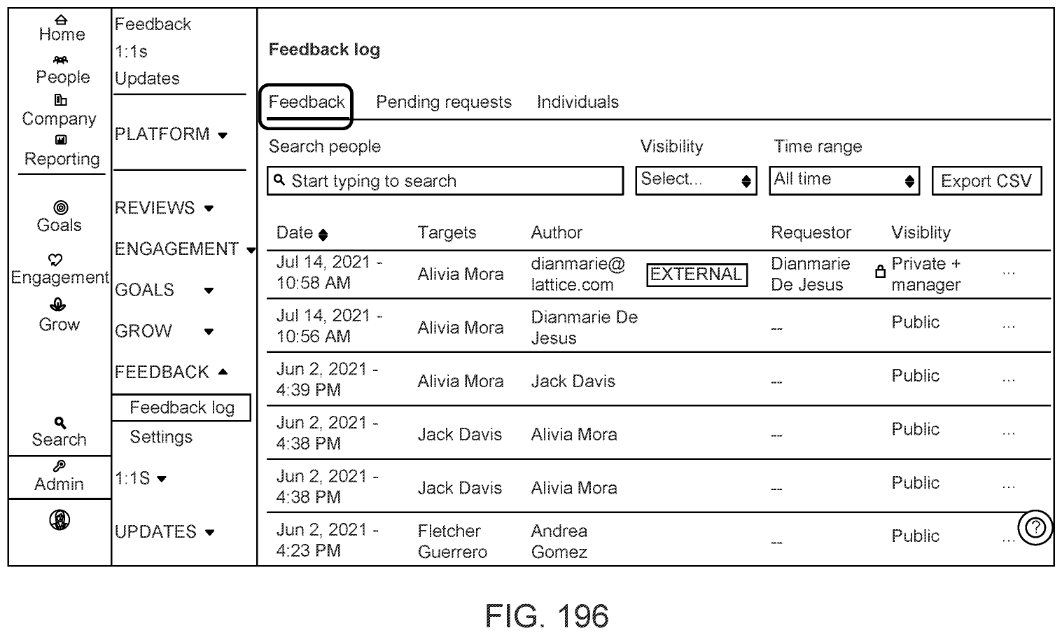

FIG. 196 is a schematic of a user interface displaying the feedback tab of the feedback log.

The Feedback tab lists the individual pieces of feedback given and received by all users in the organization, including external feedback.

The following data is available in the Feedback tab:
Date: The date and time the feedback was given.
Targets: The recipient of the feedback.
Author: The user who wrote the feedback.
Requestor: The name of the user who requested the feedback if the feedback came from a feedback request.
Visibility: The sharing visibility of the feedback.

The following actions are available in the Feedback tab:
View private and public feedback, excluding notes to self.
Delete feedback.

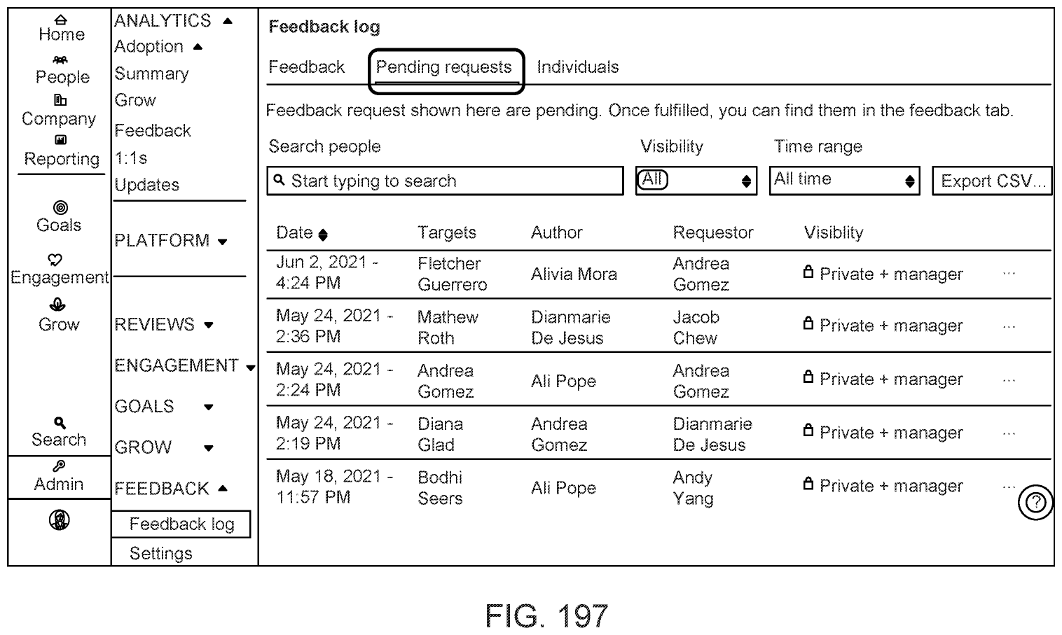

FIG. 197 is a schematic of a user interface displaying the pending requests tab of the feedback log.

The Pending requests tab shows which feedback requests are still pending. Once they have been fulfilled, they will move into the Feedback tab.

The following data is available on the Pending Requests tab:
Date: The date and time the request was sent.
Targets: The recipient of the feedback.
Author: The user who is expected to write the feedback.
Requestor: The name of the user who requested the feedback.

The following actions are available in the Pending Requests tab:
View all active feedback requests.
Delete pending feedback requests.

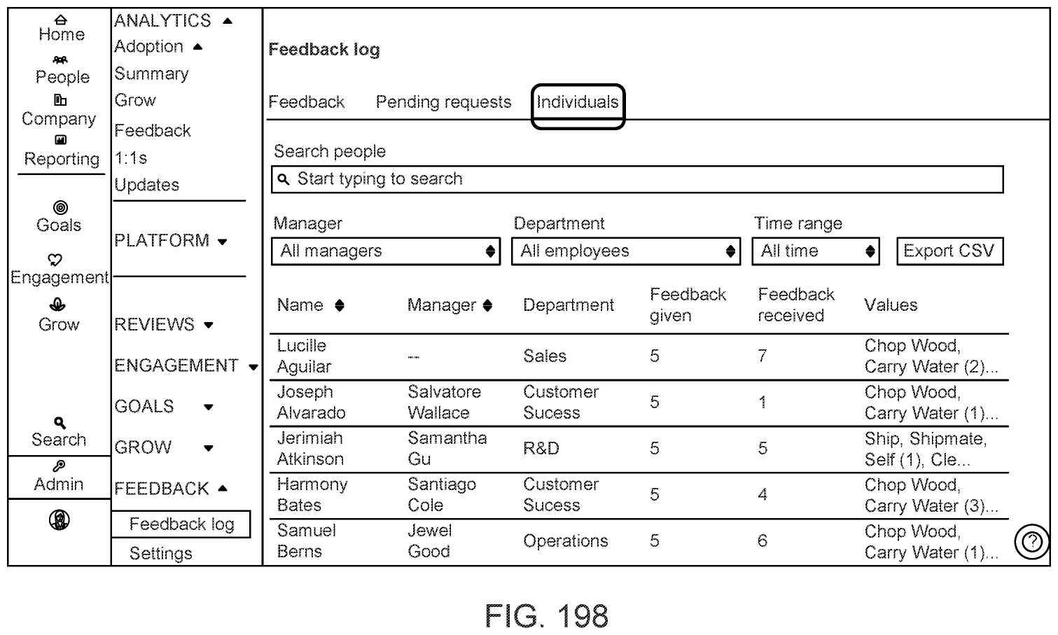

FIG. 198 is a schematic of a user interface displaying the individuals tab of the feedback log.

The Individuals tab shows how much each user has given or received feedback, along with any values attached to the individual via feedback.

The following data is available on the Individuals tab:
Name: The name of the user giving or receiving feedback.
Manager: The name of the user's manager.
Department: The department the individual is associated with.
Feedback given: The number of pieces of feedback given by the user over a given period.
Feedback received: The number of pieces of feedback received by the user over a given period.
Values: The company values attached to feedback the individual has received along with the number given over a given period of time.

### Search and Filler

To take a deeper dive into your data, you can use the following:
Search people: Use the bar to search for a specific individual.
Manager: Filter by all direct reports for a particular manager.
Department: Filter by all employees for a specific department.
Time range filter: Filter by a specific date range the feedback has been given or received.

### Export a Customized CSV

While feedback is visible directly in the system via the Feedback Log, you may want to filter or view additional customized fields. The system allows you to customize your CSV export to view the information you need and remove the information you don't.

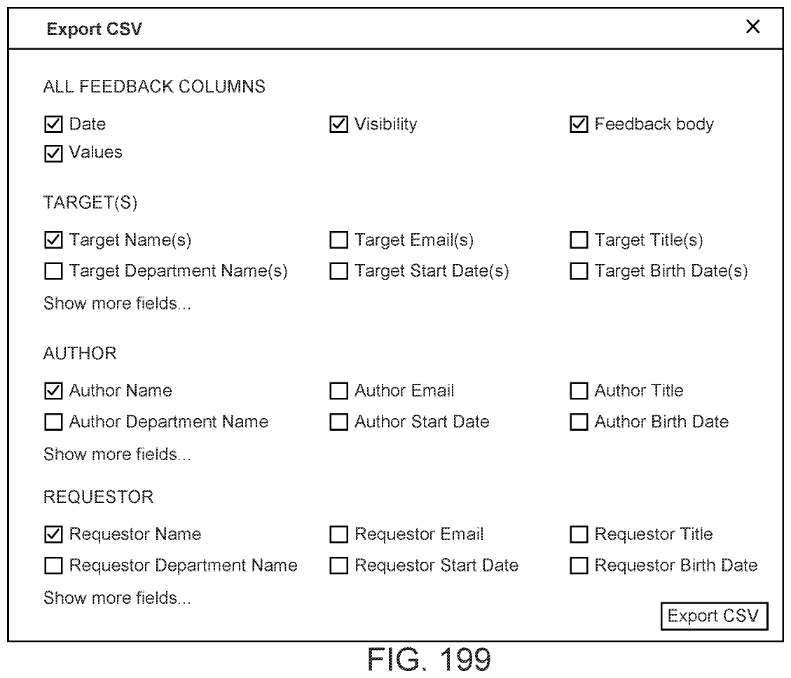

FIG. 199 is a schematic of a user interface displaying a page for customizing a CSV before exporting.

The following are steps to export a customized CSV.
1. Navigate to Admin>Feedback>Feedback log.
2. Select Export CSV . . . .
3. Select all attributes, columns of the table, and user attributes you would like to include in your export.
   Target(s): The employee that is receiving feedback.
   Author: The Employee giving feedback.
   Requestor: The employee requesting feedback.
4. Select Export CSV.

### Request Feedback as an Admin

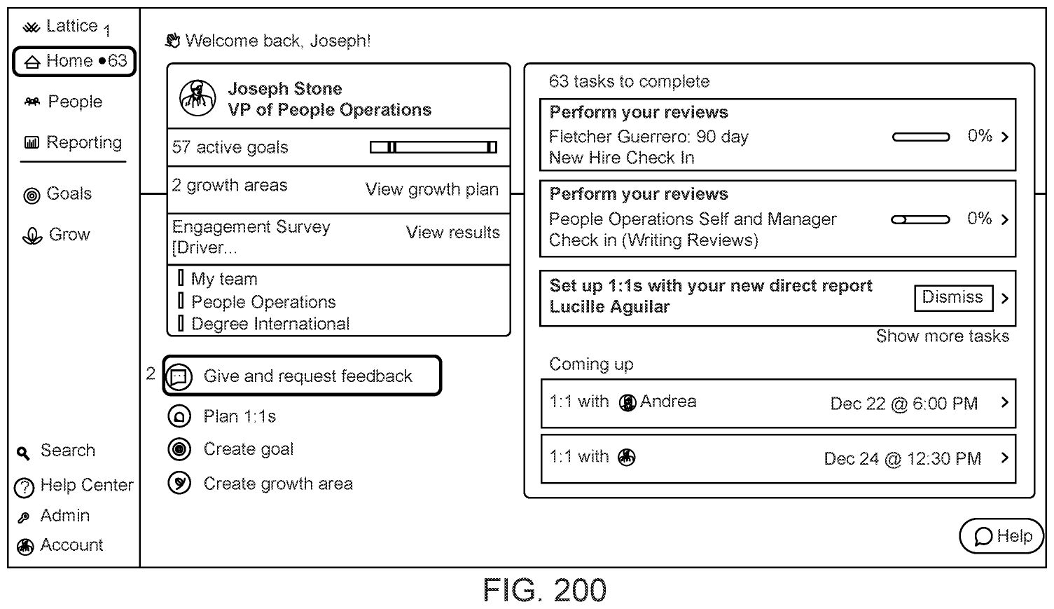

FIG. 200 is a schematic demonstrating how to navigate a user interface to request feedback.

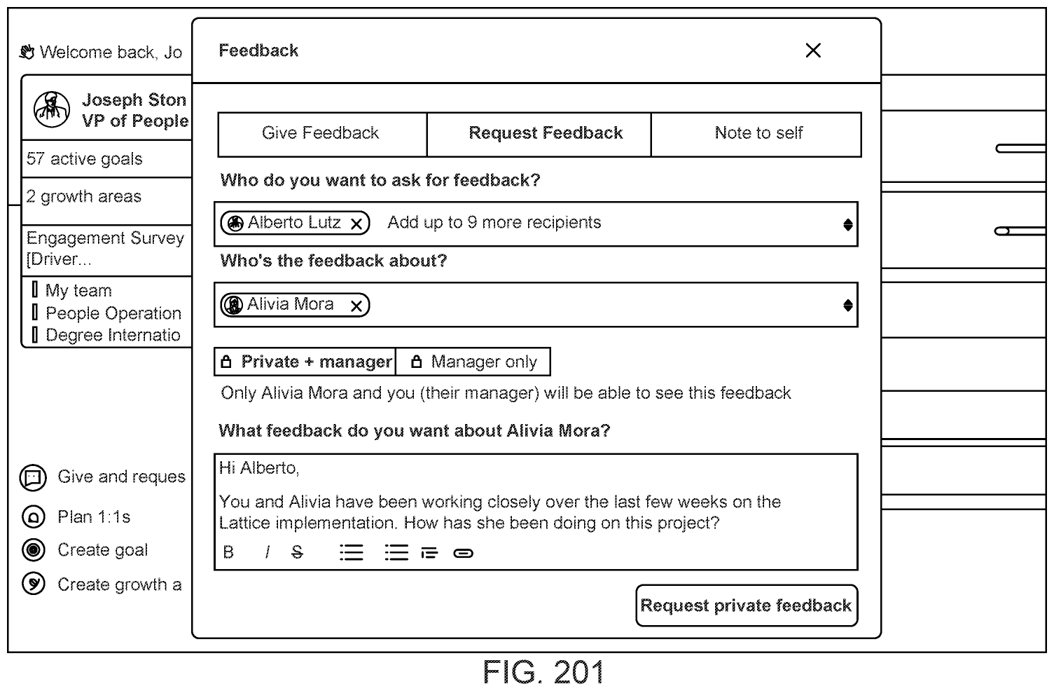

FIG. 201 is a schematic of a user interface displaying the request feedback tab of the feedback modal.

The system allows admins to request feedback on anyone in the company, ensuring administrators can inquire about any specific employee's performance.

Please note: Responders can decline a request if they choose to do so.

The following are steps to request feedback as an admin:
1. Navigate to your Home>Give and request feedback.—OR—Navigate to People>My profile>Feedback>Feedback>Request feedback.
2. The Feedback modal will appear—enter the Request feedback tab.
3. Under Who do you want to ask for feedback?, type in the employee's name who you want to ask for feedback.
4. Under Who's the feedback about?, type the name of the employee who the feedback is about. The system will give you the choice of selecting yourself, a direct report, or other employees.
   If the employee does not appear in the dropdown, type in their name in the field and then select.
5. Select visibility.
   Please note: Feedback requests do not include a public visibility option. Requests for indirect reports can only be set to Private+manager, while requests for all other employees will have the option to be set to Private+manager and Manager Only.
6. Under What feedback do you want about ______?, include a description of what you want the feedback to be about. Please note, if you select to have the feedback as Private+manager, the employee receiving the feedback will have visibility into the description.
7. Once all fields have been completed, select Request private feedback.

### The Employee Recipient View

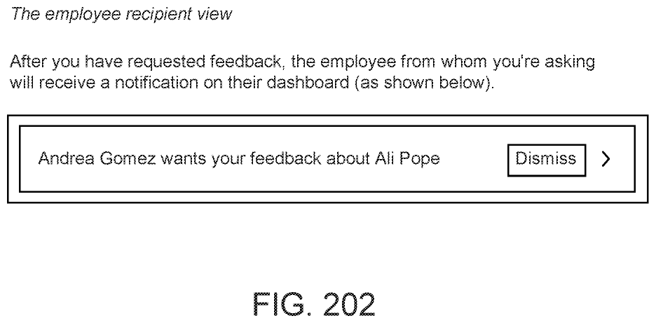

FIG. 202 is a schematic of a portion of a user interface displaying a notification indicating feedback was requested.

After you have requested feedback, the employee whom you're asking for feedback will receive a notification on their dashboard (as shown in FIG. 202).

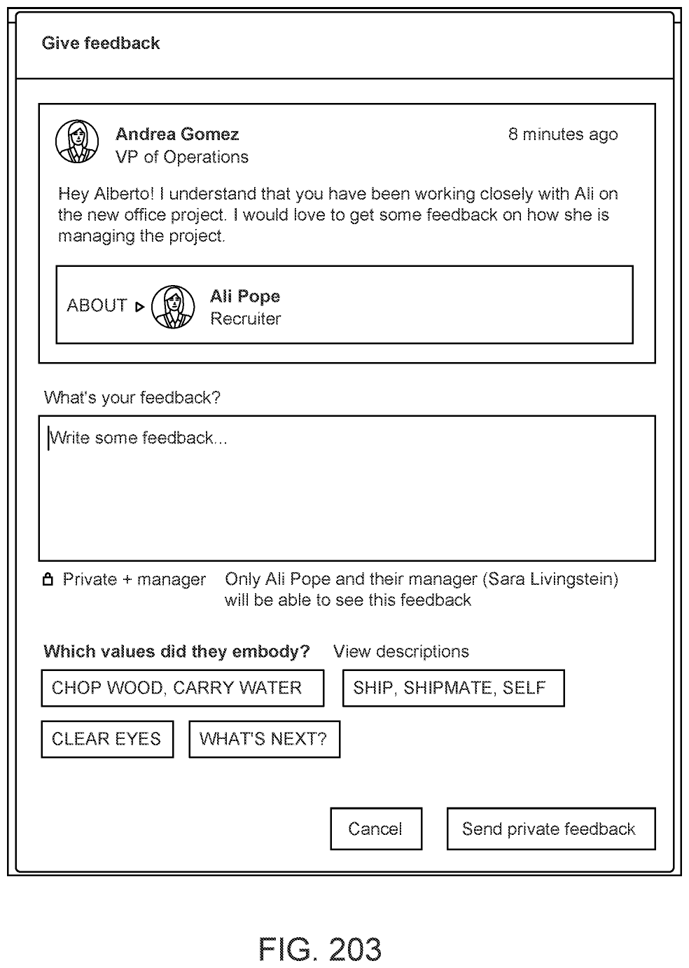

FIG. 203 is a schematic of a user interface displaying a page for providing feedback.

When the recipient clicks into the task, they will see the requestor's name, a description of what the request is for, and for whom. From here, they will be able to respond and submit their feedback.

### Delete Feedback

Feedback can only be deleted by a system admin. If you are an employee and would like to delete submitted feedback, please reach out to your HR team.

The Feedback tool must be enabled before an admin can delete feedback.

The following are steps to delete feedback:
1. Navigate to Admin>Feedback>Feedback log.
2. Search for the feedback and select the ellipsis ( . . . ) associated with the submission.
3. Select Delete from the dropdown.
4. Confirm by selecting Delete. Enable Company Values

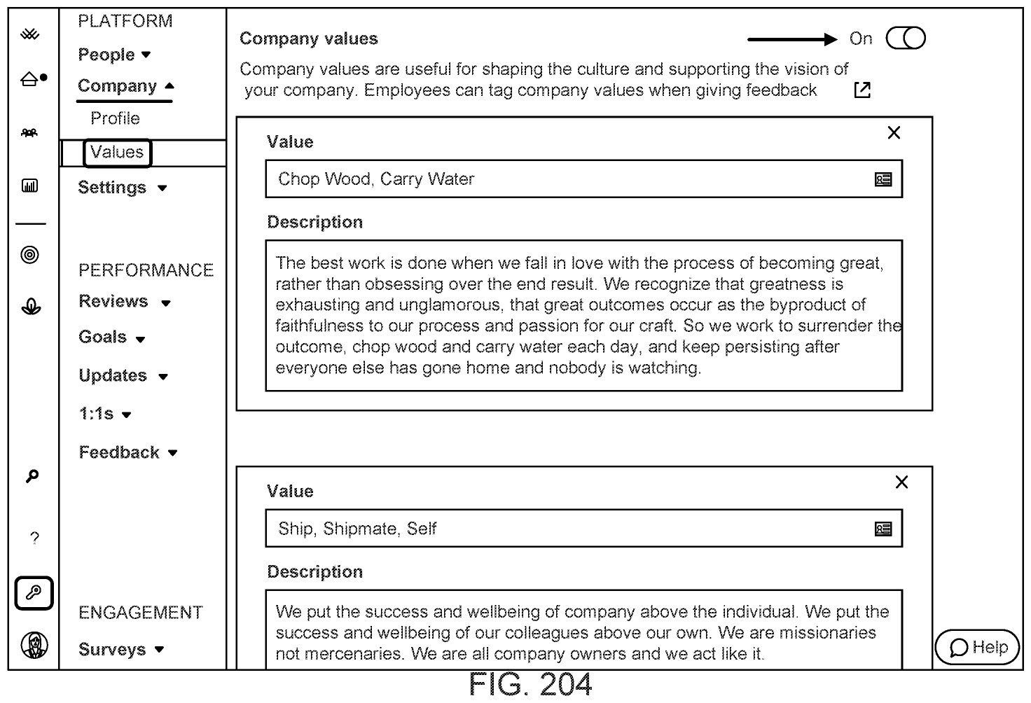

FIG. 204 is a schematic demonstrating how to navigate a user interface to enable company values.

The system allows users to attach company values to the feedback they give to their teammates. Giving feedback can often be an effective way to reinforce the values that your company holds most important. These values, created and managed by company administrators, help remind contributors of your values and praise those who embody them.

Company values must be added and enabled by a system admin. Once enabled, attaching one or more values becomes an optional step when giving feedback.

The following are steps to enable company values:
1. Navigate to Admin>Company>Values.
2. Toggle on Company values.
3. Add and manage your company values.

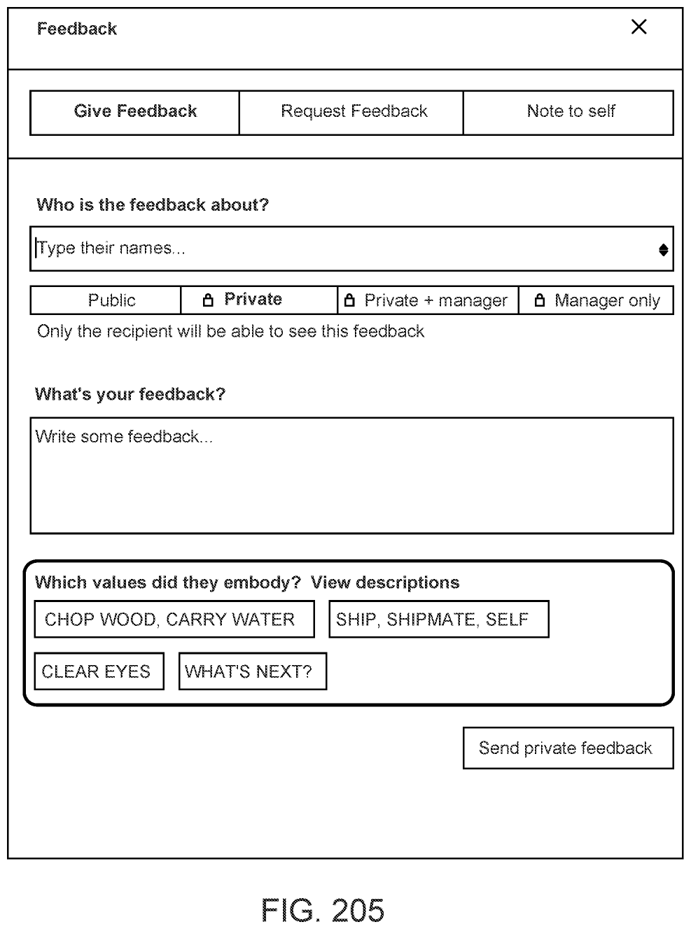

FIG. 205 is a schematic of a user interface displaying a feedback page with the option to select one or more values.

Once you've enabled company values, users will have an additional option to select one or more values when giving feedback. If your company uses Gmail or Slack, users can also attach values and give feedback through our Gmail plugin or Slack integration.

In example embodiments, an update summary window and/or a status update configuration window remain persistently displayed to enable configuration of status update templates and management of updates via selections made in the update summary window.

In example embodiments, the plurality of update settings in the status update configuration window further comprises a question settings area for defining a set of update questions to be included in each recurring status update. In example embodiments, defining the set of update questions comprises: displaying a set of pre-defined update questions, receiving a selection of one or more of the pre-defined update questions to include the selected one or more pre-defined update questions in the set of update questions, and/or receiving text input for one or more custom update questions to include in the set of update questions.

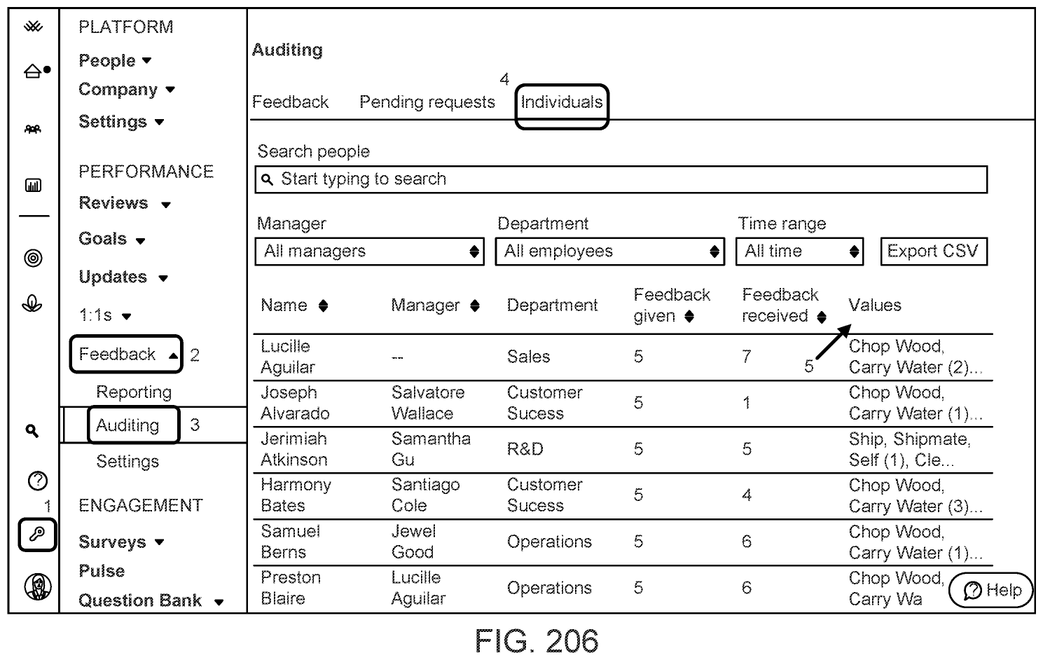

FIG. 206 is a schematic demonstrating how to navigate a user interface to monitor which company values have been attached to specific individuals when giving feedback.

System admins can monitor which company values have been attached to specific individuals when giving feedback.

The following are steps to locate values listed in the individuals tab from the feedback auditing page:
1. Navigate to Admin>Feedback>Auditing.
2. Enter the Individuals tab.
3. Each individual will show which values, along with the number of times, have been attached to the user.
4. (optional): Use the customizable Feedback CSV export to filter your values data

### Feedback for Managers

Managers can request feedback about their direct and indirect reports from other employees in the company.

### Request Feedback for Your Team

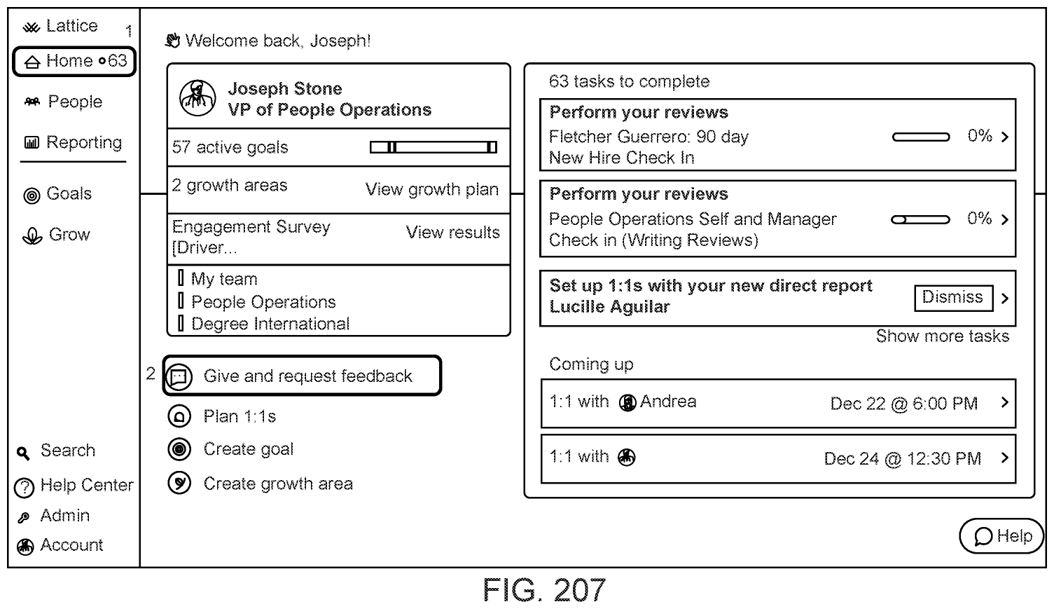

FIG. 207 is a schematic demonstrating how to navigate a user interface to request feedback for a team.

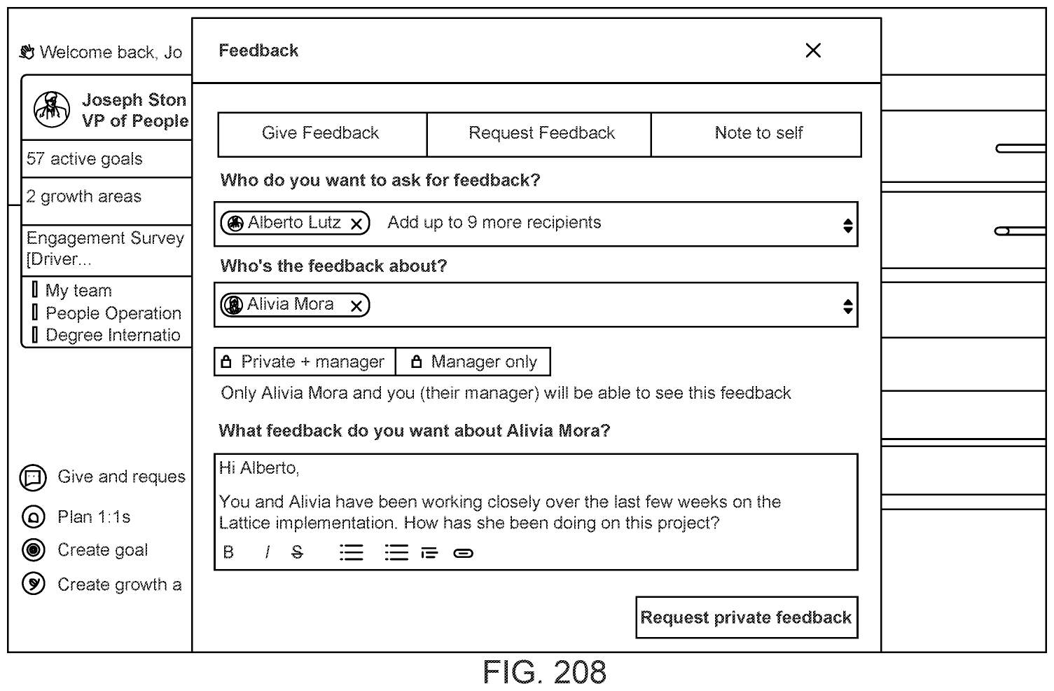

FIG. 208 is a schematic of a user interface displaying the request feedback tab of the feedback modal.

The following are steps to request feedback:
1. Navigate to Home>Give and request feedback.—OR—Navigate to People>My team>Feedback>Select the blue Feedback button>Request feedback.
2. The Feedback modal will appear—enter the Request feedback tab.
3. Under Who do you want to ask for feedback?, type in the employee's name who you want to ask for feedback.
4. Under Who's the feedback about?, type the name of the employee who the feedback is about. The system will give you the choice of selecting yourself or a direct report. If the employee does not appear in the dropdown, type in their name in the field and then select.
   Requestors with additional permissions will see a third “Other” section within the dropdown. This section includes employees who are not a part of the direct manager/report relationship that you can still request feedback for:
      Managers of Managers (MOMs): Managers of Managers can request feedback for their indirect reports.
      Custom Role Owners/HRBPs. Role owners will be able to request feedback for any employee that is included within the group attribute selected when creating the role.
      Custom Relationships/Dotted line managers: Dotted line managers can request feedback for any employee they have been assigned visibility into via a custom relationship.
5. Select visibility.
   Please note: Feedback requests do not include a public visibility option. Requests for indirect reports can only be set to Private+manager, while requests for all other employees will have the option to be set to Private+manager and Manager Only.
6. Under What feedback do you want about ______?, include a description of what you want the feedback to be about. Please note, if you select to have the feedback as Private+manager, the employee receiving the feedback will have visibility into the description.
7. Once all fields have been completed, select Request private feedback

### The Employee Recipient View

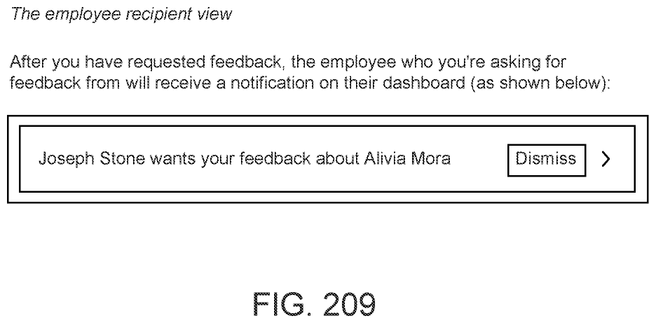

FIG. 209 is a schematic of a portion of a user interface displaying a notification requesting feedback.

After you have requested feedback, the employee who you're asking for feedback from will receive a notification on their dashboard (as shown in FIG. 209):

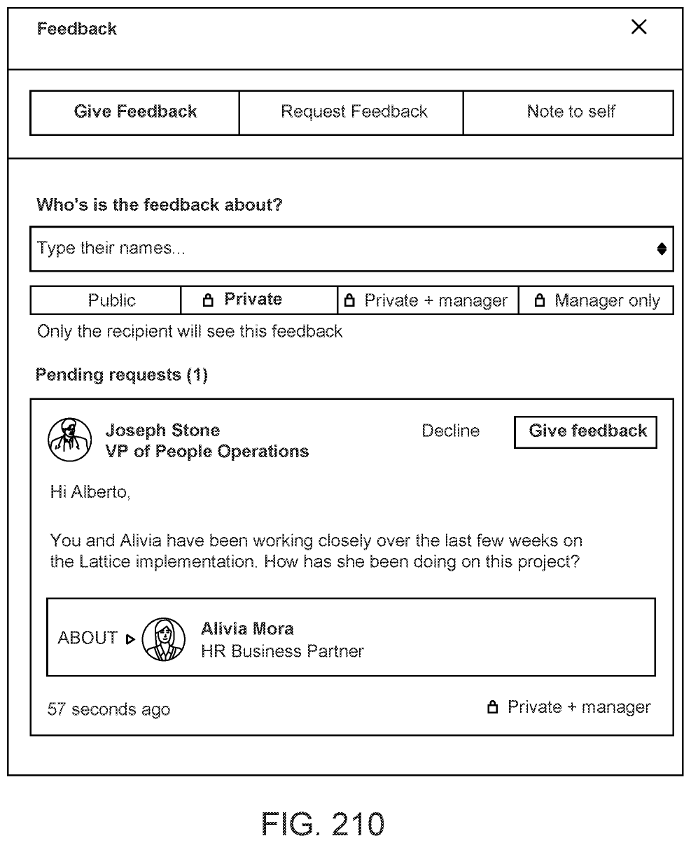

FIG. 210 is a schematic of a user interface displaying the give feedback tab of the feedback modal.

When the responder clicks into the task, they will see the requestor's name, a description of what the request is for, and for whom. From here, they will be able to respond and submit their feedback.

Please note, responders have the ability to decline a request if they choose to do so.

In example embodiments, managers of managers can access feedback for their indirect reports from the Reporting page.

### View Feedback for Your Team

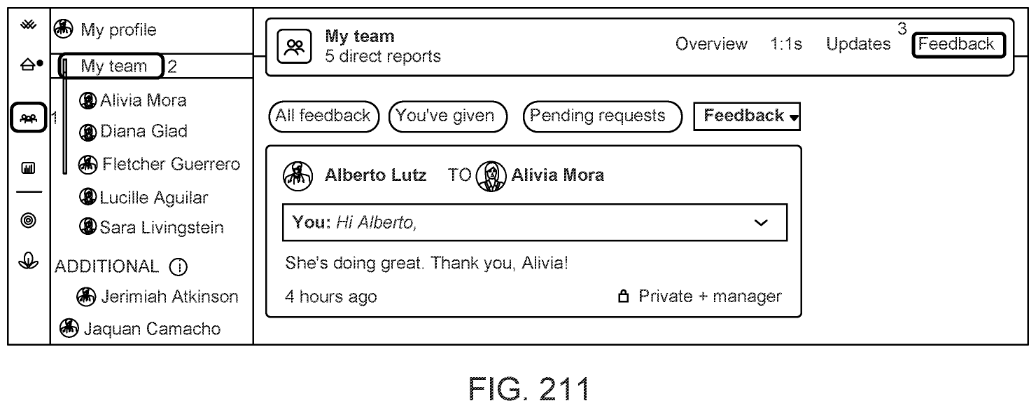

FIG. 211 is a schematic demonstrating how to navigate a user interface to view feedback for a team

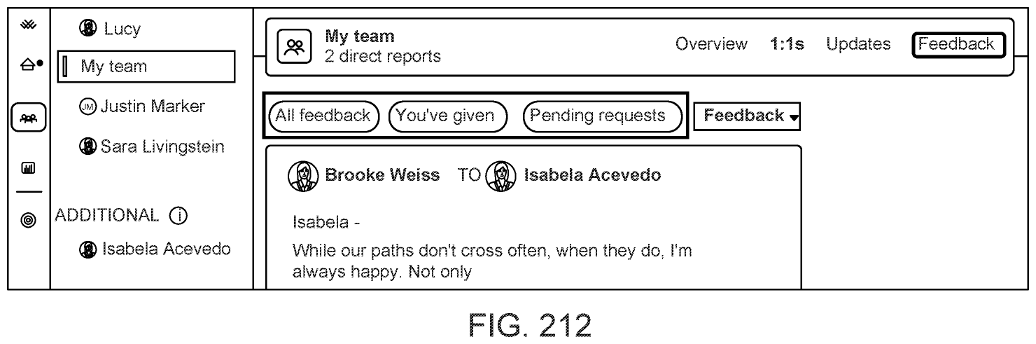

FIG. 212 is a schematic of a user interface displaying the feedback tab of a my team page.

The following are steps to view feedback for a team:
1. Navigate to People>My team>Feedback.
2. Toggle between All feedback, feedback You've given, and Pending requests for your team.
   All Feedback: any feedback you have given to your reports with private or public visibility
   You've given: any feedback you have given (including notes to self)
   Pending feedback requests: any outstanding requests for feedback you have asked for.

### View Feedback for an Individual Direct Report

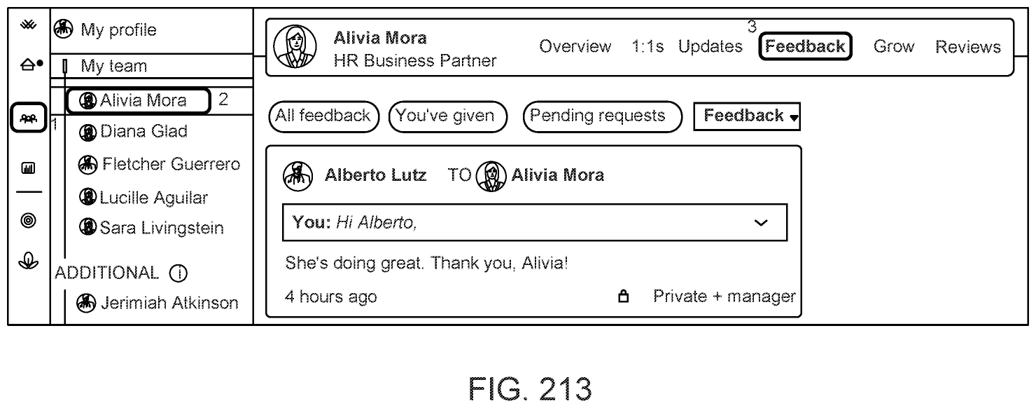

FIG. 213 is a schematic demonstrating how to navigate a user interface to view the feedback tab of a page for an individual direct report.

The following are steps to view feedback for an individual direct report:
1. Navigate to the People page.
2. Under the My team section within the People navigation, select a direct report to enter their profile page.
3. Enter the Feedback tab.
4. Toggle between All feedback, feedback You've given, and Pending requests for the direct report.

In example embodiments, managers can access feedback from their reports from the My team page.

View Feedback for your Indirect Reports

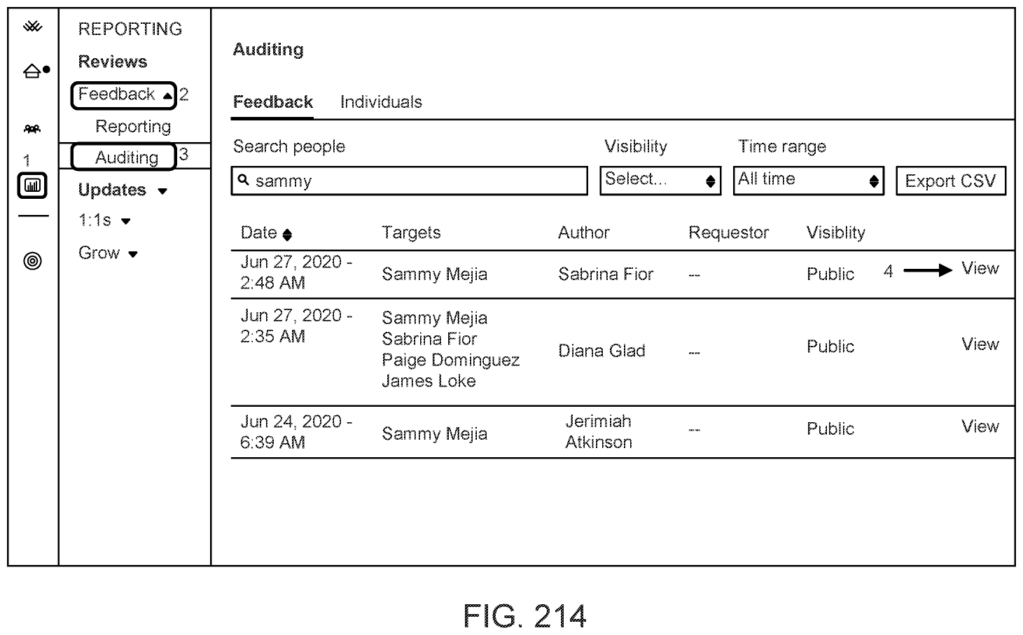

FIG. 214 is a schematic demonstrating how to navigate a user interface to view feedback for an indirect report.

The following are steps to view feedback for an indirect report:
1. Navigate to Reporting>Feedback>Auditing.
2. Under the Feedback tab, search for the indirect report or navigate through the list.
3. Next to the desired feedback, click View.

### Feedback for Employees

Our Feedback tool makes it easy to give and request public and private feedback within your organization. This tool allows employees to praise their peers, celebrate wins together or ask for and provide constructive feedback. This helps employees grow in their roles and be recognized for the great work that they're doing!

Continuous feedback is an essential element of any healthy and productive work environment, but employees often don't provide continuous feedback because they lack a process and/or tool. Luckily, Feedback makes it easy to give, receive and store feedback. You can also integrate our Feedback tool with Slack so that your employees can easily and quickly give and request feedback throughout the day!

Continuous feedback is an essential element of any healthy & productive work environment, but often users don't contribute to the feedback loop primarily because of logistics. Luckily, the system's feedback feature makes it easy to give, receive and store feedback for future reference.

To access the Feedback tool, navigate to Home>Give and request feedback—OR—People>My team>Feedback

Example Feedback tool functionality may include one or more of the following:
Give feedback.
Request feedback.
Submit a note to self.
React to feedback.
Integrate with Slack or Gmail.

Feedback makes it easy to give, receive and store feedback for future reference. Users can select up to ten people to provide public feedback to at one time.

The following are steps to provide feedback:
1. Navigate to Home>Give and request feedback—OR—People>My team>Feedback.
2. Within the Feedback tool, navigate to the Give feedback tab.
3. Under Who's the feedback about?, add the name of the feedback recipient(s).
4. Choose your share settings.
   Manager only: feedback is private and will go directly to an employee's manager.
   Public: feedback is visible to everyone.
   Private: feedback is visible to only the recipient.
   Private+manager: feedback is only visible to the recipient and their manager.
5. Under What's your feedback?, write your feedback message in the text box.
6. (Optional) If your admin has set up company values, you can associate a value to the feedback before submitting the feedback under Which values did they embody?

Note: Your visibility share settings may differ depending on your admin's feedback settings.

The Feedback tool makes it easy to give, receive and store feedback for future reference. Users can request feedback from all employees and external stakeholders.

Note: Users cannot request public feedback.

The following are steps to request feedback:
1. Navigate to Home>Give and request feedback—OR—People>My team>Feedback.
2. Within the Feedback tool, navigate to the Request feedback tab.
3. Under Who do you want to ask for feedback?, select employees at your company by name or externally by providing an email address.
4. Under Who's the feedback about?, select who the feedback is associated with. Based on your permission levels you may be able to select from:
   All users.
   Direct reports.
   Indirect reports.
   Yourself.
5. Choose your share settings.
   Manager only: feedback is private and will go directly to an employee's manager.
   Private: feedback is visible to only the recipient.
   Private+manager: feedback is only visible to the recipient and their manager.
6. Under What do you want feedback on?, write your request for feedback.
7. Select Request private feedback.

Feedback makes it easy to give, receive and store feedback for future reference. Users can leave themselves a Note to Self about themselves or another user in the system.

Notes are private and only visible to the person who has written the note.

The following are steps to create a note:
1. Navigate to Home>Give and request feedback—OR—People>My team>Feedback.
2. Within the Feedback tool, navigate to the Note to self tab.
3. Under Who's the note about?, add the name of the user the note is associated with
4. Under What do you want to remember for later?, write the message in the text box.
5. Select Save note.

Any user who has visibility into the feedback will have the option to react and view reactions to the feedback.

Note: Reactions do not integrate with Slack; therefore, Slack reactions are not shown or counted in the system.

### React to Feedback

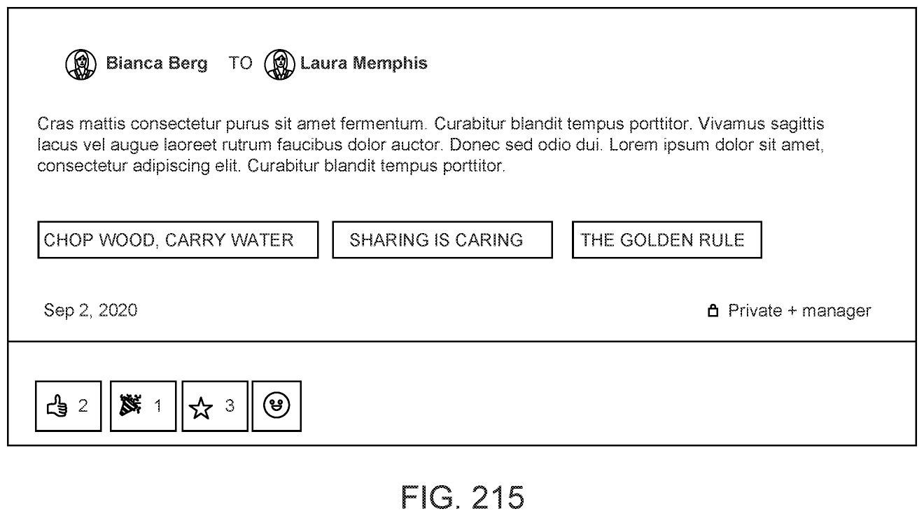

FIG. 215 is a schematic of a portion of a user interface displaying a feedback card containing the option to select an emoji icon as a reaction to the feedback.

The following are steps to react to feedback:
1. Navigate to one of the three Feedback pages in the system:
   For feedback you've received. People>My profile>Feedback
   For feedback your direct reports received: People>My team>Feedback
   For public feedback all users received: Company>Feedback
2. Within the desired feedback card, select the emoji icon and choose an emoji.

Note: Hovering over each emoji will display the users who have reacted to the feedback.

### View Your Feedback Summary

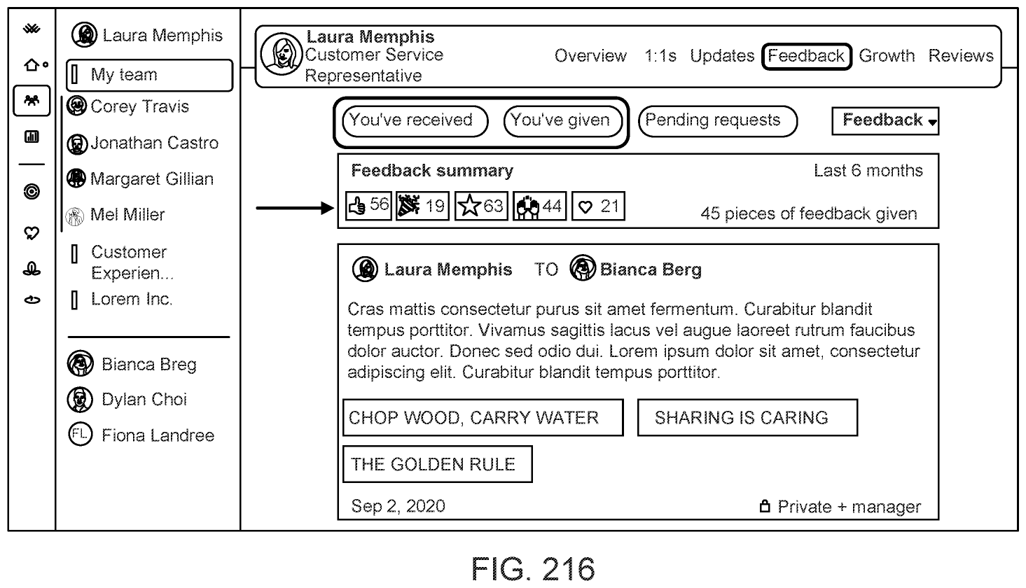

FIG. 216 is a schematic of a user interface displaying a feedback page containing a feedback summary.

Within your Feedback page, the system will display the total number of reactions you have received and the total number of reactions to the feedback you have given to others.

Giving feedback is a great way to help improve employee relationships and development. The system allows you to provide feedback to employees that are only visible to them or their manager.

In example embodiments, the feedback visibility options available to you may be different based on the Feedback settings set by the account admin.

Note: If the employee's manager changes, their new manager will have visibility to any previous manager-only feedback.

### Give Private Feedback

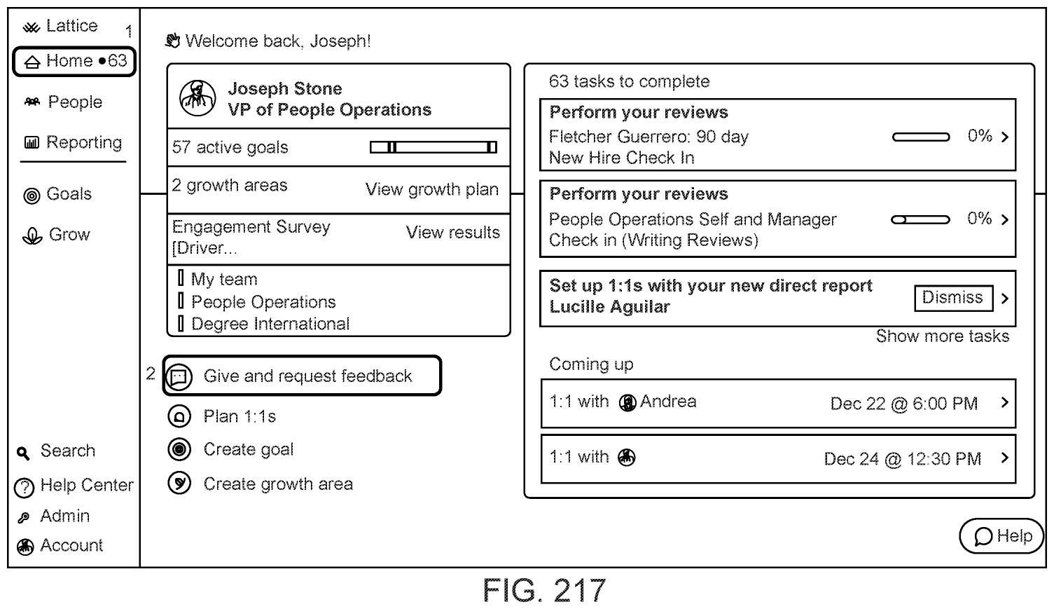

FIG. 217 is a schematic demonstrating how to navigate a user interface to give and request feedback.

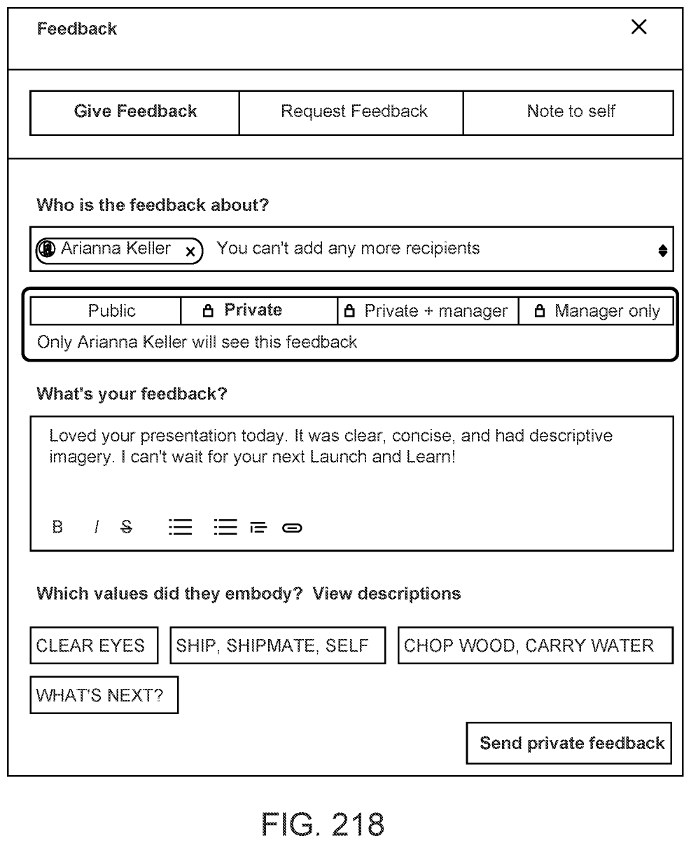

FIG. 218 is a schematic of a user interface displaying the give feedback tab of the feedback modal containing the option to select visibility for the feedback.

The following are steps to set visibility for feedback:
1. Navigate to Home>Give and request feedback.—OR—Step 1: Navigate to People>My team>Feedback>Select the blue Feedback button>Request feedback.
2. The Feedback modal will appear—enter the Give Feedback tab, add the recipient name, and include a feedback description.
3. Select the visibility option for the feedback.
   Private: Only the recipient will be able to see the feedback.
   Private+manager: Only the recipient and their manager will be able to see the feedback.
   Manager only: Only the recipient's manager will be able to see the feedback.

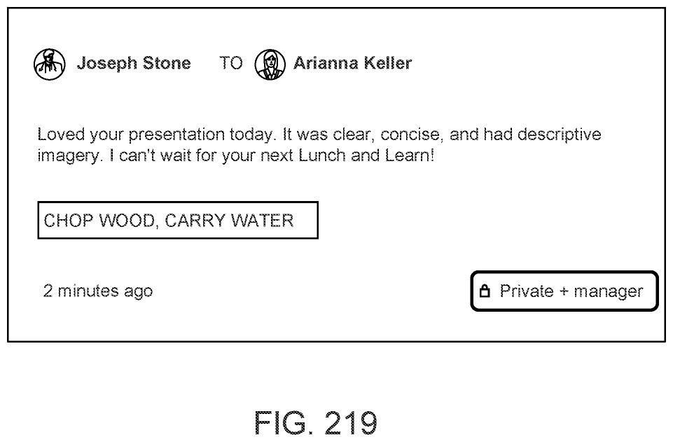

FIG. 219 is a schematic of a portion of a user interface displaying feedback and the visibility of the feedback within the system.

Once your feedback has been submitted, the recipient and/or their manager will receive an email notification letting them know. The receiver will be able to view the visibility of the feedback within the system.

### Request External Feedback

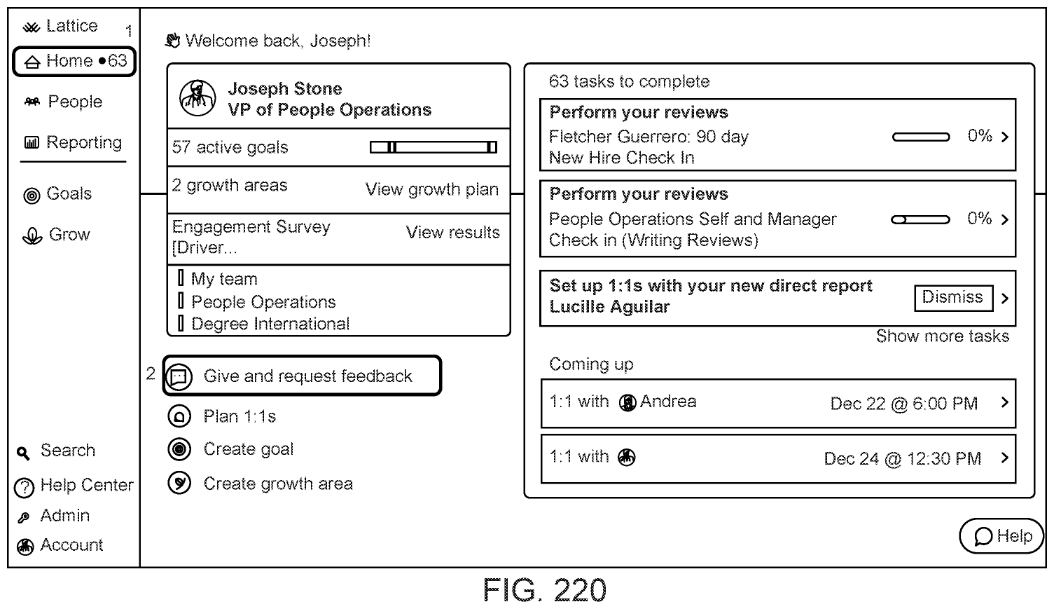

FIG. 220 is a schematic demonstrating how to navigate a user interface to give and request feedback.

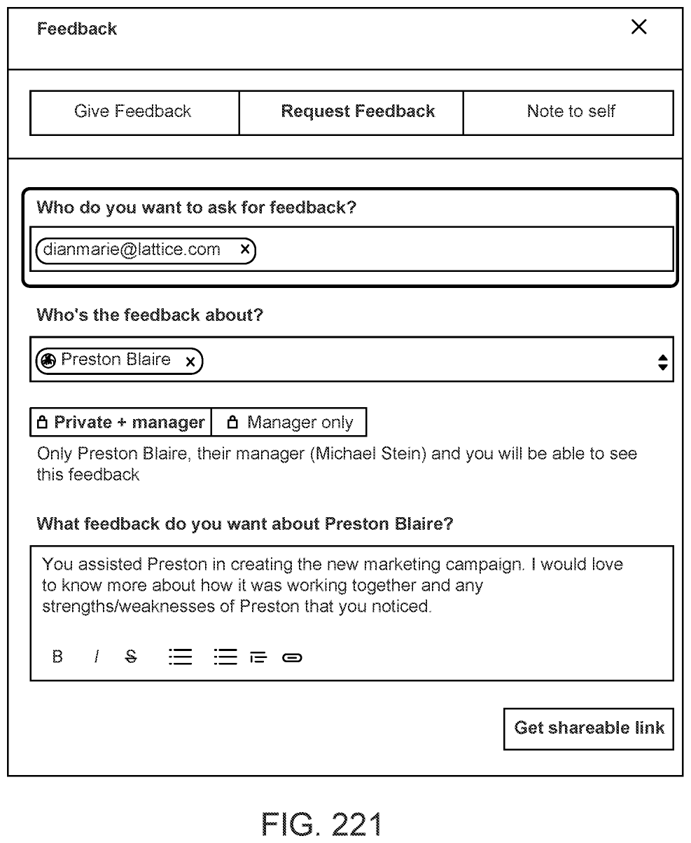

FIG. 221 is a schematic of a user interface displaying the request feedback tab of the feedback modal containing a text box for identifying recipients of the feedback request.

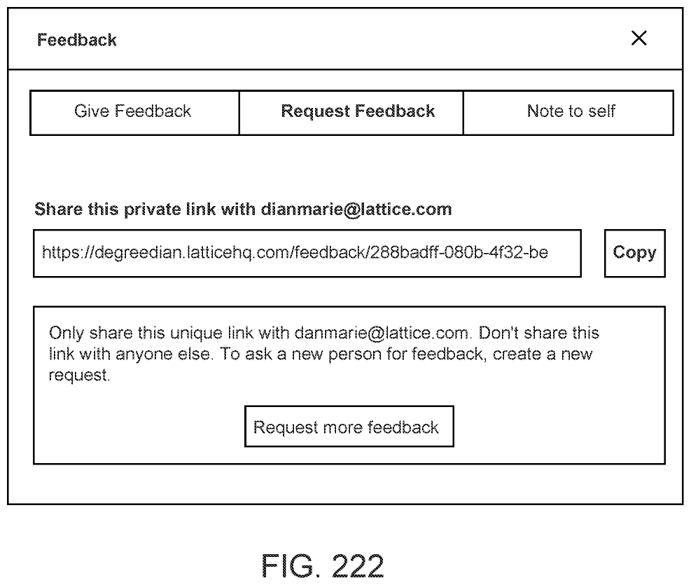

FIG. 222 is a schematic of a user interface displaying the request feedback tab of the feedback modal containing a private link to view the feedback request.

The system allows you to request feedback for yourself or your direct report from clients, partners, and associates you collaborate with outside of your organization.

Admins need to enable employees to use the external feedback functionality via their Feedback settings.

The following are steps to request external feedback:
1. Navigate to Home>Give and request feedback.—OR—Navigate to People>My team>Feedback>Select the blue Feedback button>Request feedback.
2. The Feedback modal will appear—enter the Request feedback tab.
3. Under Who do you want to ask for feedback?, type the email address of the person you wish to receive feedback from.
4. Under Who's the feedback about?, type the name of the employee who the feedback is about. The system will give you the choice of selecting yourself or a direct report. If the employee does not appear in the dropdown, type in their name in the field and then select.
5. Select visibility.
   Please note: Feedback requests do not include a public visibility option. Requests for indirect reports can only be set to Private+manager, while requests for all other employees will have the option to be set to Private+manager and Manager Only.
6. Under What feedback do you want from ______?, include a description of what you want the feedback to be about Please note, if you select to have the feedback as Private+manager, the employee receiving the feedback will have visibility into the description
7. Copy the private link and send it to the person to give external feedback.

### Receiver View

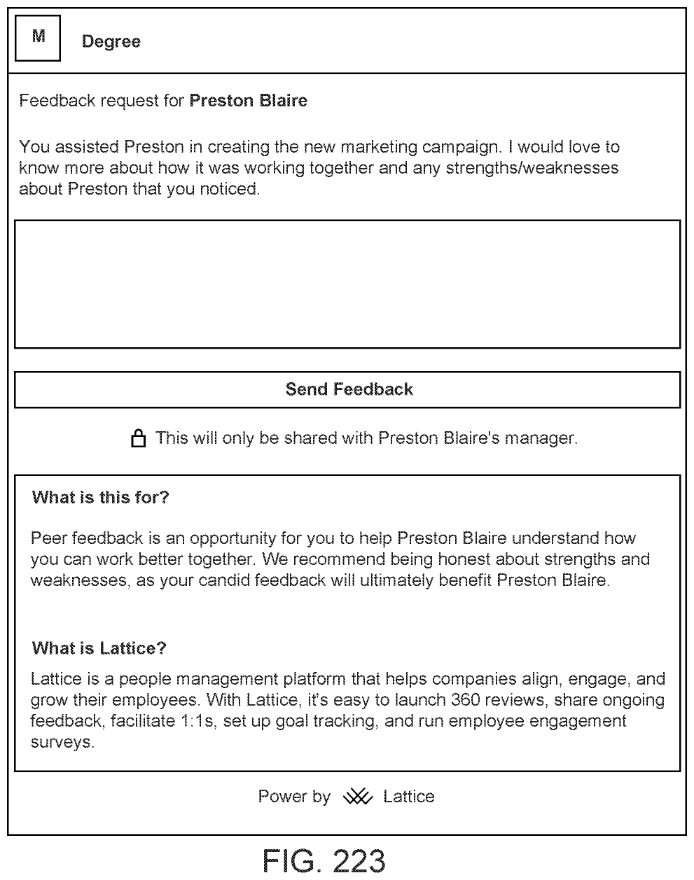

FIG. 223 is a schematic of a user interface displaying a page for submitting feedback in response to a feedback request.

Once the receiver has access to the private link, clicking on it will take them to a standalone page to write and send their feedback.

The feedback page includes:
The name of the person the feedback is about.
The description of the feedback request.
The visibility option selected when creating the private link.

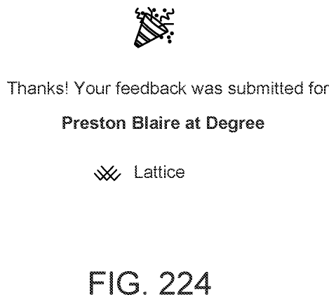

FIG. 224 is a schematic of a confirmation page for submitting feedback for an employee.

Once submitted, the system will show a confirmation page.

### Delete a Pending Request

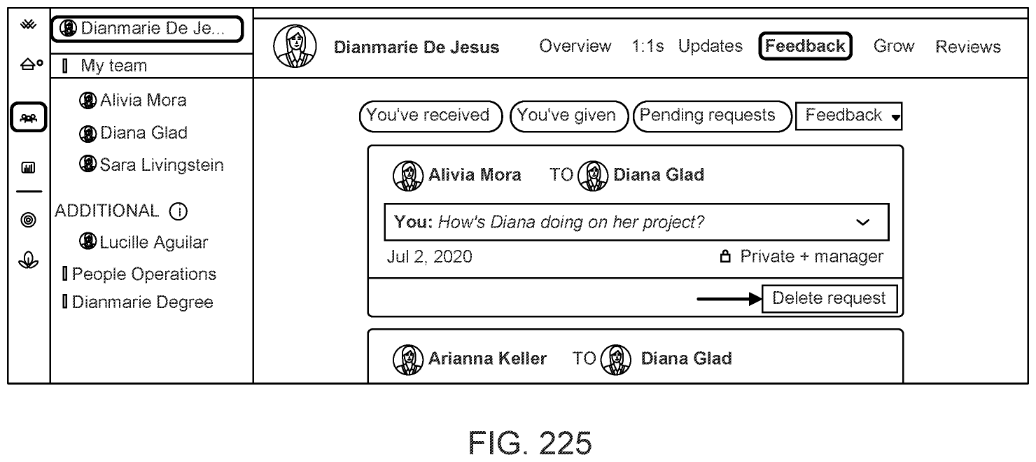

FIG. 225 is a schematic demonstrating how to navigate a user interface to delete a pending feedback request.

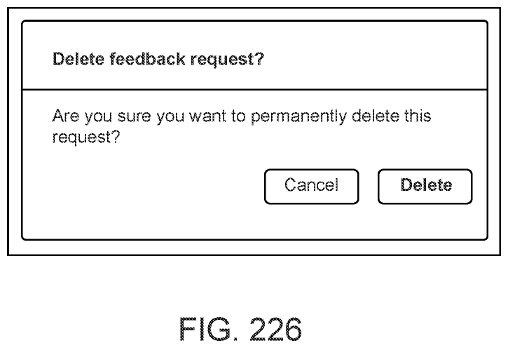

FIG. 226 is a schematic of a confirmation page for deleting a feedback request.

You may want to delete a feedback request that you previously submitted. As long as the request has not been answered, you can follow the steps below to delete pending feedback requests.

When you initially request feedback from someone, they will receive an email asking them to submit feedback. However, when you cancel or delete pending requests, that person will not receive a notification.

Note: The receiver of the feedback request has the option to decline once they have received the request.

The following are steps for deleting a pending feedback request:
1. On your Home page, select People.
2. Navigate to your employee profile.
3. Click on Feedback from the Performance toolkit and select Pending requests.
4. Find the relevant request and click Delete request.
5. The system will then prompt you to confirm and Delete.

### Decline a Request

There are two places in the system where you can decline a feedback request: the Feedback modal and the People page. Steps for both experiences can be found below.

The Feedback tool allows users to request feedback from others in the company. However, there may be times when the feedback request may no longer be relevant. Because of this, the system allows users to decline feedback requests.

The request sender is not notified if you decline a feedback request. However, the request will be removed from their Pending requests in the system.

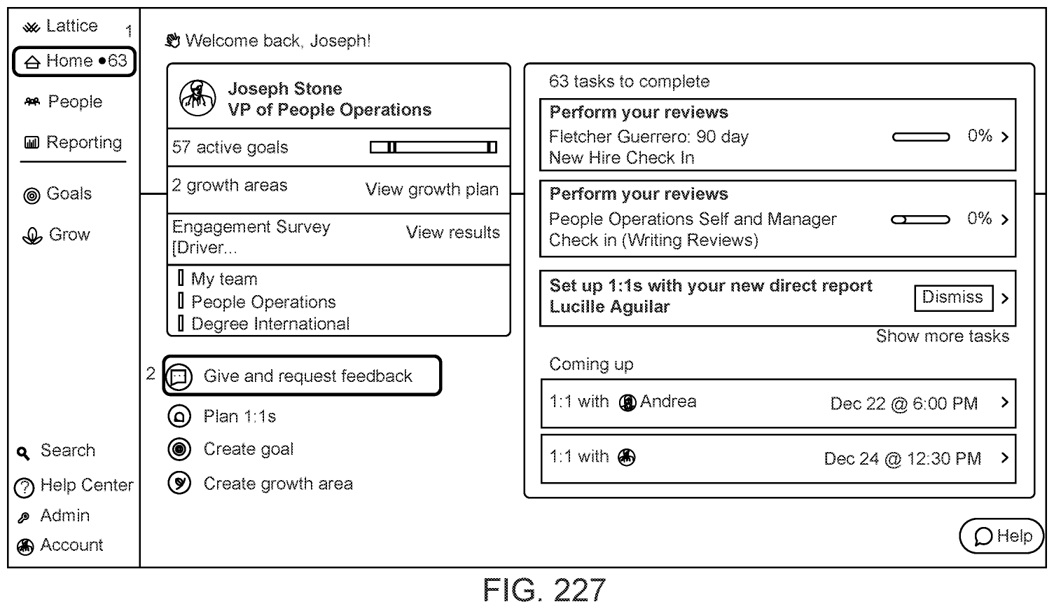

FIG. 227 is a schematic demonstrating how to navigate a user interface to be taken to the feedback modal.

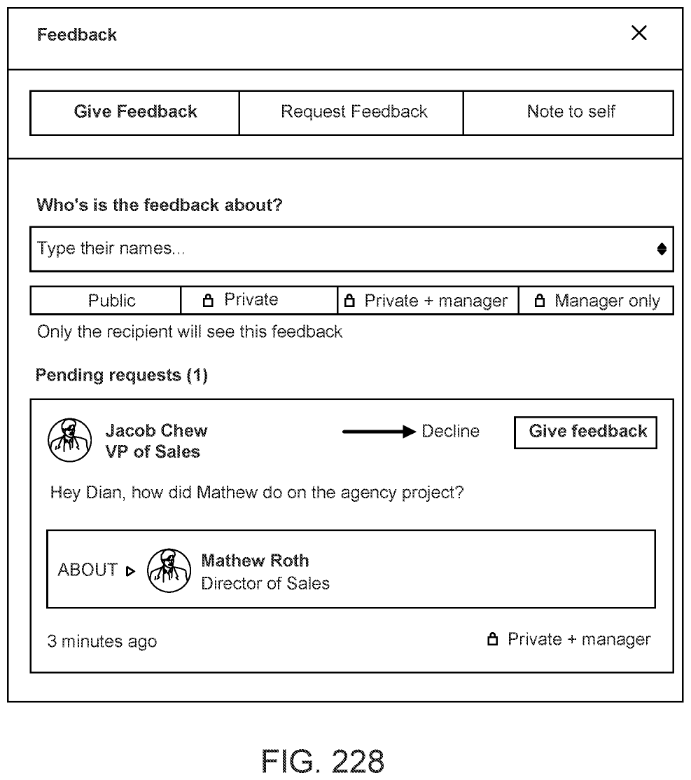

FIG. 228 is a schematic of a user interface displaying the give feedback tab of the feedback modal containing the option to decline a pending feedback request.

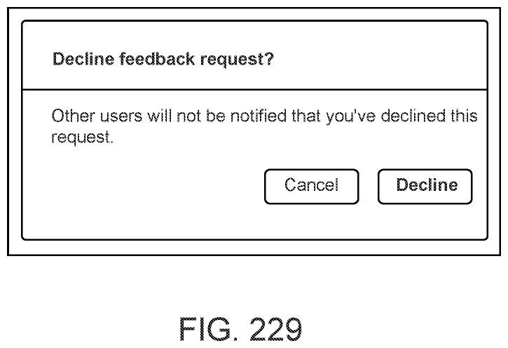

FIG. 229 is a schematic of a confirmation page for declining a feedback request.

The following are steps to decline a feedback request from the Feedback modal:
1. Navigate to Home>Give and request feedback.
2. The Feedback modal will appear; under the Give feedback tab>Pending requests, select Decline.
3. The system will then prompt you to confirm and Decline.

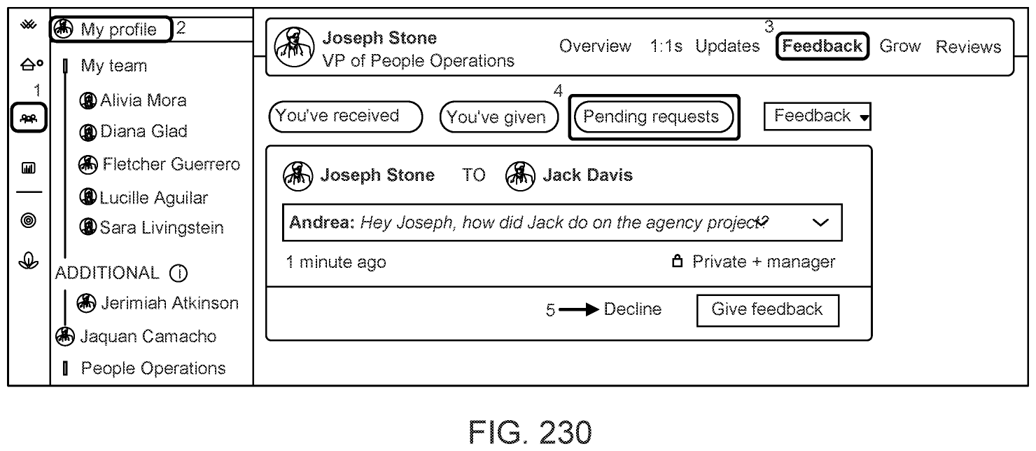

FIG. 230 is a schematic demonstrating how to navigate a user interface to decline a pending feedback request from the people page.

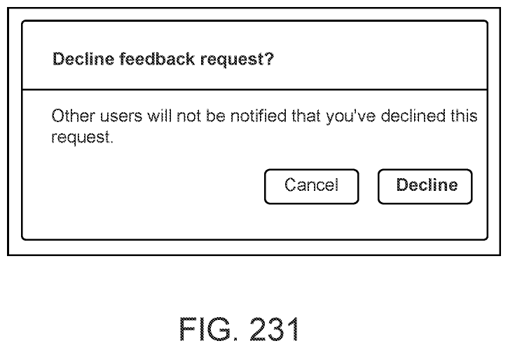

FIG. 231 is a schematic of a portion of a user interface displaying a confirmation page for declining a feedback request.

The following are steps to decline a feedback request from the People page:
1. Navigate to the People page>My profile>Feedback.
2. Filter by Pending requests.
3. Find the relevant request and click Decline.
4. The system will then prompt you to confirm and Decline

After the request has been declined, you can expect:
The request to be removed from your Pending requests.
The associated task will be removed from the Home Page.
Any previous links to fulfill the request will bring the responder back to your Pending requests.

### Notes to Self

Often when submitting feedback, users would like a dedicated space to remember details about another user for future reference. Whether it be a direct report or a peer, the Note to Self feature within Feedback allows you to create private notes about others that you can later refer to when completing reviews.

Any Notes to Self are only visible to the author of the note and will only appear for the note's author in the context panel of reviews for the user the feedback is about.

### View a Note to Self in a Review

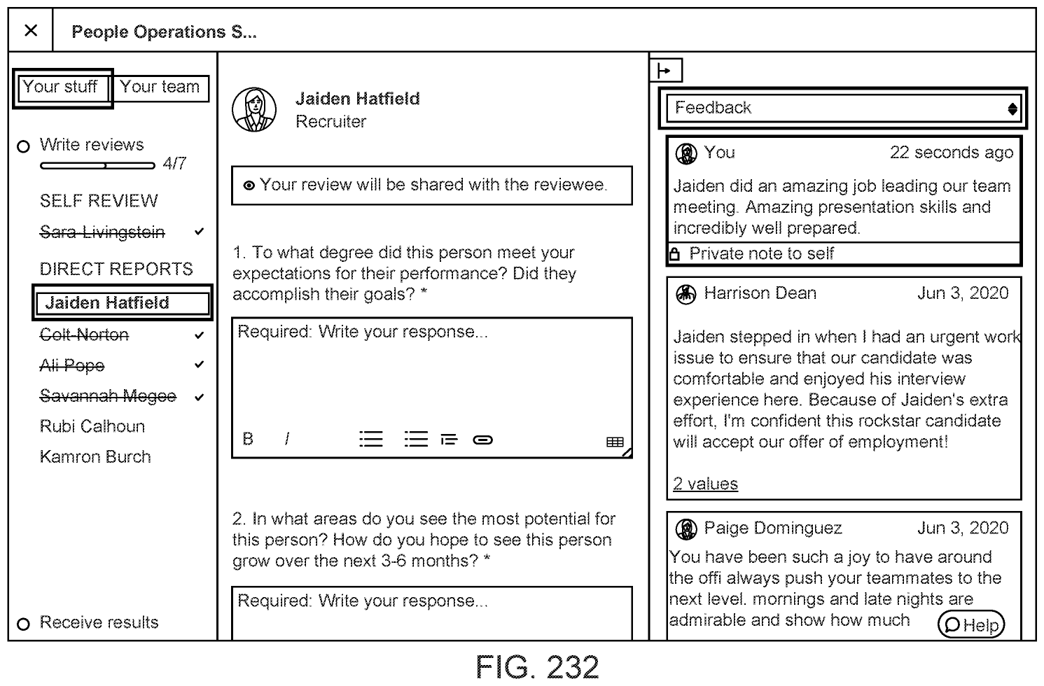

FIG. 232 is a schematic of a user interface displaying a review page for a direct report containing a context panel listing feedback including a note to self

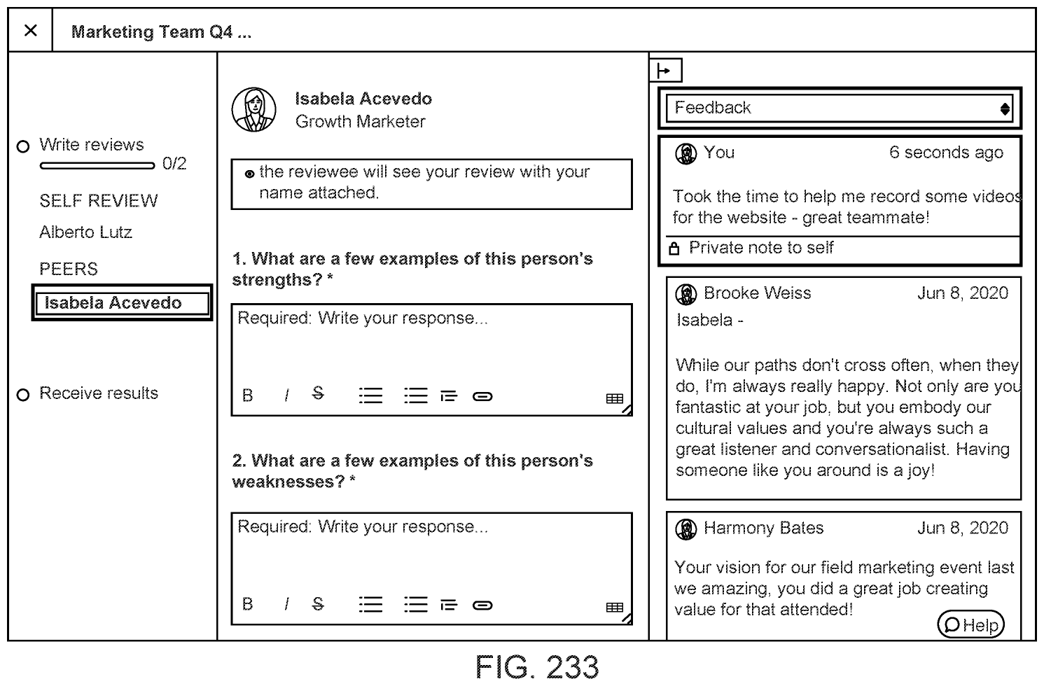

FIG. 233 is a schematic of a user interface displaying a review page for a peer containing a context panel listing feedback including a note to self.

Notes to Self are especially useful when completing a review You can refer to a Note to Self in a review by accessing all feedback in the context panel.

The following are steps to view a note to self in a review as a manager:
1. In the Your stuff tab, select the review for the appropriate individual beneath Direct Reports.
2. In the context panel to the right, select Feedback within the dropdown.

When Feedback is selected, any Notes to Self created for this user by the author of the note will appear in yellow.

The following are steps to view a note to self in a review as a peer:
1. Beneath Peers, select the individual you are writing a review for.
2. In the context panel to the right, select Feedback within the dropdown.

As above, when Feedback is selected, any Notes to Self created for this user by the author of the note will appear in yellow.

### The System's Slack App

The system's Slack app allows the system to meet employees where they work most. Employees can give, request, and respond to feedback requests directly within Slack.

The system's Slack integration must be set up by a user who is both a system and Slack admin.

### Navigate to the System's Slack App

FIG. 234 is a schematic of the Slack user interface displaying a drop-down menu for selecting a user to start a direct message with.

FIG. 235 is a schematic of the Slack user interface displaying a direct message thread with the Lattice app.

The following are steps to navigate to the system's Slack app:
1. In Slack, start a direct message with the system's app.—OR—Navigate to the Apps section, select Lattice to open the app, and begin a direct message.
2. Type and send the word Help to interact with the app.

### Give Public Praise

Public praise given in Slack will be posted to the system and the public Slack channel that your system admin has created.

There are two ways to give public feedback in Slack:
1. Direct messaging with the system's Slack app.
2. By using the custom command: /praise.

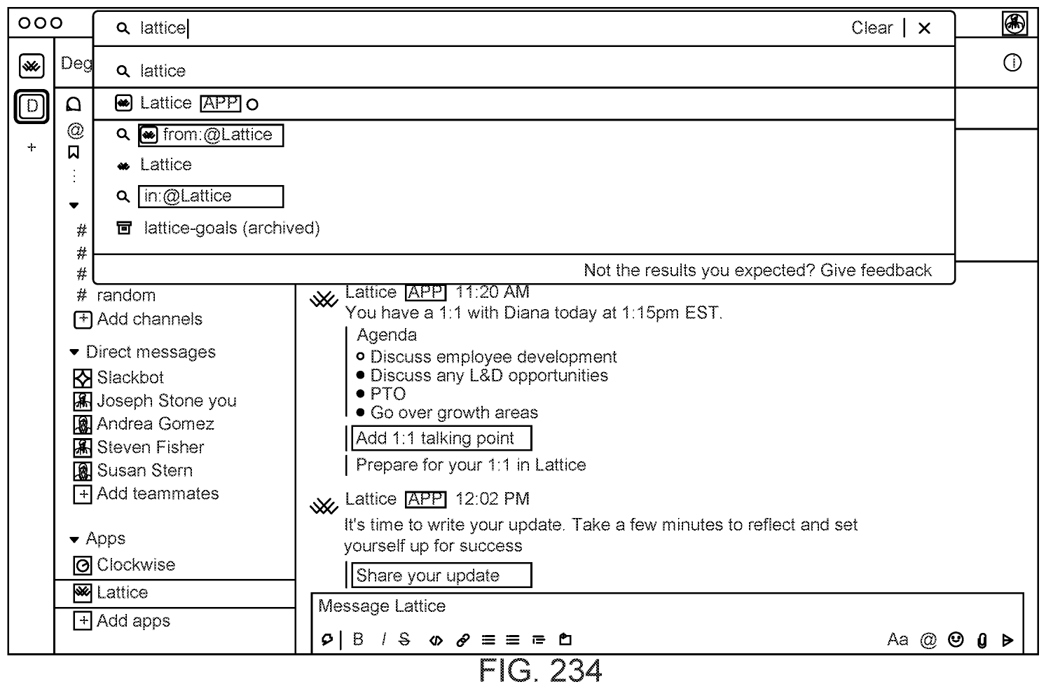

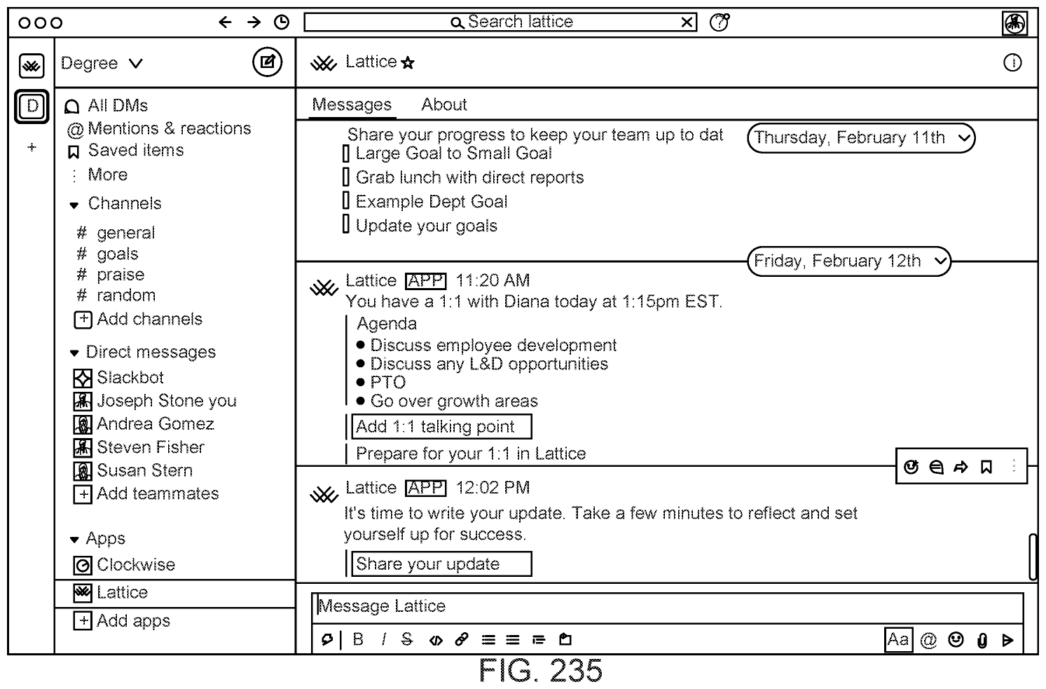

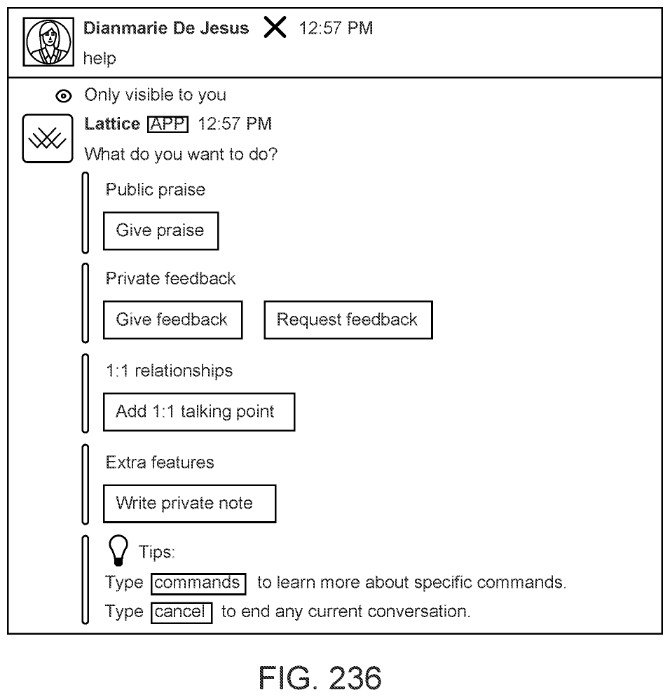

FIG. 236 is a schematic of a portion of the Slack user interface displaying a direct message thread with the System's app containing the action menu.

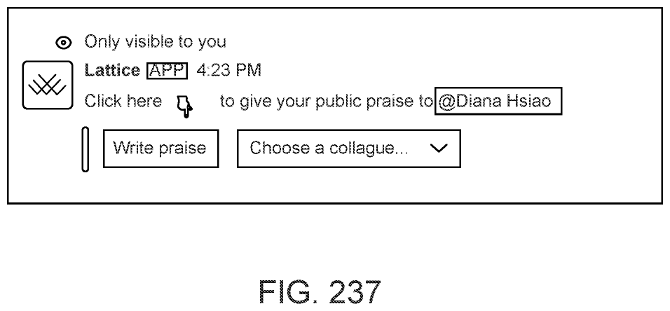

FIG. 237 is a schematic of a portion of the Slack user interface displaying a direct message from the System's app containing a link to submit public feedback.

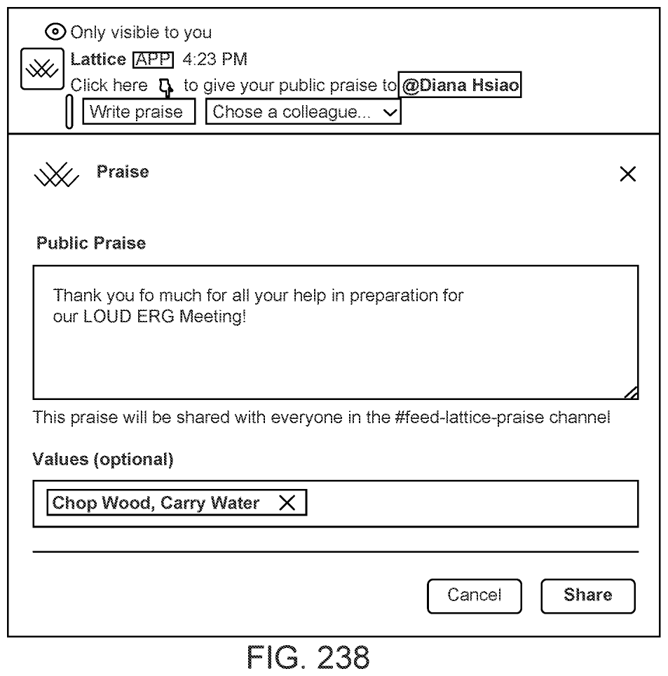

FIG. 238 is a schematic of a portion of the Slack user interface displaying a pop-up modal for submitting public feedback.

The following are steps to give public feedback through a direct message with the System's app in Slack:
1. Open a direct message with the system's Slack app and type Help to open the action menu.
2. Select Give praise.
3. Enter the name(s) of colleagues you would like to give praise to, and then select Write praise.
4. Enter the public praise and select any company values attributed to the feedback.
5. Select Share.

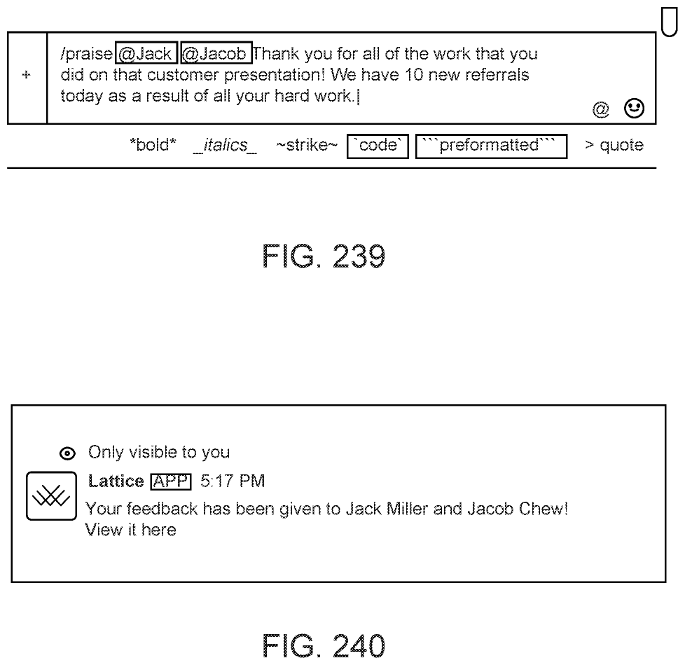

FIG. 239 is a schematic of a portion of the Slack user interface displaying a text box containing the /praise command and text comprising the content of public feedback for individuals.

FIG. 240 is a schematic of a portion of the Slack user interface displaying a confirmation message that public feedback has been submitted.

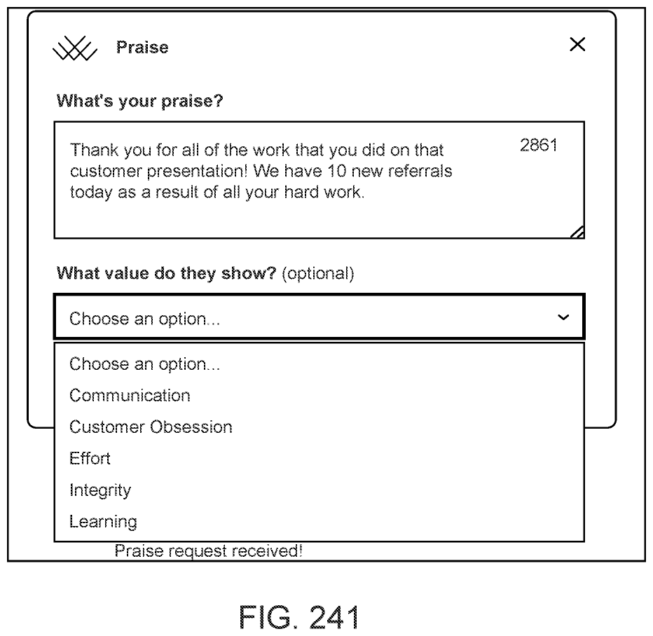

FIG. 241 is a schematic of a portion of the Slack user interface displaying a pop-up modal containing a drop-down menu for adding company values to public feedback.

The following are steps to give public feedback using the custom command /praise in Slack:
1. In any channel, use /praise followed by the Slack username of the person (or people) you want to give feedback to, followed by the content of your feedback.
   Note: When using the /praise command, your feedback will be shared in the system's app and in the dedicated system praise channel in Slack (even if you choose to create and submit the command in any other Slack channel). If public feedback is not enabled, users will receive a Sorry [user], the /praise command is not available right now message.
2. Hit enter to automatically create a piece of public feedback in the system for you.
3. (optional): If your company has company values enabled in Slack, you will be prompted with a pop-up window to add the company values to your Slack feedback.
4. Click Submit, and the feedback will appear in both Slack and the system.

### Give Private or Manager-Only Feedback

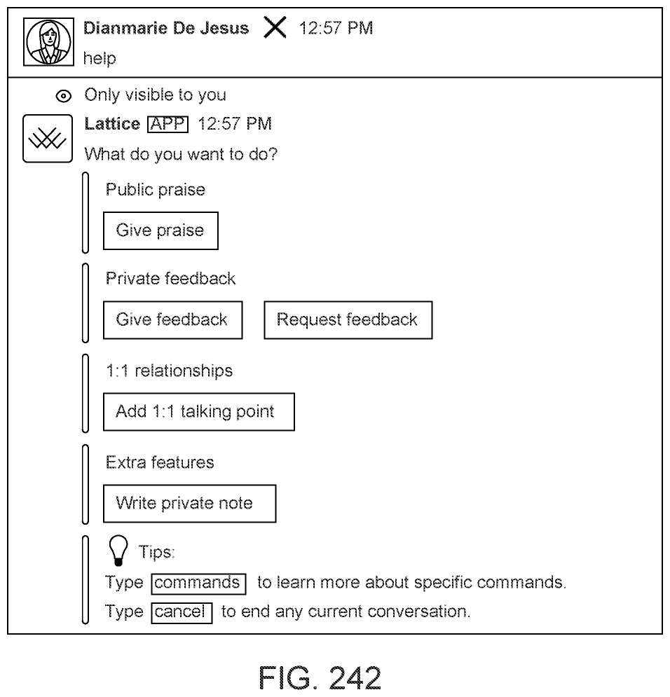

FIG. 242 is a schematic of a portion of the Slack user interface displaying a direct message thread with the System's app containing the action menu.

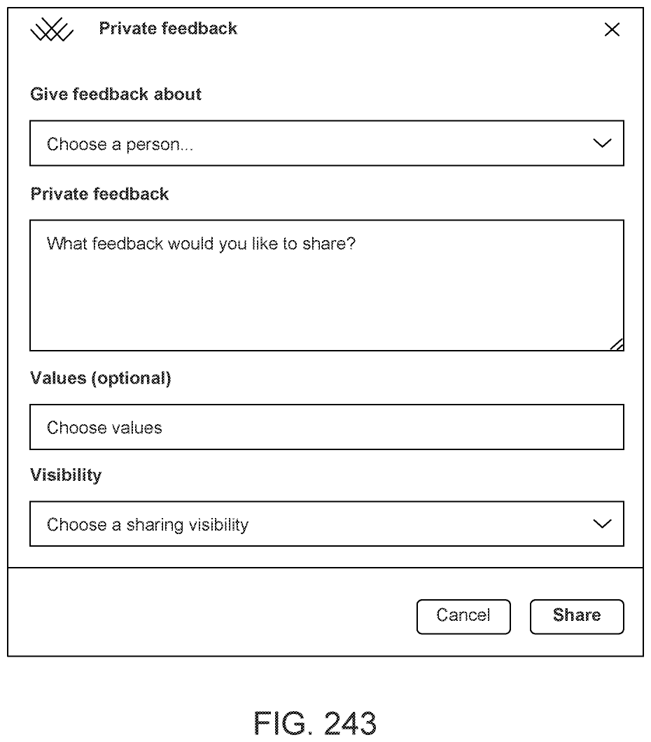

FIG. 243 is a schematic of a portion of the Slack user interface displaying a pop-up modal for providing private feedback.

The following are steps for giving private or manager-only feedback through Slack:
1. Open a direct message with the system's Slack app and type Help to open the action menu.
2. Under Private feedback, select Give feedback.
3. Choose the feedback recipients, write the feedback description, and attach any company values.
4. Choose a sharing visibility.
   Reminder: Private feedback can be sent to just the recipient or just the recipient and their manager. You can determine that level of visibility in the Feedback settings in the system.
5. Select Share.

Once the feedback is submitted, the recipient and their manager will receive an email notification and be able to view the feedback in the system.

Request Private feedback

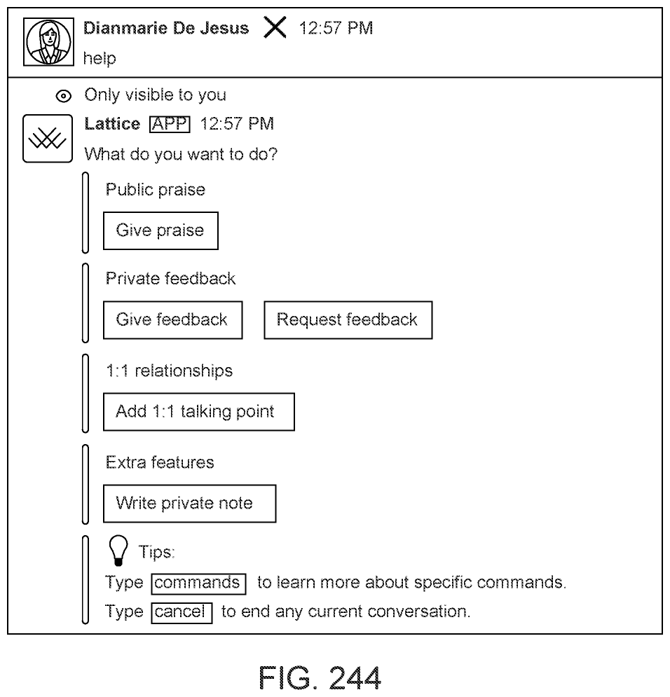

FIG. 244 is a schematic of a portion of the Slack user interface displaying a direct message thread with the System's app containing the action menu.

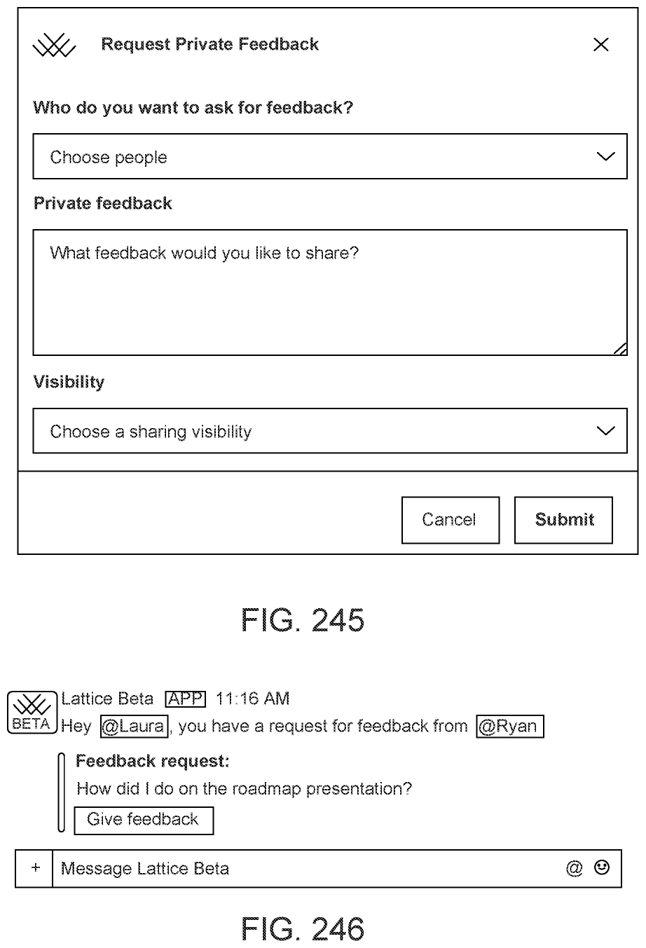

FIG. 245 is a schematic of a portion of the Slack user interface displaying a pop-up modal for requesting private feedback.

Note: The Slack app allows you to request feedback about yourself. Requesting feedback about other employees must be done via desktop.

The following are steps for requesting private feedback through Slack:
1. Open a direct message with the system's Slack app and type Help to open the action menu.
2. Under Private feedback, select Request feedback.
3. Select either to Request feedback internally or, if enabled, Request external feedback.
4. Choose who you want to ask for feedback, and add a description of the request.
5. Choose sharing visibility.

Reminder: Feedback requests can only be shared as Private or Private+manager.

Once the feedback is submitted, the recipient will receive an email notification and task in their system dashboard. Once they have responded to the feedback, the user will receive an email notification and be able to view the feedback in Lattice.

### Respond to Feedback Requests

FIG. 246 is a schematic of a portion of the Slack user interface displaying a direct message thread with the System's app containing a notification of a feedback request.

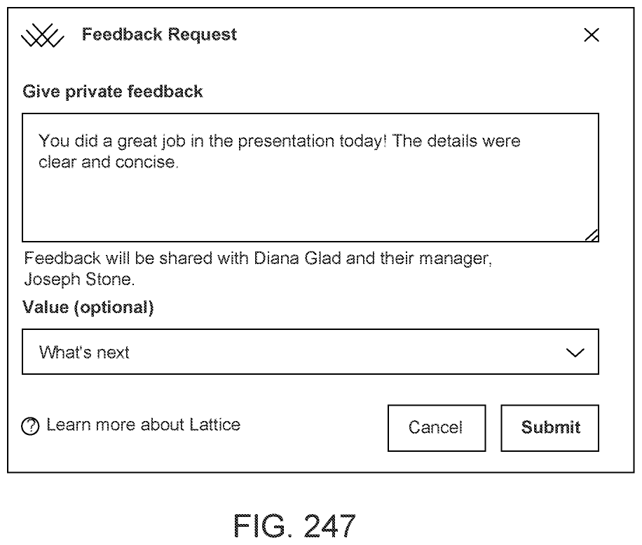

FIG. 247 is a schematic of a portion of the Slack user interface displaying a pop-up modal for responding to a feedback request.

The following are steps to respond to feedback requests through Slack:
1. Slack will notify you if you have received a feedback request. To respond to the request, select Respond to requests.
2. The request will populate—select Give feedback to respond.

Once the feedback is submitted, an email notification will be sent to the recipient and/or their manager. The visibility will always be displayed on the screen before you submit.

### Write a Note to Self

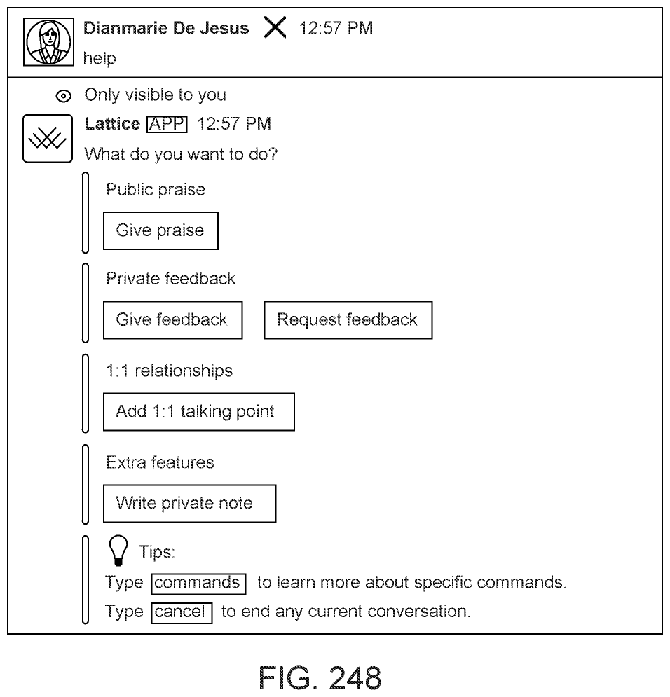

FIG. 248 is a schematic of a portion of the Slack user interface displaying a direct message thread with the System's app containing the action menu.

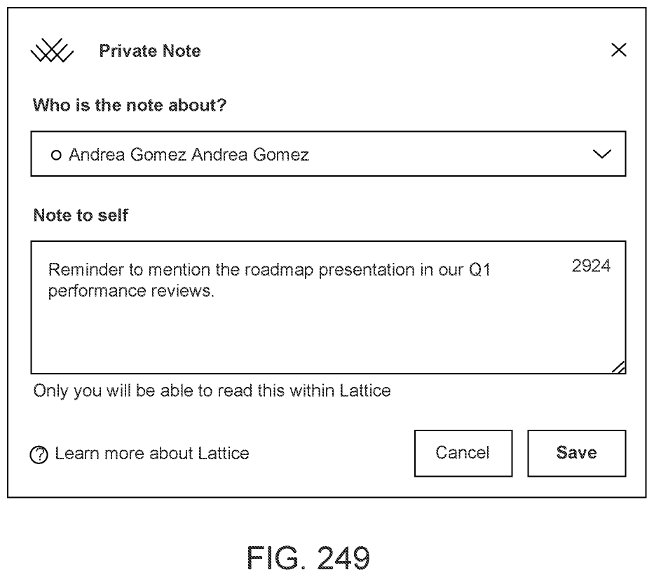

FIG. 249 is a schematic of a portion of the Slack user interface displaying a pop-up modal for providing a private note to self about an individual.

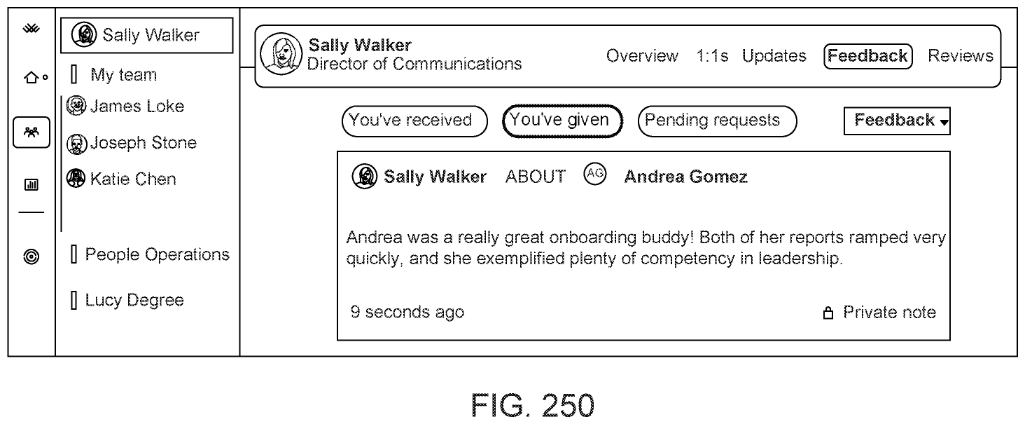

FIG. 250 is a schematic of a user interface displaying a feedback page containing a note to self.

A Note to Self is a private note about either yourself or an employee that is only visible to you. This message is a great way to give yourself a reminder that you can use for a review cycle or a 1:1 meeting.

The following are steps to write a note to self through Slack:
1. Open a direct message with the system's Slack app and type Help to open the action menu.
2. Under Extra features, select Write private note.
3. Choose the employee you want the note to be about and add the note description.
4. Select Save.

Once you write your Note to Self, it will be available on your system Feedback page.

Sharing Feedback with the System's Gmail Plug-In

The system's Gmail plug-in makes it easy to share in-the-moment feedback with teammates, publicly or privately.

Here are some helpful reminders before giving feedback in Gmail:
You must be signed into the system to leave feedback.
Your team member must be an active system user.
While you can give feedback via the Gmail plug-in, you cannot see feedback that you or others have previously received.
If you have issues, try logging in and out of both the system and your Gmail.
You can minimize the extension by clicking on the system icon.

### Install the System's Gmail Plug-In

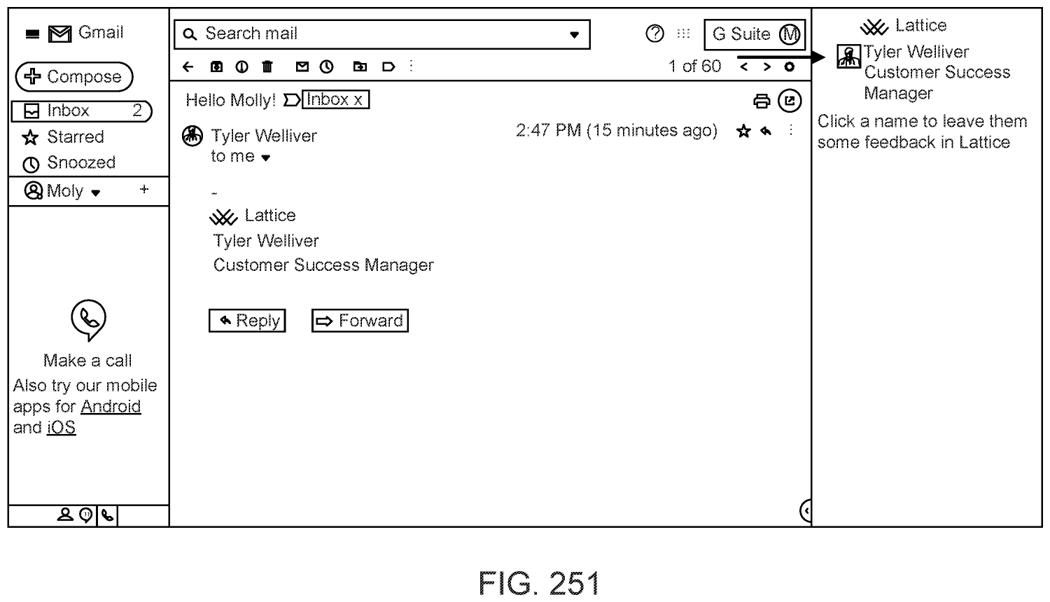

FIG. 251 is a schematic of a Gmail user interface displaying the system plug-in.

The following are steps to install the system's Gmail plug-in:
1. Login to the system via your desktop.
2. Download the Lattice Chrome extension for Gmail.
3. To confirm a successful install, enter an email thread where the sender or recipient(s) are system users.
4. On the right side of your Gmail inbox, you will see the system plug-in; you are all set!

### Give Feedback Via the Gmail Plug-In

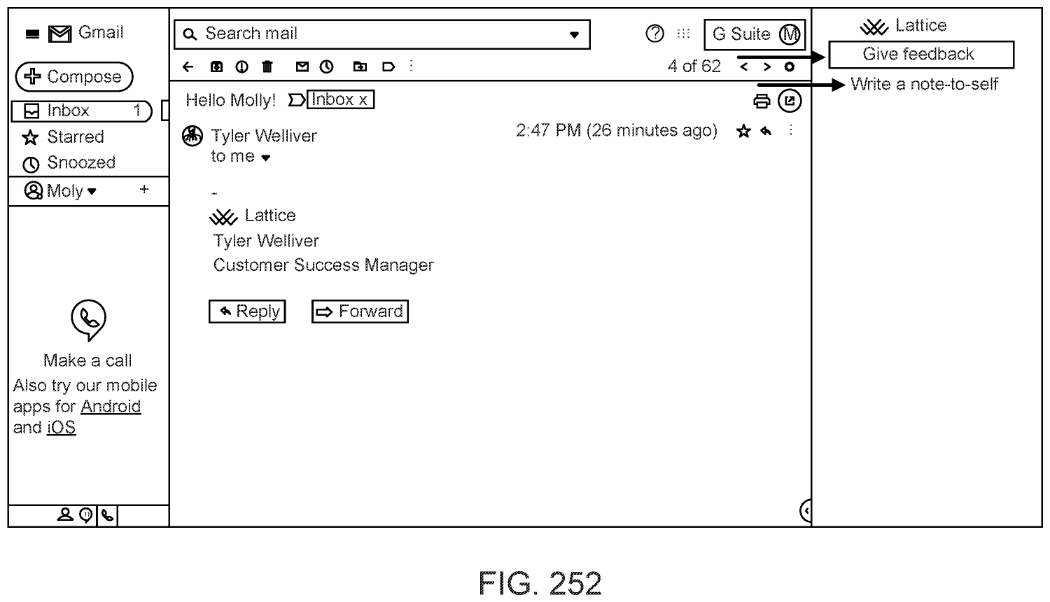

FIG. 252 is a schematic of a Gmail user interface displaying an email thread containing the option to submit feedback or write a note to self.

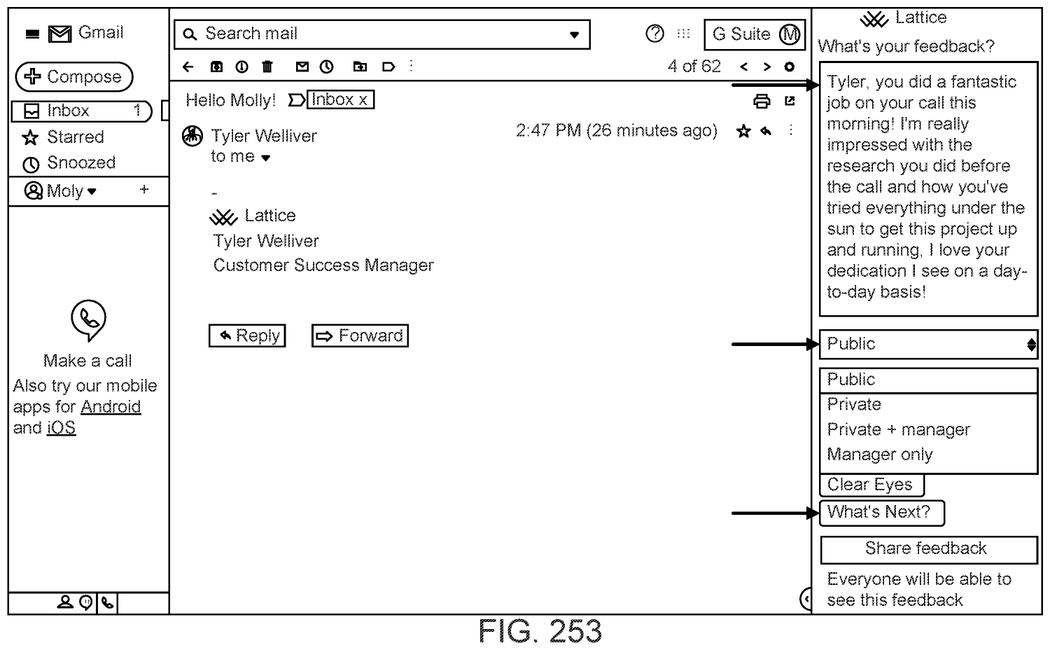

FIG. 253 is a schematic of a Gmail user interface displaying an email thread containing the option to submit feedback, select feedback visibility, and associate a value to the feedback.

The following are steps to submit feedback via the Gmail plug-in:
1. Enter an email thread where the sender or recipient(s) are system users—participating team members will appear within the Gmail plug-in
2. Select the feedback recipient and feedback type:
   Give feedback.
   Write a note-to-self.
   (Note: All note-to-self feedback will only be visible to the author of the note.)
3. Select feedback visibility.
   Public: Everyone will be able to see the feedback.
   Private: Only the recipient will be able to see the feedback.
   Private+manager: Only the recipient and their manager will be able to see the feedback.
   Manager: Only the recipient's manager will be able to see the feedback.
   (The types of feedback available will depend on the Feedback settings selected by the admin.)
4. (optional): If your admin has set up company values, you can associate a value to the feedback before submitting the feedback.

### Give Feedback Via the Mobile App

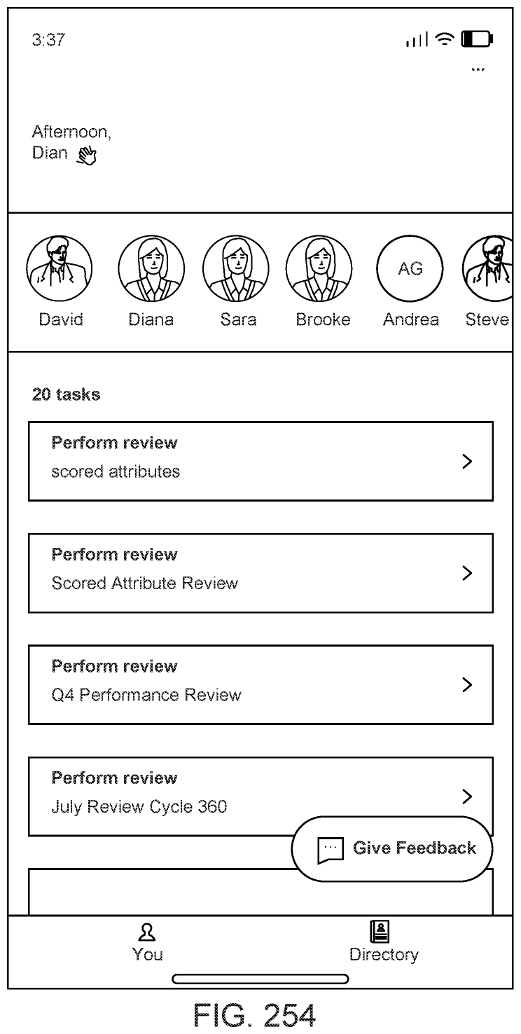

FIG. 254 is a schematic of a mobile user interface displaying a You page containing a give feedback button.

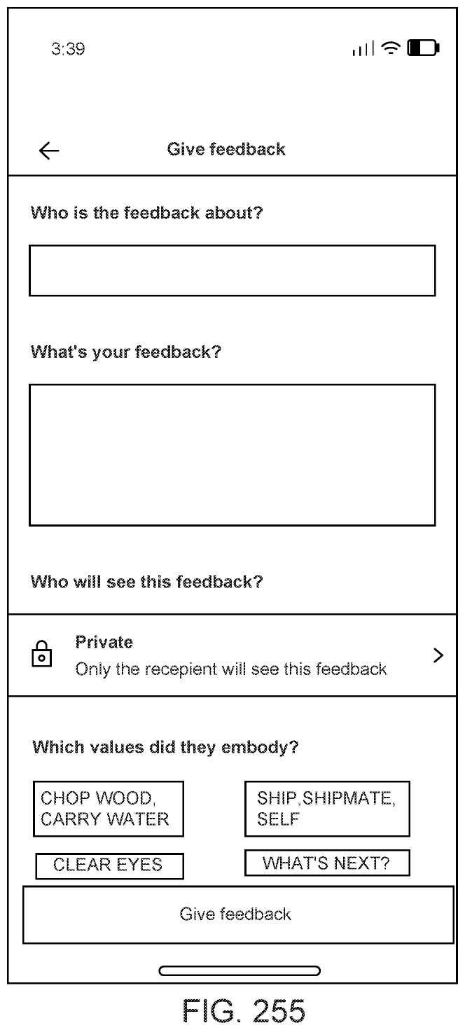

FIG. 255 is a schematic of a mobile user interface displaying a page for submitting feedback and providing associated information.

The system's mobile app focuses on the Feedback experience, giving all Lattice users the ability to give and view feedback they've received away from their computer.

The following are steps for submitting feedback via the mobile app:
1. Click on the blue Give Feedback button on the You page.
2. Under Who is the feedback about?, type the name of the employee who the feedback is about. The system will give you the choice of selecting yourself or a direct report. If the employee does not appear in the dropdown, type in their name in the field and then select.
3. Under What's your feedback?, include a description of what you want the feedback to be about. Please note, if you select to have the feedback as Private manager, the employee receiving the feedback will have visibility into the description.
4. Select visibility: Public, Private, Private+manager, or Manager only.
5. Attach any relevant company values.
6. Select Give feedback

### View Feedback in the Mobile App

You can view any public feedback you or your colleagues have received within the mobile app.

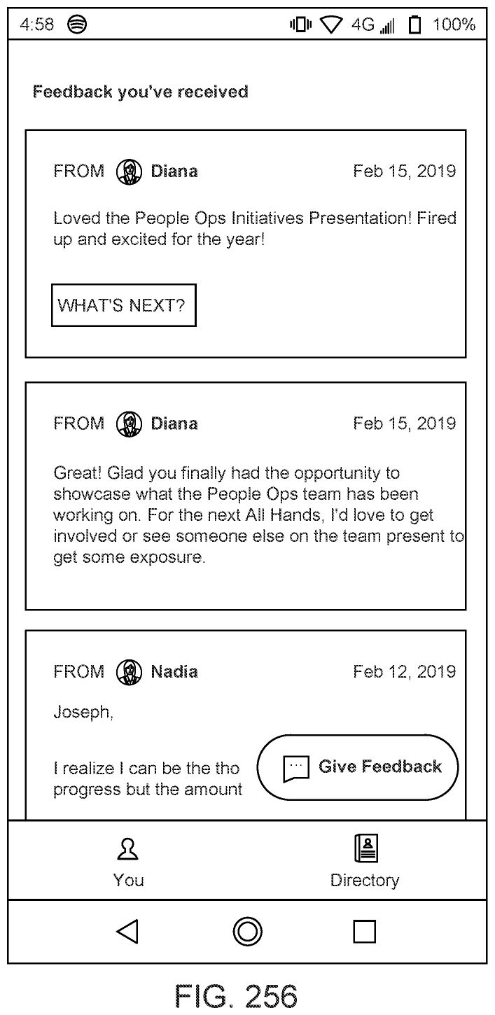

FIG. 256 is a schematic of a mobile user interface displaying a page containing feedback that has been received by the user.

The following are steps to view your feedback in the mobile app:
1. Navigate to the You page.
2. View your feedback under Feedback you've received.

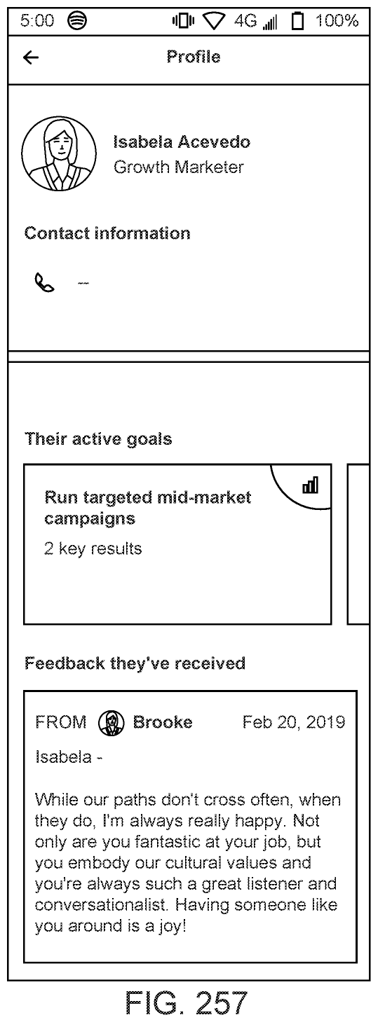

FIG. 257 is a schematic of a mobile user interface displaying a page containing public feedback that an individual has received.

The following are steps to view public feedback for an individual in the mobile app:
1. Navigate to Directory>All employees.
2. Select an employee to enter their profile.
3. View their public feedback under Feedback they've received.

### Feedback Notifications

Once you have navigated to the Notification Center, there are three options for how notifications can be sent when it comes to our Feedback tool—through Slack, Microsoft Teams, and/or through email.

Feedback notifications are sent as follows
When you have been requested to give feedback.
When you have unfulfilled a feedback request.
When you have received feedback.
When a direct report has received Public or Private+Manager feedback.
When a manager is nudged to complete feedback for their direct report.

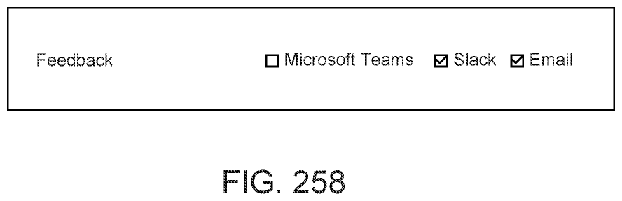

FIG. 258 is a schematic of a portion of a user interface displaying the option to send feedback notifications through Microsoft Teams, Slack, and/or Email.

To send these through Slack, Microsoft Teams, or email, you can check on the boxes to the right of Feedback, as shown in FIG. 258.

Note: Slack notifications are sent via the system's app.

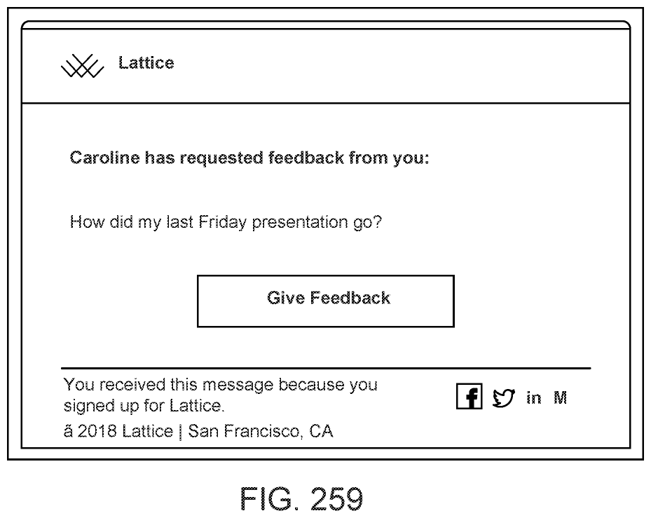

FIG. 259 is a schematic of an email notification indicating that feedback has been requested of the user.

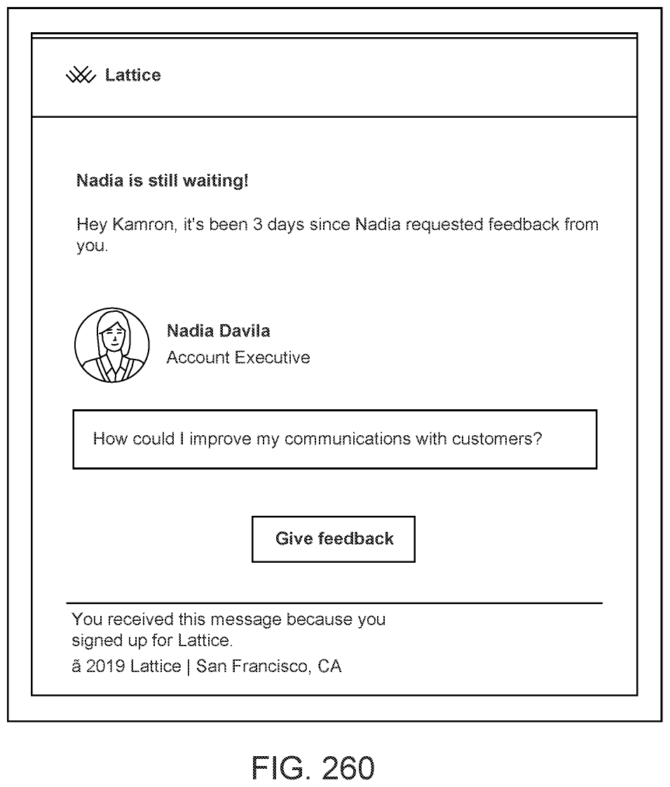

FIG. 260 is a schematic of an email notification indicating the user has an unfulfilled feedback request.

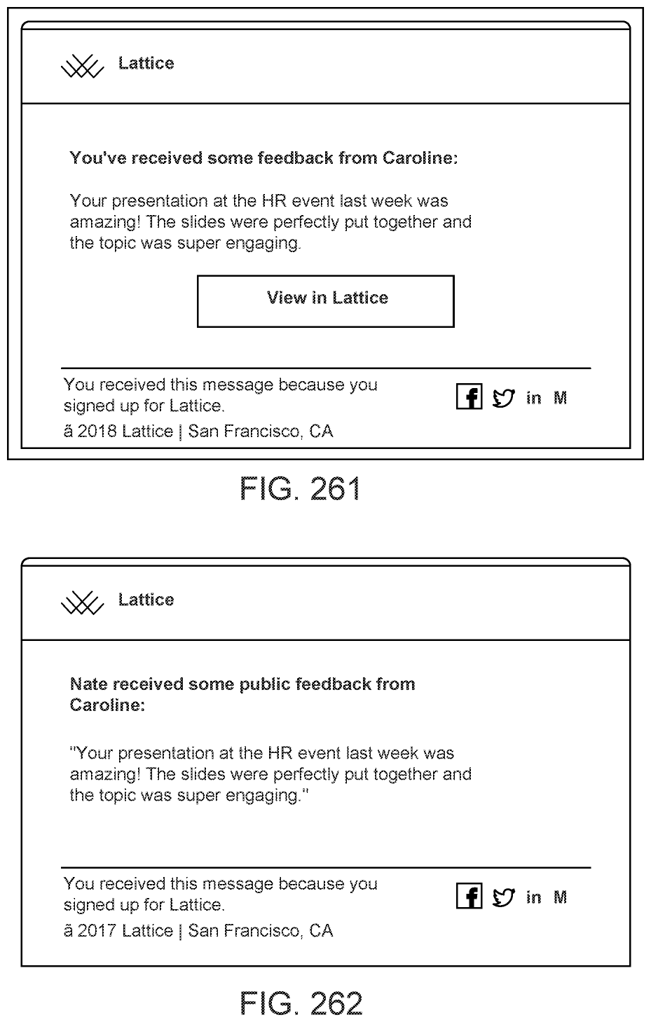

FIG. 261 is a schematic of an email notification indicating the user has received feedback.

FIG. 262 is a schematic of an email notification indicating a direct report has received feedback.

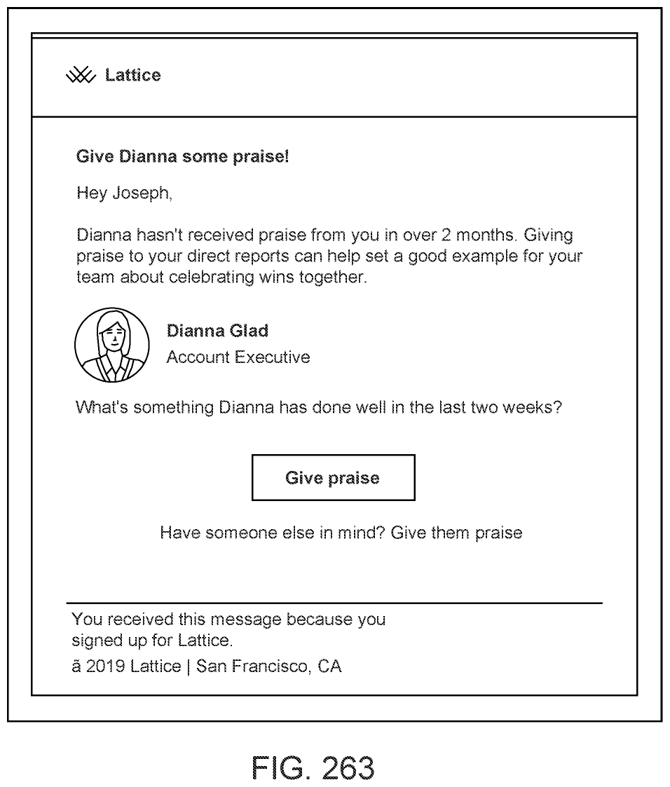

FIG. 263 is a schematic of an email notification indicating a user has received a nudge to complete feedback for a direct report.

Notifications will be sent to employees when:
Someone requests feedback from you. The notification will let you know who has requested the feedback and what feedback they've requested.
When you have an unfulfilled Feedback request. The notification will be sent out 3 business days after your colleague requests feedback from you and will let you know who is waiting for feedback and what feedback they requested
Someone gives you feedback. The notification will let you know you've received feedback.
When your direct report receives feedback. The notification will let you know which direct report received feedback, from whom, and what was said
When a manager is nudged to complete feedback for their direct report. The notification will let you know the name of the direct report the system encourages you to give feedback to.
Note: Feedback Nudges need to be enabled by the account admin

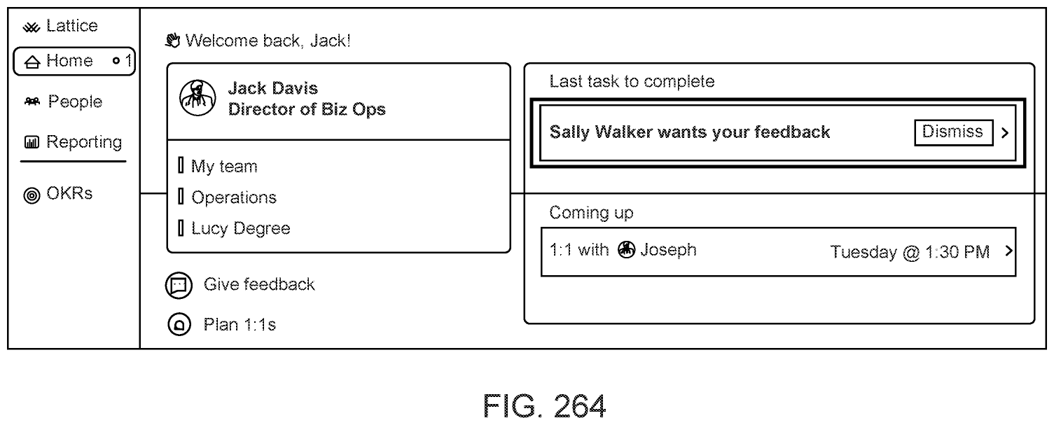

FIG. 264 is a schematic of a user interface displaying a home page containing a task notification for a pending feedback request.

The Feedback tool will only notify users via a task notification if they have a pending feedback request.

When someone requests feedback from you (or a manager requests feedback about their direct report), you will receive a task notification, prompting you to fulfill their request.

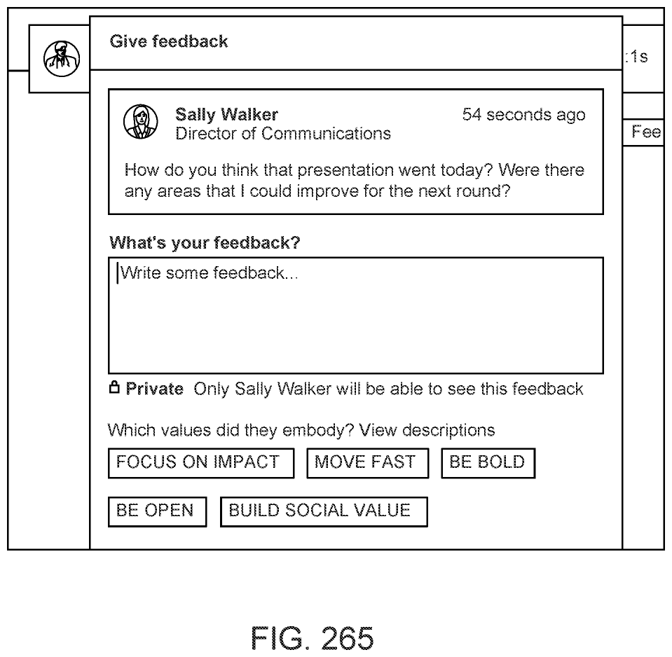

FIG. 265 is a schematic of a user interface displaying a feedback module.

These tasks are always dismissible, but once you click on them, the system will bring you into the feedback module for you to fill out the request.

Once you have navigated to the Notification Center, you will see three options for how notifications can be sent from our Feedback tool, depending on what you have integrated with. You can receive notifications through Slack, Microsoft Teams, or email.

Feedback notifications are sent as follows:
When you have been given feedback.
When a direct report has been given Public or Private+Manager feedback.
When you have been requested to give feedback.

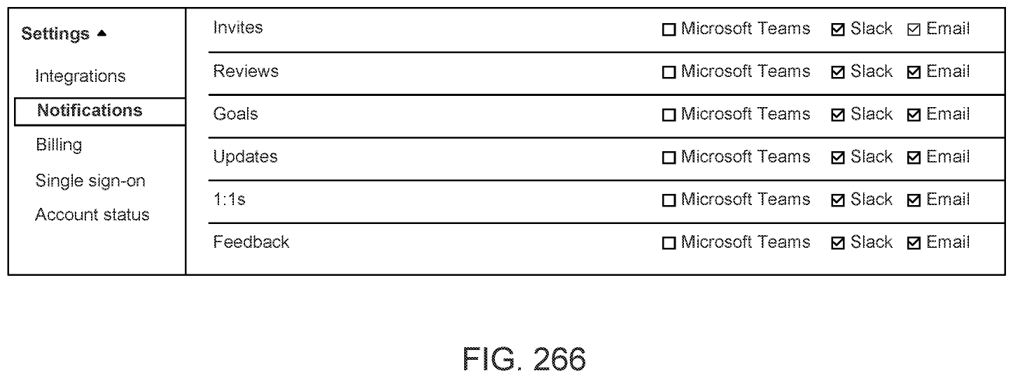

FIG. 266 is a schematic of a portion of a user interface displaying the option to send feedback notifications through Microsoft Teams, Slack, and/or Email.

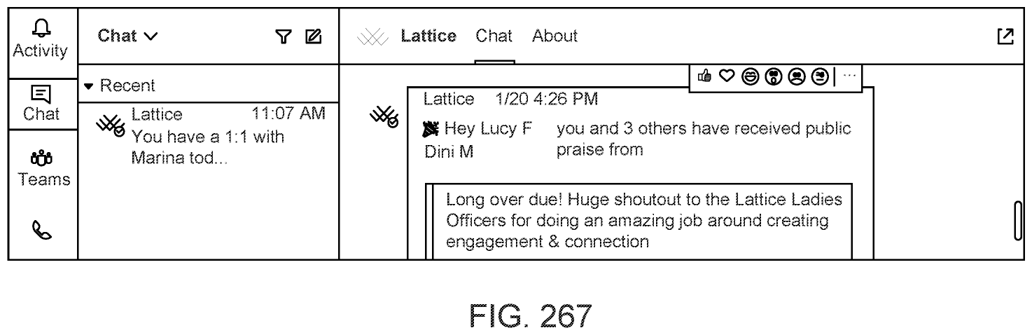

To send these through Slack or email, you can check on the boxes to the right of Feedback, as shown in FIG. 267.

FIG. 267 is a schematic of a portion of a Microsoft Teams user interface displaying a chat window containing a notification.

Teams notifications come through Chat and appear as shown in FIG. 267:

### Example Mobile Device

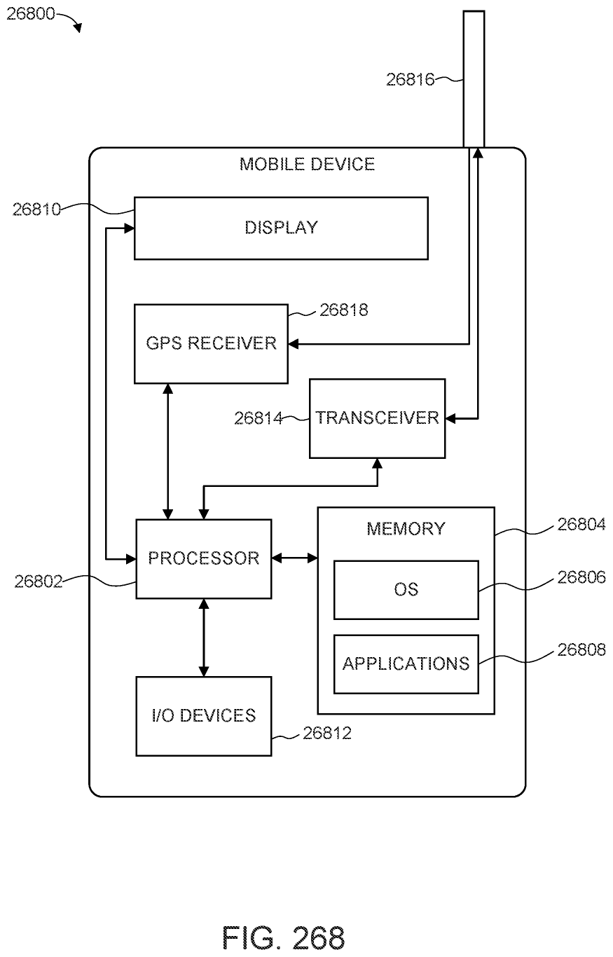

FIG. 268 is a block diagram illustrating a mobile device 26800 according to an example embodiment.

The mobile device 26800 can include a processor 26802. The processor 26802 can be any of a variety of different types of commercially available processors suitable for mobile devices 26800 (for example, an XScale architecture microprocessor, a Microprocessor without Interlocked Pipeline Stages (MIPS) architecture processor, or another type of processor). A memory 26804, such as a random access memory (RAM), a Flash memory, or other type of memory, is typically accessible to the processor 26802. The memory 26804 can be adapted to store an operating system (OS) 26806, as well as application programs 26808, such as a mobile location-enabled application that can provide location-based services (LBSs) to a user. The processor 26802 can be coupled, either directly or via appropriate intermediary hardware, to a display 26810 and to one or more input/output (I/O) devices 26812, such as a keypad, a touch panel sensor, a microphone, and the like. Similarly, in some embodiments, the processor 26802 can be coupled to a transceiver 26814 that interfaces with an antenna 26816. The transceiver 26814 can be configured to both transmit and receive cellular network signals, wireless data signals, or other types of signals via the antenna 26816, depending on the nature of the mobile device 26800. Further, in some configurations, a GPS receiver 26818 can also make use of the antenna 26816 to receive GPS signals.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

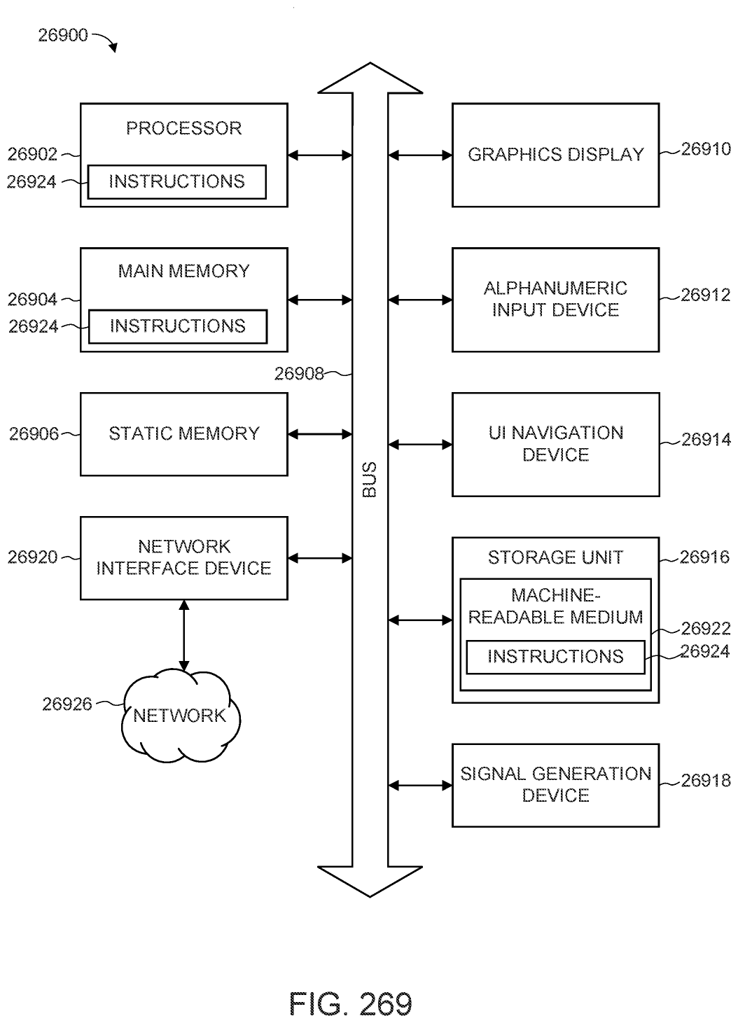

FIG. 269 is a block diagram of an example computer system 26900 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 26900 includes a processor 26902 (e.g., a central processing unit (CPU), a graphics processing unit (GPU) or both), a main memory 26904 and a static memory 26906, which communicate with each other via a bus 26908. The computer system 26900 may further include a graphics display unit 26910 (e.g., a liquid crystal display (LCD) or a cathode ray tube (CRT)). The computer system 26900 also includes an alphanumeric input device 26912 (e.g., a keyboard or a touch-sensitive display screen), a user interface (UI) navigation device 26914 (e.g., a mouse), a storage unit 26916, a signal generation device 26918 (e.g., a speaker) and a network interface device 26920.

### Machine-Readable Medium

The storage unit 26916 includes a machine-readable medium 26922 on which is stored one or more sets of instructions and data structures (e.g., software) 26924 embodying or utilized by any one or more of the methodologies or functions described herein. The instructions 26924 may also reside, completely or at least partially, within the main memory 26904 and/or within the processor 26902 during execution thereof by the computer system 26900, the main memory 26904 and the processor 26902 also constituting machine-readable media.

While the machine-readable medium 26922 is shown in an example embodiment to be a single medium, the term “machine-readable medium” may include a single medium or multiple media (e.g., a centralized or distributed database, and/or associated caches and servers) that store the one or more instructions 26924 or data structures. The term “machine-readable medium” shall also be taken to include any tangible medium that is capable of storing, encoding or carrying instructions (e.g., instructions 26924) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 26924 may further be transmitted or received over a communications network 26926 using a transmission medium. The instructions 26924 may be transmitted using the network interface device 26920 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored in the one or more computer memories, the set of instructions configuring the one or more computer processors to perform operations, the operations comprising:
receiving, via a give feedback tab of a user interface, a selection of a feedback visibility setting for a feedback message from a plurality of predefined feedback visibility settings;
receiving, via the give feedback tab, the feedback message and a selection of one or more recipients;
sending the feedback message to the selected one or more recipients based on the selected feedback visibility setting;
receiving, via a request feedback tab of the user interface, a request for feedback and a selection of one or more feedback providers;
sending the request for feedback to the selected one or more feedback providers; and
storing received feedback responses linked to a user profile of the feedback requestor.

2. The system of claim 1, the operations further comprising:
tracking participation metrics for the one-to-one meetings including a number of meetings completed and a number of agenda items discussed;
generating analytics and reports related to the participation metrics; and
providing the analytics and reports visually to the first participant and second participant.

3. The system of claim 1, the operations further comprising:
causing a manager dashboard to be displayed, the manager dashboard comprising consolidated one-to-one meeting information for a plurality of direct reports of a manager, wherein the manager dashboard displays identified meeting patterns, relationships between meeting effectiveness and employee metrics, and suggested improvements to increase meeting effectiveness.

4. The system of claim 1, wherein the plurality of predefined feedback visibility settings comprises a public setting configurable to make the feedback message viewable by all users in a system, a private setting configurable to make the feedback message viewable only by the selected one or more recipients, a private plus manager setting configurable to make the feedback message viewable by the selected one or more recipients and a manager of the selected one or more recipients, and a manager only setting configurable to make the feedback message viewable only by a manager of the selected one or more recipients.

5. The system of claim 1, the operations further comprising:
in response to determining a private setting is selected, generating a notification of the feedback message only to the selected one or more recipients; or
in response to determining a private plus manager setting is selected, generating a notification of the feedback message to the selected one or more recipients and a manager of the selected one or more recipients; or
in response to determining a manager only setting is selected, generating a notification of the feedback message only to a manager of the selected one or more recipients.

6. The system of claim 1, wherein receiving the request for feedback and the selection of the one or more feedback providers comprises:
displaying, on the request feedback tab, a recipient field configured to receive a selection input identifying the one or more feedback providers;
receiving, via the recipient field, the selection input identifying the one or more feedback providers for the request for feedback;
displaying, on the request feedback tab, a description field configured to receive text input describing the request for feedback;
receiving, via the description field, text input comprising a description of the request for feedback; and
generating the request for feedback based on the identified one or more feedback providers and the received description.

7. The system of claim 1, wherein the one or more feedback providers comprise at least one of one or more employees of an organization, one or more external partners associated with the user, a manager of the user, a dotted-line manager of the user, a project manager associated with the user, a peer of the user, a direct report of the user, an indirect report of the user, or a user-specified custom recipient.

8. The system of claim 7, wherein receiving of the user-specified custom recipient comprises:
displaying, on the request feedback tab, a custom recipient field configured to
receive a user input specifying a custom feedback provider;
receiving, via the custom recipient field, the user input comprising contact information for the custom feedback provider, wherein the contact information includes at least one of an email address, a phone number, or a social media identifier;
verifying the received contact information corresponds to an existing contact by searching a contacts database connected to the system;
in response to verifying the custom feedback provider is an existing contact, assigning the existing contact as the custom feedback provider for the request for feedback; and
in response to failing to verify the custom feedback provider is an existing contact, prompting the user to enter additional information for the custom feedback provider.

9. The system of claim 1, wherein sending the request for feedback to the selected one or more feedback providers comprises:
determining a notification delivery method associated with each of the selected one or more feedback providers;
generating a notification of the request for feedback for each of the selected one or more feedback providers based on the determined notification delivery method, wherein the notification delivery method is at least one of an in-application notification, an email notification; a text message notification, or a third-party communication application notification;
sending the in-application notification to one or more feedback providers via an interface of the system or a third-party application interface, sending the email notification to one or more feedback providers via email, or sending the text message notification to one or more feedback providers via text message.

10. The system of claim 9, wherein sending the in-application notification comprises:
generating a notification event containing the request for feedback;
determining one or more feedback providers for which the in-application notification delivery method is selected; and
for each of the one or more feedback providers, determining an interface associated with the feedback provider, wherein the interface is one of the interface of the system or the third-party application interface, transmitting the notification event to the determined interface, receiving the notification event at the determined interface and extracting the request for feedback from the notification event, and displaying a notification in the determined interface containing information about the request for feedback.

11. The system of claim 1, wherein storing received feedback responses linked to a user profile of the feedback requestor comprises:
receiving a feedback response from a feedback provider in response to the request for feedback;
identifying the feedback requestor associated with the request for feedback;
accessing a user profile of the feedback requestor stored in a profiles database;
linking the received feedback response to the user profile of the feedback requestor;
updating the user profile to include an identifier of the stored feedback response; and
storing, in the profiles database, the linkage between the received feedback response and the user profile of the feedback requestor.

12. The system of claim 11, wherein the linkage between the received feedback response and the user profile of the feedback requestor enables at least one of:
displaying a history of feedback responses linked to the user profile on a user feedback page;
analyzing feedback responses linked to the user profile to generate feedback insights and metrics;
processing feedback responses linked to the user profile to automatically identify development areas for the feedback requestor;
processing feedback responses linked to the user profile to automatically generate feedback nudges;
referencing feedback responses linked to the user profile when evaluating performance and development of the feedback requestor; or
exporting feedback responses linked to the user profile along with user profile information into a report.

13. The system of claim 12, wherein automatically generating feedback nudges comprises:
accessing a nudges settings database connected to the system to identify rules for generating nudges;
analyzing the feedback responses linked to the user profile to determine a last feedback submission date and a praise ratio for the feedback requestor, wherein the praise ratio indicates a proportion of positive feedback;
applying the rules for generating nudges to the last feedback submission date and the praise ratio to determine whether a nudge should be generated;
in response to determining a nudge should be generated based on the rules, selecting a nudge type and generating a nudge notification based on the nudge type; and
sending the nudge notification to a manager of the feedback requestor.

14. The system of claim 1, wherein the request for feedback is a recurring feedback request automatically generated based on feedback collection rules, wherein the rules specify at least one of a feedback category to be collected, a periodicity of collecting feedback, a feedback visibility after collection, a group of feedback providers to request feedback from, or a set of questions to include in the request for feedback.

15. The system of claim 1, wherein receiving the request for feedback comprises:
receiving a feedback request initiated through a third-party application interface;
extracting details of the feedback request from the third-party application interface, wherein the extracted details include at least an identification of one or more feedback targets and a feedback visibility; and
generating the request for feedback based on the extracted details.

16. The system of claim 15, wherein the third-party application interfaces comprises at least one of a human resources management system interface, a customer relationship management system interface, an email application interface, a messaging application interface, a project management system interface, a performance management system interface, a code repository management system interface, or a social media application interface.

17. The system of claim 1, wherein the user interface comprises:
a summary display region presenting a limited set of selectable options related to feedback management, wherein the summary display region and configuration display region remain visible on the user interface during selection of options and settings related to feedback management; and
a configuration display region presented concurrently with the summary display region, the configuration display region comprising adjustable settings related to feedback.

18. The system of claim 1, the operations further comprising:
dynamically exhibiting a first indicator in one of multiple positions in a feedback visualization region of the user interface, each position in the feedback visualization region representing a corresponding time interval along a constant time scale, the first indicator conveying a quantity of feedback received within the corresponding time interval;
presenting the feedback visualization region with the fixed time interval labels along the constant time scale such that when new feedback is received, the time interval labels remain stationary and the first indicator changes position relative to the constant time scale;
providing a feedback entry area with positions corresponding to time intervals along the constant time scale; and
in response to a selection of a position within the feedback entry area, establishing a time interval for a new feedback entry associated with the selected position along the constant time scale.

19. A method comprising:
receiving, via a give feedback tab of a user interface, a selection of a feedback visibility setting for a feedback message from a plurality of predefined feedback visibility settings;
receiving, via the give feedback tab, the feedback message and a selection of one or more recipients;
sending the feedback message to the selected one or more recipients based on the selected feedback visibility setting;
receiving, via a request feedback tab of the user interface, a request for feedback and a selection of one or more feedback providers;
sending the request for feedback to the selected one or more feedback providers; and
storing received feedback responses linked to a user profile of the feedback requestor.

20. A non-transitory computer-readable storage medium storing a set of instructions that, when executed by one or more computer processors, cause the one or more computer processors to perform operations, the operations comprising:
receiving, via a give feedback tab of a user interface, a selection of a feedback visibility setting for a feedback message from a plurality of predefined feedback visibility settings;
receiving, via the give feedback tab, the feedback message and a selection of one or more recipients;
sending the feedback message to the selected one or more recipients based on the selected feedback visibility setting;
receiving, via a request feedback tab of the user interface, a request for feedback and a selection of one or more feedback providers;
sending the request for feedback to the selected one or more feedback providers; and
storing received feedback responses linked to a user profile of the feedback requestor.
